(19) United States
(12) Patent Application Publication
(10) Pub. No.: US 2016/0048934 A1
(43) Pub. Date: Feb. 18, 2016

(54) Property Scoring System & Method

(71) Applicant: Real Data Guru, Inc., Palo Alto, CA (US)

(72) Inventor: John Nicholas Gross, Berkeley, CA (US)

(21) Appl. No.: 14/874,270

(22) Filed: Oct. 2, 2015

Related U.S. Application Data
(63) Continuation-in-part of application No. 14/499,057, filed on Sep. 26, 2014.
Application No. 14/499,057 is a continuation-in-part of application No. 14/499,061, filed on Sep. 26, 2014.
(60) Provisional application No. 61/990,429, filed on May 8, 2014.
(60) Provisional application No. 61/883,609, filed on Sep. 27, 2013.
(60) Provisional application No. 61/990,429, filed on May 8, 2014.
(60) Provisional application No. 61/883,609, filed on Sep. 27, 2013.

(51) Int. Cl. G06Q 50/16; G06F 17/30

(52) U.S. Cl. CPC G06Q 50/16; G06F 17/30876; G06F 17/30241; G06F 17/30525

(57) ABSTRACT

A home rating and assessment system includes logic configured to identify, analyze and rate features of properties in accordance with customizable filters. By accounting for specific structural aspects of properties, including key structural features, their workmanship, condition, etc. more precise estimates can be calculated for rating/ranking homes relative to each other for particular industries.

### RELATED APPLICATION DATA

The present application is a continuation-in-part and claims the benefit of the filing date of U.S. Ser. Nos. 14/499,057 and 14/499,061, which applications claim the benefit under 35 U.S.C. 119(e) of the priority date of Provisional Application Ser. Nos. 61/990,429 filed May 8, 2014 and 61/883,609 filed Sep. 27, 2013; and is further related to the following filed on the present date entitled:

Clustered Property Marketing Tool & Method (application Ser. No. ______, JNG 2014-1CIP2)

Tag Based Property Platform & Method (application Ser. No. ______, JNG 2014-1 CIP3)

all of the above which are hereby incorporated by reference herein.

### FIELD OF THE INVENTION

The present invention relates to automated tools, methods and systems which permit scoring of properties according to different customizable criteria. The invention has particular utility in the areas of real estate prospecting, appraisals, insurance, home improvement, targeted marketing, and similar domains where it is desired to easily and rapidly assess property stock according to different contexts, requirements, etc.

### BACKGROUND

Competition for housing stock is rapidly increasing in the United States. In some areas turnover of housing is extremely small and cannot satisfy demand. The problem is exacerbated as people live longer and stay in their residences for longer periods than in the past. Young families have significant difficulties finding suitable existing homes for rent or purchase in many desirable areas.

Current and useful information about housing stock is often both incomplete and inaccurate. While some details can be found at governmental websites (tax authorities, planning departments) and at sites such as Zillow, Trulia, Redin, etc., there is no easy mechanism by which a prospective renter or purchaser can search and locate properties that—while not in perfect condition—may be good leads. For example many homes are dilapidated or in poor condition as a result of owners being unable to maintain such properties (or attendant grounds) because of age, poor health, etc. In some instances the is structure is not even inhabited. These homes would be excellent leads for housing opportunities but currently go undiscovered and thus unexploited due to inadequate research and assessment tools.

In a similar vein other interested parties would benefit from more detailed knowledge on the types and conditions of housing stock in their areas. For example public agencies should be kept aware of the health and welfare of citizens who may be too elderly to travel on their own, or respond to phone calls. Construction and home building supply, insurance and other providers are also similarly unable to quickly and accurately assess the health of housing stock with current tools.

While some tools have been used in the past to assess buildings, these have been limited and do not address the problems above. For example, generic image databases of real estate properties are shown in U.S. Pat. No. 5,794,216. U.S. Pat. No. 8,078,436 to Pershing et al., and US Publication No. 2003/0171957 to Watrous (both incorporated by reference herein) are all directed to simple overhead, top down aerial inspections of the roofs of structures. Such system typically rely on satellite or other image databases. Billman (U.S. Pat. No. 8,289,160) requires a number of sensors in a house from which he records data such as temperature, water pressure, humidity, etc. to assess a future risk of damage or destruction of the structure. Schwartz (US Publication No. 2004/0162710) requires a manual inspection form for rating a risk of mold. Similarly, Pendergast et al. (U.S. Pat. No. 5,842,148) incorporates a manual inspection form that is used to assess a risk of damage to a house as a result of physical disturbance such as wind, earthquakes, etc.

U.S. Pat. No. 5,742,335 issued in 1998 to Cannon (incorporated by reference herein) teaches the use of a camera system for surveying a property. The setup is quite complicated, however, and requires extensive manpower to implement. Maciejczak (U.S. Pat. No. 4,550,376 incorporated by reference) similarly uses a complex unmanned apparatus for capturing condition information for a structure. However, in both references little or no automated processing is done of the captured structure information. Cannon for example teaches only is that recordings capture over time can be manually examined to detect weathering changes. Despite these older teaching, the state of the art has not improved beyond what is shown therein.

In addition there is a considerable market in the US for home improvement goods and services, such as for example, windows, landscaping, siding, paint, roofing, plumbing and similar products to name a few. Companies in this space have traditionally used generic flyers for marketing purposes, as they have little or no specific structural information for a specific property. Current hard copy advertising materials therefore are represented by the examples shown in FIG. 9. Furthermore, to date such types of entities have not targeted groups of homes in a neighborhood by identifying common issues with structures that could induce or at least incentivize group purchasing behavior.

### SUMMARY OF THE INVENTION

An object of the present invention, therefore, is to reduce and/or overcome the aforementioned limitations of the prior art.

### DESCRIPTION OF THE DRAWINGS

FIG. 1 is an illustration of components of an embodiment of a real estate assessment system of the present invention;

FIG. 2 illustrates an exemplary method used for identifying and assessing real estate in accordance with the present teachings;

FIGS. 3A-3C illustrate an exemplary method used for identifying and reporting on real estate leads in accordance with the present teachings;

FIG. 4 illustrates an exemplary structure/format used for collecting and storing parameters associated with real estate leads in accordance with the present teachings;

FIG. 5 illustrates an exemplary method used for processing real estate image information to identify and log key features in accordance with the present teachings;

FIGS. 6A-6B illustrate examples of images and features that can be identified and rated in accordance with the teachings of the present disclosure;

FIGS. 7A-7E illustrate examples of image processing, feature processing and reporting for a typical building structure that can be performed in accordance with the teachings of the present disclosure;

FIG. 8 illustrates an example of a reference structure and image/feature processing that can be employed with embodiments of the present invention.

FIG. 9 illustrates examples of prior art advertising and marketing to home/property owners for products and services;

FIG. 10 shows a typical city sized block in a residential neighborhood which can be assessed and targeted in accordance with embodiments of the present teachings;

FIG. 11 identifies examples of structural features, parameters, conditions, etc. that can be identified, assessed, tagged, coded and stored for a particular building structure in a city block in accordance with embodiments of the present teachings;

FIG. 12 identifies further examples of structural features, parameters, conditions, etc. that can be identified, assessed, tagged, coded and stored for another structure in a city block in accordance with embodiments of the present teachings;

FIG. 13 identifies other aspects of structural features that can be classified in accordance with embodiments of the present teachings;

FIG. 14 provides an exemplary embodiment of a targeted advertisement generated for a property owner identifying a specific structure and specific improvements identified by a classification system of the present invention;

FIG. 15A provides an exemplary embodiment of a second variant of a targeted advertisement, customized delivery envelope and customized coupons generated for a property owner for a specific structure, products, services, etc. in is accordance with embodiments of the present invention;

FIG. 15B provides an exemplary embodiment of a third variant of a targeted advertisement for a property owner for a specific structure, products, services, etc. in accordance with embodiments of the present invention;

FIG. 16 illustrates a preferred embodiment of a data acquisition process used by a classifier of the present invention for building structures in a target city;

FIG. 17A illustrates a preferred embodiment of a structure coding process used by a classifier of the present invention for building structures in a target city;

FIG. 17B illustrates a typical structure coding as it would be performed in accordance with embodiments of the present invention including as shown in;

FIG. 18A depicts an exemplary embodiment of a query engine and interface that can be implemented in accordance with the present teachings to facilitate identifying relevant properties matching a particular target structural profile;

FIG. 18B depicts an exemplary embodiment of a query result list for a vendor can be implemented in accordance with the present teachings to facilitate identifying relevant properties matching a particular target structural profile;

FIG. 19 depicts an exemplary embodiment of a query engine and interface that can be implemented in accordance with the present teachings to facilitate identifying relevant properties matching a particular target product profile;

FIG. 20A depicts an exemplary taxonomy that can be employed to map structure features, impairments, etc., categories to respective product/service categories, or vice versa to facilitate responding to queries and identifying prospects for customized advertising;

FIG. 20B depicts an exemplary graphical interface that may be presented to a user seeking to make home improvements;

FIG. 20C shows a block diagram of an exemplary automated computing process that can be employed to assist homeowners and merchants coordinate for remodeling and renovation projects;

FIG. 21 depicts a preferred embodiment of a preferred tailored advertisement marketing engine implement in accordance with the present is teachings;

FIG. 22 shows a block diagram of a preferred embodiment of an overall direct marketing system implemented in accordance with the present teachings;

FIG. 23 shows a preferred embodiment of a property/structure owner verification process that can be implemented in accordance with the present teachings;

FIGS. 24-1 and 24-2 show a preferred embodiment of a vendor interface that can be used by a vendor to identify, create and target particular property structures in a geographic area.

FIGS. 25A and 25B depict an exemplary auction process for matching vendor products to targeted structures in response to queries, including general keyword queries at a conventional search engine.

FIG. 26A depicts a neighborhood noise scoring process that can be implemented algorithmically by embodiments of the invention;

FIG. 26B illustrates a graphical noise map that can be generated and presented by embodiments of the present invention;

FIG. 27A is a graphical housing coding interface that is implemented by embodiments of the present invention;

FIGS. 27B and 27D are graphical search/search interfaces implemented by embodiments of the present invention;

FIG. 27C is a graphical mapping/reporting interface that is implemented by embodiments of the present invention;

FIG. 28A depicts a first graphical component of a HomeScore™ Report generated in accordance with embodiments of the present teachings;

FIG. 28B depicts a second graphical component of a HomeScore™ Report generated in accordance with embodiments of the present teachings;

FIG. 28C describes a home scoring process and algorithmic logic suitable for generating the aforementioned Homescore™ Report;

FIG. 28D describes an image decomposition process used in the aforementioned home scoring process;

FIG. 28E depicts a label and annotation layout process used to generate a HomeScore™ Report generated in accordance with embodiments of the present teachings;

FIG. 28F depicts a spreadsheet algorithm used to calculate a HomeScore™ report in accordance with embodiments of the present invention;

FIGS. 29A-29D depict examples of a graphical Home CurbReport™ scoring feature implemented in accordance with the present teachings;

FIG. 29E is a depiction of a graphical interface useable for customizing a CurbReport™ score for a set of properties;

FIG. 29F depicts an example of a graphical interface that provides sorted text based output for identifying homes meeting predefined CurbReport™ criteria;

FIG. 29G depicts an example of a graphical interface that provides a visual map based output for identifying CurbReport™ scores;

FIG. 29H is a depiction of a spreadsheet interface useable for customizing a CurbReport™ score for a set of properties;

FIGS. 30A-30B identify a prior art system for locating home improvement services based on a user query;

FIG. 30C depicts a first embodiment of an automated enhanced cluster based advertising targeting system implemented in accordance with embodiments of the present invention in which clusters are preferably derived from expert home report data provided by an expert third party system;

FIGS. 30D-30E describe visually analytical approaches used in embodiments the enhanced cluster based advertising targeting system implemented in accordance with embodiments of the present invention;

FIGS. 30F-30H are exemplary embodiments of enhanced cluster based electronic coupons implemented in accordance with embodiments of the present invention;

FIG. 30J depicts a second embodiment of an automated enhanced cluster based advertising targeting system implemented in accordance with embodiments of the present invention in which clusters are preferably derived is from queries provided at a general home improvement portal;

FIG. 30K is an example of a visual cluster based coupon presented to a homeowner for identifying prospective neighbor/partners that could participate in a merchant cluster;

FIG. 30L is an example of a visual graphical map presented to a homeowner for identifying prospective neighbor/partners that could participate in a merchant cluster;

FIG. 30M shows real-world samples and demonstrations of the utility of the invention(s) in assessing and identifying housing structures for potential home improvements/services;

FIG. 31A is a visual depiction of different representative stakeholders participating in and contributing to an automated property tag platform through different modalities and interactions;

FIG. 31B is a visual depiction of a representative record of different tag types associated with a target property;

FIG. 31C shows a graphical web or mobile visual map generated by embodiments of the invention, in which merchant property tags are presented in a virtual property gallery;

FIG. 31D shows a graphical web-based visual house profile generated by embodiments of the invention, in which merchant property tags are presented for a target property;

FIG. 31E shows a first variant of graphical mobile app interface generated by embodiments of the invention, in which merchant property tags are selectable and presented for a target property;

FIG. 31F shows a second variant of a graphical mobile app interface generated by embodiments of the invention, in which merchant property tags are selectable and presented for a target property;

FIG. 31G shows an entry screen generated by embodiments of the invention for selecting different modalities of tags, in which property tags are input and output based on a profile/type of a mobile app user and a selected modality;

FIG. 31H shows an entry screen generated by embodiments of the invention for inputting different types of tags and metadata for a target property;

FIG. 31J shows a structure of an algorithm that presents and collects tags to a user within a mobile interface;

FIG. 32A is a block diagram of the main components of an automated property tag platform implemented in accordance with the present teachings;

FIG. 32B is a depiction of a mobile app property tag screen interface generated in accordance with the present teachings configured for inputting gamer/pedestrian tags/metadata;

FIG. 32C is a depiction of a property tag screen interface generated in accordance with the present teachings configured for inputting homeowner tags/metadata;

FIG. 32D is a depiction of a property tag screen interface generated in accordance with the present teachings configured for inputting neighbor(hood) tags/metadata;

FIG. 32E is a depiction of a property tag screen interface generated in accordance with the present teachings configured for inputting expert rating tags/metadata;

FIG. 32F is a depiction of different automated tags (both positive and negative) that are created by embodiments of the present invention for soliciting input from property raters;

FIG. 32G is a block diagram of the main components and flow of an automated system 3200 implemented in accordance with the present teachings;

FIG. 32H depicts components of a preferred tag job generated by the system of FIG. 32G;

FIG. 32J identifies the main components of a tag prioritization engine used in the system of FIG. 32G

It will be apparent to those skilled in the art that the aforementioned diagrams, figures and discussion describe and identify algorithms and substantial architectural framework to permit a skilled artisan to implement such features as is described herein.

### DETAILED DESCRIPTION

### Property Assessment—System Architecture

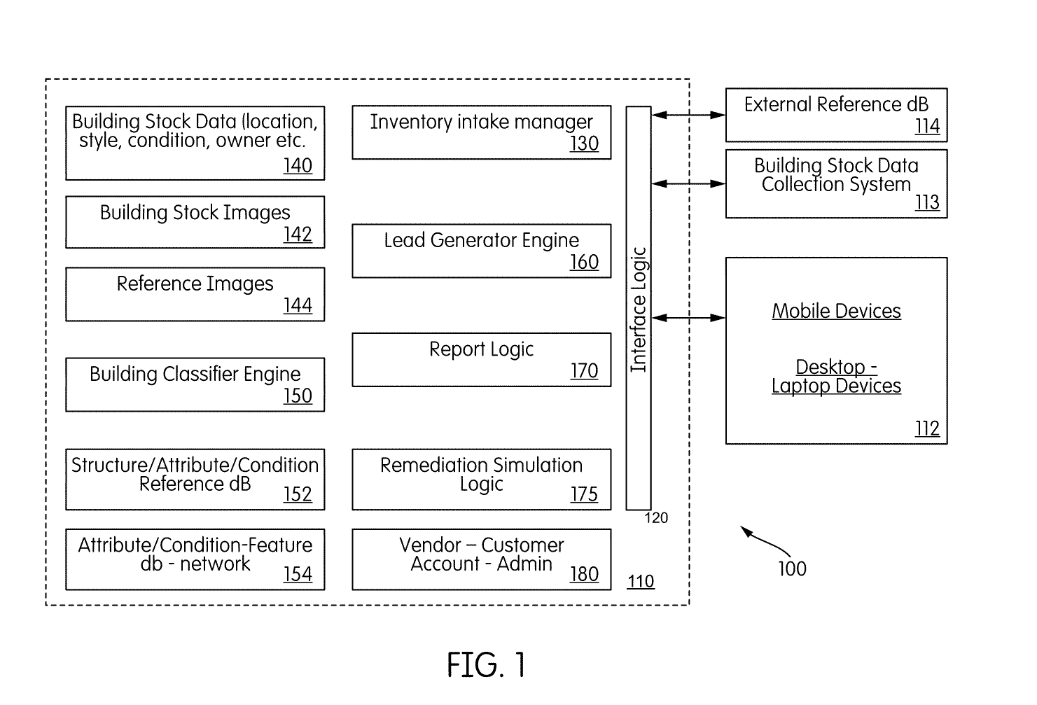

A preferred embodiment of a system 100 for identifying, assessing, rating and reporting on real estate properties, building structures, etc. is depicted in FIG. 1. While the preferred embodiments are presented in the context of single family residential housing structures, it will be understood that the invention has applicability to other types of building structures, such as commercial structures, or any other structure for which there is sufficient visual/machine perceptible information to perform the processes described herein. Since SFR have a high degree of variability—architecturally, aesthetically, etc. —their wear, aging and weathering characteristics are also variable and thus allow for significant differentiation statistically. The terms “property” or “real estate” used herein are is intended broadly to denote the entirety of a property opportunity present at a particular site, including any building structures, fencing, walls, landscaping, foliage, trees, public sidewalk features, vehicles, appurtenant structures, etc., the owners/inhabitants, and neighborhood related factors as well such as crime rates, schools, access/convenience to shopping, demographics, economics, and other factors known in the art.

As seen herein, a property assessment server computing system 110 is preferably an online collection of computing machines and accompanying software modules suitable and configured particularly for performing the operations described below. The preferred system 100 interacts through interface logic 120 with outside data sources including a building stock data collection system 113 and an external reference database 114. Building Stock Data Collection system 113 can be any known provider of information (such as for example Google through Google Maps image data) about the properties being assessed, and may be accessed through an API in appropriate instances. At a minimum such entities provide real estate information (images, videos, etc.) sufficient to identify a property at a particular location and perform an assessment such as described below. In other instances the external databases 114 may contain further information concerning the property, such as owner/inhabitant identifications, gps coordinates, liens, taxes, deed recordings, sales transactions, valuations, trends, and other similar types of data maintained at governmental systems and/or conventional real estate sites such as Zillow, Trulia, Redfin, etc. Other types and sources data such as described in the art above can of course be utilized and the invention is not limited in this respect. It will be further understood that while FIG. 1 shows that this data is obtained from third parties, it can of course be collected and retained internally if desired.

System 110 engages with users employing computing devices 112 through interface logic 120 as well. These computing devices 112 may range and include smartphones, PDAs, notebooks, tablets, laptops, desktops, etc. In a preferred embodiment system 110 is part of a website which can be accessed through a conventional browser running on such devices, or alternatively through an app on Android or IOS device.

System 110 includes a number of specialized software modules and storage modules which implement the processes described below, including an Inventory Intake Manager 130, a Building Stock Data Manager 140, a database of Structure Images 142, a Building Classifier Engine 150, a Structure/Feature Reference database 152, a Lead Generator Engine 160, Report Logic 170, and Vendor/Customer Account Admin module 180. Some of the main functions of these modules is as follows:

Inventory Intake Manager 130—preferably includes logic to programmably and periodically locate and catalog new/updated building stock images, new updated property records, etc.

Building Stock Data Manager 140—preferably includes data on each property, including location, style, condition, owners, etc. as gleaned from external systems 113, 114, human volunteers/raters, and as derived from internal classifications/assessments performed internally;

Structure Images 142—preferably includes raw and/or annotated image data of at least outside portions of the structures for the properties in question;

Reference Images 144—preferably includes exemplar—reference image data for a reference set of building attributes/elements and associated conditions, and that is used by a classification engine described below;

Building Classifier Engine 150—preferably processes and evaluates property data, including image data, to identify/assess structures;

Structure/Attribute/Condition Reference database 152—preferably contains reference list of structure types, attribute types, associated economic/physical impairments, scores, etc. to be discovered in target structures;

Attribute/Condition—Feature databases/network 154—preferably contains computed models, templates or patterns developed by a classifier to identify correlations between specific structure attributes, conditions, and image features which can be used to identify specific attribute/condition associated with a particular structure;

Lead Generator Engine 160—preferably interacts with customers and is back end systems to identify properties of interest based on selected query parameter criteria;

Report Logic 170—preferably cooperates with lead engine to provide actual report organized and or composed in part under control of a user, a vendor, etc.

Remediation Simulation Logic 175—uses specialized image filtering and other image processing to remediate or simulate visual improvements to building elements in a target structure for the benefit of users;

Vendor/Customer Account Admin module 180: preferably coordinates and manages vendor and customer accounts, including billing, alerts, etc. The functions and features of each is discussed in more detail where appropriate below.

It will be understood that system 110 will likely have other components, modules, etc., and so as to better highlight the key features of the present invention only those aspects most germane to such are presented. Moreover the software modules described (referenced usually in the form of a functional engine) can be implemented from the present teachings using any one of many known programming languages suitable for creating applications that can run on client systems, and large scale computing systems, including servers connected to a network (such as the Internet). Such applications can be embodied in tangible, machine readable form for causing a computing system to execute appropriate operations in accordance with the present teachings. The details of the specific implementation of the present invention will vary depending on the programming language(s) used to embody the above principles, and are not essential to an understanding of the present invention. To the extent it is considered relevant to the present invention, the Applicant specifically disclaims any coverage that may encompass so-called “transitory” subject matter deemed unpatentable under 35 USC 101, including for example any coverage to transitory media or bare transitory propagating signals and the like, and/or to any pure “abstract” ideas or exceptions to eligibility not encompassed by 35 USC 100, 101 etc.

### Processes, Functions and Algorithms Employed for Property Assessment

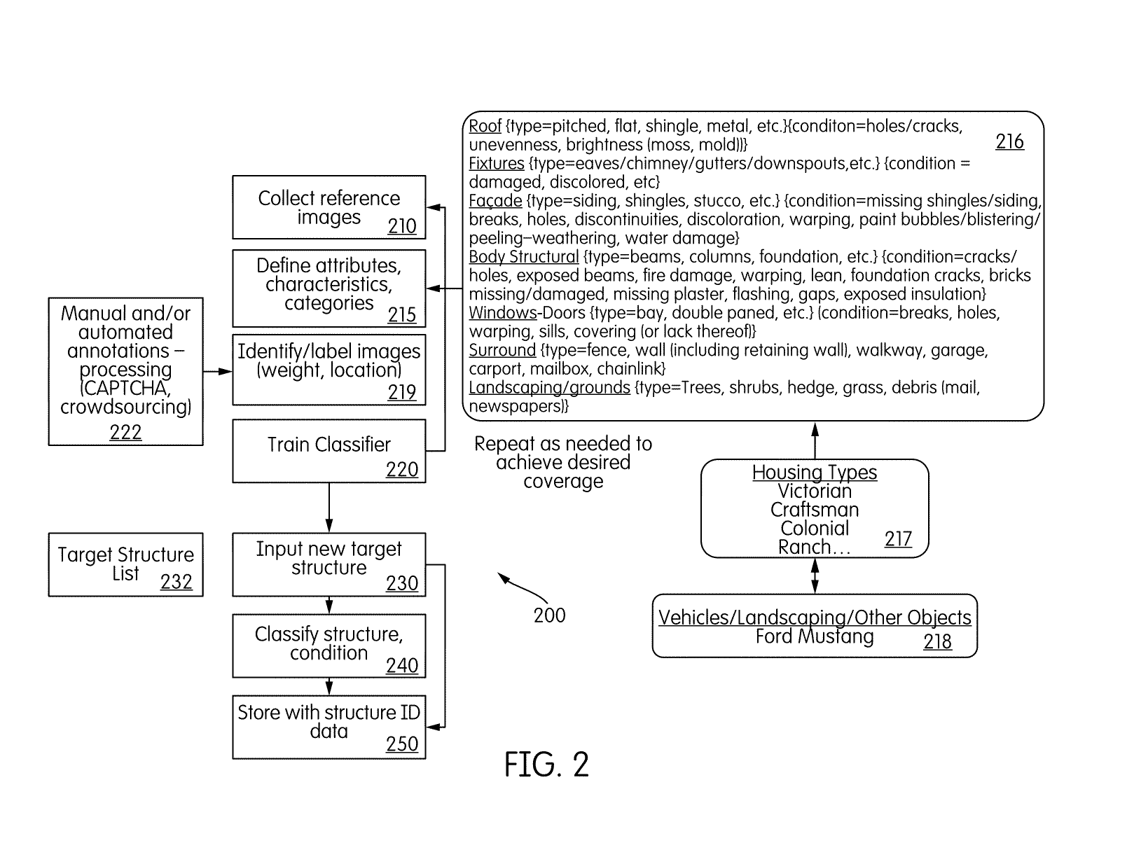

FIG. 2 illustrates the main processes 200 used in preferred embodiments of the disclosure, including broadly the two tasks of 1) training the Classifier Engine 150 (FIG. 1) and 2) using it to assess and rate different new properties. A list of basic building elements that can be identified and logged can be found at nyc.gov/html/lpc/html/glossary/glossary.shtml. Other online sources can be consulted of course for a catalog of identified building elements. In the most straightforward case examples of each basic building attribute is captured, such as façade, eaves, windows, balcony, porch, arch, piers, columns, lattices, false timbering, ornamental, etc. along with specific types (i.e., façade (shingle, siding, brick, stone, horizontal boards, vertical boards, etc.) roof {pitched, double pitched, hipped, flat, metal, tile, shingle, slate, parapet, dormer, mansard, fascia, brackets, eaves, pent, pediment, etc.} and so on).

At step 210 a set of reference images for database 144 are collected. The reference images can be captured by human assistants, and/or obtained from a reference image database(s) such as Google Maps (not shown) etc. Preferably a reference set is established which includes sufficient exemplars representing different building elements to be classified. The reference images are also preferably tagged by human annotators to identify each building attribute, an associated condition, a location in the image, etc. Building Stock database 140 should include complete data on each entry in the property database which identifies any and all reference building elements or attributes associated with a particular structure, as well as other data noted above.

Image database 142 preferably includes a current image of the structure in question which is in a form that can be analyzed for building elements. The images can also include annotations (see below) identifying structure elements, defects, severity ratings, locations of identified defects, etc. as annotated automatically by a classifier and/or manually by a human operator.

In addition it is desirable to include image exemplars of the building elements or attributes in various physical conditions or impairment, which form is part of reference image set in database 144. The conditions/impairments are each associated with a particular building attribute. Each is also separately identified and classified to make them amenable to query. Thus at step 215 one or more examples of the following structure attributes or elements and related conditions pairs are defined:

Roof {new, missing/damage tile, shingle, metal, holes/cracks, unevenness, brightness (moss, mold))

Fixtures {new, damaged eaves/chimney/gutters/downspouts, leaves in gutters}

Façade {new, missing shingles/siding, breaks, holes, discontinuities, discoloration, warping, paint bubbles/blistering/peeling—aging, weathering, water damage}

Body Structural {new, cracks/holes, exposed beams, fire damage, warping, lean, foundation cracks, bricks missing/damaged, missing plaster, damaged flashing, gaps, exposed insulation}

Windows/Skylights/Doors {new, breaks, holes, warping, sills, covering (or lack thereof)}

Support {leaning/damaged columns, retaining walls}

Surround {new, fence, wall (including retaining wall), walkway (condition, overgrowth), garage, carport, mailbox, chain link}

Landscaping/grounds {Trees, shrubs, hedge, grass, debris (mail, newspapers)}

Secondary objects {tools, toys}

It will be understood that this is a just a partial list, and that a number of other individual structure attribute/condition pairings can be identified as well, and/or that the attributes and conditions can be logically associated in different ways. To build out database 144 therefore a graphical image (photograph or electronic rendering) of a structure (e.g., a house) with a roof (feature) having missing tiles (condition) is preferably collected and included in the reference image set. Examples of structures with new and broken windows are collected, and so on. In some instances it may be desirable to also include and assign is severity weightings (i.e., a scaling factor of any convenient range (1-10, or the like) for the identified condition) as well as damage location data (i.e., an indication in a coordinate grid of where the condition exists for the element on the structure). Consequently each individual reference record of a particular structure attribute may contain a different condition, severity, location, etc. It will be understood of course that a single reference image may have more than one attribute that can be tagged. As noted earlier, in most instances it will be preferable for a human to create the tags for the reference images, including an identification of each building attribute, a condition, and a location thereof.

While the above presents a number of examples, it will be understood that this is not the entirety of attributes that could be extracted for a property, and that others could be captured as desired for any particular application. In some instances the data in the reference set will be augmented by additional data gleaned from external sources and without reference to the images alone. For some applications, rather than resort to actual image data, it may be more convenient or effective to have a human artist creating the renderings identifying a model or reference example of an element, attribute, condition, severity, etc. In this manner the reference set can be made more uniform and potentially yield more predictable and consistent results across different condition types.

Preferably the reference set 144 also includes data/images from different architectural types, so that a nominal House Type 217 including from Victorian, Craftsman, Colonial, Ranch, and other common types can be represented. This allows for embodiments in which users can query and select for distinct housing architectural types.

Since vehicle data can also be processed as part of property assessment, data for such items should also be captured by reference to vehicle types 218. The state of image recognition software at this point is such that identifying vehicle makes, models from photographs is a relatively straightforward task. Other items or objects such as living organisms (persons, animals (pets)) personal property items (bicycles, strollers, carriages, lawn mowers, children's toys, tools, decorations, signs) etc., may be identified in images as well, and can is be positively associated and predictive of whether a structure is inhabited. Negatively correlated items such as chain link fences, debris, garbage, newspapers, mail, etc., can also be identified and recorded. Again, it is not necessary to identify the identity of persons, or the object, only a high likelihood of the presence of such item or object. As will be apparent some items/objects may be simply identified as being present and not have a corresponding condition that needs to be logged. Finally it may be possible in some instances to automatically identify and classify types of trees, flowers, plants, etc. from image data alone and by comparison to reference images of such foliage.

The identification/labeling or tagging of the reference images (including any appurtenant data for vehicles, foliage, etc.) at step 219 is preferably done by humans, since they can more quickly identify and log the corresponding architecture type, attribute/condition, and/or augmented data set including severity and location. Nonetheless a machine classifier can provide preliminary or tentative coding based on pre-processing as described herein, to give a significant leg up in such annotation process. This data is preferably stored as part of a structure/attribute/condition database 152 which is correlated to reference images 144 and which is accessible to Classifier Engine 150.

It will be understood that with improved image and computing processing it is also likely to be a task that can be automated with a computing system as well. In some cases it may be possible to crowdsource the tagging of reference images at step 222, including through implementing them as part of a human interactive proof test, or CAPTCHA. For example to gain access to a resource (device, data, etc.), a human may be asked by a computing system to identify (with a mouse or other pointer) where there is a cracked window in a presented image of a house, or if a particular attribute can be found in a particular house in a set of images presented. The system can then sense if the user has identified the feature correctly and use such information as part of the tagging process.

In some applications it may be desirable to scale or normalize the size of the structures in the reference image sets 144 to some optimal processing size (e.g., N pixels by M pixels for a particular structure) prior to training, which can be is determined through routine experimentation. Accordingly the reference images in database 144 may be cropped, shrunk or expanded depending on the target desired comparison size. Other customized image processing operations (rotations, noise clean up, etc.) may also be performed to derive and generate an image reference set.

At step 220 the Classifier Engine 150 is trained with the template consisting of the training set of reference images 144 and tags as created and logged in database 152. Objects (and their reduced feature set) can be analyzed in image patterns using a variety of techniques, including statistical processing, neural networks, etc., which can be used to detect and extract features of such attributes. In this instance the attributes identified by the tagging are analyzed in the images to break them down and reduce them into (or extract) smaller distinct features that can be more readily detected. This attribute—condition—feature dataset is stored in the form of models, template or other suitable form in a database or network 154.

Using conventional image processing, each attribute (and related condition qualifier) may be reduced in dimensionality and characterized by a distinct set of pixels, shapes, sizes, proportions, curves, textures, or other mathematically derivable feature from the image. The training results in extraction and optimization of specific features most appropriate for a particular element, so as to minimize classification errors for the attribute in question. Feature extraction algorithms are well-known in the art, and examples of such that are suitable and/or can be adapted easily for use in the present embodiments is set out in literature such as A Survey of Face Recognition Techniques, by Jafri et al. appearing in Journal of Information Processing Systems, Vol. 5, No. 2, June 2009 and incorporated by reference herein. Commercial systems for identifying defects in manufacturing materials could also be adapted for this purpose, such as those offered by Camea's Visual Inspection System and as disclosed in references such as Surface Defects Detection for Ceramic Tiles Using Image Processing and Morphological Techniques by Elbehiery et al. appearing in World Academy of Science, Engineering and is Technology 5 2007 and incorporated by reference herein. Again it will be understood that the type and amount of training may vary according to the particular attribute and condition to be identified, and thus will be the subject of routine experimentation.

In the end the classifier(s) can be configured to use some form of similar or template matching, probabilistic (Bayesian logic) decision, or a combination thereof. Consequently at step 230 the classifier preferably outputs a score for each entry in a Building Stock images 142 (or other particular unknown target image presented in a list 232) along with a confidence score for each of N possible attributes, M possible conditions for each, and additional information such as an estimated location in the target image. Tentative structure classifications (architecture type, attributes, conditions, etc.) are identified at step 240 and then stored at step 250 along with unique structure id in database 140. For better accuracy it may be useful to employ multiple classifiers trained with different algorithms to give a combined or averaged score to identify the attributes and classify the structure.

As part of the training step 220 noted earlier, a classifier may also be provided with additional data for the reference image structures 210 in question which can be later correlated, including any recorded/estimated economic details (value of the property), occupancy data (inhabited/not inhabited, rented/owned), internal details (size, # of bedrooms, # rooms, etc.) This type of data is available from a number of sources, including commercial real estate entities, government agencies, etc. An output 240 therefore comparing a target structure to a reference structure can also generate a correlation indicating a tentative or predicted value of the structure, an occupancy score/rating, and other similar useful metrics. All of this property related data can be stored as part of prospect database 142 noted above.

In some instances the attribute and/or condition may be determined geometrically and without strict reference to a template or pattern. For example significant aging, extreme weathering, paint peeling, and other types of deformities or damage may be detectable with image filtering and processing is without resort to templates per se. An article by Winkler et al. titled Visibility of Noise in Natural Images, Proc. IS&T/SPIE Electronic Imaging 2004: Human Vision and Electronic Imaging IX, vol. 5292, p. 121 incorporated by reference herein explains how noise can be inserted into or filtered from images. The pattern of aging, weathering/façade damage for many structures appears as and mimics the effects of general image noise and thus could be detected in a similar fashion. A similar noise reduction process is identified in the aforementioned Elhebierry et al. reference for detecting defects in tile materials and could be adapted for a similar purpose here.

A reference by Lin et al. titled Salt-Pepper Impulse Noise Detection and Removal Using Multiple Thresholds for Image Restoration appearing in the Journal of Information Science and Engineering, Vol. 22, pp. 189-198 (2006) incorporated by reference, discloses optimal techniques for removing certain specific types of noise from images. As this noise again mimics the appearance of aging and/or weathering, one option for detecting aging/weathering in building façades proposed by the inventor therefore is to noise treat the images, and generate a noise reduced version of the same. The amount of “noise” detected in the image can be treated as a proxy for the degree of aging and/or weathering of the building structure. In general preferred embodiments of an image processing process are configured to mimic a human eye's capability of discerning errors, defects and other irregularities in an otherwise homogeneous or regularly textured object.

### Classifier Training Exemplars

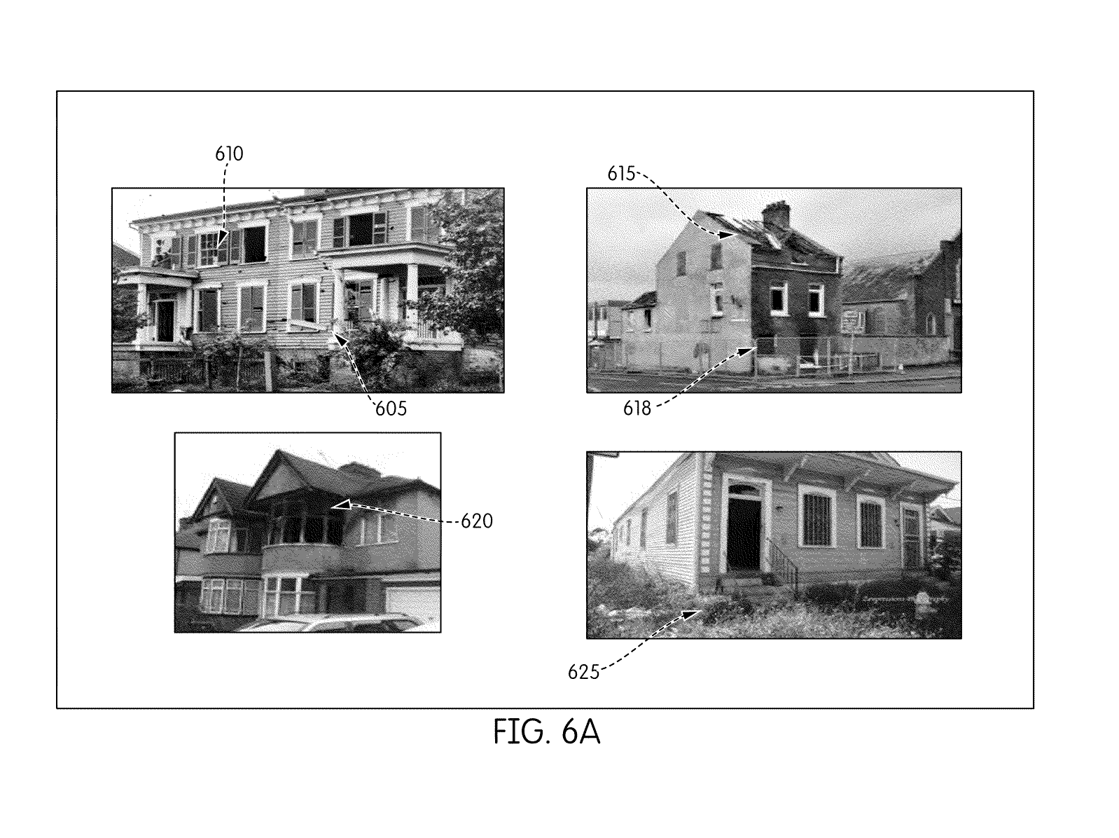

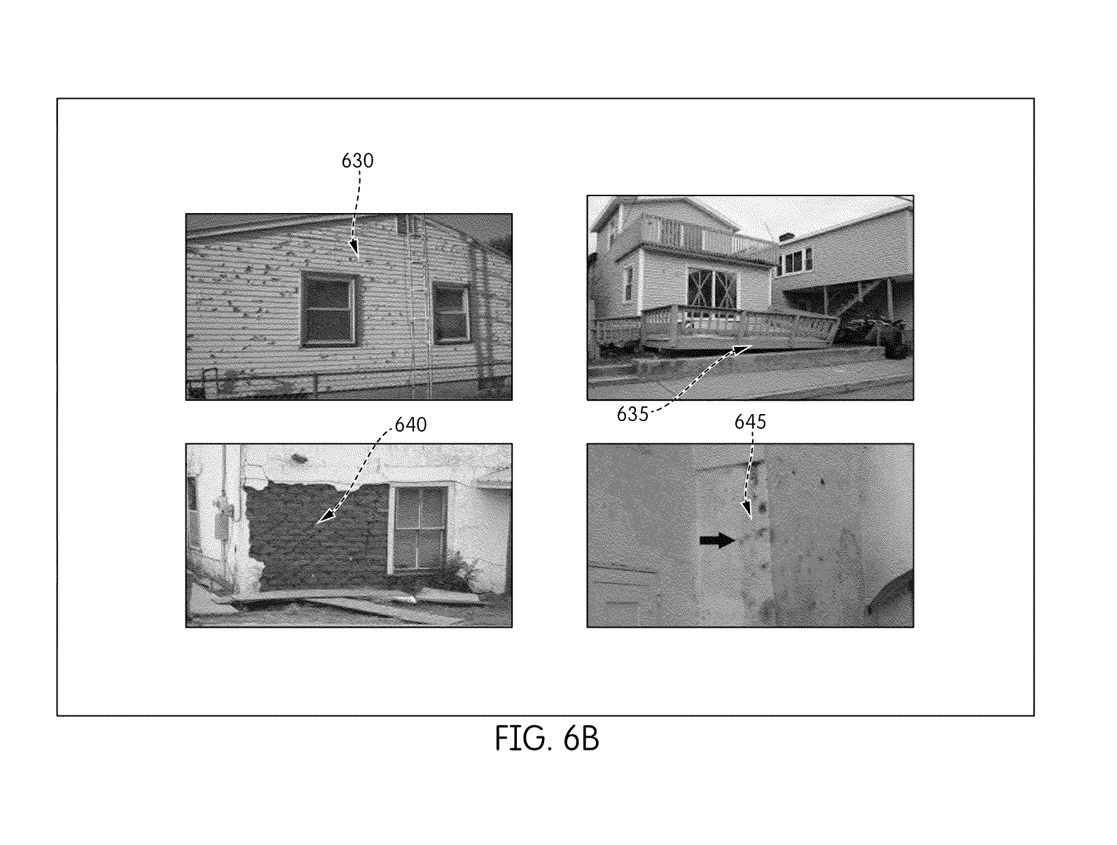

Examples of the types of attributes and conditions that can be used for training the classifier are illustrated in FIGS. 6A-6B. As seen there, a first structure is in very distressed condition and is boarded up in some places, as evidenced by elements 605 which are boards superimposed over a window. This element 605 has both an irregular orientation, and overlaps with a window element, making it an unusual feature that can be detected. Elements 610 illustrate examples of broken windows which can also be easily identified by distinct and detectable image features. Other examples are shown as well in FIGS. 6A-6B including:

damaged/exposed roof elements 615

chain link fencing 618

burned out areas 620

overgrown weeds/plant growth 625

peeling paint 630

damaged—deformed porch and patio 635

exposed—broken façade 640

water stains (abrupt changes in color)—rotting 645

As is apparent from these clear examples, these elements represent tell tale signs or signatures of damage, aging, weathering, neglect, etc. to a building structure, and which can be readily identified in image data. In general, since humans are very adept at picking out inconsistencies or visual errors in an otherwise homogeneous texture, it is expected that relevant training samples are easy to obtain. Other examples will be apparent to those skilled in the art from the present teachings.

### Query Processes and Algorithms

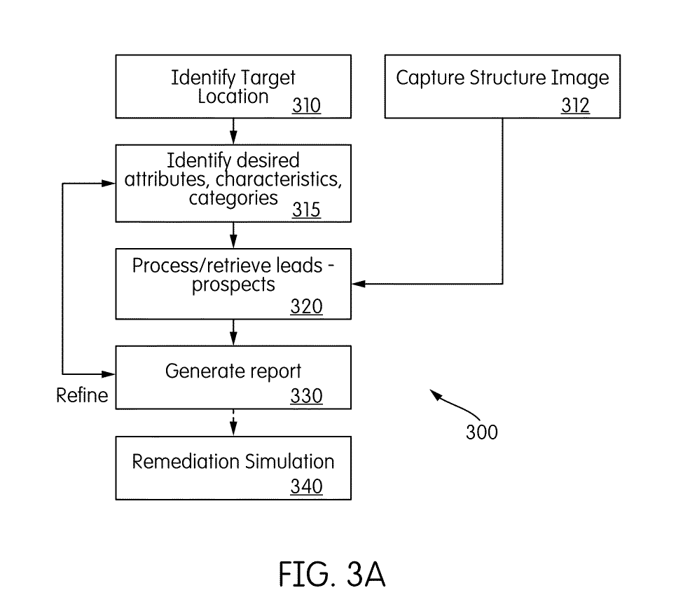

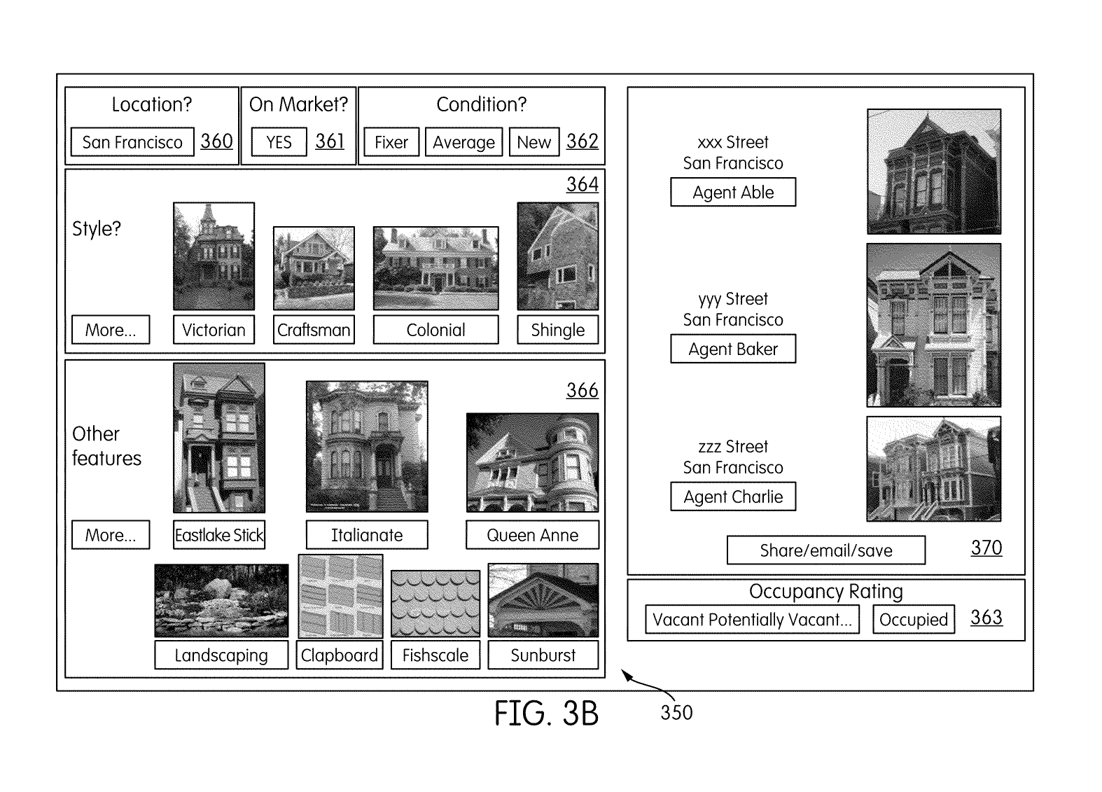

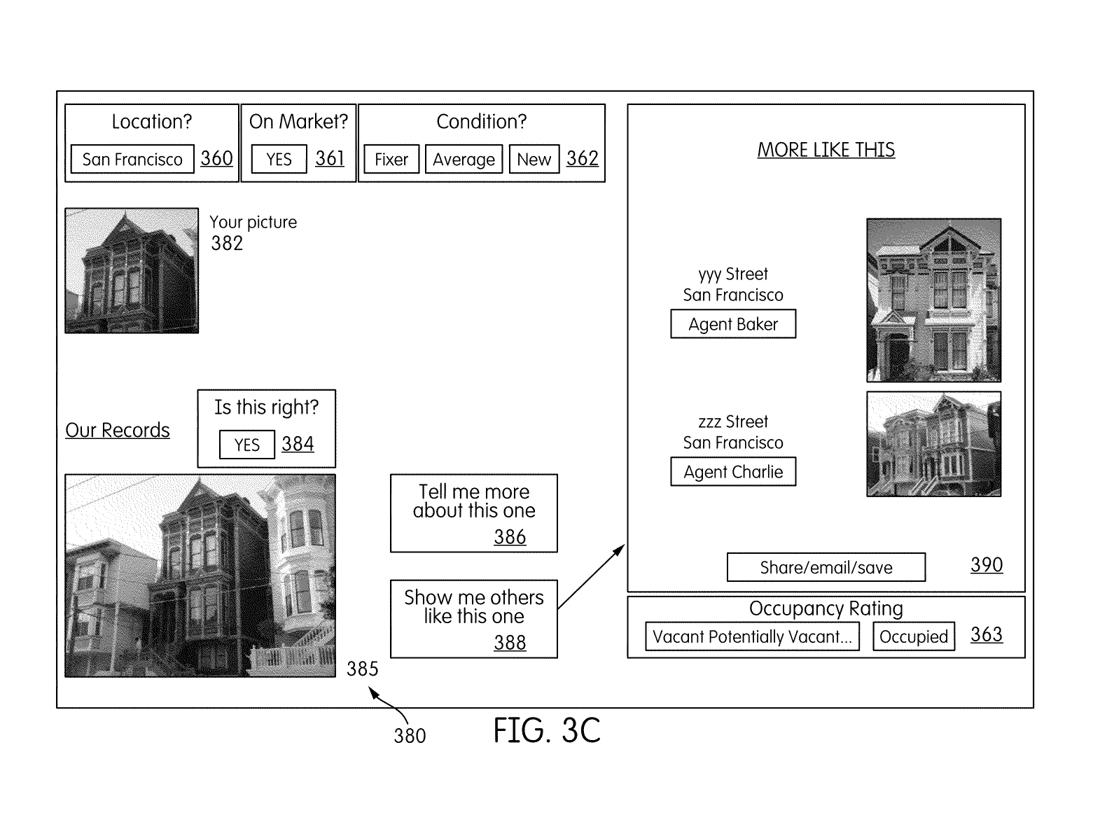

FIG. 3A depicts a process 300 by which users can search for real estate/building stock that meets particular criteria of interest, including certain visual aesthetics, architectural features, predicted occupancy criteria, etc. This is done preferably through providing search parameters to Lead Generator Engine 160 (FIG. 1) which then identifies matching properties and outputs reports through Report Logic 170 to a client device 112.

As seen in FIG. 3A a target location is optionally provided at step 310, such as a City, neighborhood, zip code, street, or any other desired geographical qualifier. Other attributes, characteristics, categories, etc., can be specified at step 315 to the Lead Generator Engine 160 as desired to filter appropriate results. Matching leads are then identified at step 320 from property prospect database 142 along with building images in appropriate cases.

At step 330 a report of the results is presented to the user in accordance with the filtering parameters specified, and any desired formatting, sorting, etc. For example results presented on a mobile handset may vary dramatically from that shown on a webpage to a desktop user. The output results can be tailored for a particular platform using known techniques. If the user wishes to refine the results or search with different parameters, they can refine the query appropriately.

One further aspect that can be optionally employed in some embodiments is a remediation simulation function implemented by module 175. For example a user may find a target property that is in dilapidated condition, and may desire to understand better what such structure would look like if it were improved. As noted above the present invention preferably stores reference images of structures similar to the target images reviewed by the user, and is also able to characterize or model the effects of aging or weathering. Alternatively different types of noise reduction, removal or image enhancement can be performed to smooth out and improve the image. Consequently it is a simple matter to “reverse” some of the effects of such aging or weathering and/or simulate correcting many of the attribute impairments in the target image using conventional image filtering and processing. The simulation can be controlled selectively to correct particular damage or attributes, such as façade/siding cracks, paint irregularities, roof damage, etc. or other basic building elements. Note that this feature is handy and could be employed by painters, contractors, etc., who are presenting or bidding on remodeling of a property. The Remediation Simulation Logic 175 thus outputs a simulated image of a remediated version of the target structure. The corrected image version of the building structure can be shared, emailed, etc. in any conventional fashion.

The selection of search parameters shown in process 300 can be achieved through an interactive interface 350 seen in FIG. 3B, which in a preferred embodiment is implemented as part of an interactive web page presented by interface logic 120 (FIG. 1) and viewable within a browser on device 112. Nonetheless it could also be implemented as part of an app executing on a smartphone device as alluded to above.

This selection screen 350 includes a number of query selection boxes, buttons, pull-down elements, etc. which may become active with mouse-overs and other techniques known in the art. The user can specify a location for the property in query box 360, in this case selected to be San Francisco, or some other geographical region (city, state, neighborhood, zip code, etc.) In addition the user can qualify whether the property in question is in fact for sale or not in box 361. Other options may specify that other properties not on the market should be included so as to increase the range of prospects. The condition of the property can also be specified in query box 362 which may be presented in the form of a sliding scale, descriptors, etc. which permit a wide range of building stock to be searched, from “new” all the way to “extreme fixer upper” or some other similar moniker.

Occupancy rating query box 363 allows the user to again filter or control the types of properties presented, based on a calculated occupancy score for the properties in question. As noted above, in some instances a potential purchaser may be interested in pursuing unconventional or otherwise unexploited opportunities by looking for properties that appear to be unoccupied. The type of ratings, scores and selection mechanisms for this function can be varied in accordance with any desired capability or performance. For example a degree of confidence in the occupancy of the structure could range from “known occupied” to “known vacant” and several grades in between. As seen in FIG. 3B the user can select from a slide bar, a set of designated buttons, or any other convenient scheme.

In query box 364 users can further specify an architectural “style” for the house as well if they wish. To make the query easier to formulate, it can include visual clues or objects as parameters as many people do not know the names of building elements, or the types of architecture, etc., but do know what they like aesthetically when they see it. In this instance the user has selected “Victorian” as the style of house they wish to peruse.

Query box 366 allows a user to specify other property elements, including architectural subtypes (there are many types of Victorians, including Eastlake Stick for example), specific attribute styles for façades (clapboard style, fish scale, style, etc.) ornamental features common to that architectural style (finials, sunbursts, etc.) and other desirable property features (landscaping, trees, lawn, etc.) In this instance the user has indicated that they are interested in properties that have a sunburst element, which was a common ornamental embellishment in housing stock built in the late 19^{th} century.

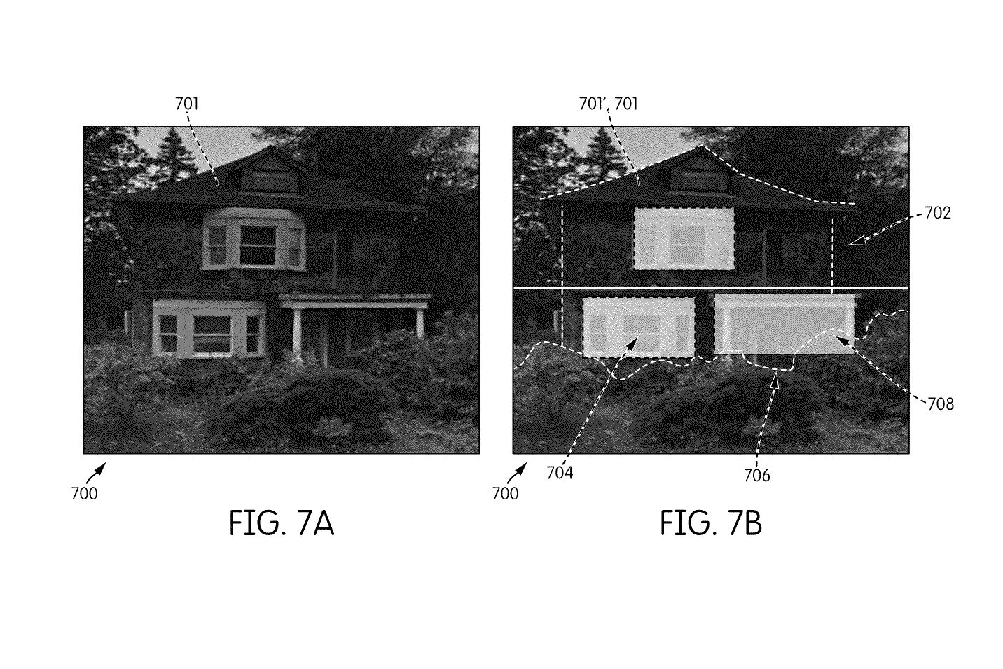

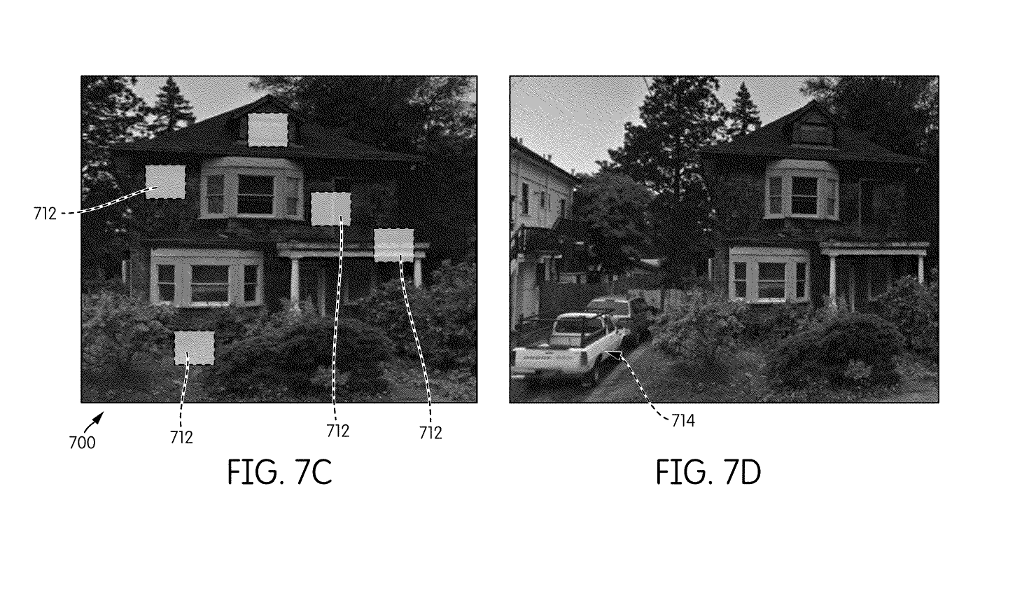

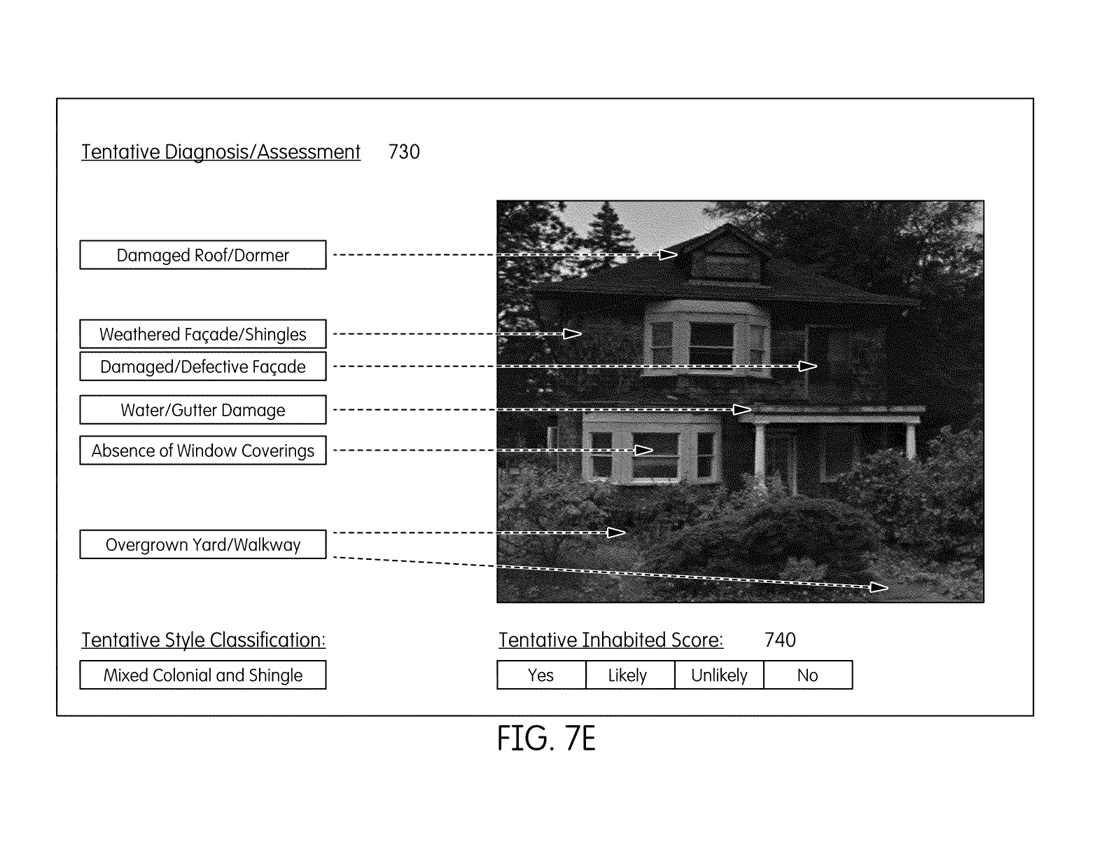

An output 370 in interface 350 can take any convenient form known in the art, including by identifying the locations of listings on a map (virtual pins) or by presenting visual listings with building images, addresses, and similar real estate data as alluded above. Information about a listing agent may be included as well, and the search results can be shared, emailed, saved etc. in any convention manner. By selecting one of the entries the user can be provided with any other useful details pertaining to the property, including the type of information maintained by such entities as Zillow, Trulia, Redfin and/or a listing broker/agent. In addition the user can be provided with additional classifying details about the building structure such as highlighted, tagged or annotated version of the building structure identified in FIG. 7E. This allows the user to quickly see the assessment of the property as performed by Building Classifier Engine 150 and/or human editors.

Consequently embodiments of the invention include a visual search engine (FIG. 3B) that assists a user in constructing and configuring a virtual target exemplar building in accordance with user criteria. The user can construct a model of a desired house from various building parameters (architectural types, roof types, façade types, etc.) color, condition, etc., and then query against database 142 to find one or more closest matches. In some instances it may be desirable to set aside a portion of the interface 350 to behave as a virtual canvass (not shown) so the user is permitted to see a virtual model of the housing structure they are creating for reference purposes.

To make the query process easier, the options presented for additional structural elements presented in box 366 can be selected/filtered automatically within the interface so that only appropriate choices for a selected structure from box 364 are presented. For example in selecting a Victorian there would be is different façade and structural elements than those presented for a Colonial, Craftsman, etc.

While the selection parameters/icons are shown as thumbnail photos for simplicity, it may be desirable to use uniform sized black/white artist-rendered impressions of the various attributes, or to create more isolated/focused versions of the attributes instead. This would give a more consistent look to the options although it may be less informative absent other contextual details provided by a complete image of a building structure. Again a default of ALL can also be included as an option in most instances to allow a wider range of search results.

It will be understood that these are just examples of a query interface and accompanying query tools, and that other variants with different forms, formats and variables could be implemented as well consistent with the present teachings.

FIG. 3C shows an interactive interface 380 presented within a mobile computing device such as a smartphone, along with an additional level of functionality that permits rapid, on the spot identification and review of property details. In this embodiment Lead Generator Engine 160 is distributed and incorporated (at least in part) within code and part of an app running on a smartphone. The app integrates with the device's built-in camera (not shown) so that the user simply captures an image of a target property 382 as they see it on location. This can include both interior and exterior images of course. The image and other useful data (such as location data) is uploaded to a server side component of Lead Generator Engine 160, which queries database 142 to locate a match. As noted above, image matching for building structures can be accomplished in any number of ways by adapting existing recognition algorithms to recognize the types of objects of interest here. Further details about the target property 382 can then be presented within portion 385 or 390 of an interface 380 presented on their respective computing device.

As most smartphones also capture geolocation data, the present system can utilize such data to better match or correlate the captured structure image to entries in databases 142 and 144. If the user's location is known, then the range is of image data that must be scanned to identify the property is significantly reduced, and the accuracy is also significantly enhanced. Nevertheless even in the absence of explicit geolocation data the user's image data of the property can easily be broken down and analyzed for attributes, features, etc. by Classifier Engine 150 to identify likely matches from the preexisting stock of building structures in database 142 in a similar manner as discussed above, even if it takes more time.

The match is retrieved for the user within portion 385 of an interface of their mobile computing device. The user can be prompted to confirm that the match is correct by checking selection box 384. Other aspects of the records in database 142 can also be confirmed directly from the user on site, including by presenting them with an output such as seen in FIG. 7E, and asking them to confirm, modify or reject any condition designated for a particular building element. In such embodiments the database can be populated effectively through user-contributed content, or so-called crowd sourced data.

Again after confirming the identification of the target property the user can be prompted to see if they want to see more details (box 386) which would permit them to see the kinds of data discussed earlier for FIG. 3B. Alternatively since the property attributes are known from database 142, the user can also query against such records to find other matches (filtered by location, availability, condition as before) that are aesthetically similar to the target property image they have captured. These can be presented within section 390 to permit the user to find similar leads based on their personal tastes. As further refinements the user can be provided with additional filtering options such as noted above (box 366) if they want to constrain the search result list further by building characteristic/element, property features, distance from the target property/user's location, etc.

The query “input” to a property prospect engine therefore can be in the form of a direct visual image provided by the user, so that the process operates to locate other building structures that are most similar to the one identified by the user. This is useful because in many instances users/purchasers frequently is desire a particular visual look in a house, and the invention can help them find other stock that matches their target appearance, and which may be available (or more likely to be available) for purchase.

In some embodiments the retrieved entry from database 142 and 144 is presented in interface 380 along with visual tags or selectable overlays, so that the user can further define or refine a target building structure. For example the user may desire a different type of façade (stucco instead of shingle) a different color (white instead of dark brown) or a different roof type (slate instead of shingle), etc. These can be presented as drop-down menus to form a final query that is then processed by Lead Generation Engine 160 to retrieve corresponding entries. The entries can then be presented as noted earlier in map form, listing form, etc. with any desired accompanying data. The user can also be prompted to confirm information in database 142 concerning building attributes, associated conditions, etc., for a particular target property.

In addition it may be useful to log and compile data on particular properties that are the subject of such data captures, by property identification, building type, neighborhood, city, etc. to glean insights into the current mindset of prospective home buyers, and for other similar marketing or research purposes. To collect information first hand on building stock inventory, mobile handset users can be solicited to directly rate the quality or aesthetic appeal of a building structure that they are viewing on location within interface 380 as well using any convenient scale. A frequency, average score, or popularity of buildings within a City or neighborhood captured in images can be identified with a heat map or other convenient visual indicator. Similarly the queries made by users with Lead Generator Engine 160 can be logged, categorized and mined to identify trends in tastes for architectural types, building elements, building aesthetics, etc.

In addition to processing queries and presenting search results, a mobile version of interface 380 can also capture pedestrian/passerby ratings, tags, etc., ascribed to any particular structure present at a particular location. This is described further below in connection with FIG . . . , in which properties can be free-form rated by a flexible data capture interface. Additional tags are is aggregated and selectively presented within a mobile interface reflecting data contributions by expert/machine raters (scoring the condition of the structure/property), neighbors (identifying characteristics of tenants, neighborhood), realtors, merchants (identifying work performed or desired at the property location) and so on.

### Property Features Classification Records

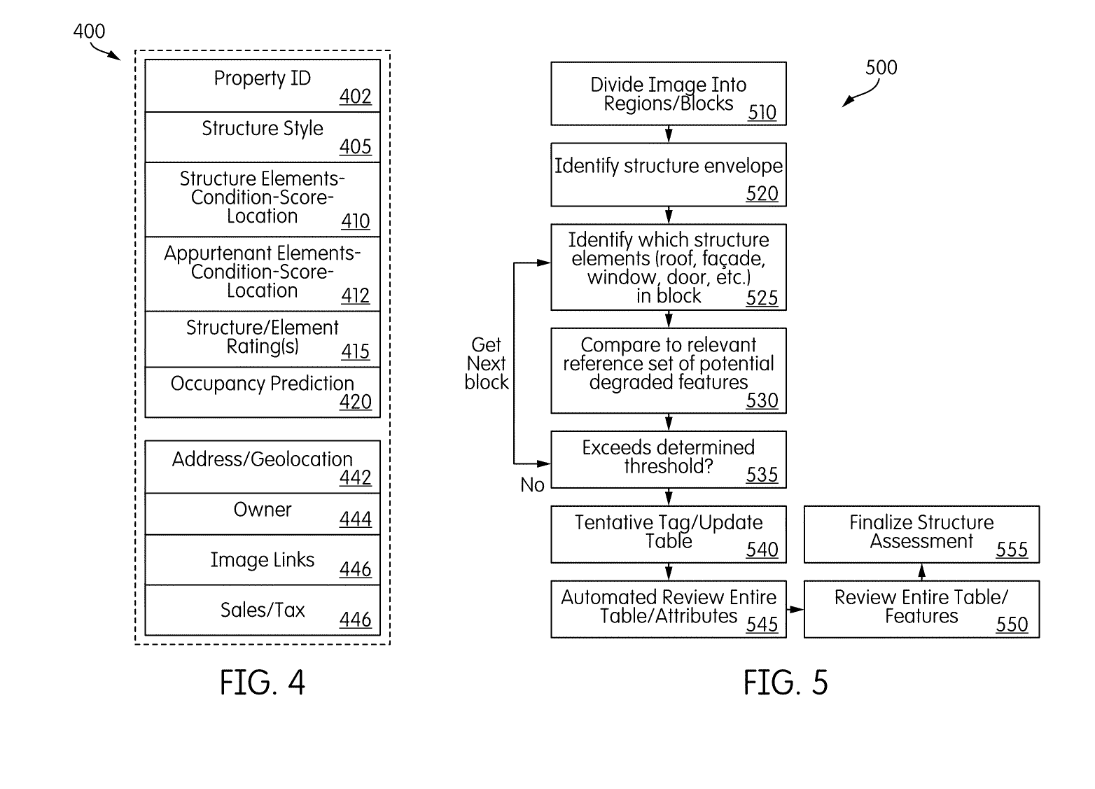

FIG. 4 illustrates an example of a record 400 containing a number of relevant data fields generated by Classifier Engine 150 (or which can include human annotations in some instances) and maintained in database 142 for each property. Each property preferably has a unique ID stored in field 402. The property ID could also store data logging details such as the dates of image captures, which helps to understand a currency of any recorded data.

A property structure style field 405 identifies an architectural type (Victorian, Craftsman, etc.) as discussed earlier. Structural element fields 410 including an identification of each structural element presented in the property, a condition of such element, a rating/weighting of such condition, and an image location for such particular element. It will be understood that a particular property ID may have multiple structural elements, and in fact several of the same type of structural element, each of which can have its own pertinent particulars. The same information is made for appurtenant elements with fields 412, including for example ancillary buildings, fences, garages, vehicles, foliage, etc.

One or more overall structure ratings is provided in field 415 which is generated by Building Classifier Engine 150 using a number of factors in accordance with features desired for a particular application. For example structure ratings may be derived on a granular, attribute-by-attribute basis, or based on an entire collection of elements present in a structure. Since each attribute may be considered a different dimension of the property data, the ratings may be based on or constitute multi-dimensional vectors representing a particular structural element, or group of elements, or of an entire structure. In is this form they can be more easily compared to other property structures as well for purposes of grouping, classification and querying. Those skilled in the art will appreciate that many variations of ratings can be employed by a system 100 for purposes of improving and optimizing individual property assessments and comparisons.

Occupancy Prediction field 420 stores a score (of any convenient range) generated by system 100 identifying a likelihood of current occupancy of the structure. As noted earlier this score may be associated or mapped to other content labels, such as “confirmed vacant” or “confirmed occupied,” etc. Preferably the prediction should have some reasonable range to help differentiate structures, as well as a confidence score. Thus there may be other ratings or predictions such as likely vacant, uncertain, likely occupied, and so on. As noted above where this information is already known with certainty by reference to public records it can be included here. Since it is not usually known, however, the invention derives a prediction of occupancy by comparing the property structural element conditions, scores, etc. against other known examples for properties in which the properties are confirmed occupied (at one end of the spectrum) and other examples in which the properties are confirmed vacant, abandoned, etc.

Data fields 442 (address, geolocation) 444 (owner, occupant data) 446 (image links) and 448 (transaction, tax records) can be obtained usually from any number of public records or commercial resources. In other instances, as noted below, it is expected that interested persons will capture and communicate this type of data (including image data, aesthetic ratings, attribute ratings, etc.) from mobile devices directly. While not shown here it is possible of course to integrate or cross-reference to other data tables to indicate a registered agent/broker associated with the property. It will be understood that the database could be adapted differently and that any particular commercial implementation is likely to have significant variations.

### Automated Image Classification

FIG. 5 depicts an exemplary building attribute/condition assessment is process 500 that employs image processing that is suitable for embodiments of the present invention. General aspects of the image processing are also shown in FIGS. 7A-7D.

As seen in FIG. 7A an image 700 is retrieved from database 144 (or derived from other source) and is divided into distinct regions or blocks 701 at step 510 (FIG. 5). While only one block is shown it will be understood that any and all parts of the image can be divided and treated this way. The size and shape of the blocks 701 can be varied of course using conventional techniques such as discussed above and it will be understood that FIG. 7A's depiction is not necessarily drawn to scale and is merely illustrative to help facilitate understanding of the invention.

A building envelope 702 (FIG. 7B) is identified at step 520 (FIG. 5) by image processing adapted to detect edges of structures. The envelope information (and similar profile data) is useful and can be used for identifying an architectural type descriptor for the target structure, for defining regions of blocks to be used within the envelope for further evaluation, etc. The building envelope information can be employed to define a building structure grid (not shown) from which the individual examination blocks can then be derived. Since different architectural types can have different grids, this grid information can be used as well to improve block definition, attribute identification, etc., as it will be determined statistically that a particular grid element in a first building type will contain very different structure attributes than a corresponding element in a second building type. Other boundaries for other objects such as landscaping 706, trees 708, etc., can also be determined and logged.

At step 525 an identification is performed to determine structural elements presented in a first block 701, including such attributes as roof elements, window elements, façade elements, etc. Again the identification of such attributes (and their types) can be performed in any number of ways by Classifier Engine 150 after it has been trained, including by pattern recognition techniques and statistical image processing using models, templates, etc. Preferably each block is assessed to see if it contains one or more of a set of target structural elements is or attributes. For example the first block 701 may be coded to denote that an attribute {roof} with type {pitched} and {shingle} is contained, and so on. The first block can also be color coded as well, so that abrupt changes within the block or between blocks can also be used as an indicator of an irregularity, defect, damage or the like.

Confidence scores and similar measures can be employed and recorded with each attribute/type pair to improve performance. Attribute characteristics can be identified, generated and stored as part of such process. For example an attribute {roof} would be expected to have a certain attribute size/shape relative to the building structure and an attribute orientation. These attribute codings can be used to identify and confirm the existence and extent of an element in the target building structure. Consequently data from adjacent blocks (of which 701′ is an example) can be used to influence and score a confidence rating as well. Thus, for instance if a first block is tentatively coded as noted above, and a second adjacent block is also tentatively coded the same way, the likelihood is high that the attribute identified is correct because the {roof} attribute in question is known to have characteristics matching the observed block data.

Similarly as additional blocks of the property image are processed, and depending on an identified architectural type, it might be unlikely to have an attribute in a particular block. For example a roof attribute would be uncommon below a certain level (line 705) in a building structure. Conversely, doors are uncommon at a rooftop level, and so on. These statistical observations can be gleaned and used to train the classifier as well so that it weights the presence of attributes in each block in accordance with the location of the attribute, the type of architectural type identified, and so on.

At step 530 a tentative condition score is computed for the detected attribute. Again it is preferable to assess the condition of the attribute against a reference set of conditions to determine an appropriate rating. In this instance the dark or irregular color may cause a roof element to score poorly. As before it is possible in some embodiments to use adjacent block coding scores, so that the detection of a roof in poor condition in one block is likely to mean that a is second adjacent block with such attribute is likely to be scored in a poor condition. A window element may be detected with reference to blocks at 704, and with a condition of {no covering} which may be an indication of abandonment (since most people prefer some kind of privacy/covering if they inhabit a structure). Landscaping 706 occludes structure 700 and is irregular, and thus may be classified in this manner along with other appropriate plant/tree identifiers and condition descriptors for the same as noted earlier.

If Classifier Engine 150 identifies an attribute, condition and location with an acceptable confidence in block 701 (which again can be calibrated as needed) at step 535 then the data is coded in a tentative tag table at step 540, along with an indication of the block id, location id, or similar coding. If the attribute is not confirmed, the process simply loops around and looks to see if another element may be present. This is done repeatedly (see FIG. 7C) to identify any number of elements 712 (siding, dormers, fascias, overgrowth, water stains, missing windows, etc.) in poor condition. As seen in FIG. 7D information concerning the existence of a vehicle 714 vehicle models, types, etc. can also be captured as part of the process.

While the blocks do not have to overlap, in some embodiments the process can be repeated with different sized blocks, with overlapping blocks, etc., so as to increase a confidence in the attribute tagging process. Furthermore it is expected that in many instances there will be multiple images of the same target property and each can be assessed individually to contribute to the overall structural rating. This may be desirable particularly in instances where shading, light intensity, etc. may vary significantly between images.

At step 545 the entire table of attributes is reviewed in automated process for consistency, final scoring, etc. As alluded above some smoothing of the data or the like may be performed.

A visual assessment report 730 can be generated (see FIG. 7E) at step 550 (FIG. 5) which preferably identifies at least those attributes identified by the system as having some measure of damage, impairment, aging, weathering, etc., This data is presented in a list and visual form for a human reviewer, and is within an interface may have interactive tags so that the tagged elements/conditions may be further reviewed, modified, etc. by the human operator. Intensity information can be provided by way of color coding to denote a degree of severity of the identified condition, along with location information.

An initial tentative architectural designation is also identified in field 735, along with a tentative inhabited score field 740. This latter score may be derived by examining and comparing any number of identified defects in the property structure against reference examples. Correlations may be derived based on individual elements, combinations of elements, etc.—for example absence of window coverings on multiple windows may be strongly correlated with abandonment or vacancy. Overgrowth of landscaping or extremely weathered siding may be correlated with aged occupants, and so on. A number of statistical observations can be derived and used to determine an estimate of the likelihood of occupancy of the structure, and whether is occupied by a renter or owner, etc. Other fields, data can be presented of course and the invention is not limited in this respect.

During step 550 (FIG. 5) a human reviewer can accept or modify the initial classification presented in visual assessment report 730. As alluded to earlier in some embodiments the visual information report may be incorporated as part of a CAPTCHA so that a human user is requested to confirm or verify the presence (and/or location) of certain building elements in the image that are impaired/damaged/aged/weathered, etc., to crowd-source the assessment of the target properties, or the reference templates used to rate the target properties.

The final structure assessment data is then recorded at step 555 with the property information in database 142 as noted above. Based on the assessment of individual elements, their condition, etc., and collectively over all the elements, an overall assessment or rating of the exterior physical condition can be assigned to the building structure. This rating or score can be normalized by reference to other specific buildings have the same architectural type as well for better comparison. A structure may be ranked or rated for condition relative to peer structures in an immediate, specified target region. “Peer” structures may is include all structures, or a subset having the same architectural style, or a predetermined number of common features, etc. A “target region” may include a street, block, zip code, city, or any other desired benchmark.

By correlating each of the impairments to repair or improvement figures, and summing over all the attribute conditions, an overall estimate can also be generated to identify a cost to restore the building structure to a nominal target state. Using sales data for similar structures in a similar condition, and other similar parameters a purchase prospect score can also be assigned. This and similar data can be stored in database 142 as part of a structure rating 415. Since the image data is regularly updated, long term evaluations over defined time periods can be made as well to identify changes in a property condition.

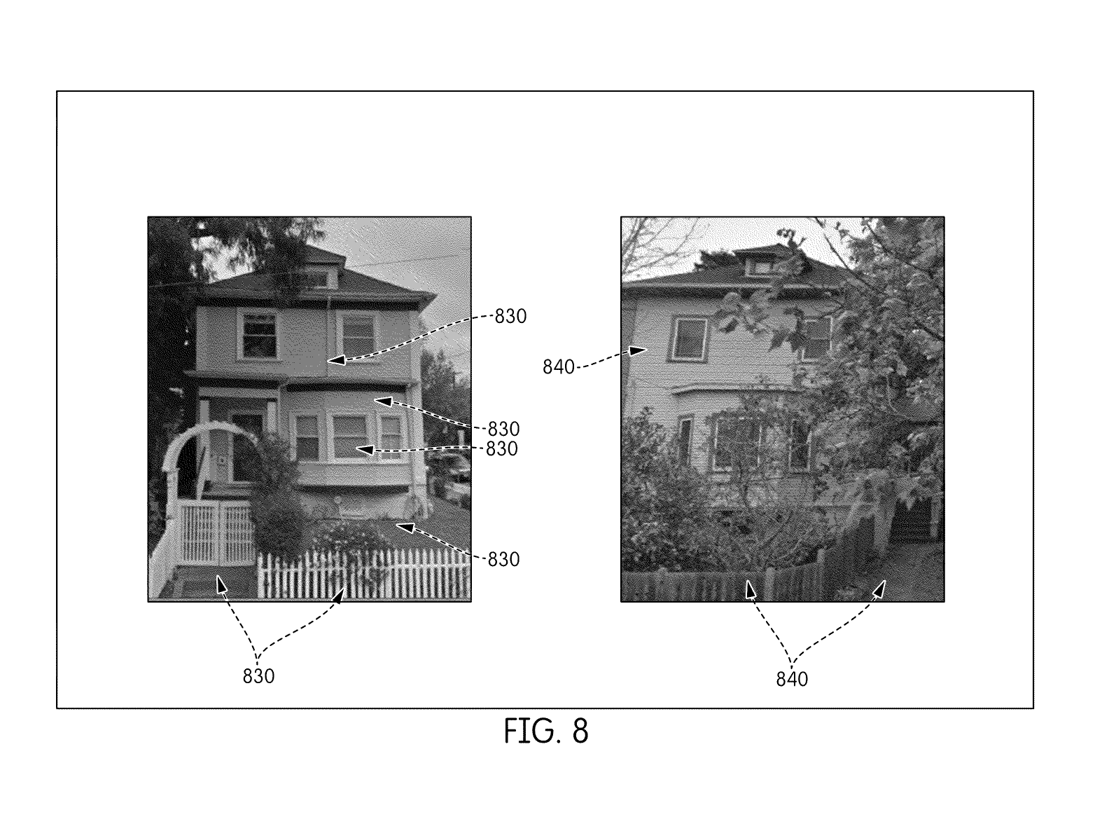

FIG. 8 illustrates further examples of reference property structure images that can be used in embodiments of the present invention and coded in database 142. The attributes of reference property 830 identified here include examples of siding, windows, downspouts, walkways, fencing, lawns which can be classified as corresponding to a positive or high end of a condition scale, i.e., being in top condition and lacking any noticeable weathering or aging. In contrast reference property's walkway is notably less “clean” (i.e., includes plant overgrowth) and the fence is discolored and weather. Extreme examples of each building element can be captured and analyzed statistically in this way to help characterize elements having opposite valued ratings. In addition, botanical elements such as particular trees (maple, willow) can be seen in these images along with particular notable flowering and climbing plants that could be identified and logged as part of a reference database.

### Targeted Advertising Based on Property Characteristics

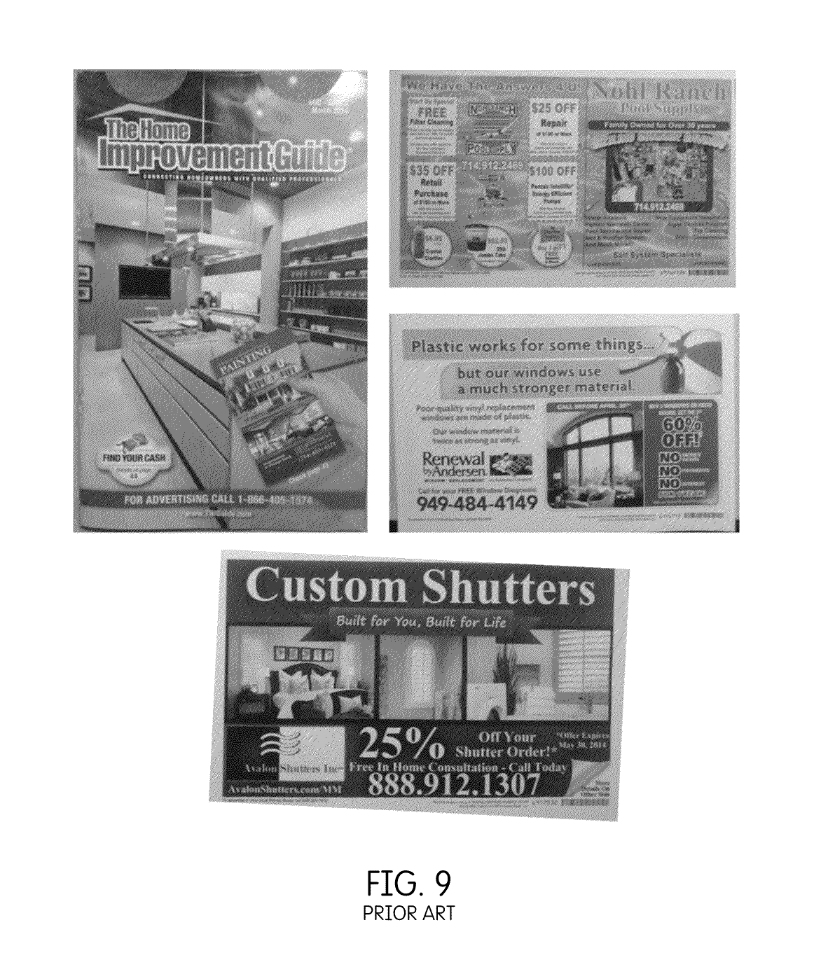

FIG. 9 illustrates different examples of prior art advertising materials in the general areas of home improvement. As is apparent from a cursory glance, these marketing materials are at best relevant on a macro scale approaching a city or zip code level, but little if anything about these materials is tailored or customized for any particular neighborhood block, let alone for a specific domicile, residence or building. For this reason these flyers or circulars have is little appeal or relevance to any particular homeowner, and the targeting appears to be little more than hit or miss. At best it is based on “seasonal” improvements generally seen in particular geographic regions, meaning it is more likely a resident of Chicago will see a pool supply ad in early summer rather than mid winter. Similar generalized advertising is presented online as well in response to search queries, so that a homeowner querying “windows” is given at most generic advertising from a vendor near their location.

### Neighborhood Cluster Based Advertising

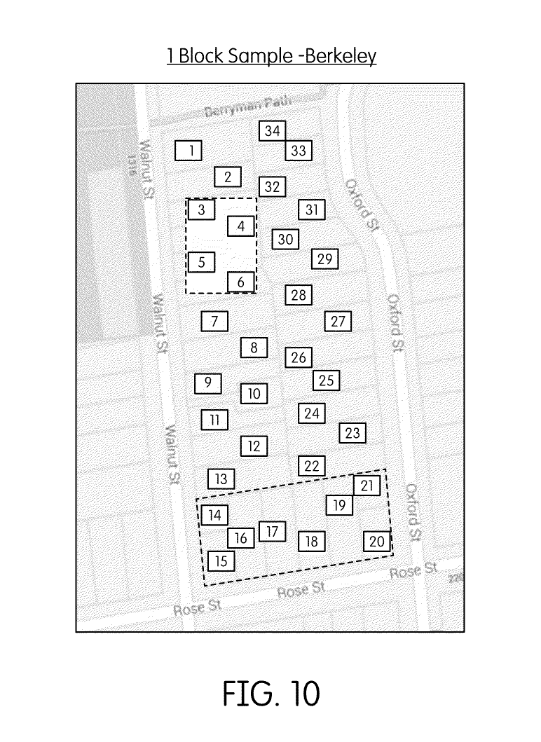

FIG. 10 shows a typical city sized block in a residential neighborhood which can be assessed and targeted with better marketing materials in accordance with embodiments of the present teachings. The individual buildings and lots have been identified with unique numbers in this block to make it easier to understand the present discussion. It will be understood that the residential and commercial housing stock of any particular city, town, etc., can be divided in this fashion by the computing system of FIG. 1 using a number of automated procedures based on computer records, address data, etc. and/or using some other convenient scheme for purposes of achieving the objectives set forth herein.

Furthermore it will be apparent that the size of the block can be adjusted as needed or desired for any particular assessment, advertising campaign or group offer. For example it may be determined that as concerns marketing for window products, the target size of a group block or offer should include about N separate buildings (see logical block encompassing structures 3-6) while the target size of a group block for landscape or roofing services should be about M separate structures (see logical block encompassing structures 14-21). Other logical groupings that do not require contiguous boundaries are also possible of course. The present teachings can be used to glean such optimal group sizings and clustering to better increase an adoption rate for particular campaigns.

Furthermore by observing and logging participation rates by individual homeowners embodiments of the present invention can identify and optimize is logical groupings in any block for any particular product or service. For example it may be determined by a computing system that homeowners in lots 7, 10 and 12 are frequent purchasers of paint products. A database 140 of structures, owners and specific products can be maintained to log such purchases. If all three purchased products within a period T1-T2, and a predetermined or calculated update period T3 for such product is approaching or has expired, these individuals can be targeted with a group discount or coupon to increase their odds of participation. By analyzing owner purchase histories and expected product lifetimes the computing system 100 can pair and aggregate similarly behaving owners in a particular block with similar needs to create customized targeted group advertising. On a larger level of course groups of blocks too can be analyzed for optimal targeting.

### Ratings Interface

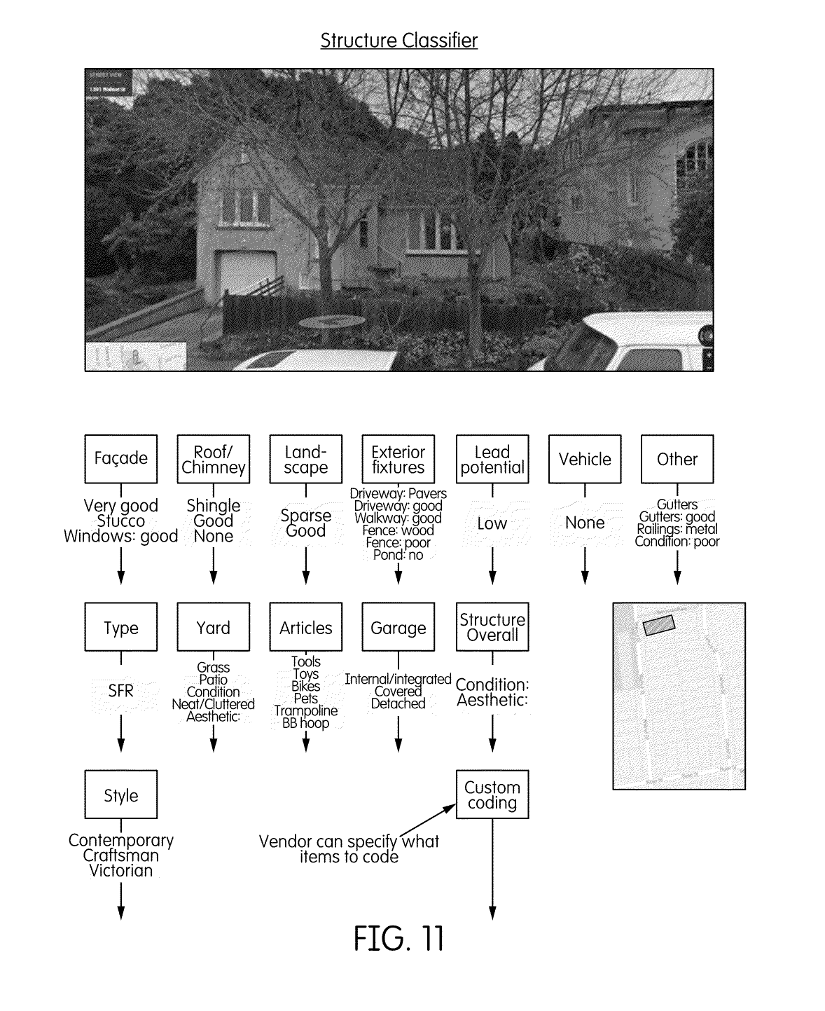

FIG. 11 identifies examples of structural features, parameters, conditions, etc. that can be identified, assessed, tagged, coded and stored for a particular building structure in a city block in accordance with embodiments of the present teachings. It will be understood that these are but examples of course, and other features could be classified as well. In a preferred embodiment, each structure is classified in accordance with at least N different mandatory features, and potentially with an additional M optional features. For example it may be required to capture at least the street address from a sign on the structure, from sidewalk markings or other similar indicators. The number of distinct visible stories can be logged (1, 1.5, 2, etc.) Landscaping and vehicle data may be optional, and so forth. The number of features to be coded will vary in accordance with a desired purpose of the data being captured. In some instances a particular entity may want to capture additional customized data, such as the presence of a sign indicating an alarm system. In other instances a homeowner can be encouraged or induced (including through online surveys) to contribute interior photographs as well of specific rooms. Thus images of kitchens, bathrooms, bedrooms, and surroundings—floors, walls, ceilings, fixtures (lights, appliances) can be captured is and coded as well. This can be used as a feeder to an online user home improvement interface. For example a property owner desiring a kitchen renovation could upload photos of a current kitchen to get an assessment, evaluation, etc. by competing vendors or contractors desiring to take the job. A homeowner may similarly contribute such interior information as quid pro quo for access to a full exterior report as described herein.

As noted above, preferably the presence of the feature, type and condition is coded and collected and stored in digital form. For example, feature “facade” has a type “stucco” and a condition “good.” Other forms of classification and annotating will be apparent to those skilled in the art. Information on the type of structure, the presence, type and condition of facades, roofs, awnings, porticos, landscaping, flags, exterior fixtures, vehicles, yards, articles, garages, building types, air conditioners, fuel storage tanks, window bars, security signs, security lights, flower pots, flower boxes, fire escapes, amount of tree/building shading, street obstruction, and even colors of objects can be collected. For commercial establishments, the type of business can be tagged and stored as well (dry cleaner, restaurant, bar, convenience store, etc.) Grafitti can also be identified in this manner. The types of private—public trees, to the extent discernable, can also be collected as such data can be used for a number of purposes as well. For example certain types of trees produce sap or other droppings that cause damage to vehicles on a seasonal basis, and cluttering of gutters. Knowing the time(s) of year when trees flower or are likely to produce droppings is another item of information that can be exploited for targeting optimal structures, homeowners and times for marketing cleaning products, car wash entities, gutter/window cleaning, etc.

The existence of public or private utility poles, boxes (lights, phone, cable) and cable wires, telephone wires, common fences or open areas between structures can be noted for each structure. In some instances the existence of open parking spaces, and public street signage can be identified and logged as well. An overall density, availability, etc. of street parking relative to private driveway parking can be estimated as well. This data can be aggregated and is used for determining potential parking places for persons unfamiliar with an area. The existence and condition of fire hydrants, street parking signs, school signs, can be compiled for any convenient purpose.

Relative sizes and areas of objects in the image data can also be collected if desired. This data can have further utility in assessing the overall features of a structure and potential for different products/services. For example, dimensions such as a size of a roof area, amount of landscaping, height/size of trees, hedges, a size of a driveway, size of window openings, sidewalks, etc. can also be collected and stored for each structure. To facilitate such measurements, additional scales, tools, etc., could be included in the interface of FIG. 11 to assist a human rater/coder. An amount of height displacement from street level can also be measured if desired. While some images may allow only for one/two dimensional measurements it is expected that additional data could be gleaned from other perspectives obtained by other image capturing systems, or from public records which identify the layout of building envelopes on each lot. Accordingly a front-on shot may identify a dimension of X feet width for a yard, and a public record may indicate a setback of Y feet from a public street. From such combined data it is possible therefor to glean additional site characteristics.

An overall structural rating can be identified as well, along with a relative target area rating indicating a comparison other structures in the area. Many times prospective investors, home owners, etc., want to know a ranking of a structure relative to other homes in a particular neighborhood.

To improve data accuracy it is expected that multiple human coders could be employed to review any particular structure. This will increase accuracy and coverage through crowdsourcing of such tasks. A voting algorithm can weigh the contributions from individual coders in assessing and attributing the presence of features, their type and condition. Since the image data is in electronic form it is expected that such human classifiers could be trained and do such work from any location that has computer access, including in remote or foreign locations where labor costs may be significantly lower. As noted above it is expected that with sufficient training an automated classifier could participate in the process, if is not perform the entire process of classifying structural features. To make it easier for human coders, a visual palette can be presented with the features on the screen. As a coder completes one feature, a corresponding box could turn from red to green. Pulldown menus can be employed as seen in FIG. 11 to assist with the coding parameters. Again, as noted above in some instances these features can be pre-computed by a preprocessing operation and given a tentative designation for human confirmation.

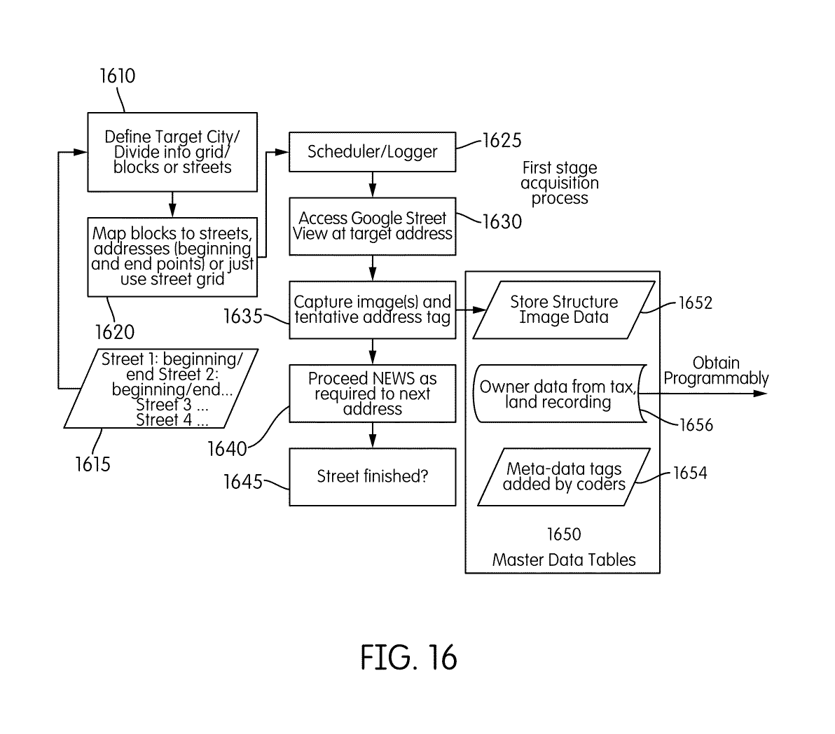

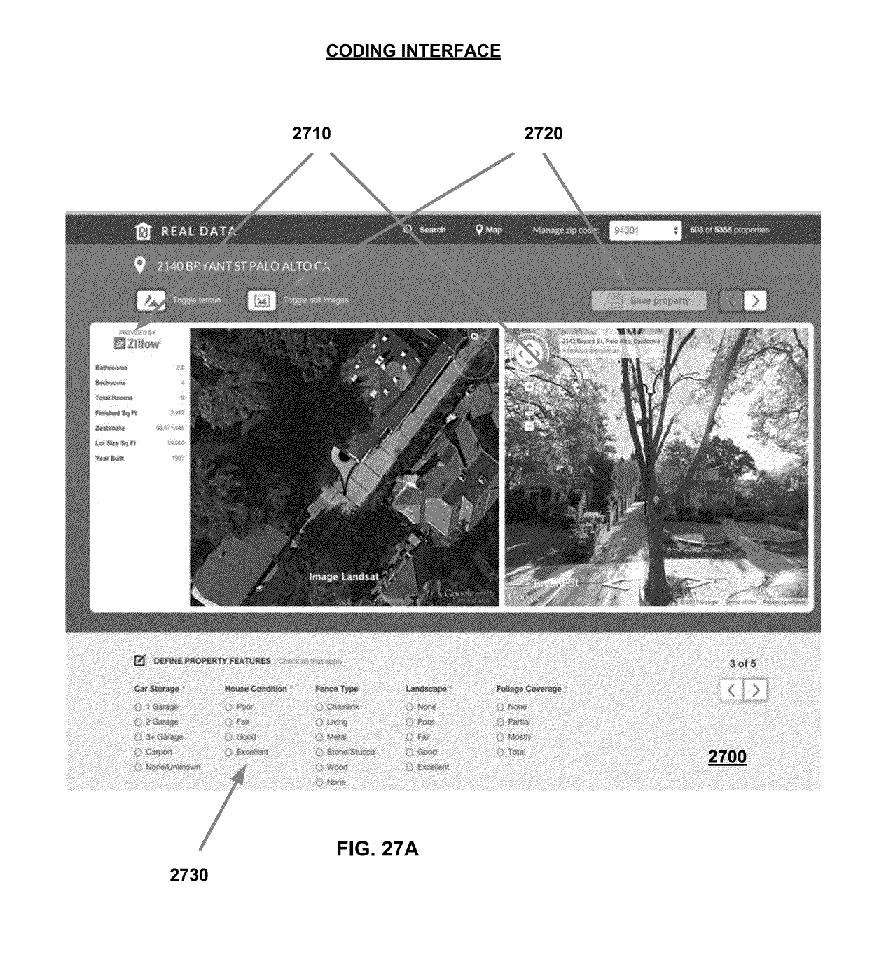

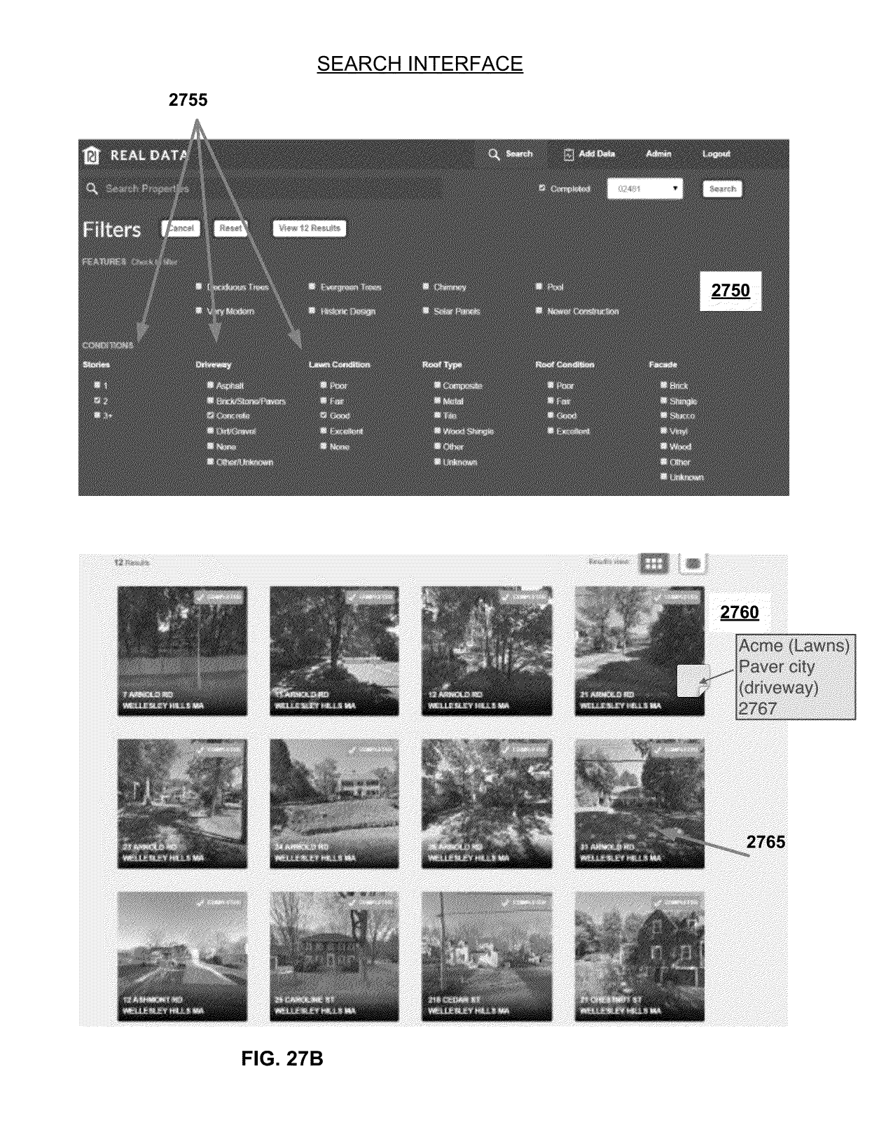

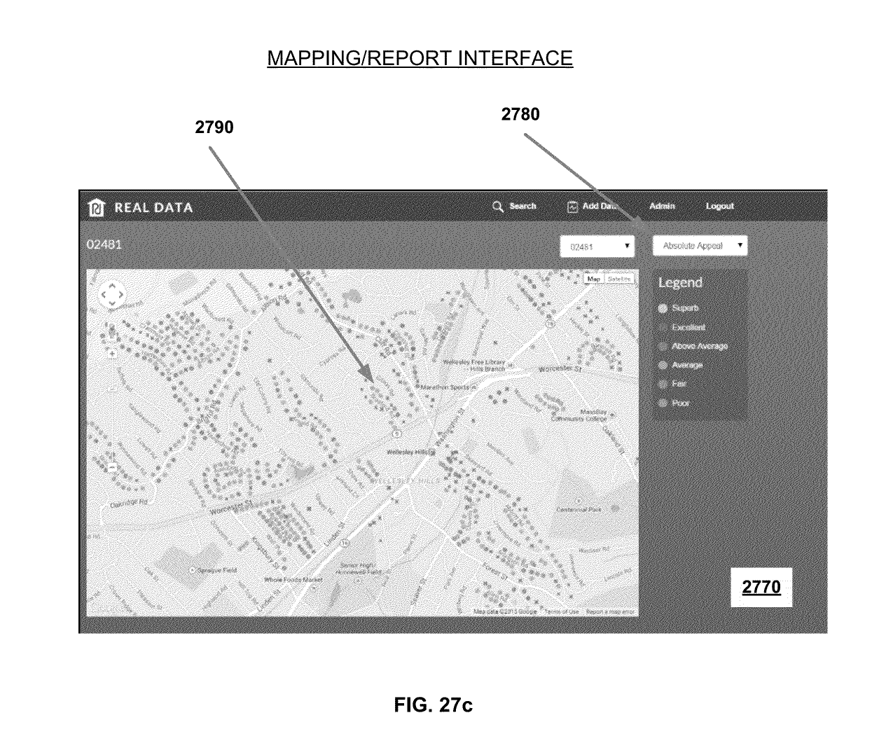

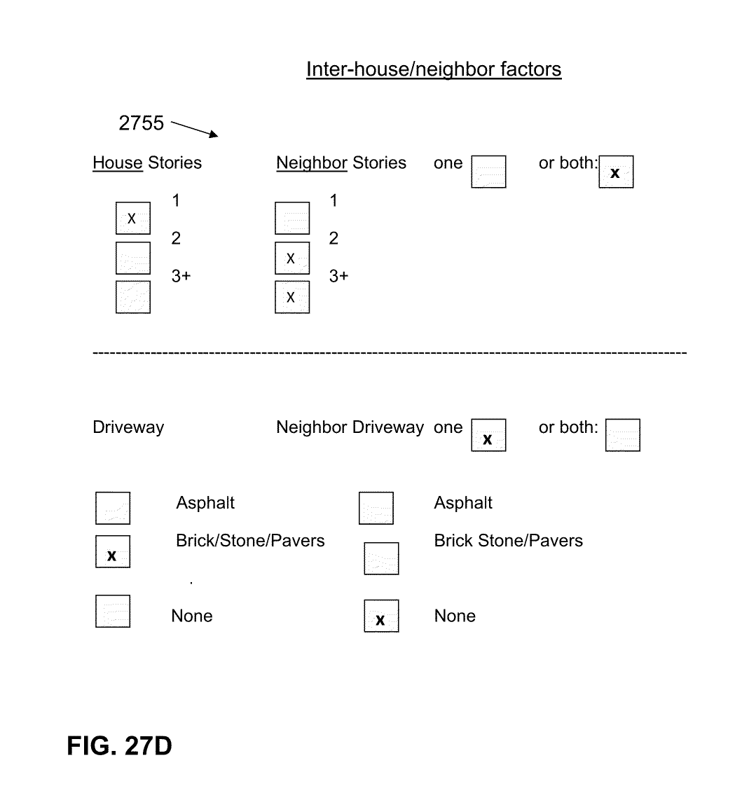

FIG. 27A is another embodiment of a coding interface 2700 which may be used to populate property records 400 (FIG. 4) and coding tag db 1654 (FIG. 16). Image and other property data 2710 may be incorporated from a third party source (such as Google's Streetview, Google Earth or Zillow) for convenience, and then integrated with a data interface/overlay within a first portion of a browser interface. A data entry overlay 2730 then permits manual entry of the features described above and is implemented with conventional radio buttons, sliders, or any other convenient input field. Additional control and navigation buttons 2720 are implemented to effectuate basic functions such as saving the coded data, moving between entries, toggling between different views of the data, etc. By integrating the native applications directly the functionality can be better preserved so that for example a coder can access and use the navigation features in a street level perspective. Thus the can virtually move around in front of the structure, observe different perspectives, zoom, etc.

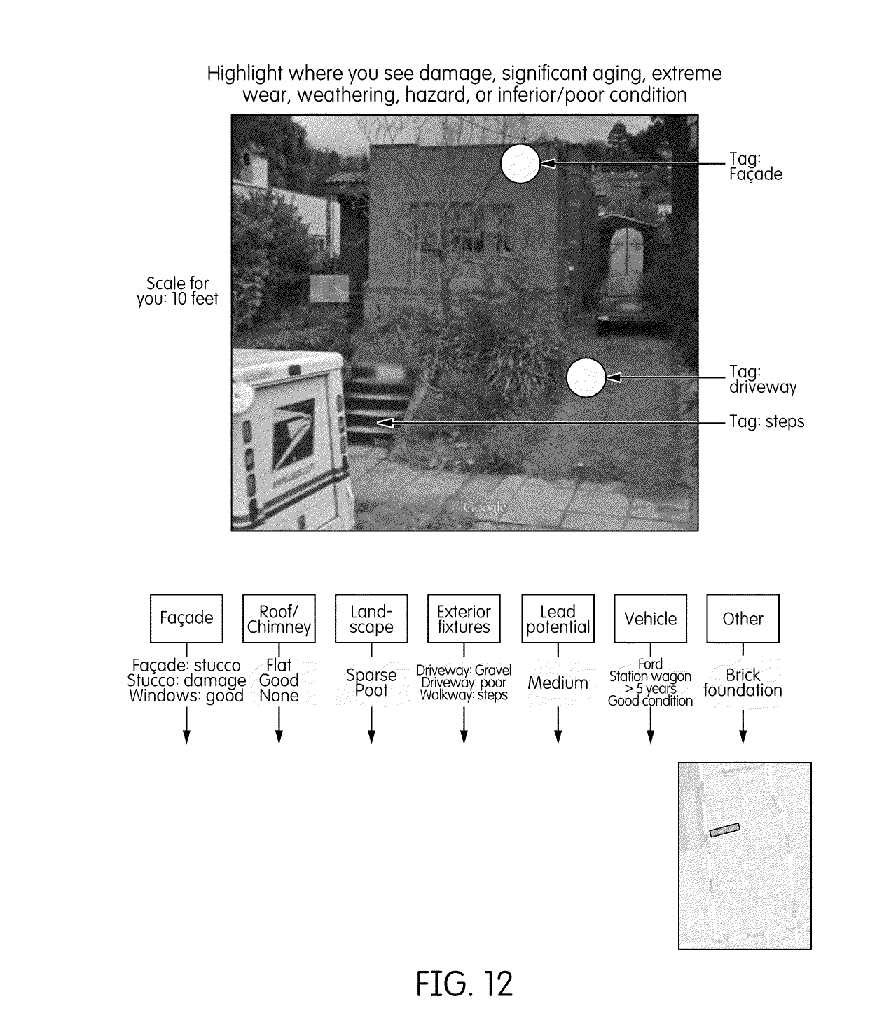

FIG. 12 identifies further examples of structural features, parameters, conditions, etc. that can be identified, assessed, tagged, coded and stored for another structure in a city block in accordance with embodiments of the present teachings. Information on the type of structure, the presence, type and condition of yards, articles, garages, number of stories, and building types can be collected. An electronic interface may be optionally configured primarily or solely for the purpose of identifying defects, wear or other hazards. Alternatively the coding process may be targeted primarily or solely for identifying structural improvements, such as the presence of a new fence, new roof, new paint job, etc. This may be preferable for some implementations in which it is desired to is get a first pass at a set of building stock, and/or where it is not necessary to capture more than a few features. Tags and other annotations can be conveniently added and stored using an automated computing system programmed in accordance with the present teachings.

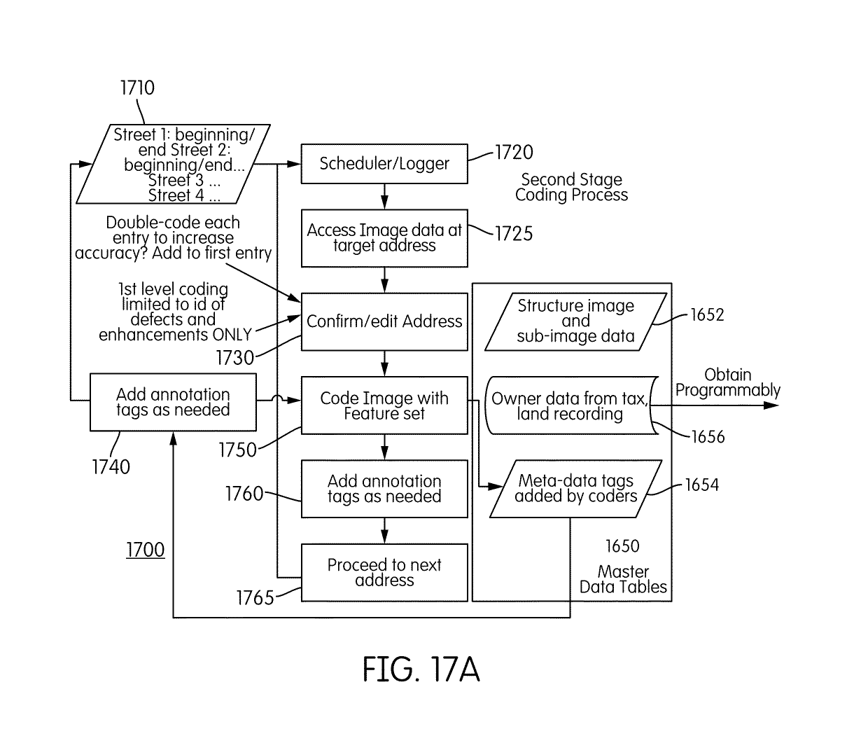

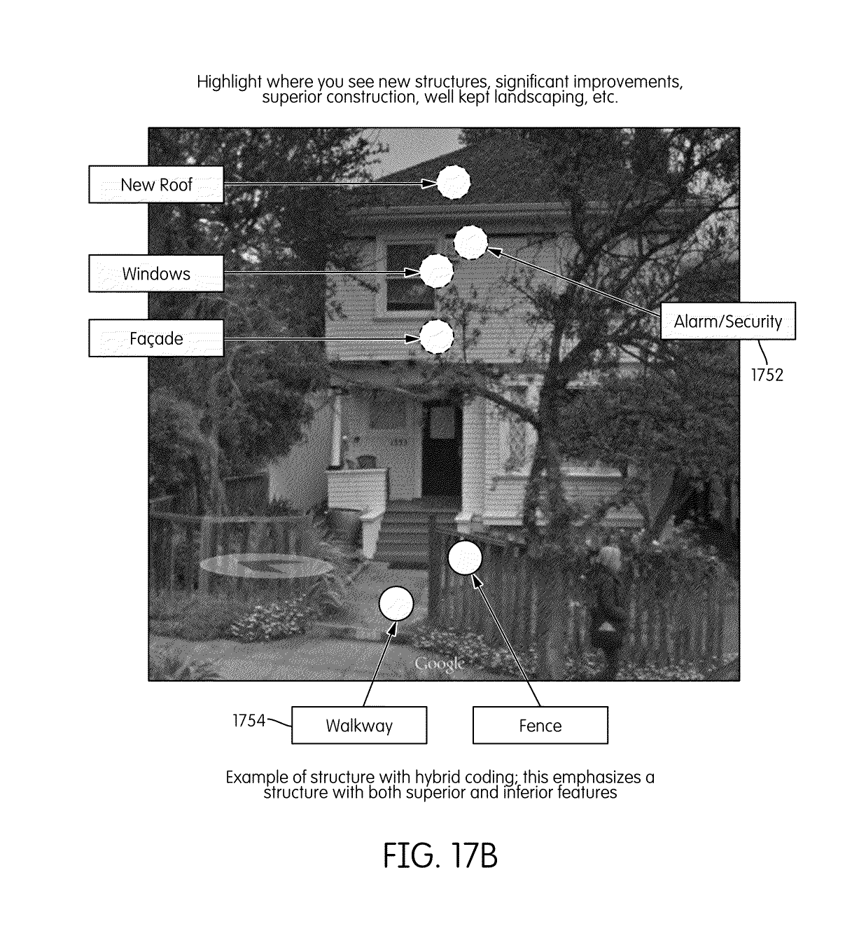

FIG. 17B illustrates a typical structure coding as it would be performed in accordance with embodiments of the present invention. In this instance both defects and property improvements have been annotated and highlighted. Again other variations for items to be coded, and tools for doing so will be apparent to those skilled in the art. The implementation of such customized electronic tool can be achieved in any number of ways known in the art based on the present teachings.

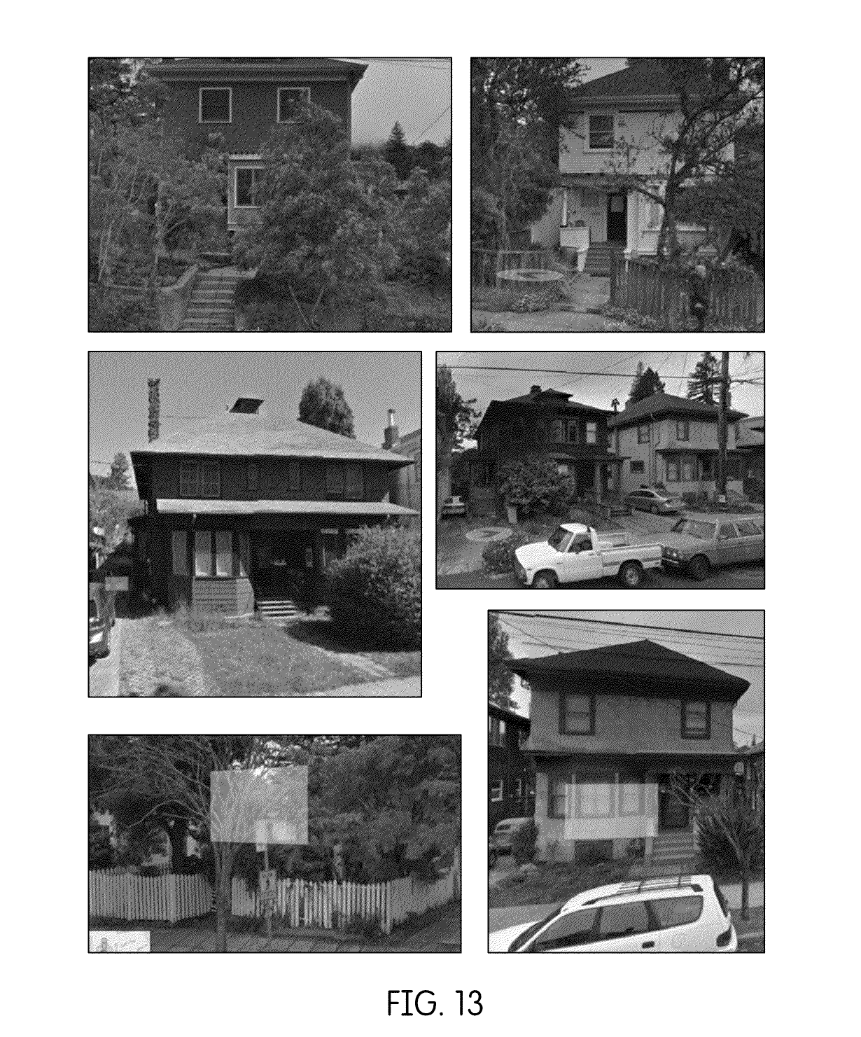

FIG. 13 identifies other aspects of structural features that can be classified in accordance with embodiments of the present teachings. For example the presence of chimneys, fire damage, defective windows, inferior fencing, weathered paint, overgrown or unkempt yards, etc. can all be tagged and logged into a database. These structures correspond to other numbered lots in the block of FIG. 10. While the preferred embodiment uses an existing database of images from a third party supplier, it will be apparent that the images could be obtained directly using conventional processes and sources as well at different angles, elevations and profiles to increase building coverage and feature currency/accuracy. For example, as noted below, it is contemplated that crowdsourcing and/or aerial drone, satellite and/or low altitude dirigible technology could be employed usefully for such purposes.

### Property Based Marketing

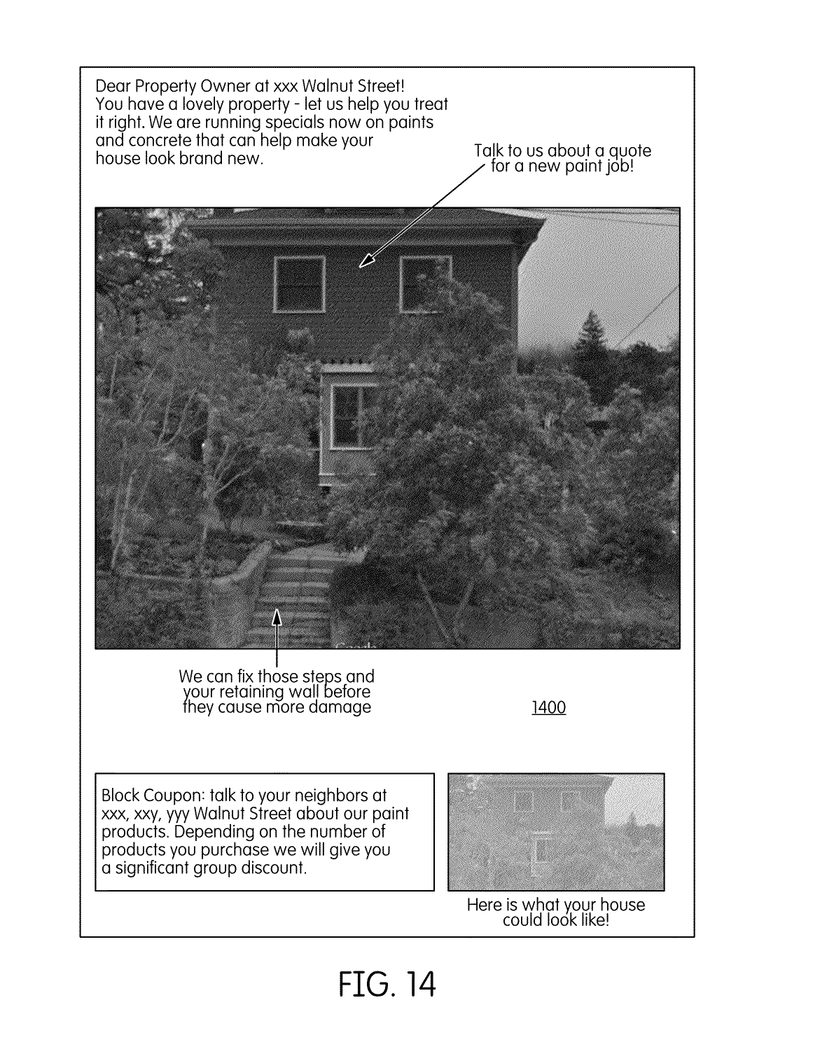

FIG. 14 provides an exemplary embodiment of a targeted advertisement 1400 (preferably generated by the computing system of FIG. 1) for a property owner containing multiple targeted and customizable content sections. Among other things these separate sections identify a specific structure and specific improvements identified by a classification system of the present invention. The content for this marketing material can be synthesized from a variety of sources, including the original image database, the annotations added by human coders, is and other tailored content appropriate to the features and conditions of the building structure. Preferably the marketing and/or advertisement 1400 includes a first section containing a current image of the structure, an identification section for the owner's name or other identifier, a targeted message section to the owner identifying the address of the structure, identification of defects or imperfections at the site, and additional sections for customized offers and/or messages addressing such defects/imperfections. Correspondence and contact information would preferably be included as well in these or other sections of the targeted material. While this material is shown here in printed form, it will be understood of course that a full report containing such information may be made accessible to a user online, and/or presented as part of a targeted electronic ad.

In addition the targeted ad may include a “group” discount coupon portion (see bottom left of FIG. 14) that informs the structure owner of group discounts, including other specific building owners in their area that can be solicited to achieve a group discount rate for a qualified set of participants. In this manner the homeowner can be engaged and motivated to interact and obtain group discounts by cooperating with their neighbors who are determined by the computing system to have similar needs or interests. A group offer can be specified in detail in another section of the targeted ad, and can include any number of criteria tailored by a vendor. For example it may require that at least X participants purchase $Y of products within a period P to obtain a discount D. For example if two neighbors purchase products exceeding $1000 within 30 days they may achieve 20% discount/refund, and so on. The format of the group offer and extent of discount may be adjusted concomitantly with the number of participants, type of products, etc.

In a preferred approach the computing system identified above (FIG. 1) keeps track of a group of owners {S1, S2 . . . } who “opt in” to a proposed discount, and gives them a grace period (T) of a certain number of days to solicit commitments by other participants so as to qualify for the group offer. Small refundable deposits are collected from each participant to secure participation in the group discounts. As the period expires the system can send reminders to the is non-opting participants, additional enhancements or discounts, etc. or qualify the existing set of participants for the discount. The deposits are then applied towards purchase of the goods or services. If the group does not achieve the target size or set the deposits are simply refunded in part or whole. Other variants will be apparent to those skilled in the art.

This type of targeted neighborhood group coupon should have reasonable and improved adoption rates and benefits since the needs of the individual owners are accounted for and aggregated in the grouping of the offers. Stated another way, rather than simply targeting every house in the block with the same random offer by mailers or emails (as is done by most group advertising technology), the present invention can identify particular houses with particular needs, group such entities, and present a specific offer to such entities based on stored profiles for such structures and owners. It will be understood that this is only an example, and the format of such advertisement could take any number of forms, styles in accordance with the present teachings.

Also shown in the bottom right of FIG. 14 (in thumbnail form) is a remediation simulation segment or portion of the marketing materials 1400. In this section the computing system provides a visual simulated version of the homeowner's structure as it could appear if remediated using the products/services proffered in the marketing materials. The remediation and/or rendering simulation software can take as an input the image file for the structure in question and using conventional image processing techniques imitate the effects of different types of improvements.

Other examples and formats of the simulation/remediation section and other sections of the targeted advertising will be apparent to those skilled in the art from the present teachings. Again while shown in hard copy form it is apparent that such targeted advertising 1400 could be created on a structure by structure basis and maintained/presented electronically. A virtual flyer/ad could thus be constructed and viewed online at a website by a homeowner or other authorized user, with the same sections noted in FIG. 14. This information could be accessed online by a homeowner in the same manner that they can currently is access or edit information online for certain real estate listing sites. By specifying a particular address, and providing suitable credentials, a user/homeowner could access his/her tailored/customized data for their structure using a general query engine. The annotated structure data and all other sections would be presented within a conventional browser or mobile equivalent for perusal. The tags, coupons and other sections could similarly include active link portions to engage with the owner directly through more interactive electronic tools.

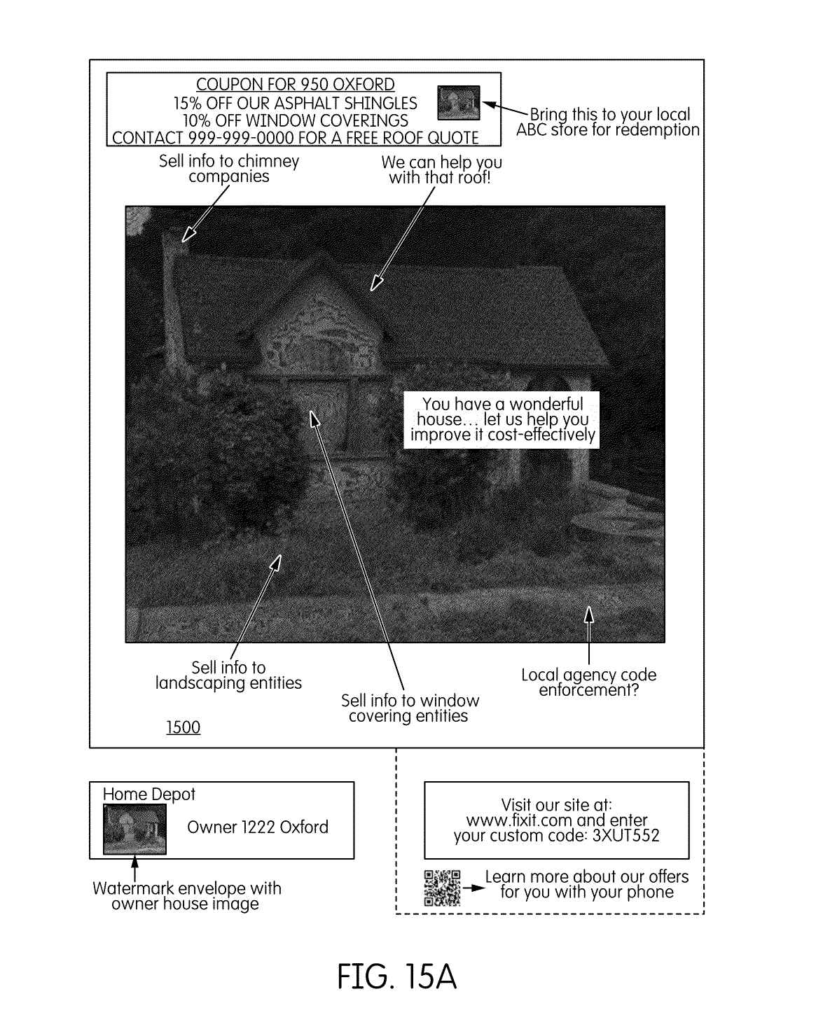

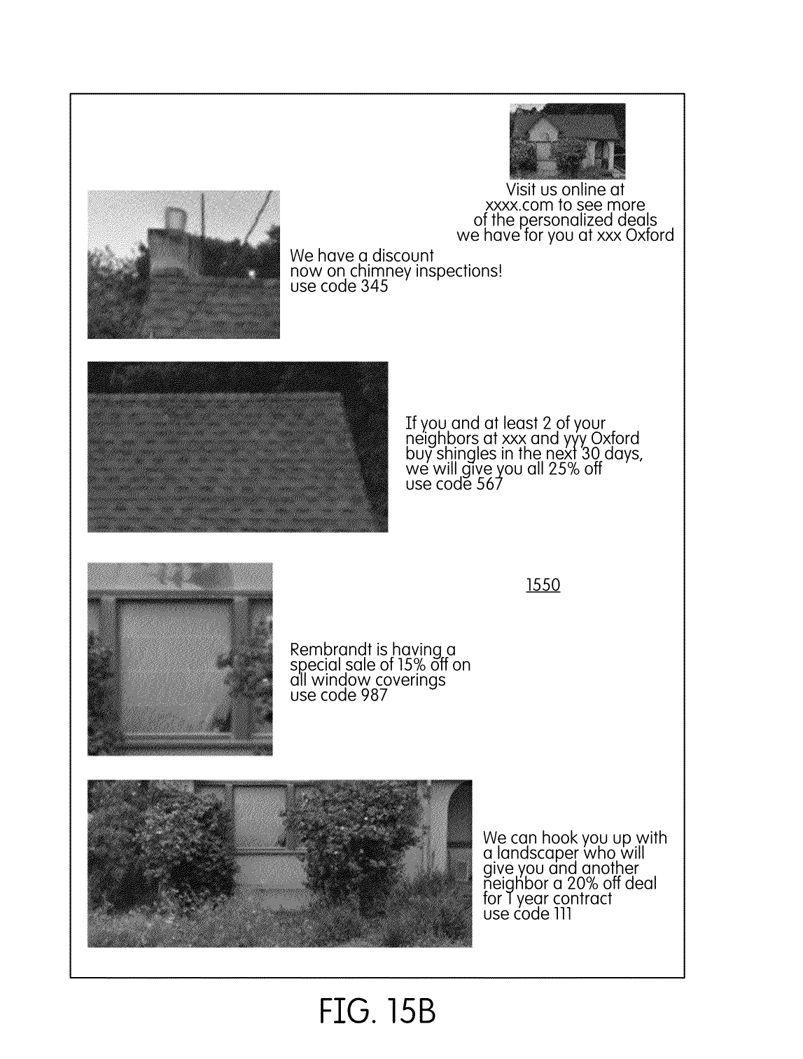

FIG. 15A provides an exemplary embodiment of a second variant of a targeted advertisement 1500 with numerous customized sections including customized coupons generated for a property owner for a specific structure, products, services, etc. in accordance with embodiments of the present invention. In addition, a separate customized delivery envelope can be employed as well (see bottom left of FIG. 15) to further personalize the message. As with FIG. 14 and the other embodiments, this information could be accessed and presented electronically as well within a conventional Internet-accessible interface.

This figure illustrates further that different components and aspects of the coded data can be customized and monetized for use by different service/product companies. For example information on chimneys, roofs, landscaping, windows, etc. can be captured and segmented for analysis and targeted marketing. Interior features can be captured and coded in the same fashion (hardware floors, carpeting, linoleum, tiles, etc.) As seen at the top section of the targeted ad, a coupon can be customized and generated with offers and discounts matched to particular conditions observed and identified at the particular structure. The content can be further tailored based on prior purchase and/or engagement behavior of the owner.

An owner of such property, therefore, can receive a different flyer and targeted advertisement based on the particular condition of their living structure, which may be entirely different than their adjacent neighbor(s). Each flyer or targeted advertisement may have different sections (identification, structure details, coupons, remediations, etc.) and with different content in each section. In this manner the present invention can micro-target advertising for specific individuals on a building by building basis to achieve superior results over generic mass marketing techniques. Conversely product and service companies can quickly and accurately identify promising leads for their business using more relevant information.

Other interaction mechanisms with the owner can be included in the advertisement as well, including URLs, barcodes and QR codes in another section of the advertisement (see bottom right of FIG. 15) that can be scanned by a smartphone to access content, and web based codes useable at an entity's website as well. These additional access points allow an owner to quickly and rapidly see additional targeted and tailored materials appropriate for their structure. Again group offers can be presented on such advertisement as well.

As alluded to above the marketing materials are preferably further customized for the homeowner by including a small graphic, image or icon of their structure directly on an envelope or similar mailer/flyer. This further reinforces the personalization factor and attractiveness of the materials for the individuals being targeted. Rather than receiving a generic flyer with their name and address, the present invention can present high quality, structure-specific content appropriate for their situation.

FIG. 15A provides an exemplary embodiment of a second variant of a targeted advertisement 1500 with numerous customized sections including customized coupons generated for a property owner for a specific structure, products, services, etc. in accordance with embodiments of the present invention. In addition, a separate customized delivery envelope can be employed as well (see bottom left of FIG. 15) to further personalize the message. As with FIG. 14 and the other embodiments, this information could be accessed and presented electronically as well within a conventional Internet-accessible interface.

### Basic Data Acquisition Process

FIG. 16 illustrates a preferred embodiment of a data acquisition process 1600 used by a classifier of the present invention for building structures in a is target city as it would be implemented on a customized structure assessment—targeted marketing computing system. The general purpose of this specialized computing module is to acquire appropriate image data for structures within a target area, along with accompanying address and owner biographical and purchase profile data if available. It is expected that the critical steps identified in this process can be implemented into executable software routines and modules using any number of ways by skilled artisans based on the present teachings.

At step 1610 a target city (or other convenient population unit) is divided into grids, blocks and streets by a human and/or an automated software program. Information identifying a beginning and end of each individual street, road, alley, etc, is used as well at step 1615 from any convenient database or similar source.

At step 1620 customized logical blocks are constructed by the computing system either from actual physical residential/commercial blocks, from boundaries established by street address ranges, or by any other convenient scheme that facilitates the present objectives. An automated scheduler/logger routine is also used at step 1625 to keep track of the progress and status of processing of each street, block, etc.

During step 1630 image data (and other similar machine captured data) for the building structure is retrieved for the target address in question. Again in a preferred approach this data is obtained from a third party vendor, but it can be generated as needed as well using any conventional techniques. For example it is expected that aerial drones, satellite, balloon and similar technology can be used in certain areas to easily capture structure image data from a variety of perspectives, and at different times. Because such devices can obtain image data different elevations, this will also facilitate building out a comprehensive image database. By taking pictures at later hours (including at night) such devices could also identify whether structures are inhabited or not based on the presence of lighting and other similar signatures. Appropriate safeguards could be implemented of course to ameliorate or at least reduce privacy concerns.

The building image and tentative address are tentatively tagged and is stored as part of a set of master data tables 1650, including in a structure image database 1652. The structure image database can also include structure sub-images, which are based on automatically dividing the original image into separate blocks, or separate areas corresponding to distinct building elements using an image computing device. The sub images can then be used in targeted marketing for the target property instead of an entire structure image in some circumstances where it is desirable to highlight or focus on one or more particular elements, or where it may be considered less intrusive to the homeowner's privacy.

Owner data for such structure can be accessed automatically and stored in a database 1656 as well, along with optional prior home improvement data (building permits), vendor historical purchase data, line of credit data where it is available, etc. Metadata tags for each structure are stored in a database 1654 as they are coded. It will be understood that the format and routines required to access and store such data can be implemented in any number of ways based on the present teachings.

The automated process continues at step 1640 by proceeding to a subsequent address. Again this may be done programmatically or can even be done manually by a human operator navigating and accessing an image view of a street under consideration. When a street is completed at step 1645 the process can continue by selecting a different street until an entire target area is completed. To optimize targeting the scheduler logic may be programmed to discontinue image and data access when a density of structures falls below some threshold minimum. For example, in some suburbs and rural areas the benefits of logging and assessing specific structures may be less because of a lack of critical targeting mass. Conversely in large cities it may be less desirable to analyze large apartment buildings, and instead prioritize based on single family residences and small businesses. This approach may yield less comprehensive coverage for some areas, but can be employed to prioritize assessment and marketing. Additional mechanisms for collecting structure specific data are identified later herein including through mobile and web data is contributed by volunteers, game participants, etc. It will be understood that some steps are simplified for purposes of elucidating the key points of the present teachings and that many other steps could be implemented in accordance with any particular commercial application.

### Basic Coding Process

FIG. 17A illustrates a preferred embodiment of a structure coding process 1700 used by a classifier of the present invention for analyzing building structures in a target city. This process is used to capture and annotate data within an interface such as shown in FIGS. 10-13. It mirrors the process of FIG. 16 in many respects, and like reference numbers are intended to refer to like processes and structures. For example structures 1650, 1652 (image data), 1654 (metadata tags) and 1656 (owner data, profiles) are the same.

At step 1710 a coding process initiates preferably at one endpoint of an identified street. A scheduler/logging step 1720 keeps track of a completion process for any particular target area and street—address range set.

The image data for a particular target address is obtained at step 1725, along with a tentative address tag. Preferably this address information for the structure is confirmed at step 1730 to ensure that the targeted marketing materials (ads, flyers and envelopes) contain accurate information for a particular address.

At step 1740 an input coding overlay or coding template is presented to a human coder to facilitate annotating, scoring, etc. of a target structure image. This template tool can take any convenient form suitable for assisting a coder, and may have a number of pop up fields, pre-designated tags, and image recognition capability, etc. for performing a coding process. For example when a coder places a mouse over a roof portion of the structure, the image data may include some pre-processing areas with preexisting tentative feature designations to facilitate data input. Other features may already be automatically tentatively classified as noted above, so that the human coder is mostly used in a verification role. When a coder selects a portion of this area the template can present a tag already populated with the appropriate feature label, or a set of is labels predicted to be present in the designated region. Preferably the tool includes predictive and error-control logic so that the user is constrained to use predesignated labels for features, types and conditions that become active as the user enters data into particular fields. It will be understood that any number of different techniques can be employed to collect the image feature data and the invention is not limited in this respect.

During step 1750 the input template is used by a coder to identify, classify and rate a condition of features in an image for a structure. Again in a first pass it may be desirable simply to identify only defects or only improvements. In some embodiments it may be desirable to code each image with contributions from multiple observers. For some applications it may be sufficient to collect data from volunteers contributing information ad hoc based on their informal surveys of structures conducted on a portable device such as a smartphone, tablet, etc., while they are in the vicinity or in the location of the structure in question. Any number of techniques can be used for this purpose.

During step 1760 a coder provides annotation tags as required by the template, and according to their visual inspection of the structure in question. Again because a significant amount of structural information—particularly defects or impairments—can be gleaned rapidly and easily by the human eye, the coding is expected to be relatively easy to perform, even for unskilled workers.

As alluded to above a structure image database 1652 can also include structure sub-images. During or after the coding process, the image for the structure can be automatically divided by an image processing system into different sub-images of different size, location, etc., which correspond to distinct building elements. Thus the coding database preferably includes both a tag, as well as a corresponding sub-image of a desired size to identify the element and its condition. The size and content of the image can be made uniform, or it can adjusted based on the type of element, selected by the coder manually using a conventional image cropping tool, or automatically identified and bounded by an automated classifier as noted above. Again these sub images can then be used in reports, responding to queries, creating targeted marketing for the target is property (instead of an entire structure image) and so on.

The automated process then proceeds to the next address at step 1765 to facilitate further data entry by the coder. This is repeated by until each structure is coded as needed for a particular application. Again in some instances it may be desirable to divide the coding of structural information into distinct coder “experts” so that individuals with experience and understanding of facades may be employed to do that kind of work, while persons familiar with landscaping or roofing could be used for other components, and so on. By hyper-segmenting the identification/classification task, it may be faster and easier for certain coders to obtain proficiency at certain tasks and improve accuracy, rather than requiring them to master all identification tasks. A first team of coders may be dedicated to roofs, with another team to fences, landscaping, facades, vehicles, etc. Accordingly, a number of different coders can work on the same image data and provide a number of separate tags and annotations for the same structure serially or in parallel. The data can then be aggregated and updated as needed in metadata tag database 1654.

As alluded to above, in some instances an automated classifier can be trained to locate the features of interest, either as a complete data capture, or even simply as an initial pre-coded template that is reviewed by a human coder for accuracy and completeness. The final meta data template can be tweaked, edited, augmented etc. by a human operator. In this cooperative approach a machine can perform the bulk of difficult annotating/tagging and a human can do more of the fine-tuning of the results. As seen below, additional mechanisms for rating and coding structure features are identified later herein including through mobile and web data contributed by volunteers, game participants, etc.

### Structure Feature Query

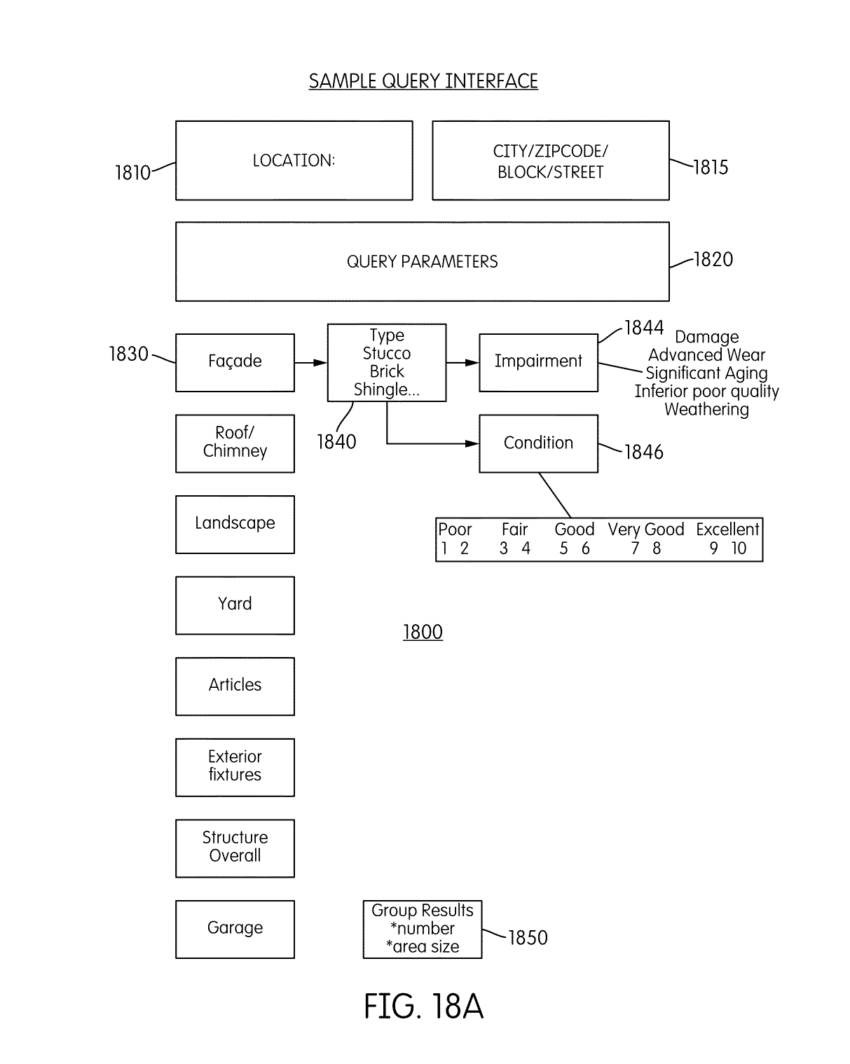

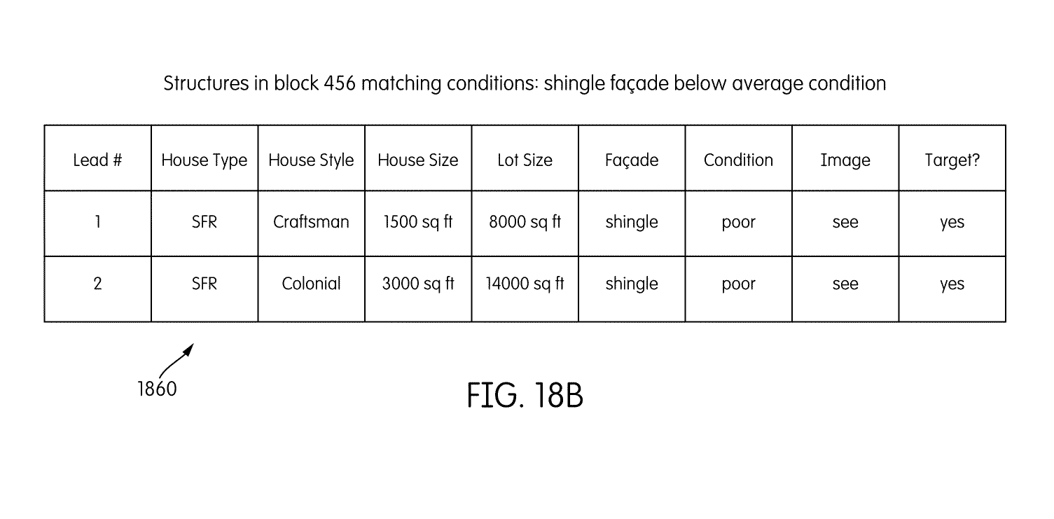

FIG. 18A depicts an exemplary embodiment of a query engine and interface 1800 that can be implemented in accordance with the present teachings to facilitate identifying relevant properties and homeowners matching a particular target structural profile. It is expected that this type of search tool can be used online over the Internet or some other network by vendors and service providers is in any number of different industries to identify leads, generate reports and customized, targeted advertising such as seen in FIGS. 14 and 15.

As seen in FIG. 18A, a location 1810 can be specified, and, if desired, a particular zip code, city block, street, etc. Other query parameters can be provided within a search field 1820 and the invention is only limited by the features that are captured or derivable from the coding data. For example a vendor or user may filter leads by whether they are already existing customers or not of such vendor. Other income, demographic and similar owner profile data can be incorporated as desired as well.

To facilitate use, the search engine may include a number of predefined fields 1830 corresponding to coded searchable features in a building—structure set. The features can be associated and filtered by type field 1840, as well as preferably by an impairment 1844, condition 1846, etc. In some applications a vendor can be given a visual search field for a query based on impairments 1844 and/or condition 1846, so that a variety of exemplar images are presented corresponding to each categorized condition. The vendor therefore can thus easily glean what types of conditions are associated with a particular feature across a spectrum of classified values—i.e., what constitutes a poor condition shingle (level 1) an excellent condition shingle (level 10) and so on.

For example a user can specify that they would like a result set of all structures in Berkeley, zip code 94709 which have shingle facades and that are below average condition (level 5). Other default values could be used to review all structures in a particular area, with sorting and reporting capability as well.

Furthermore a vendor can specify that a result set should be grouped using a query construct selector 1850. For example the vendor can specify that a result set from the query engine should logically group structures within a particular area (e.g., a cluster of 4-5 houses or an entire city block) and in a particular number (say 10) which share a common feature, type and/or condition or rating. This information can be used as leads for developing group discounts and promotions.

FIG. 18B depicts a typical report 1860 as it could be generated by a query is engine 1800, in response to a basic query such as identifying all structures in a particular city block that have shingles as a facade, and which are below average in condition. The report can identify the fields listed, as well as any other desired data maintained by the platform for vendors. Preferably the specific address or other contact information is masked in most instances to prevent poaching of the data by competitors or the vendors. In some instances it may be desirable to allow vendors to see at least partial image information to confirm that they want to target the customer in question. This depiction of a sample report 1860 is not intended to be exhaustive of course, and other formats, fields, and features will be apparent to those skilled in the art from the present teachings.

The specialized interface and functions of structure feature query engine 1800 and report generation can be implemented using appropriate computing systems adapted with software to perform such functions in accordance with the present teachings.

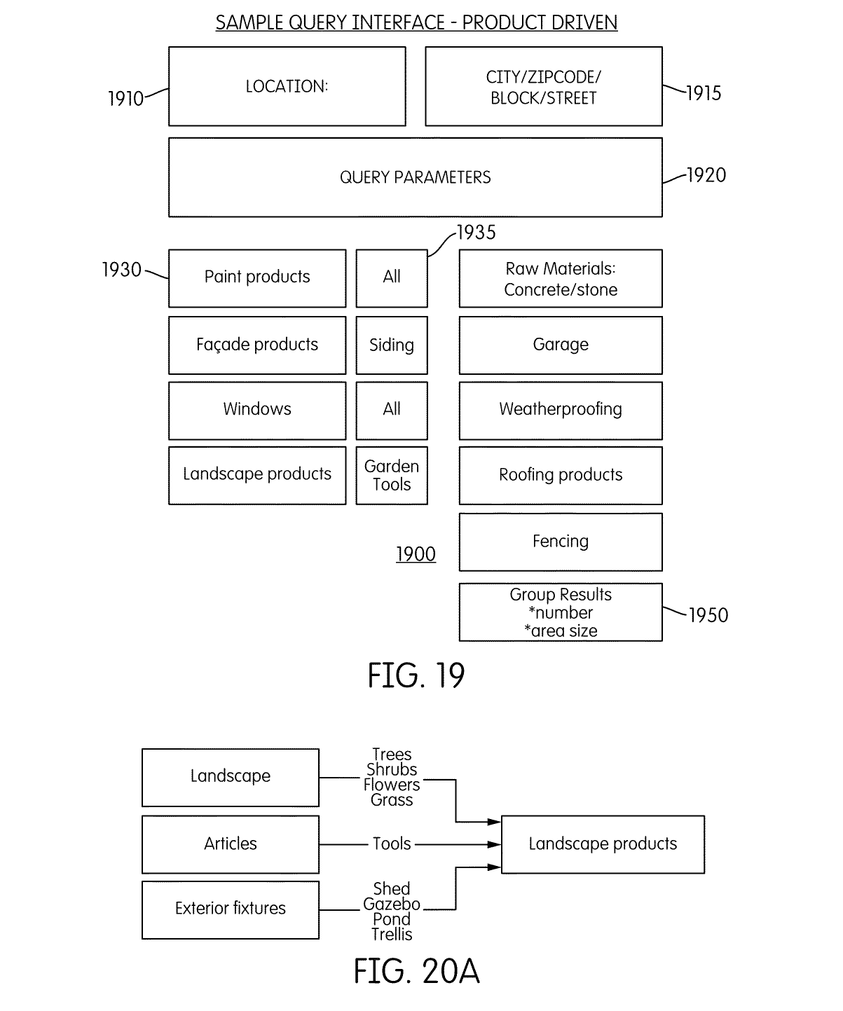

An example of a web-based embodiment of a search query interface 2750 operating within a conventional browser is shown in FIG. 27B. This embodiment complements the interfaces discussed above in connection with FIGS. 18A, 18B and FIG. 19 and is somewhat more graphical/intuitive.

The various filter parameters 2755 can be specified through checking off boxes. In the example given, the user is performing a query to find selected houses in zip code 02481 that match a profile of being: 1) at least two stories; 2) with a concrete driveway; 3) a good lawn. Other parameters (not shown) can be used as well of course (i.e., whether it has a garage, landscaping, etc.) The result set (in this case 12 matching structures) is presented in thumbnail form in a report interface 2760 as entries 2765. Each of the entries is selectable to permit a user to see a detailed profile of the house, such as shown in FIG. 27A. Other examples of formats and data will be apparent to those skilled in the art.

FIG. 27C illustrates an embodiment of a mapping interface 2770 that can be used to report results of a search query. This interface allows a user to select a feature/condition from a drop down menu 2780, and then view the results in pictorial form as individual icons 2790 overlaid on a geographical region. Here a is user has requested to see the “Absolute Appeal” rating of every house in zip code 02481. The search engine retrieves the relevant data from tables 1650 (FIG. 17A) for each structure and overlays it in iconic form on a map with a different color/icon for each rating. As seen in FIG. 27C for example, any house with “Superb” appeal is shown in yellow/gold, while poor houses are shown in orange, and so on. Other data, formats, etc. could be used of course depending on application requirements. The individual tags are also preferably selectable (such as with a cursor overlay or click) to see detailed information for the property in question. This type of graphical report can be extremely useful for quickly assessing entire neighborhoods and finding particular homes meeting a desired profile. Clusters of similarly/disparately rated homes are also easily located to determine homogeneity or heterogeneity of housing stock.

### Structure Product/Service Query Leads

Looking at it from another perspective, FIG. 19 depicts an exemplary embodiment of a query engine and interface 1900 that can be implemented in accordance with the present teachings to facilitate identifying relevant properties matching a particular target product profile. Where apparent, like reference numbers are intended to refer to similar structures and functions identified in FIG. 18. For example a vendor/service provider could specify a particular location 1910 (a city) and/or narrowed to a particular area 1915 (zip code, street, block) and specify a variety of search parameters 1920. In the example of a home improvement entity, they could request a result list that included leads for product field 1930 such as “paint” with a type field 1935 of “all,” or structures that require siding facades, and so on. As with the interface of FIG. 18, this logic could be implemented on a webpage at a website in any convenient form and accessed through a browser or mobile device. Similar queries for building stock matching other criteria can be solicited according to vendor product categories, such as weatherproofing, raw materials, etc. A result set could look like that shown in FIG. 18B, but instead include a ranked listing of structures in the designated area according to a predicted need for the product in question.

Furthermore as alluded to above, a vendor can specify that the result set is should be grouped using a query construct selector 1950. For example the vendor can specify that a result set should logically group structures within a particular area (e.g., a cluster of 4-5 houses or an entire city block) and in a particular number (say 10) which may be good leads for a specified product or service. This information can be used as leads for developing group discounts and promotions. The interface and functions of structure feature query engine 1900 similarly can be implemented using appropriate computing systems adapted with software to perform such functions in accordance with the present teachings. It will be understood of course that other features could be implemented in such interface(s) as well.

### User Customized Home Improvement Related Queries

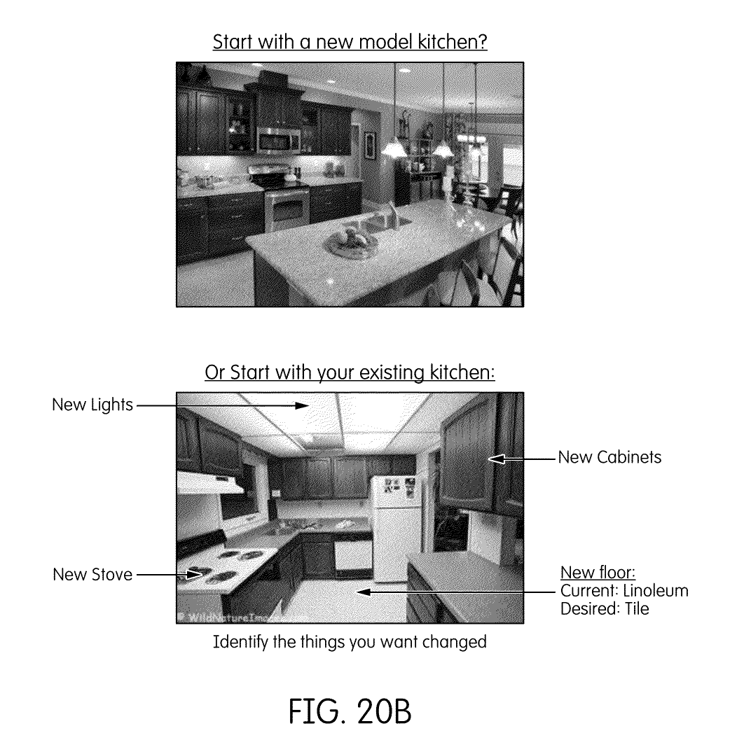

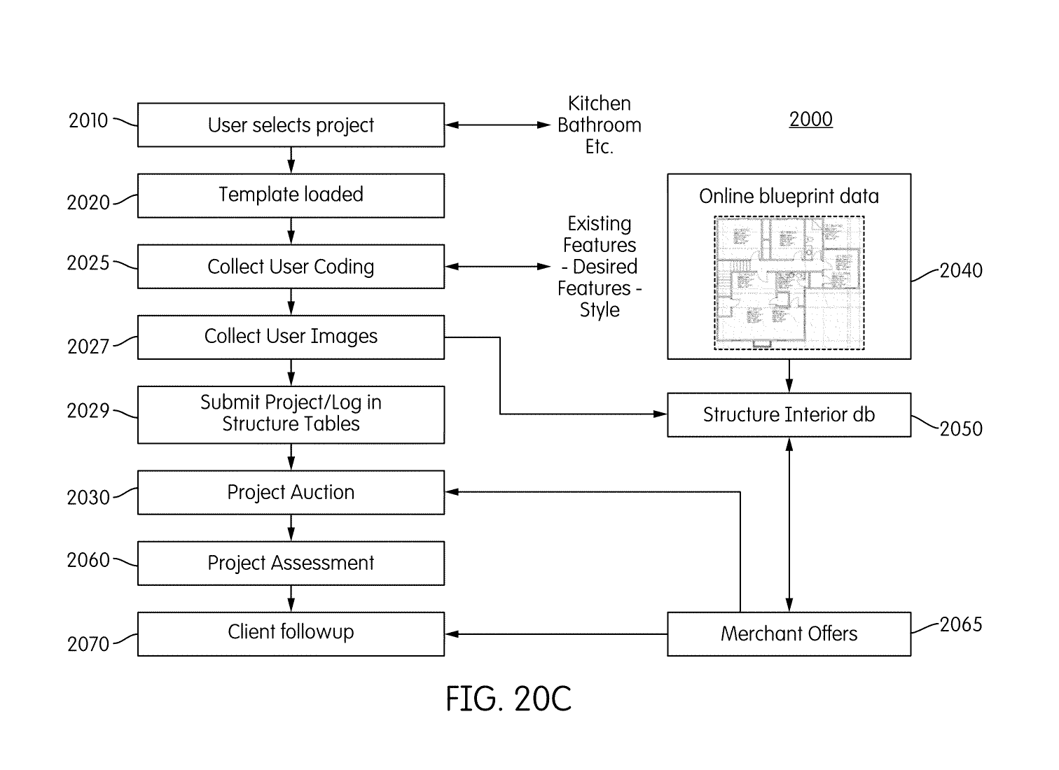

To facilitate the operations of search engines 1800 and 1900, FIG. 20A depicts an exemplary taxonomy that can be employed to map structure features, impairments, etc., categories to respective product/service categories, or vice versa to facilitate responding to queries and identifying prospects for customized advertising. This taxonomy may be centralized and made generic for basic mappings, but it is expected that each vendor will customize or tailor a mapping of a set of features, types and conditions to their particular product line. This can be gleaned by such vendor using their own proprietary logic for ascertaining the correlation of identified features and their product line(s). For example a landscape company may determine through correlating products and features that their targeting should be made to specific structures which have certain landscape annotations, include certain articles (garden tools) and/or which have particular exterior features (sheds, gazebos, ponds, trellis) etc. A roofing company may consider not only a type and state of a roof but also whether other prominent improvements are present, potentially indicating a homeowner predisposed to invest in improving their property. An insurance company may determine that owners with well-kept properties file fewer claims, and so on. Other companies may employ their own taxonomy and correlations to define appropriate queries that best map to their customer intelligence data. The present invention enables a large ecosystem of prediction—recommendation is approaches to be used in the final matching process because it collects a large number of diverse feature items which can be analyzed in a myriad of ways.

In addition to exterior features it is possible of course to identify and map opportunities for interior projects using embodiments of the present invention. For example, a homeowner may be interested in a new kitchen floor, new cabinets, new countertops, new fixtures, etc., or a new bathroom, bedroom, etc.

To assist the homeowner, a pre-configured digital image template can be presented, with all necessary or available features presented and coded for the user's review and input online. As seen in FIG. 20B for example a user wishing to do a remodel is offered either to start with a brand new model kitchen, or to work from an existing kitchen. A mock-up is the presented to the user to allow them to see what items can be replaced, upgraded, etc. The user simply has to identify each feature in their own particular situation that they want to address, and provide some basic information on type, condition, etc. For example a user can identify that a current flooring is linoleum, and a desired replacement is tile. This data can be implemented much in the same way the coding tool described above is implemented for capturing exterior condition data. The homeowner can be directed or walked through an image capture process that is tailored to the particular project or room. The precise parameters for each project can be specified by the merchants or service providers, or the ad serving platform.

An example is shown in FIG. 20C of an exemplary automated computing process that can be employed to assist homeowners and merchants coordinate for remodeling and renovation projects. All of these steps, again, can be implemented on a customized computing system adapted with appropriate software modules to execute code to effectuate the steps noted in FIG. 20B and render customized, targeted advertising material for the user. The result is a report, an estimate, or an offer from a merchant that is again custom tailored to the user's particular circumstances.

As seen in FIG. 20C a user selects a desired project at step 2010, which may be an interior project, or an exterior project. In this example the user may select to remodel a kitchen as seen in FIG. 20B. A template is then automatically is loaded within the user's browser or other viewing platform to permit them to code their desired remodel with appropriate parameters. Images from the user's existing property may be collected at step 2027, either directly from the user (through a mobile device, a local camera or other means) and/or from a structure database 2050. The latter may be supplemented with online blueprint data 2040 as discussed below.

The user then preferably identifies specifically both an existing feature, condition, etc., and a target or desired feature, type, condition, etc. This is repeated until the user has coded all the features they wish to be targeted and addressed by merchants and contractors. During step 2029 the user submits the project (preferably online) which updates all structure tables as well.

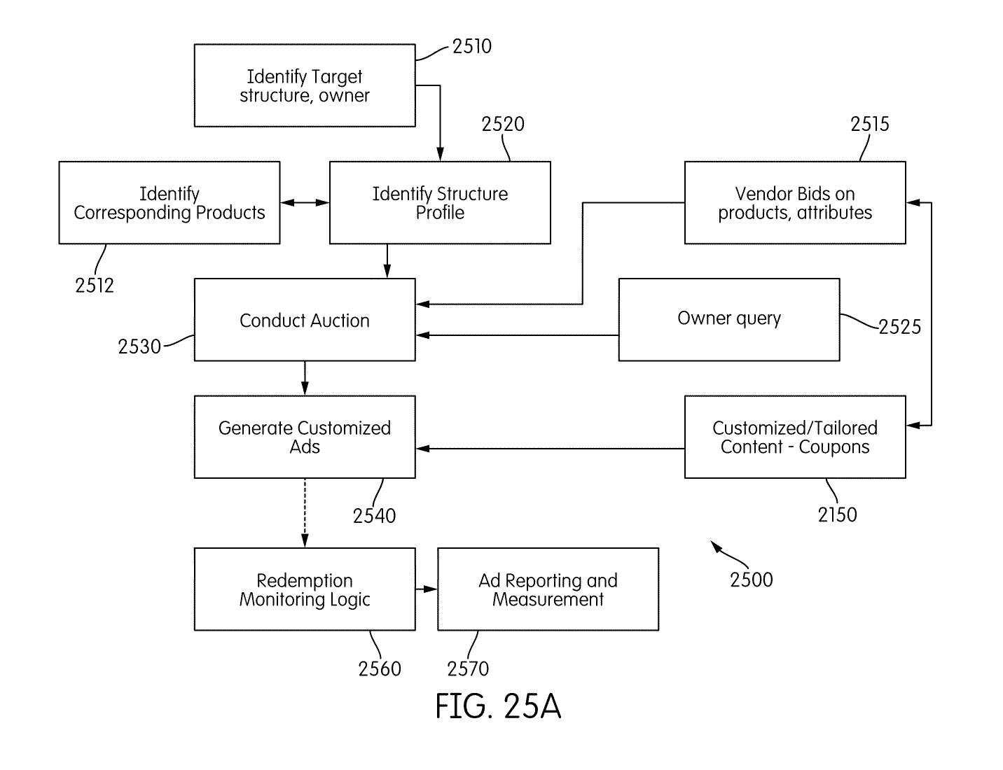

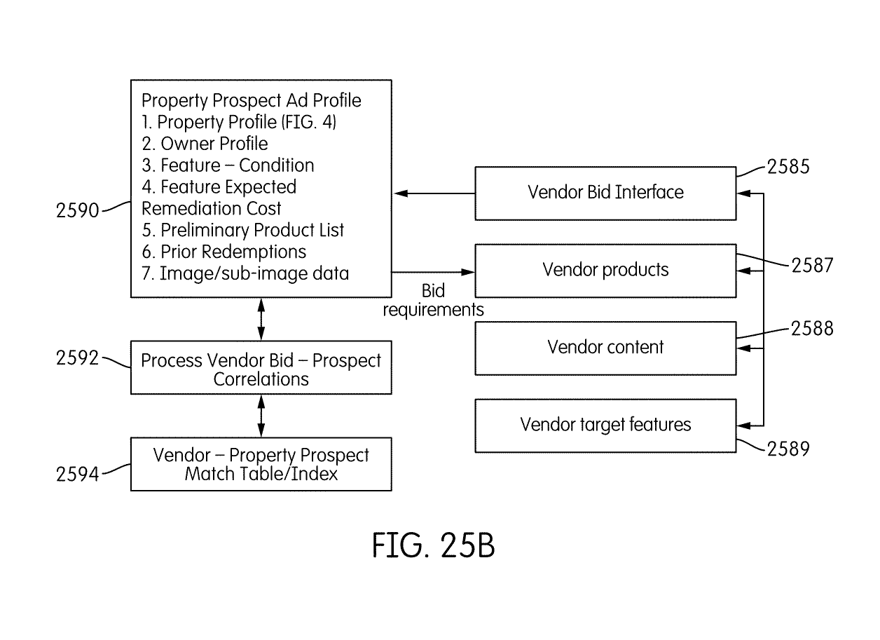

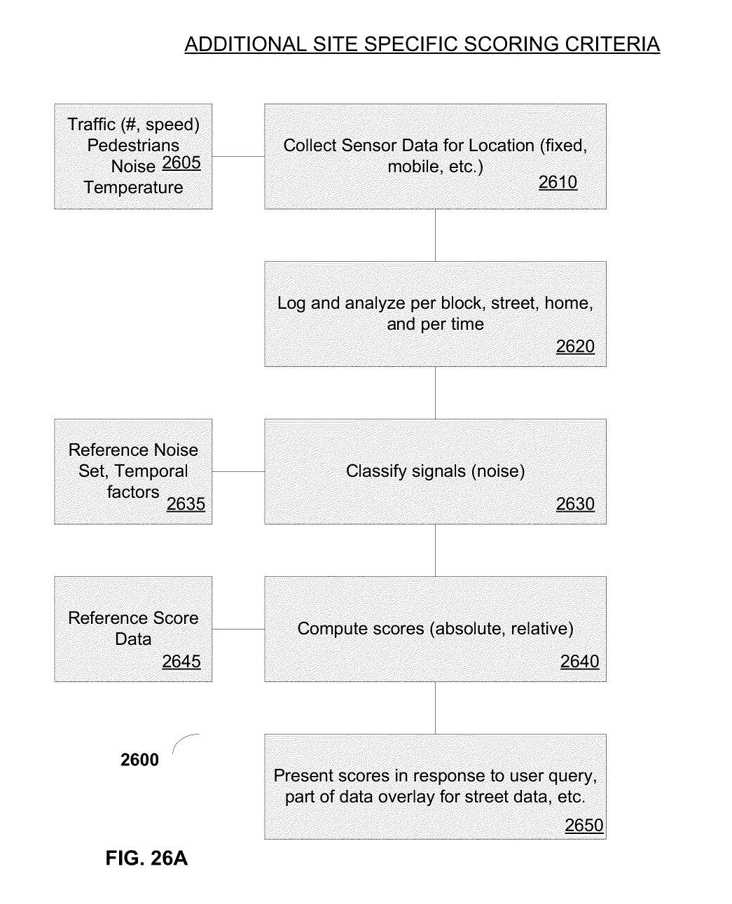

During step 2030, which may be done in real-time or off-line, a series of one or more project auctions are conducted (see discussion below for FIG. 25A, process 2530) to identify winning merchants, contractors etc. who are permitted or qualified to view or bid on the user's project. The merchants may bid against each other in the manner described below for FIG. 25A, 25B. Merchants who participate and succeed in such auction can then process the project data to make assessment at step 2060. For example a vendor may determine that the project exceeds a certain desired threshold, or alternatively is too small and may decline to participate further. In any event the processing of the project data may be done with reference to any number of standard techniques that are used for estimating renovation costs.

Should the merchant wish to propose an offer, they may elect to do so at step 2065. This offer is then presented to the client and follow up can commence at step 2070. It will be understood of course that multiple merchants may bid on the same project, and/or that the projects may be partitioned automatically into separate pieces or categories depending on the renovation. For example a floor job and materials may be separated out and bid on separately from a fixture renovation, cabinet replacement, etc.

While the example of a kitchen renovation is given, it will be apparent that improvements for other interior aspects can be similarly designed in a manner is that permits a homeowner or user to quickly identify and define a condition of an existing structure, and desired remediation. For example to provide a remodel or closet upgrade, photos or data of the existing closets can be uploaded, with sufficient onsite information (size, shape, etc.) to assist user in capturing relevant data in an interface (see FIG. 20B) and assist a merchant/contractor in assessing the lead and providing a reasonable estimate of repair or renovation. By capturing and analyzing the information ahead of time, a merchant and/or local contractor can rapidly assess and present a meaningful review and proposal to a homeowner at a first meeting, rather than waste time collecting onsite information during an initial visit.

In some instances where online information exists for the structure in question—such as electronic blueprints—it may be possible to process and consult such data at step 2040 as well as part of an estimation service. Many local agencies require that homeowners provide such detailed drawings as part of remodels. From this layout/schematic information the identity, size and shape of rooms is typically identified for individual property structures. If metadata or other data is available and/or can be derived from such repositories, a merchant or service provider can better assess opportunities as well by calculating a number of square feet of each room, a number of windows, number and size of closets, patios, and so forth. A layout database of such features can be compiled, either directly from such blueprint data, and/or from other sites that have interior information contributed by occupants of such structures (homeowners or tenants).

In other instances a user's social networking account can be mined for relevant interests and possessions. For example pictures of an individual may include background scenes, identifiable objects, etc. With the user's permission these items can be image processed, and tagged to identify relevant items. Any form of image data associated with a user profile, or user collected data, can be compiled and targeted by an advertiser. For example user or member photos on a social networking site can be analyzed, dissected, etc., to identify relevant objects, concepts, etc.

An advertiser on such network can designate to be matched against such recognized objects, and/or to be matched (based on some threshold) by comparing the advertiser's reference object image to a potential customer's captured image (or sub-image). For example an advertiser may want to target homeowners/users who have certain breeds of dogs; by analyzing photos of users' dogs, and matching them to a profile provided by the advertiser, an index can be determined of potential candidate matches. Similarly in most advertising contexts an advertiser knows the value of the item they are promoting to the user. In the case of an unconfirmed property prospect, a vendor must rely on estimates of the economic advantage afforded by the lead. Accordingly a property prospect file should contain sufficient information to permit a vendor to accurately estimate a value of an opportunity presented.

### Marketing Engine for Home Improvement Services

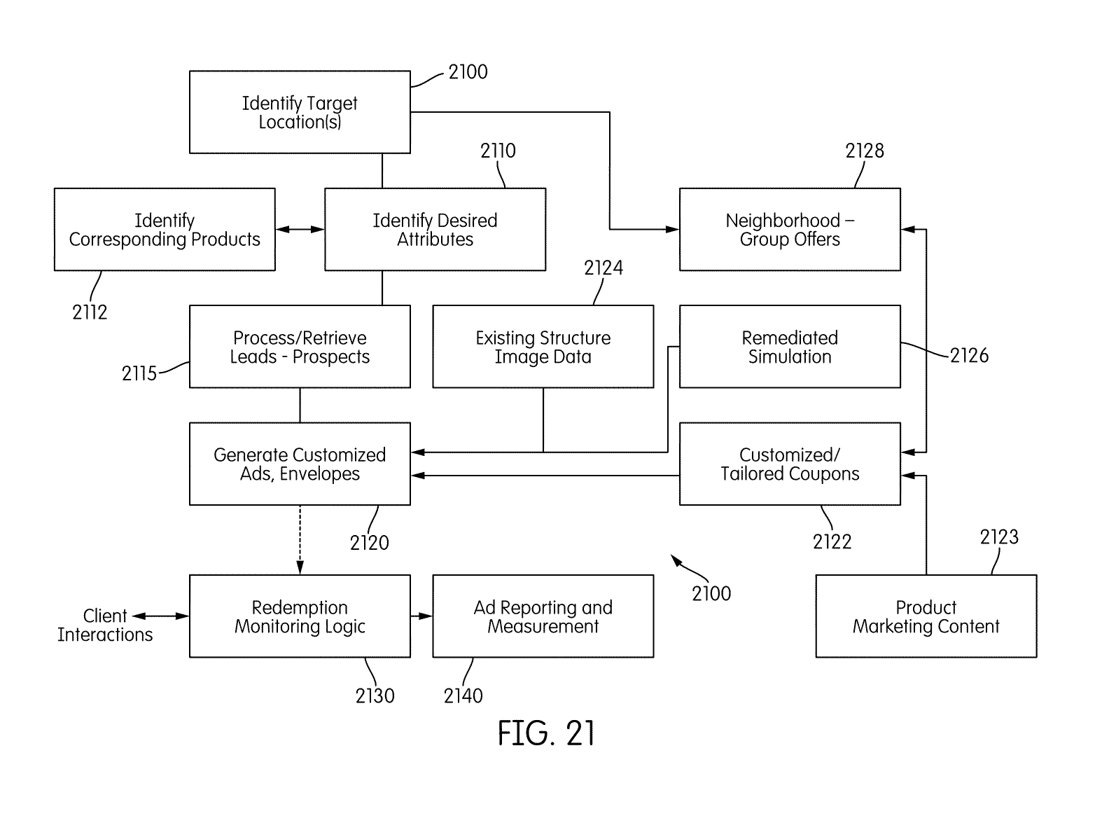

FIG. 21 depicts a preferred embodiment of a preferred tailored advertisement marketing process 2100 implement in accordance with the present teachings. A marketing engine preferably runs on a customized computing system adapted with appropriate software modules to execute code to effectuate the steps noted in FIG. 21 and render customized, targeted advertising material such as shown in FIGS. 14-15.

As see in FIG. 21 target locations 2100 are specified by a vendor. Desired structure features (FIG. 18) and/or product attributes (FIG. 19) are specified as well at step 2110. For each targeted feature, a corresponding product or service can be automatically associated by the vendor using step 2112. An automated process then retrieves a matching set of prospects at step 2115. The matching set can take any form, including with details on the structures such as size, type of house, a listing of impairments, partial image information, etc., broken down by any convenient field, including location (city, block, zip code, etc.)

For some or all of these prospects a customized ad and mailing envelope is generated and prepared at step 2120, with exemplary embodiments shown in FIGS. 14 and 15 or any other suitable form. The marketing materials are is synthesized from a set of structure image data 2124, and include a set of customized—tailored coupons 2122. The content for the ads, coupons, etc., is preferably provided by the individual vendors at step 2123, so that it can be integrated and presented in a form suitable and compatible with their branding, marketing look etc. If desired a simulated remediation image can be generated at step 2126 and presented with the marketing materials, to help a homeowner visualize a proposed new state based on the offer provided. Neighborhood or other group offers can be generated as discussed herein and incorporated at step 2128 as shown as well.

The advertising-marketing materials are then distributed in any convenient form, including hard copy, electronically, through email, etc. Redemption monitoring logic preferably identifies engagements made by homeowners, records types and dates of product/service purchases, group behaviors, and develops homeowner profiles during a step 2130. These interactions can be measured and reported on by another automated process at step 2140 to provide feedback to vendors and to update structure and homeowner profiles. As noted below, for example, a particular structure may be “tagged” by vendors as they complete jobs at such location. These tags are then searchable and accessible by users later on looking for examples of the merchant's work.

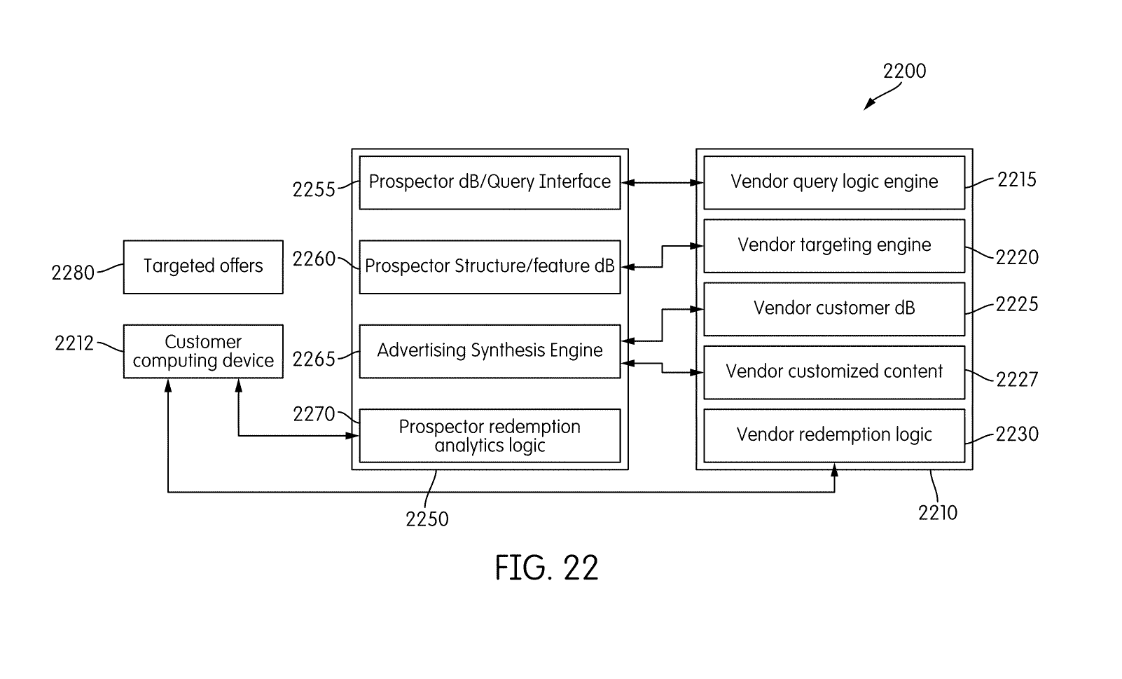

FIG. 22 shows an overall architecture of a direct customized—targeted marketing system 2200 implemented in accordance with the present teachings. In this system there are three main participants: 1) customers; 2) targeted advertising providers; 3) vendors. While these labels are used for purposes of explaining the present invention(s) it will be apparent that other identifiers could be used for these entities.

As seen in this diagram, Customers interact through their computing devices 2212 with a vendor computing system 2210 and a direct targeted advertising platform 2250. These computing systems are include servers, routers, storage devices, databases and customized program code adapted to implement the functions noted herein.

A vendor computing platform 2210 includes a number of components, and is may be coupled or associated to a vendor website. As noted above, Vendors may be providers of products and services as noted above. As such they have their own proprietary database 2225 of customers, transactions, etc., which can take any number of forms.

A customer targeting engine 2220 is configured with inputs and analytics that are unique to the vendor, in that they identify, quantify and correlate customer behavior, adoption and engagement with that vendor's products/services. This automated logic informs and drives a vendor's marketing logic, in that it identifies and optimizes marketing and advertising for an existing and targeted customer base. This information may be derived from external sources as well, including surveys. For example, a company selling high end window products may target existing homes in particular zip codes based on weather characteristics, home owner income, time of year, etc. Other forms of targeting can be considered as well.

In some embodiments a vendor may be given other options as well to “piggyback” on a targeted flyer or advertisement with vendors of other products that do not directly compete. To achieve this a vendor may be given a white list of products that are acceptable for co-marketing, or even a set of products or co-vendors that are preferable for partnering. As an example a provider of pool products may designate that they prefer to partner with providers of landscaping products, and so on. Conversely a vendor may be given an option to exclude co-marketing with specific entities, products, etc. in accordance with their own advertising campaign(s).

A vendor can engage with a direct marketing platform 2250 with a query logic engine 2215 (see FIGS. 18, 19) that is informed and programmed with inputs from the targeting engine. That is, the query logic can be configured to automatically solicit leads from platform 2250 through prospector interface 2255 that match one or more vendor specific criteria. For example, a query may specify that the desired lead or result list should include houses with new roofs but broken fences in a particular city, and so on. This information is extracted from prospector structure/feature dB 2260 in the manner noted above. Again the is variety of queries and targeting options is expected to vary in accordance with each vendor's specific knowledge set of its customers' behavior, needs, purchases, etc. Regularly updated feeds of lead data may be provided by platform 2250 as well. As will be apparent to those skilled in the art, the vendor platform 2210 may be repeated in distinct discrete installations or as part of a grouped cloud configuration servicing a number of different vendors.

Platform 2250 facilitates and informs operation of targeting engine 2220 and the two can cooperate to educate and optimize a vendor's marketing. Access to platform 2250 is preferably controlled and monetized with each vendor on a query basis, a subscription basis, a lead/result basis, a type of query, etc. For example queries directed to certain types of high end products may be priced differently than for less expensive bulk products. Note that if the results of the marketing, advertising efforts are successful, an operator of platform 2250 may be further compensated in accordance with monetization events achieved from direct marketing efforts made on behalf of vendors, including through flat rate payments, commissions, etc.

Note further that to preserve its proprietary data and correlation intelligence an independent marketing platform 2250 operator can provide a sanitized or redacted lead list to a vendor, which report contains sufficient information to inform the latter of a matching list of structures that meet desired criteria, but does not include all address, structure or owner information. This prevents usurpation of the efforts and systems of the direct marketer. For example a vendor of façade products could be given a list identifying a number and ID of houses in a particular zip code, block or city that uses shingles, or both shingles and stucco, and so on. In some instances partial or whole images of the leads could be presented as it may be difficult or at least not commercially impractical for a vendor to reverse engineer an address from an image alone, especially if it has been masked appropriately to prevent identification of an address. This information nonetheless informs and permits a vendor to determine if such leads should be targeted, and, if so, how. The vendor can further generate their own correlations, as well, based on such reports and is feedback from redemptions, to determine how to optimize their marketing.

In addition a vendor can elect to share at least limited portions of its own customer db 2225 with the advertising platform to improve correlations and targeting. By providing such data to an advertising platform 2250, the latter can correlate specific customers to specific purchases, behavior, etc. and provide additional insights. For example a vendor may want to know that in a result set of structures in a city that have shingles and stucco, a significant portion of such owners also purchased another set of one or more specific products from such vendor. Absent being able to cross-correlate address and owner information, it would be much harder to glean such useful insights.

In addition, a vendor may “claim” a property within database 2225, meaning, the vendor can associate their name with a feature, condition, etc. of a property. This claiming process may include both tags for actual clients and desired clients. The former would be used by a merchant to identify actual clients or jobs, while the latter could be used to help a merchant target new clients. This tagging and claiming feature is useful because now homeowners and other interested users can peruse a housing database 140, and identify solid leads for vendors based on the state of the property that they can see for themselves, such as shown in FIG. 27B.

A landscaping company for example can tag a particular property as being a client or project site. In other instances a product company (e.g., a paint company like Sherwin Williams) may sell exterior paint to a homeowner at a particular location, and then issue an update to cause the housing database to credit such vendor with the exterior facade condition. Another source of data can homeowners as well, as they can tag their own properties and features as originating from a particular vendor. For example a homeowner may identify their windows as originating from Armstrong or some other merchant. An easy interface can be used to assist users in tagging their own property features in this manner. The tagging of individual properties, therefore, may be a combination of automated and manual efforts which create tags for each property reflective of work done at such site. Other examples will be apparent.

As described herein, the coding process for such structure may rate the landscaping as very good or excellent. When a user searching database 140 (such as shown in FIG. 27 or seeing a house on the street within a mobile application such as in FIG. 3) asks for houses with landscaping that is very good or better, the listings will include work done by the merchant. By selecting a tag 2767 within interface 2760 a user can then be presented with the names of merchants who contributed to creating, remodeling or repairing of a particular property. It will be understood that different formats may be used for this function, and only an exemplary embodiment is illustrated in FIG. 27B. Moreover the tagging process may allow a merchant to “tag” a property as a desired or target project job/client. This allows merchants to target specific properties, neighborhoods etc. for particular types of services.

When a user selects one of the active links in tag 2767 they are presented with the interface and report shown in FIG. 27D, which is discussed in detail below. This tool may be implemented in a mobile adapted format as well, and allows a user/homeowner to review other jobs by the vendor, to determine if the vendor has other existing discounts, to determine if the vendor has an outstanding cluster group coupon in the homeowner′ neighborhood that could be useful, and so on. In general, a mobile application may have particular utility because a passerby/viewer can quickly see and assess the quality and performance of the vendors claiming association with the property. As seen in FIG. 27D the various vendor features are positioned in a graphical overlay to inform a user on the origin. Each can be the subject of an active URL or link to contact the vendor directly for information.

Over time of course a marketing platform 2250 will build and construct its own redemption/behavior database or network as a result of engagements with customers of the vendor. Thus it is expected that the two operations and collections will overlap to some degree over time and they do not have to be mutually exclusive. By sharing selected information the two entities can achieve significant synergy.

To create a desired look and feel for targeted offers 2280 (see FIGS. 14 and 15) a vendor may have their own customized content 2227 that they can insert into the targeted sections shown in these mailers, flyers (whether in hard copy or electronic form). For example the wording of a marketing pitch, specific images/graphics, etc. can be specified by a vendor for inclusion in a targeted advertisement. This information is then used by an advertising synthesis engine 2265 which combines the data from the vendor (and potentially other compatible co-marketing vendors) to generate a tentative targeted offer (not shown) for entities in a particular result set. In some implementations a vendor is then permitted to inspect the content for the targeted material in advance to approve or veto the final product. This process can be iterated until a desired format and substance is achieved. In the end targeted offers 2280 (in the form shown in FIGS. 14, 15, etc.) are delivered by mail, electronically, etc. to individual customers.

In some embodiments an advertising synthesis engine 2265 includes an automated auction component. This auction logic can be implemented in applications where multiple vendors are attempting to target the same or similar products to the same or similar structure prospects. For example two different vendors A and B may desire to target window products X and Y respectively to structures/owners which meet a certain threshold condition. The auction logic can be programmed so that for any particular time window, or batch of targeted offers, only one vendor is permitted to be included in such 2280. Alternatively the offers may be time or batch “blended” so that multiple vendors can pitch the same product to different structures in a target set, or even the same structure. Thus an offer 2280 in hard copy form may include targeted advertising from multiple vendors for the same product matched to the same building element/condition. In another instance an offer 2280 may make reference only to the structural element/impairment in the structure, and invite the owner with a designated code to visit an online site to see further information. This designated code is used to identify the owner, the structure, etc., and helps to facilitate targeted advertising by one or more interested vendors.

An auction process 2500 for matching vendor products to targeted is structures is depicted in FIGS. 25A and 25B and may be implemented in a similar process to that used in other environments which include automated bidding for ad impressions to users. For example Google's E-commerce Platform allows vendors to list items on Google's shopping engine in exchange for such entities bidding on keywords in queries.

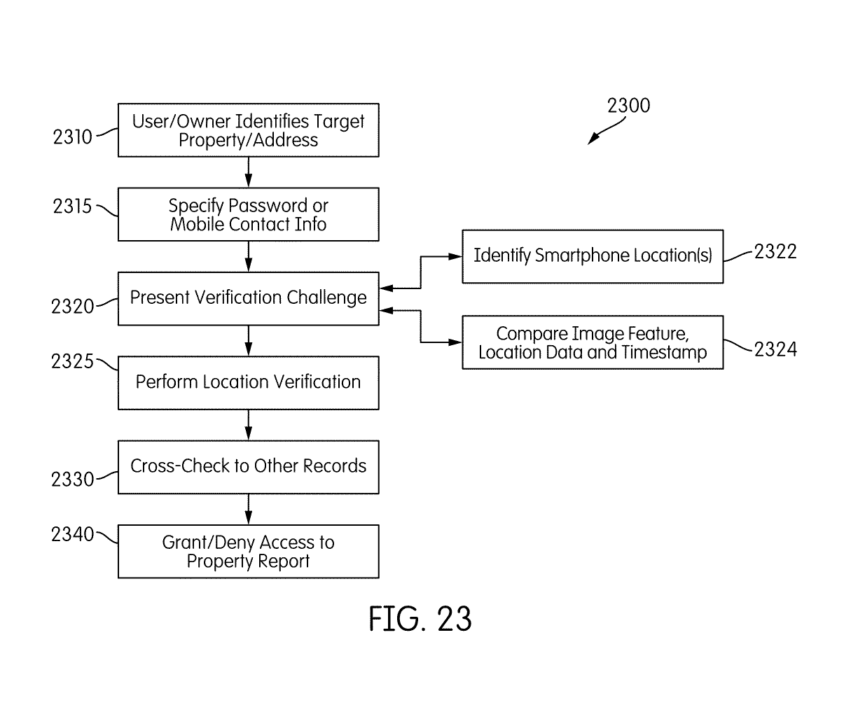

In the present embodiments if the user is already registered as the owner (see FIG. 23) they can identify themselves directly at step 2510 and the auction engine can use this data to determine the target structure profile at step 2520. In instances where the user has received a targeted printed flyer, one or more control codes can be used to identify the user and property uniquely. In still other instances, a user's exact location can be determined with geolocation data from their smartphone or other mobile device, and this can be converted into address—property information. Accordingly a target structure, owner, etc., can be identified during servicing of a generic query presented at a conventional search engine site that is directed to home improvement products, even in the absence of direct knowledge of the user's identity. Note that customized ads generated in accordance with the present teachings can be presented as ancillary or supplemental property specific ads for a user, in the instance of a generic search query made by a user directed to other product data that may not even be directly related to home improvements. In other words a user making a query for product X (where X may be clothing or some ancillary item) at a search engine may be presented with personalized ads for home improvement products created based on the present teachings and which are micro-targeted to their particular living domicile—habitat. Alternatively the user may be targeted while they are on a third party site, a social networking site, etc. and their location is determined and used, and so on. This can be done even if the user is merely a tenant, as he/she may still then be motivated to implement the proffered improvements, and/or to alert/notify an owner of such offers so that they are followed up. In instances where there is not a preexisting profile of the user's property, embodiments of the invention can generate one on the fly as part of a user query 2525. Especially when the user's intent is determined from a keyword query to is be directed to real estate or home improvement services, an advertiser can invest in generating a customized profile on the fly as part of servicing a user's query. The dynamic, or on the fly determination may only include a subset of the total profiling features (types and conditions) described above, meaning, an automated process may simply perform an image analysis to determine a fast, general overall physical condition rating of the property from a single preexisting photographic image of such property. In some instances a full report can be generated by directly creating a new coding while interacting with the user, or as part of a follow-up email. Even if the cost of procuring the reports is non-zero, these engagements may be cost effective when the measured return indicates that homeowners convert at reasonable rates. To reduce manual coding costs, the task of coding can be outsourced to a third party (such as a Mechanical Turk in another country) where labor is inexpensive. A request is provided to such third party services, specifying a property, desired coding, etc., and the report is returned within a few minutes, if not less than 30 seconds. This form of engagement also serves to build out an existing database of housing structures in an organized, prioritized fashion because it is based on directly measuring user interest in a particular property. In other words, generating profiles of all existing housing stock is probably inefficient or wasteful since a huge number will have no interest in re-sale or home improvement. By only creating profiles of homes in which there is measured intent, or predicted intent (based on studying sale, home improvement data) a cost of data acquisition can be reduced significantly.

A preexisting tentative list of matching products may be pre-computed and used to classify target structure as well at step 2512 using the classifications and taxonomy described earlier (FIG. 20). At step 2515 vendors provide electronic bid inputs to the auction engine for specific products, structure/property attributes, conditions, or some combination thereof.

Given the identity of the structure, an auction engine then conducts an auction amongst various vendors at step 2530. Unlike prior art keyword auctions, the auction in this instance is preferably based on bids made by is vendors in accordance with: 1) existence of a particular building element or feature derived during the structure coding noted above; 2) a particular element type; 3) a particular condition; 4) one or more identified products predetermined and precomputed to be germane to the target structure. For example a vendor may bid a price X to be permitted to present an ad for product Y to criteria that include a target structure meeting certain profile parameters, product needs, being located in a particular area, and so on. In still other embodiments, an estimated cost of repairs for a particular element, or an aggregate cost of repairs for an entire structure can be used as well for targeting. As noted above, estimate repair costs can be stored for a structure in database 142 as part of a structure rating 415. Thus a property profile may include information on a potential commercial remediation score, or value, either on a product-by-product or service basis. These individual scores can be targeted, either alone or in aggregate. For example a vendor can specify that they only want to target properties in which a particular product estimated net return is $X, or a total remediation estimate for the entire structure exceeds $Y and so on. An auction process can divide and tier the structures into distinct bins which can then be targeted to specifically by vendors and service providers. A final auction price therefore can be based on an expected potential return for the property lead in question. During step 2540 the customized advertisement is served to the user dynamically and on the fly in the form shown in FIGS. 14, 15A, 15B, etc., i.e., preferably in a blended form which includes both content from the owner's structure, and personalized content from the vendor integrated into a single document (here, a webpage).

In this manner embodiments of the present invention can effectuate new and unique forms of targeted advertising to users/consumers using criteria not used before. Other parameters will be apparent to those skilled in the art. The user can also optionally directly specify a query in the interface at step 2525 to receive offers on other products offered by such vendors. In some applications a vendor may elect to present an electronic coupon as part of the advertisement at step 2150, in the manner noted above. Redemption logic 2560 and reporting is logic 2570 include similar functionality to their counterparts discussed below.

FIG. 25B provides a basic process and algorithm for vendors to provide bids in targeted ads aimed at specific properties. A bid interface is presented at step 2585, to solicit a bid profile 2590 to be targeted by the merchant. Data relating to the merchants products 2587, content 2588 and target features is collected and entered as well (either manually or automated). The merchant can then identify specifically a property profile, including features, conditions, etc. to be targeted. A routine 2592 then processes the vendor specification to determine an approximate number of matching prospects that correlate to such specification. This allows a vendor to adjust up or down the constraints in a campaign, to determine how many leads are desired for focused advertising. The leads are then stored in a database, table or index 2594 for later matching and comparison in response to a user query relating to the property in question.

Returning to FIG. 22 a redemptions analytics logic engine 2270 monitors customer engagement with the offers, discounts, etc. Conversions can be identified and recorded in a proprietary database on platform 2250 and/or on vendor platform 2210. As noted above, each customer or house can be tagged or associated with a vendor for a particular feature. Because platform 2250 sits between different types of vendors and their customers, it is able to assemble and compile extensive competitive intelligence in cross-trade services and products. For instance, vendors who market pool products have little or no information or insights into housing paint marketing techniques or insights. Over time embodiments of the platform acquire massive amounts of cross-trade data that can be mined and exploited for identifying useful correlations and relationships which in turn can become a source of monetization. As an example it may be identified that purchase of certain products or services (P1, S2) presage or predict (by some correlation value R) the adoption by product P2 or service S2 within a mean time period T. The data may be further filtered or correlated according to city, zip code, street, or other geographic parameter. With such data in hand platform 2250 can optimize and speculatively market specific products to certain owners ahead of competitors. Other useful is correlations can be gleaned of course as well.

While no system is foolproof or immune from data theft, embodiments of a preferred marketing platform 2250 have enhanced protection from commercial usurpations by customers or competitor misappropriation of lead/prospect data. In part this is due to the fact that the results reports (FIG. 18B) cannot be easily correlated to later customer redemptions. For example a window hardware vendor working from a prospect list that identifies 10 k leads in a small city may receive 500 responses. From these responses of course it determines an address of the customer, but it cannot readily match such response data to a corresponding lead on the prospect list (1860). Other techniques for protecting the platform's unique data and analytics (i.e., monitoring for data mining, throttling, etc.) can be implemented and/or will be apparent from the present teachings.

In some applications it may be desirable to let a user/owner register a specific property to receive a customized/targeted improvement package of proposed improvements, discounts, etc. for a structure at such location in real-time. This obviates the need for a user to request and then physically receive a solicitation at a registered owner property address. More importantly, a homeowner may wish to see a comprehensive evaluation that they cannot perform on their own. The owner can be incentivized by a “free” evaluation to engage with marketers of products and services they may never have considered.

However since it may be difficult to determine if a requesting user is indeed a property owner of the structure in question, an optional verification process can be employed to assist. Such procedures are already used by some online real estate marketing companies, such as Zillow, Redfin, Trulia, and others. Typically such verifications require a user to confirm or provide details specific to a property that are most likely known to the property owner but not to others. For example questions directed to an amount of a tax bill, a purchase price/date, etc.

### Owner-Tenant Verification

As seen in FIG. 23, embodiments of the present invention can also implement a property/structure verification process 2300 to increase engagement with owners. This process preferably implicates multiple computing systems including a verification processor computing system, a user's mobile device, and other network connection devices (not shown). The verification system can be located either within the mobile device, and/or in part at a remote server computing system (not shown). Such systems can be programmed or coded using conventional techniques to receive, process and communicate to achieve the objectives set forth herein.

The preferred process primarily relies on an automated “proof of presence” determination that confirms that a user (or their device) is physically in or near the property of interest within an acceptable threshold of accuracy or risk. While this is of course not 100% reliable or determinative of ownership of a particular structure, it is a reasonably useful test in combination with other mechanisms to confirm or deny access to a customized structure report. This proof of presence technique can be used for other applications as well, including for verifying local residency for public benefits (schooling, mental health, other public programs).

At step 2310 a user identifies a particular property or address for which they want to see or gain access to a customized report such as those presented above in FIGS. 14-15 and so on. If the user is already registered and authenticated they can supply a password of course at step 2315 to an automated verification system and achieve access that way. In the absence of an existing account and verified access a user is prompted instead to provide contact information for a mobile device, such as a smartphone. During step 2320 a verification challenge is then presented to the user by a verification computing system, which challenge may take any number of different forms and implicate different data types, user knowledge base(s) and real-time feedback.

At step 2322 a cell/smartphone or other mobile device's location is determined. This can be achieved by an automated verification system using any number of techniques known in the art, including through identifying and is processing GPS, cell-tower triangulations, Wi-Fi network signals, etc. It is expected that in some embodiments a location determination process may employ random periodic sampling, meaning that the user is informed that the verification process may not occur in real-time, and instead may require a period of some fixed length, say 12-24 hours. In those instances the device can be interrogated randomly during different times, including at late hours when it is expected that the user will not be at some other physical location. Thus by exploiting the fact that the user is likely to be at home at such times (say 3-4 a.m.) the present verification process can confirm with reasonable certainty that such person is probably an owner or at least an occupant of the structure in question. Again this electronic challenge can be used with other applications, such as confirming that a person is residing in a particular school district. The user can be prompted as well to complete and confirm receipt of such confirmation codes to further bolster a robustness of the challenge.

In other instances a user may be requested to complete a challenge that involves a structured series or location varied set of steps. For example the user is prompted to depress a “find me” or “verify” virtual button on their device at different physical locations of the property. By comparing the different signals received at the different locations (for example at four corners of a lot) based on the measured strength of different Wife systems at such different locations, or different GPS, etc.) a verifications system at step 2324 can assess if the user is likely present at the structure in question. Alternatively a user can be asked to provide input at locations both inside and outside the structure in question, which should again cause the signal strength to vary. Other forms of inducing measurable and significant signal variations unique to a location will be apparent to skilled artisans.

In yet other variants a user can be solicited to provide details about the structure (i.e., answer questions about features) or alternatively provide one or more real-time, time stamped photo(s) of the structure for verification purposes. A virtual outline image of the property can be presented in the user's camera viewfinder. The verification test can require the user to register an actual outline is of the structure within such template in the viewfinder to confirm they are present at such location. Other examples will be apparent to those skilled in the art. Since embodiments of the present invention include data records containing image and other feature data, a verification challenge can leverage and incorporate comparisons to such preexisting data for improved accuracy.

Accordingly at step 2325 a location verification process is performed and completed using one or more of the above criteria, tests, etc. Again this particular test can be supplemented with additional conventional verification processes at step 2330, which may take the form noted earlier used in the prior art. During step 2340 a final determination is made to grant or deny access to the customized property report. As alluded to herein in the event a report is not available for such property already (as determined for example at step 2310 after seeing the address) the system can generate one on the fly; this can be done also by sending out a request to a third party coding service (not shown) to perform a new evaluation. The vendor or the third party coding service then performs the coding process described above, computes any desired home/curb scores, and returns a report as part of step 2340. Since the entire coding process only takes a few minutes, the user can be given access to the report almost contemporaneously or perhaps with a small lag. Again in some implementations this may be made in real time when there are supplemental corroborating indicators of ownership, or it may be delayed pending resolution of further checks.

While it is of course preferable to ensure that only an authorized owner receives access to a customized structure report, it should be noted that the degree or extent of risk is reduced in the present applications because the discounts and/or promotions are tied to the structure in question, and/or are personalized to an owner of record. Accordingly there is little incentive for a third party to engage maliciously to impersonate an owner of a structure since they cannot avail themselves of the benefits of the customized promotions.

### Merchant Targeted Properties, Clusters

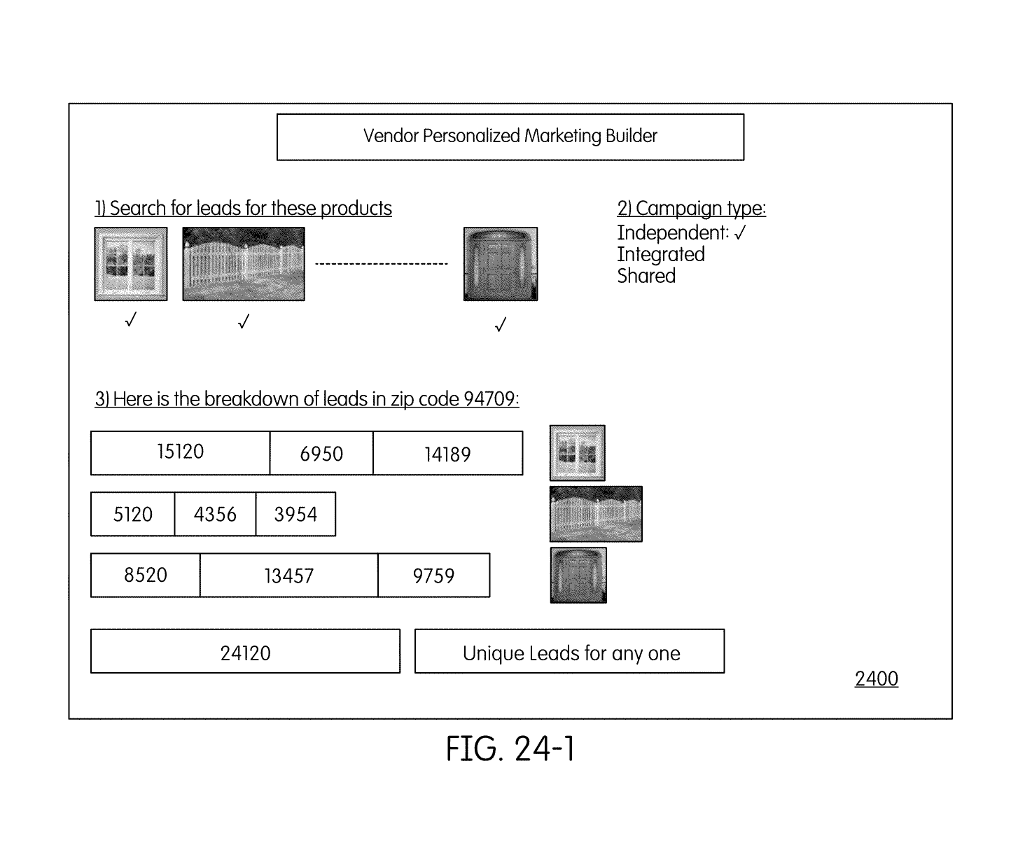

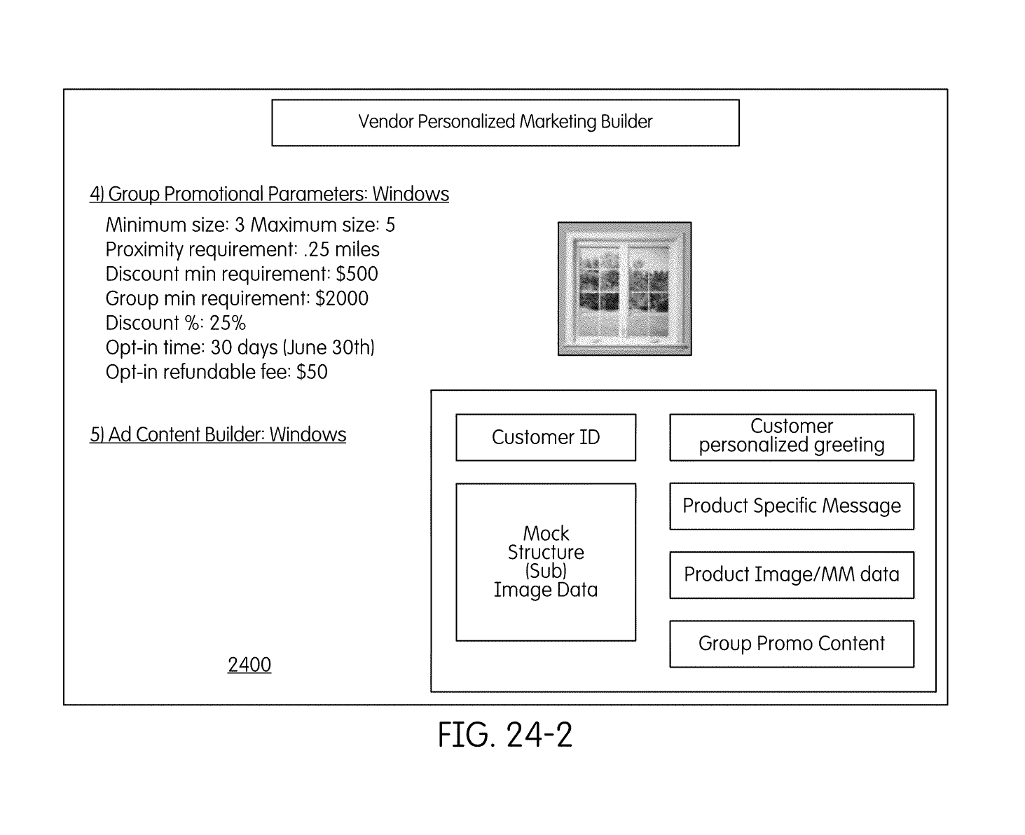

FIG. 24 depicts a preferred embodiment of a vendor interface that can be is used by a vendor to identify, create and target particular property structures with personalized content for particular products in a particular geographic area. Preferably this interface for creating personalized marketing campaigns is presented within a browser of a conventional small client computing device (desktop, laptop, tablet, etc.) and is supported and implemented by a number of software routines operating on a specially configured hardware computing system (such as shown in FIG. 1) that includes functionality as described herein. It will be understood that mobile versions of the interface can be implemented as well on smaller screens.

As seen on sheet #1, a vendor's product offerings are presented in textual and/or visual form in a first portion of the interface. Any one (or all) of the products can be selected for targeting to a particular geographic area. A campaign planner for the vendor can preferably specify also in a second portion of the interface whether they desire to run independent or integrated campaigns for each product. For example, if the vendor selects three products, they can choose to independently target the prospects with separate campaigns for each product. In an integrated campaign the vendor can elect to have multiple products promoted and pitched in a single flyer. Similarly a vendor can opt-in to a shared or co-marketing campaign with other vendors for non-competing products as noted earlier.

In a third portion of the interface a result set is presented to the vendor for leads in the particular area, here a particular zip code. The leads can be presented visually in any desired form, an example here shown as green (good leads), yellow (average leads) or red (less promising leads). Other formats will be apparent to those skilled in the art, and in this respect the outputs of FIGS. 18A, 18B and 19 could be presented for example. The interface preferably permits a vendor to simply click/select any one or more of the regions in the lead spectrum to target such result set. A bottom lead indicator provides feedback on a total number of leads or prospects that match one or more of the targeted products. In other implementations other logic could be used, so that the lead list is constrained to those structures which require two or all of the products, and so on. The third portion of the interface is preferably capable of adapting dynamically to vendor selections in the search query portion, so that they can immediately get a sense of how many prospects are possible for particular products.

As seen in the second sheet of FIG. 24 a vendor can also specify group discount or coupon parameters in another portion of the interface, on a product by product basis, as alluded to above. In the example shown, the vendor can choose a Minimum/Maximum size of the group clusterings, a group Proximity requirement, an individual participant minimum purchase requirement, a group minimum purchase requirement, a proffered discount, an opt-in time limit, an opt-in fee, and so on. In other instances where multiple products are combined, the group offer may require purchase of both products/services. Other examples and parameters will be apparent.

Finally an ad content builder can also be provided to a vendor to allow them to visually see a simulated mock-up of their content, and how it will be presented in final form by the advertising platform 2250 to an end customer. Ad content builders are available in other industries for creating customized materials, and such tools could be integrated herein as well. Preferably the advertising platform operator 2250 provides a format, layout and arrangement of the different content regions. A mock-up or placeholder for the particular structure-specific image data that will accompany the advertisement is presented in a first portion shown on the left. Additional areas for an address, customer ID, etc., are preferably reserved at well in some convention location. A vendor therefore can customize the advertisement to their liking with particular customer-specific personalized greetings, a product specific message (text, pricing, availability, etc.) product image data, product QR codes, URLs, and other references to help a customer perceive the relevance to the particular targeted structure. If elected by the vendor other Group promotional content is included as well, which may identify neighbors generally in a particular area, and/or by specific address in some cases. Again other examples of advertising/marketing building tools which are suited for exploiting the features and functions afforded by the invention(s) will be apparent from the present teachings.

### Additional Property Scoring Criteria

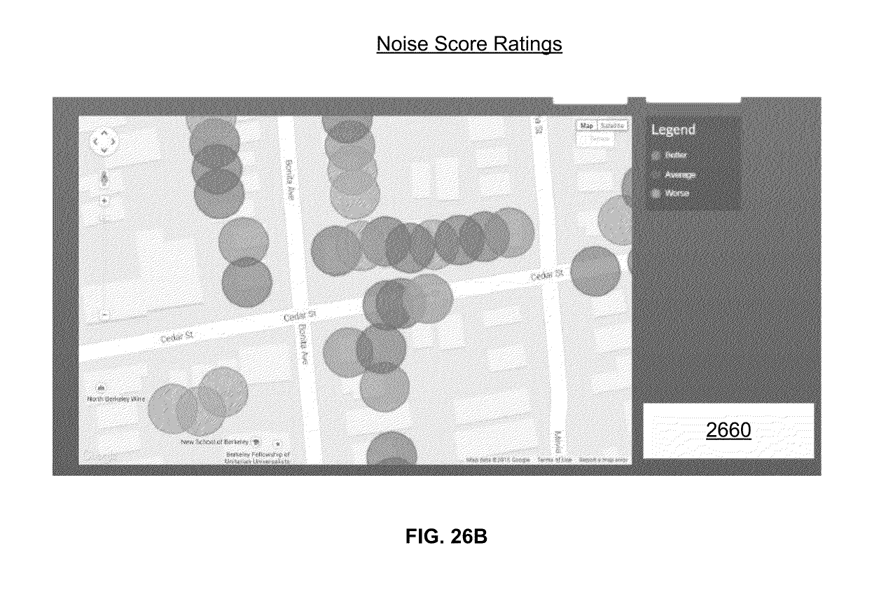

In addition to the grounds and structure specific data noted above, additional data can be integrated into a property score to reflect different parameters useful for assessing desirability. These can be computed as shown in FIG. 26 by an automated process 2600 that generates scores for traffic (vehicle and pedestrian), views, noise, and temperature as parameters 2605, all of which can affect desirability for a site.

Many would-be home owners and renters—particularly those with small children—prefer to live in areas that are not heavily trafficked by cars. When viewing a property during an open house during an otherwise quiet time (e.g., a Sunday morning), an amount and speed of nominal traffic can be misleading. Commercial traffic, common during the weekdays, may be completely absent on a weekend. This may lead a buyer to proffer a bid on a property, only to find out later that the site has extensive street traffic during normal weekday working or commute hours. During such times a prospect may also not be able to accurately see and assess a nominal or average traffic speed exhibited by drivers on such street section. A street on which cars frequently speed (over a posted speed limit) can also be undesirable for certain demographic groups. Consequently having an accurate traffic score for a site can be important to a purchase/rent decision.

A traffic score can be derived from examining sensors at step 2610, which, in a preferred embodiment, includes at least cellphone data (preferably anonymous) from drivers, and correlating it to street sections or blocks. A number of companies, including Waze, collect and aggregate traffic data, and make it available to third parties. Some local jurisdictions' traffic agencies also have fixed street based sensors and can provide similar raw data. By analyzing and logging an amount of traffic on a particular stretch of street at step 2620, and times of day, a traffic score can be assigned to reflect a number of vehicles per day, per hour, traffic speeds, etc. Any number of algorithms can be employed is for such purpose.

In a similar fashion, many data providers (Verizon, Sprint, etc.) can track locations of pedestrians at step 2610 and determine if they are stationary, walking, in what area, direction, etc. at step 2620. Many mobile apps do similar data capturing and can calculate similar data. This data can be retrieved and rendered into a pedestrian traffic score, indicating an amount and timing of human walkers traversing a particular street at particular times. Again, as with the vehicle traffic score, this data may be important to a prospective buyer/renter to assess a desirability of a particular site.

Preferably the data is determined on a block by block basis, at step 2640 i.e., between two intersections, to provide reasonable granularity and precision for any particular house on such section. Directionality can also be determined of course, as some street sections are traversed primarily in one direction by pedestrians/vehicles. Any convenient scoring system can be employed to reflect the vehicle/pedestrian traffic score, such as from 1-100 as used in other conventional neighborhood metrics offered by third parties (Walkscore™, Crime score, etc.) Consequently the traffic score may include computed data such as:
pedestrians/vehicles per hour (or some other time unit) broken down by day (or some other time period as some areas may be trafficked heavily on weekends) and by street address range (i.e., a street section may correspond to an address range between 1100 Acton and 1200 Acton)
peak traffic times with indications of quantity and frequency of vehicles/persons;
average speeds of vehicles/pedestrians;
ranking of street section compared to other areas of a region (zip code, city, etc.); this can be done using a basic sorting function

All of such data can be stored along with other property related data in records 400 as discussed above for FIG. 4. Any number of charts, graphs and similar visual tools may be employed to present the data for such information at step 2650. It will be understood as well that a traffic score may be differentiated for weekend vs weekdays as some areas (near parks for example) may be is popular because of cultural attractions during leisure times.

Again absolute figures may be less relevant than relative numbers. By comparing an existing traffic score (at the user's current residence) from reference data 2645 to the candidate site traffic score, a prospective tenant can assess quickly whether they are in for a different kind of experience, and, if so, how.

Similarly for some would-be renters or buyers, an amount and type of ambient noise can be a factor in property selection. To capture this data, again, preferably mobile devices are employed to detect local sounds at step 2610. These sounds can be correlated to a location to generate “noise” maps of an area. The maps may include average/peak decibel measurements by hour (or some other time unit) broken down by day (some days may be busier) and by specific street section. Since sound ratings can vary even on a particular street section, it is expected that sound capture would preferably occur over multiple spots, areas or regions of a street section.

Generic decibel level noise maps are known in the art. At step 2650, an output sound signal can be presented to a user (through a speaker on a PC or mobile device) emulating a noise profile at the location in question for a specific day and time. This provides the user with a better and more rigorous understanding of what sounds are present at the location at different times. Beyond simple energy levels, however, an automated noise classifier computing system can collect the ambient sound data, correlate it to distinct map locations, and do much more, such as identifying specific background sounds, and classifying them at step 2630 as corresponding to one or more noise sources registered as part of a reference set 2635, including:
automated vehicles such as cars, and including local public transportation busses, garbage trucks, police, ambulances, delivery vehicles and the like;
planes (landing and takeoff)
Crowd noise (nearby or distant attending sporting events)
Pedestrian related: people talking, and distinctions between adults and children
Property related noise (music, machine/yard tools such as blowers, lawnmowers, etc.)
Natural phenomena: weather (wind, rain, hail, lightning, thunder), physical features such as streams, rivers, oceans, trees
Living creatures: birds, insects, cats, dogs, frogs and other animal wildlife Electrical, mechanical noise from street fixtures (lights, utility poles/transformers, utility boxes/underground sewer)
construction (public and private)
Local public events (parks, sports, concerts)
Commercial related: (car wash, fuel stations, drive-throughs, onsite physical operations),

Other sources may include “regular” sound sources, such as church bells, clock bells, fog horns, factory horns, and similar structures that tend to repeat at regular temporal intervals and which are classified by a reference set 2635. Accordingly, not only is ambient noise energy measured, but preferably a source and origin for more granular understanding of a locale's sound characteristics. The individual sound sources can be rated and scored for each location on a street section, thereby creating an overall rating for each property at step 2640. Each location may also be “tagged” with the above labels to signify presence of one or more of such parameters, including a sound amplitude. For example, 3500 16th street may be scored as:

Average Pedestrian noise: 56/100;

Average Traffic noise: 68/100

Average Natural phenomena: Wind, Rain: 16/100 and so on

Other sound sources detected and rated: Planes: 55/100; construction 35/100

To derive the noise data a team of “scouts” can be enlisted or solicited to contribute sound data as they walk through individual neighborhoods. As noted earlier, fixed sensors can be used as well. In other instances public service vehicles (busses for example) may include data capturing technology to record and journal such data. By collecting large numbers of sound samples, is embodiments of the present invention can generate highly refined and rich sound maps of neighborhoods. Temperature data of course can be logged in the same way, since some new mobile devices are now equipped with thermometers.

All of the data can be aggregated and presented in visual form as seen in FIG. 26B by a computing system programmed in accordance with the above instructions. This data can be overlaid on to a general map so a user can quickly see and identify differing scores within a neighborhood, house by house. As seen in FIG. 26B, a ranges of scores can be designated with different colors, so that a property with a blue label indicates a highest rating, a purple label a medium rating, and a green label indicates a lowest rating. In other words, properties may be allotted scores from 1-3000, with the most noisy/trafficked areas scoring 2000-3000, average 1000-1999, and better at 0-9999. These figures are then translated into any desired color scheme. It will be understood of course that other formats, score ranges, etc., can be employed to visually differentiate these additional (noise, traffic, pedestrians, temperature) local parameters.

For other features, conditions, etc., a different color scheme can be used, and different icons as well, depending on a number of colors being presented. Preferably the colors are distinct enough and visually reinforcing to denote the characteristic desired, as is known in other applications of heat maps. The maps can be generated using any number of conventional tools, including through third party mapping services which generate overlays for predefined geographic locations. The above scores can be combined of course with other search filters described herein, so that a prospective buyer may specific for example that if a noise score is above 2000, and a pedestrian score is above some other threshold, they will only want to see houses that both have a fence and window condition of good or better. Other combinations of desirable factors will be apparent to those skilled in the art, as the present embodiments permit an almost infinite diversity of permutations.

### Home/Property Condition Scoring

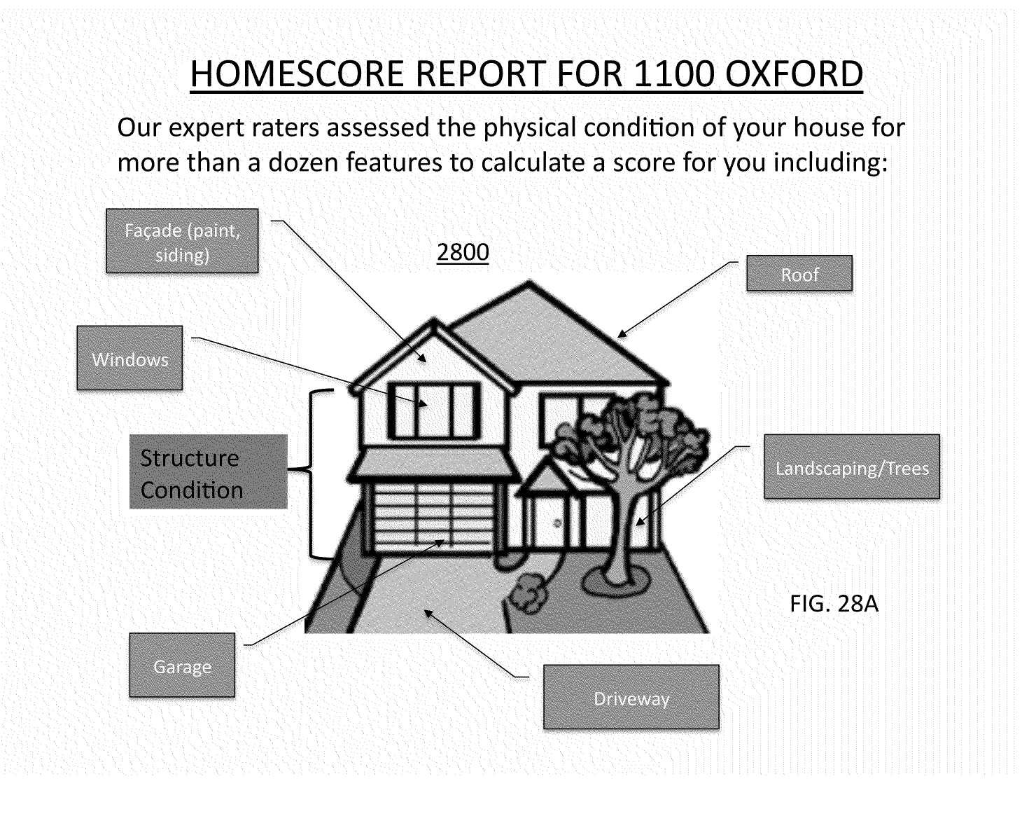

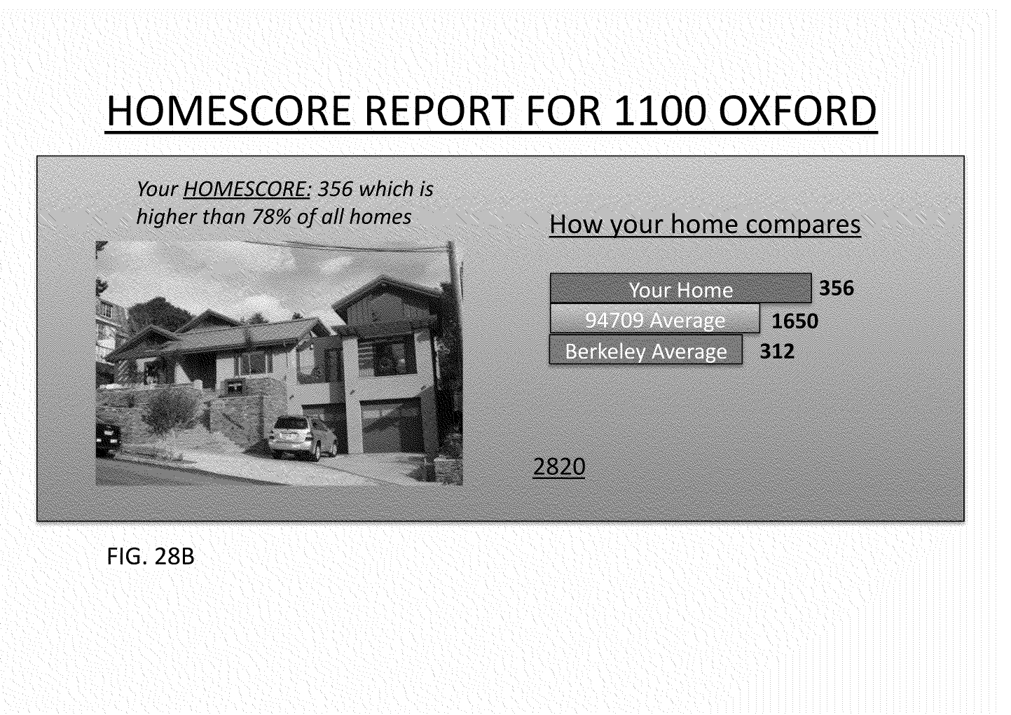

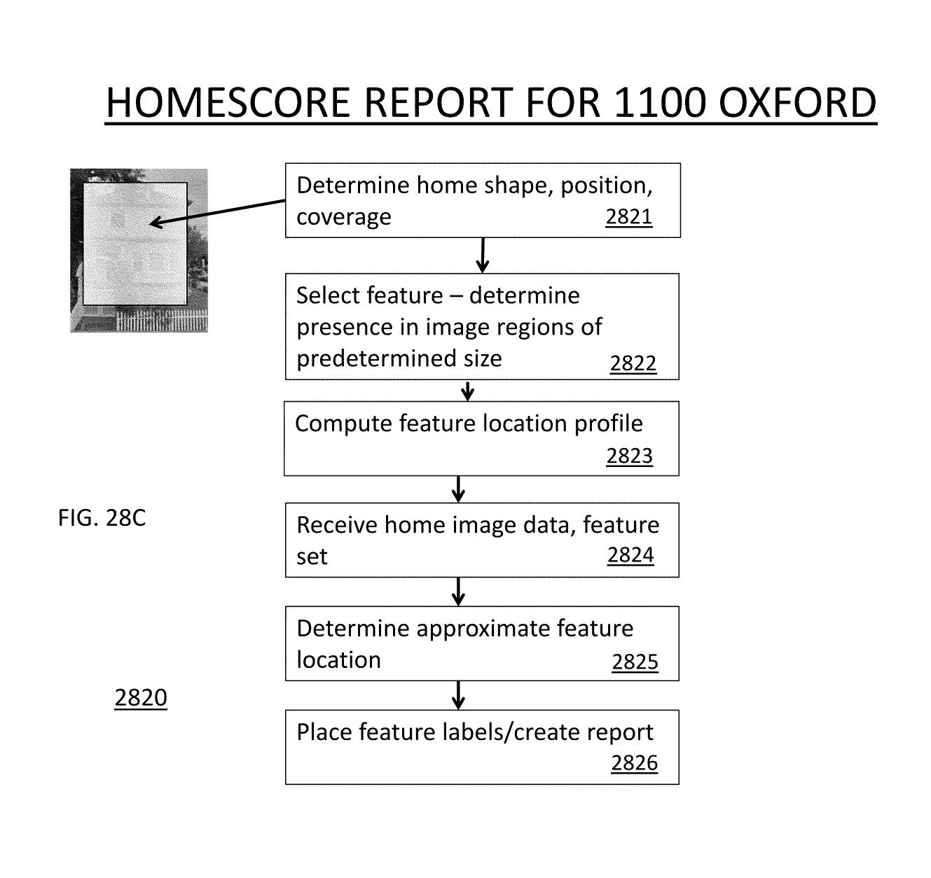

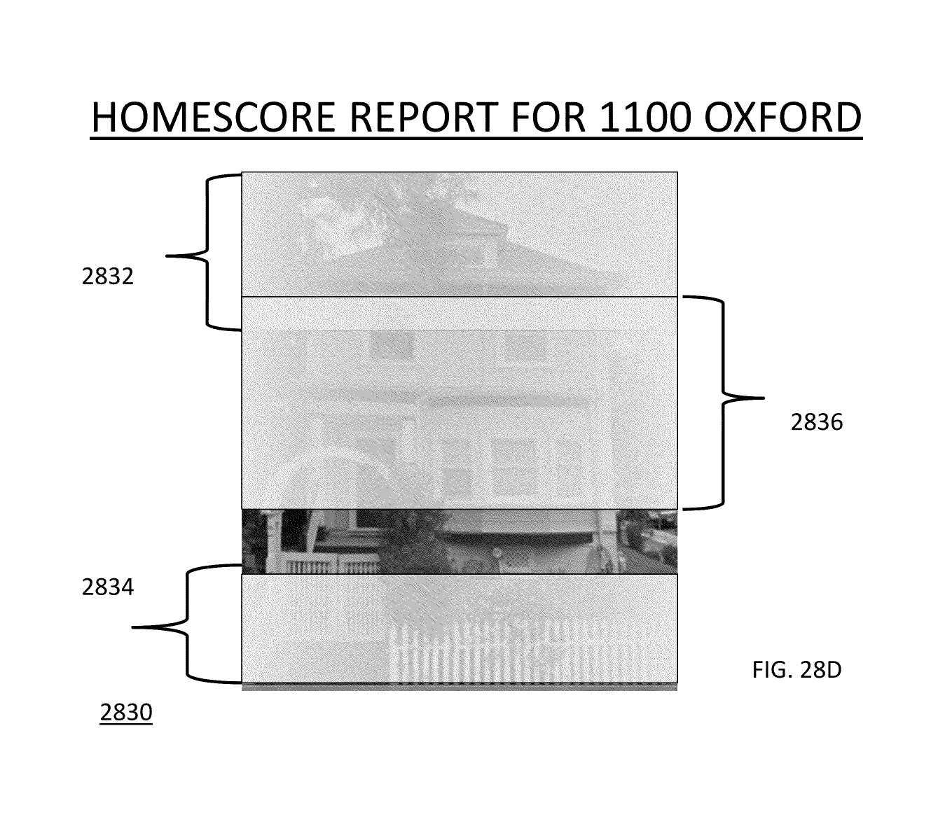

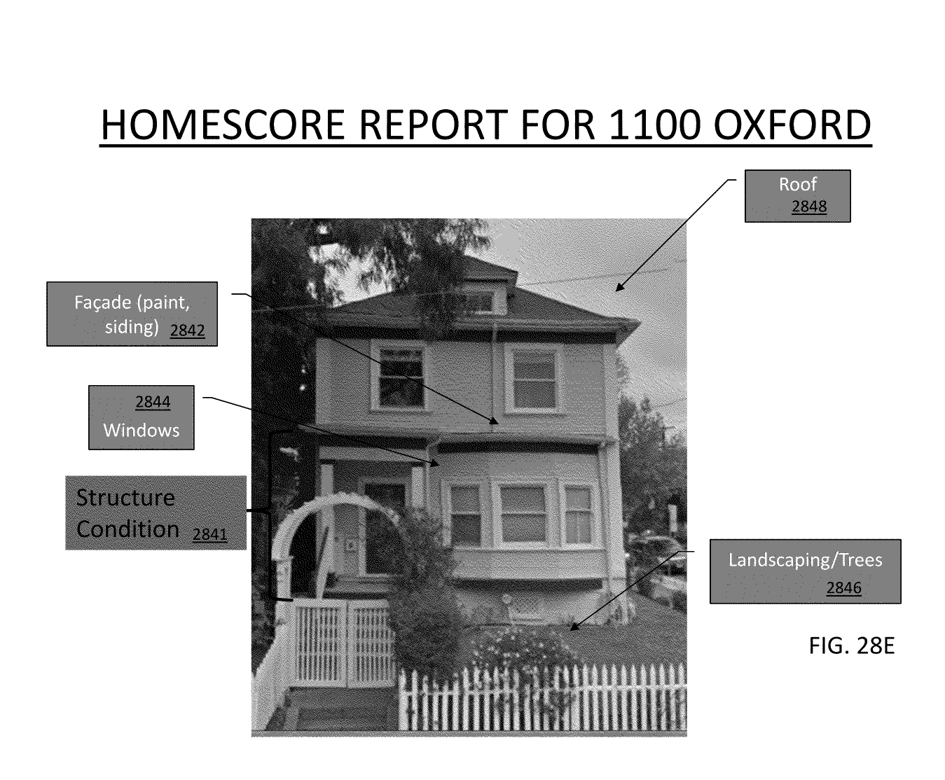

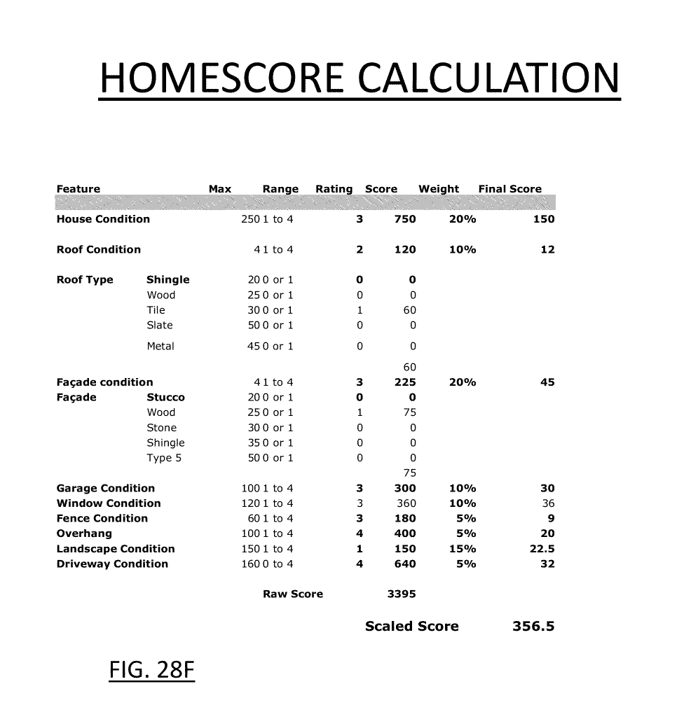

FIGS. 28A-28C show examples of embodiments of a home “score” (also is referred to herein as Homescore™) that can be calculated using the present teachings, and presented to homeowners/users, either in printed form, or online over the Internet in browser, etc. when they visit a website 110. This home score, too, can be stored as a separate field and part of a property record 400 (FIG. 4).

As seen in FIG. 28A, selected features of each structure (facade type, condition; window condition, landscape condition, presence of trees, solar, overall condition, etc.) are incorporated into an algorithm that considers each feature, weights it according to a target market, and calculates an overall score on any predetermined scale within a graphical report 2800. For example, a structure may be rated on N different features using a scale of 0-1000, or some other useful range. Each feature may be weighted in accordance with a target application and target market. The focus of the “home score” is to compute and report on an objective metric of the physical condition of a property.

The homeowner can then be presented with a graphical explanation of the score of their respective home as seen in FIG. 28B. Here for example the homeowner is given an overall score, a percentage score, and a comparison to other homes in their zip code, city, etc. This report 2810 can be formatted in any number of different forms (charts, bars, etc.) depending on a desired application. In addition to the overall score the homeowner's individual features (roof, windows, landscaping, etc.) can be individually rated as well and presented for the user's interest and consumption. Interactivity can be built into the interface as well, so that selected or enhanced information can be presented in response to a cursor location, including selecting particular coded areas.

In addition to the raw coded data, a weighting factor is preferably assigned to each feature in the form of a cost of improvement factor, so that, for instance, a roof feature, having type “shingle” in condition “poor” may be weighted more heavily than a lawn feature in condition “poor.” This is because the cost of remediation for the former may be significantly higher, and therefore from an objective cost perspective is more important to a home score. Because the cost of goods and services may vary dramatically by region (lawns may be more is expensive to grow and maintain in Southern California than Seattle), it is expected that the weighting factor of each feature could be adjusted by state, city, zip code or some other desired geographic area.

This algorithmic methodology is shown in FIG. 28E. Each individual feature (in the left hand column) has a maximum value, and includes a multiplier range, which can be influenced or based on a feature Type. For example, an overall house condition score is preferably configured to have a maximum rating of 1000 (250*4). A Roof condition, however, can have a different score depending on a roofing “type,” so that a maximum shingle based roof score is 80, while a maximum slate based roof is 200. This differentiation is provided to account for the different quality of material, expected lifetime and labor requirements for one type vs another. These values can be determined empirically based on costs of materials and labors for a particular area. The Rating column then identifies the coded value for the particular property, and is multiplied by the applicable Max figure to derive a nominal Score. Each individual feature is similarly rated and assessed to derive a total raw score. Finally, a weighting factor is applied to each score element to derive a final score for each feature. The inclusion of this separate parameter for determining the home score allows again for customized and tailored scoring for each jurisdiction, based on the cost of materials and labor for such element.

The Homescore™ values, as noted above, can be used for a number of purposes aside from being informational to an owner, realtor, insurer, etc. For instance a Homescore can be used as a signal for advertising when interacting with the homeowner, assessing an economic opportunity to a merchant, etc. A home improvement company may desire targeting to homes in a particular area that match a particular profile, e.g., a total scaled score in a particular range, an individualized facade score in a certain range, and so on. The Homescore™ may be included in a basket of factors used by other advertisers when considering bidding in an ad auction for other products. For example an advertiser of kitchen appliances, knowing the Homescore™ for the user, can tailor/optimize which brand, quality or price range of items to present or bid on. The Homescore™ values can be mapped and presented graphically in the same manner as shown for FIG. 27C, with different colors representing different physical conditions. While shown as a multiplier in FIG. 28F it will be understood that the Homescore™ calculation can be derived from any number of home features, types, conditions and formulas that help to distinguish and characterize homes or other structures. A roofing home improvement merchant may weight condition of a roof more heavily than a condition of a lawn for instance in determining the individual home scores, and the invention allows for a wide variety of flexible scoring options.

FIG. 28D explains how an automated classification process used by building classifier logic 150 (FIG. 1) can impart basic relevant location-proximate visual annotations or tags based on analyzing a home image 2830. Since it may be difficult in some instances to obtain manual coding of individual houses, or label individual features, the object of the classifier logic 150 is to imitate a human coder's capabilities to a limited extent. In other words, as seen in FIG. 12 for example, a coding interface permits human annotators to manually tag a structure for particular features (windows, roofs, lawns, etc.) Obtaining such tags may be manually inconvenient or cumbersome, and thus some embodiments of the present invention, when presenting home reports, can imitate this process through emulation logic in routine 150 that duplicates human behavior based on nominal, baseline parameters associated with locations of features in most housing structures/images.

As an example, a target home score report may include labels or annotations for a feature set S1 that includes {façade, windows, roof, landscaping}. It will be understand that any of the other features identified above could be included as well. The object of this aspect of the invention is to properly place these feature labels in an annotated version of the homeowner's report to better illustrate the coding and scoring process for the user's benefit. In other words, there is an ease in perception and comprehension for the user in placing the labels somewhere proximate to the physical feature they refer to.

To achieve this result, routine 150 statistically analyzes and categorizes is images of housing as seen in FIG. 28C to identify a number of parameters, including a feature presence probability value. First, a nominal structural shape, coverage value and location is determined at step 2821. In a preferred embodiment this refers to general image portions occupied by the house structure. Then for any particular feature, e.g., a roof, at step 2822 the system calculates the number of occurrences of such feature within a particular image region of a predetermined size. The presence of the features may be counted based on human annotated codings of a set of training images, or any other reference set. In this instance, also, “presence” is preferably determined based on a physical portion of such feature extending into such region.

Based on such computation, a statistical profile, including a mean, median range of locations, and confidence boundaries can be identified for each feature at step 2823. For example, it may be determined, for any rectangular house image type, that a roof feature is located on average at N % from the top of such image, and bounded within the top N+X % of the image by a 95% confidence rate, and so on. As seen in FIG. 28C, the system may determine that a first set of features roof, trees, chimney are highly correlated to an area/band 2832. Features such as lawn, landscaping, fence, driveway, are highly correlated to band 2834, while features such as façade, windows are correlated to band 2836, and so on. The size of each band of will vary according to the feature of course, and in this manner a sorted ranking of the location of each feature can be computed from top to bottom. Other techniques can be used as well to correlate features to image locations. Of course, the analysis can be done in the opposite manner as well, including by starting with the target regions, and counting the number of feature occurrences.

At step 2824, a home that is the subject of a home score report is identified and processed. For such home, based on the image data, the approximate location of each feature is assigned to a region of the image at step 2825 in accordance with the previously determined feature location profile. Based on the number of labels, features, to be identified in the target home report, the system them allocates and places annotations in the corresponding is feature target area at step 2826. This is shown visually in FIG. 28E. First, an overall structure annotation label 2841 can be placed approximately to correspond to some or all of a detected house image portion. A façade label 2842 extends to a middle region of the image. A windows label 2844 extends to a middle portion as well. A landscaping/trees label 2846 is placed on the lower right with an arrow that identifies a bottom portion of the image. The roof label 2848 is arranged in the upper right to point to a top portion of the housing structure, and so on. While the placement of the labels is not necessarily exact, their relative spatial relationship and arrangement is reasonably accurate, so that even if an extended arrow does not have an endpoint precisely on the feature in question, the perception and appearance is still fairly understandable and useful. The size and location of each feature of course will vary, thus resulting in different degrees of alignment error, but this again may not be a problem in many applications. In some instances an image portion can be analyzed for color to detect and assist in annotation placement. For example a bottom portion of the image can be analyzed for the presence of an expected organic material color (green, brown) as part of a placement calculation for lawn, landscaping annotations. Other examples again will be apparent for detecting and classifying appropriate locations for labels.

It will be understood of course that a highly trained classifier 500 (FIG. 5) can also achieve such annotation/tagging as alluded above in FIGS. 5, 6, 7, etc. automatically and with high precision/accuracy through machine training and object recognition techniques. Nonetheless embodiments such as shown in FIG. 28 which require less intensive algorithmic processing can achieve satisfactory results to a first order as well in applications or domains where that is acceptable and for a limited number of labels. The automated placement of annotations and labels shown herein is expected to be useful in other automated image analysis systems where it is desired to identify a set of objects having a regular or statistically correlatible position/location relationship.

FIG. 27D shows a graphical interface 2755 that can be used to identify and profile new types of relationships between adjacent properties. For example, is a user can specify that they wish to see homes which have a single story (marked with a checkbox) and are surrounded on both sides with houses that are 2 stories or more. This type of search can be serviced easily by lead generator engine 170 since it has access to each property, address, and feature/condition of such. Thus, by comparing the features of adjacent homes, a search report can be generated to identify homes having particular inter-house characteristics. Note that the parameters shown here can be flexible enough that the specification of “neighbor” can be constrained to be immediately adjacent, two houses, three houses, across the street, etc. Because embodiments of the present invention can identify relationships between houses, new and unique inter-house filtering and profiling is enabled. This ability to rate a house in context yields better information than prior art computational rating systems for individual properties.

Another example of inter-house profile is shown in the bottom of FIG. 27D. A user can specify that they would prefer to see homes which have brick/stone/paver driveways, with at least one neighbor not having any driveway at all. The search logic for performing this function can be implemented in any number of algorithms based on the teachings provided here. Preconstructed indexes of popular search variants can of course be pre-computed to improve speed and efficiency. Real estate investors for example may be interested particularly in finding homes that have a low Absolute Appeal score, but are surrounded by homes with much higher Absolute Appeal scores, or home scores, or curb appeal scores. From these examples it will be apparent that any number of possible inclusion or exclusion factors can be implemented by a lead generator or search query engine 170 to satisfy a user's target profile criteria. Home/Property Curb Appeal Score

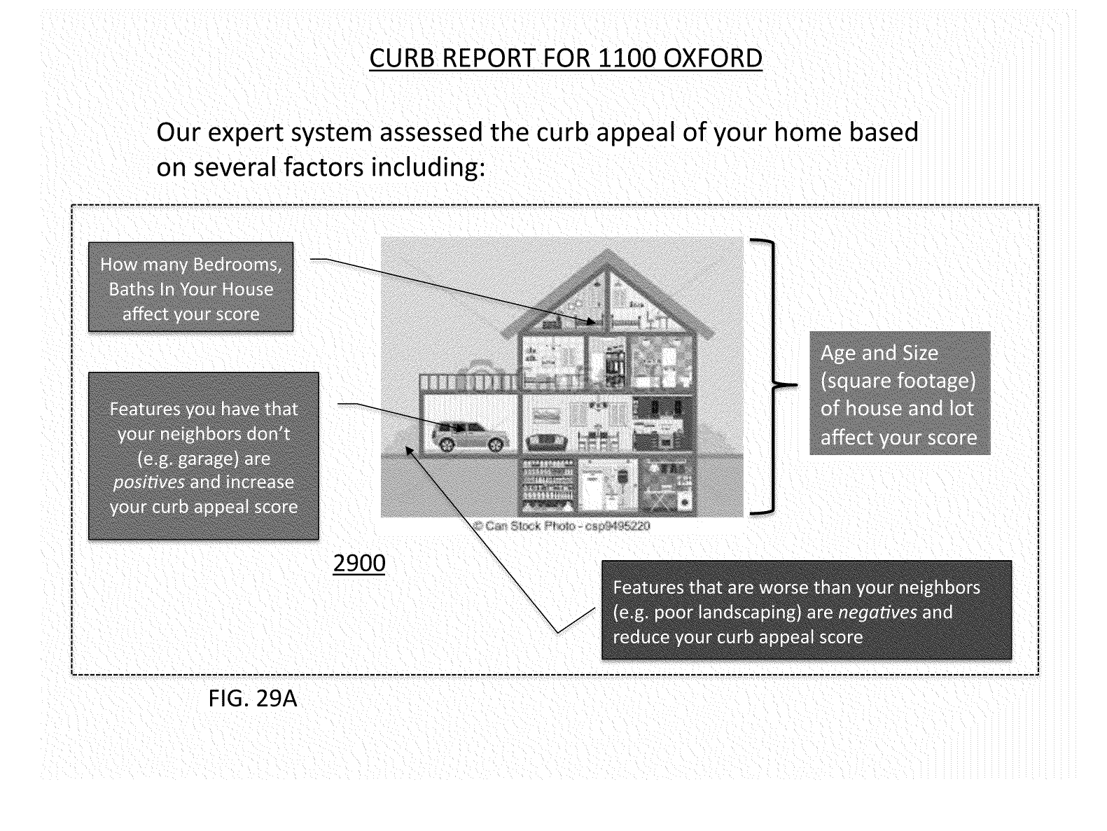

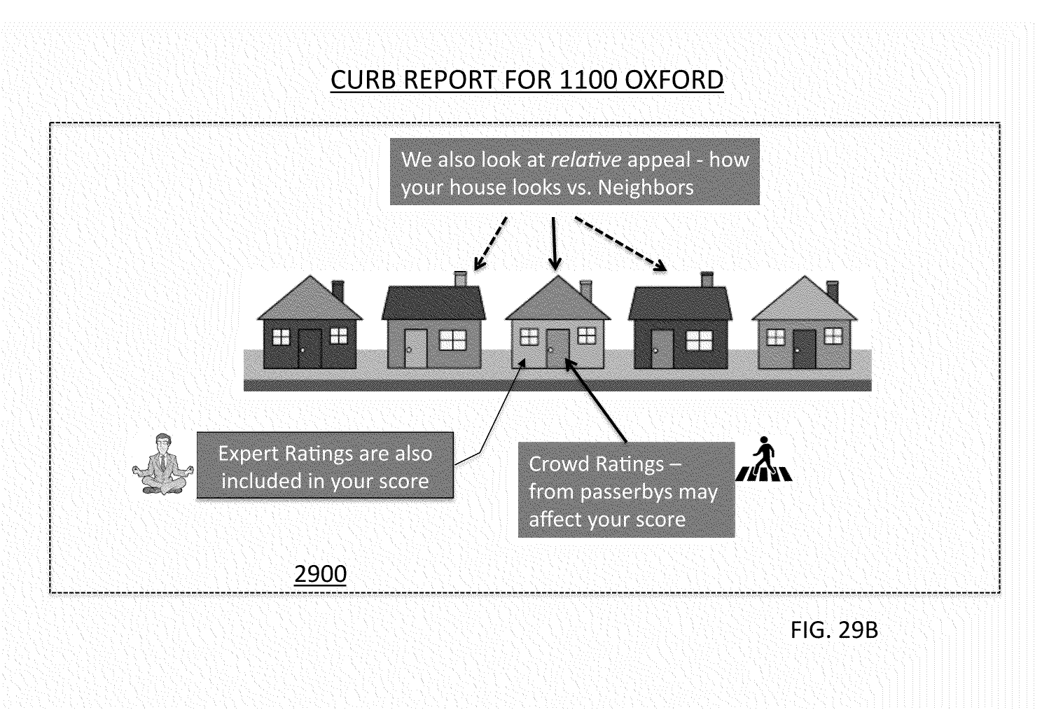

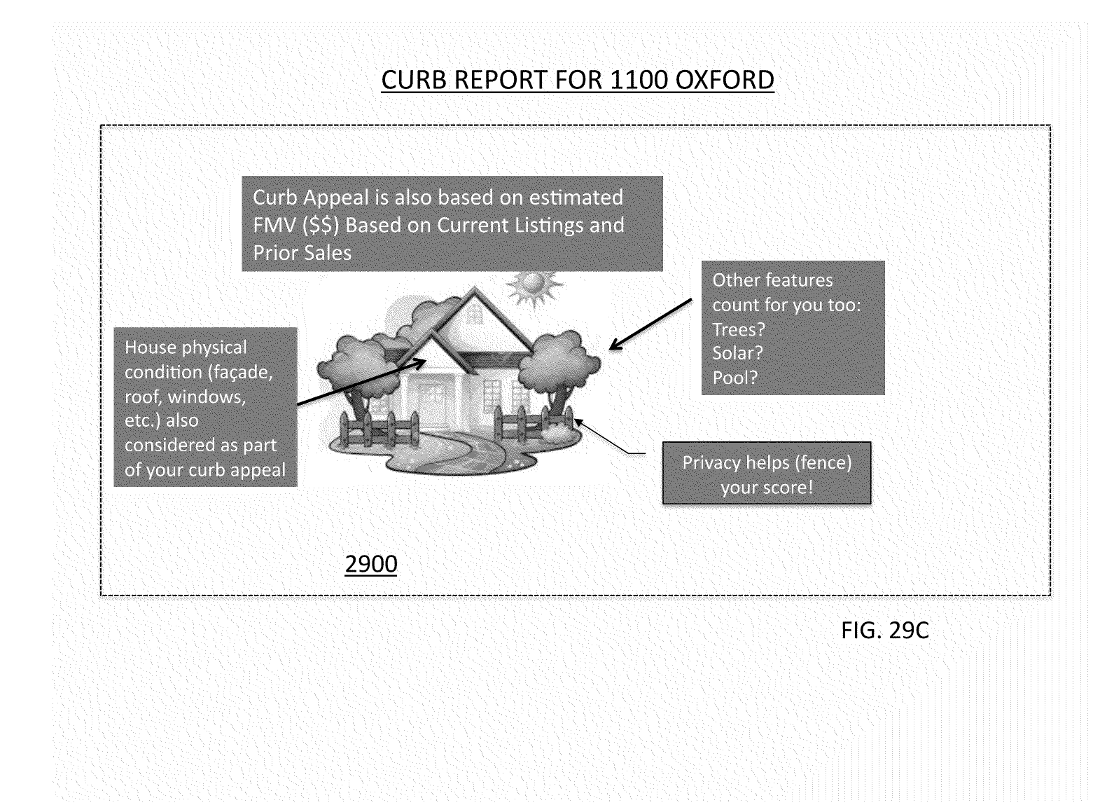

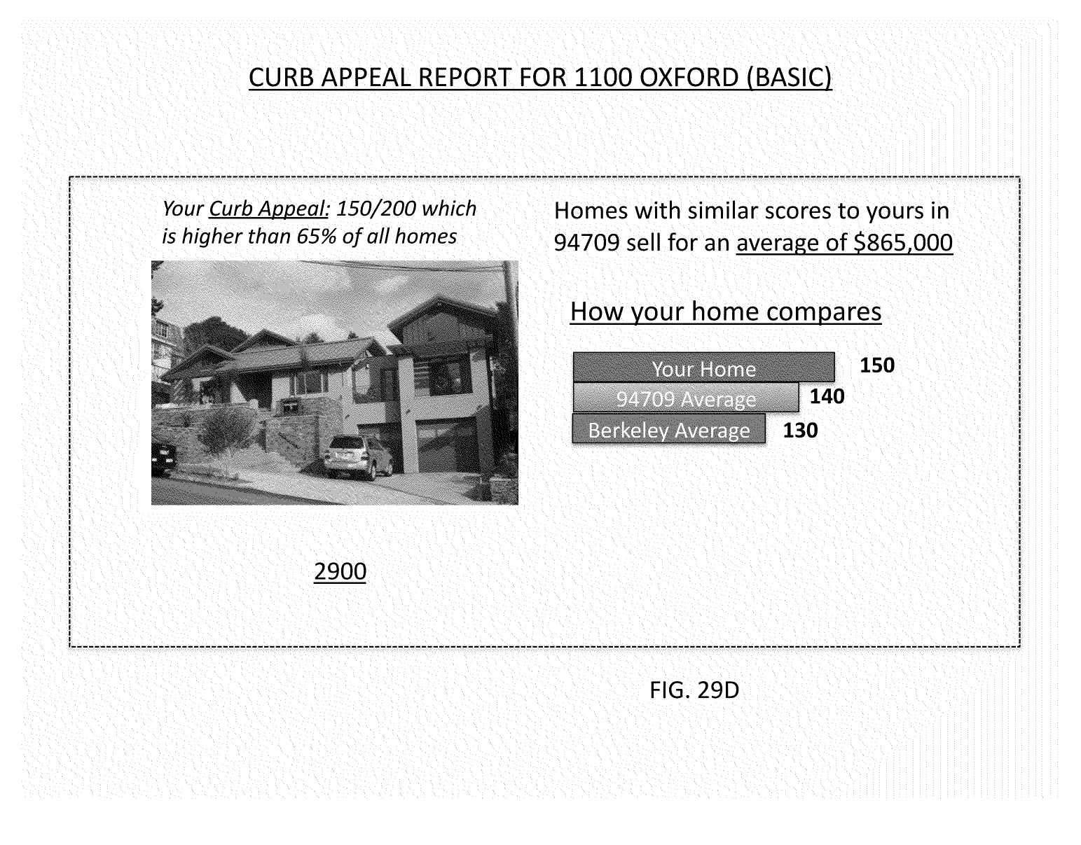

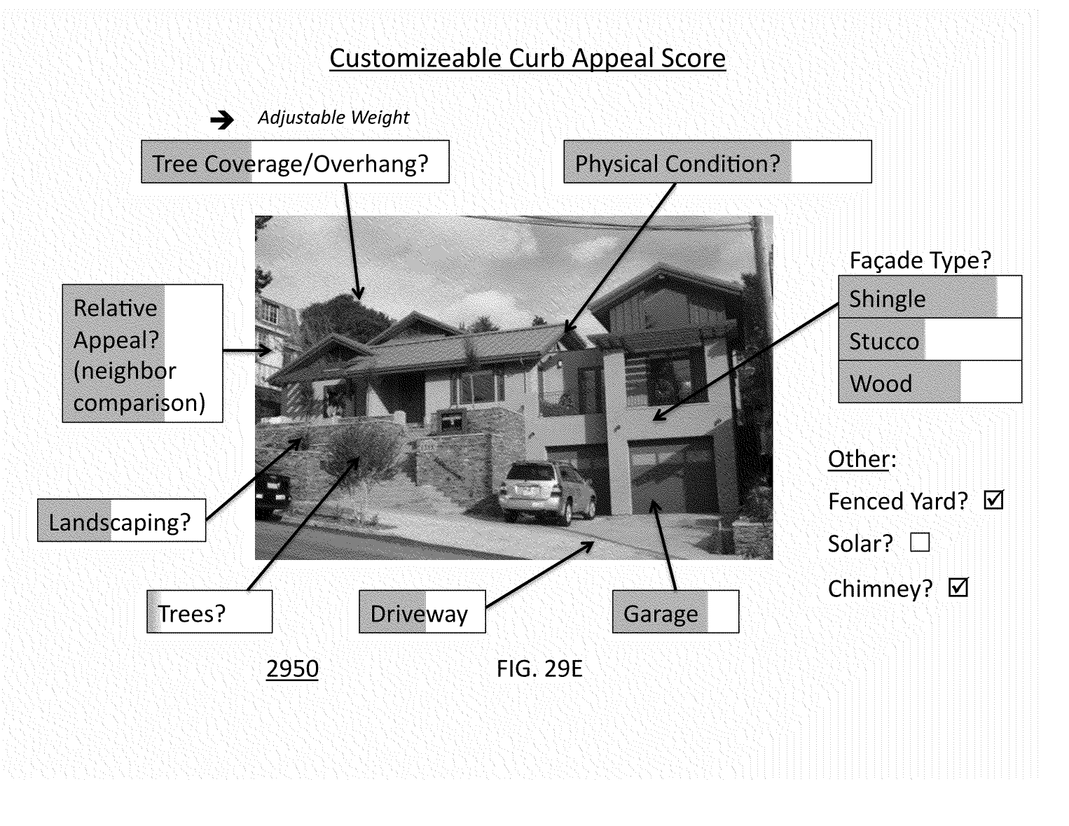

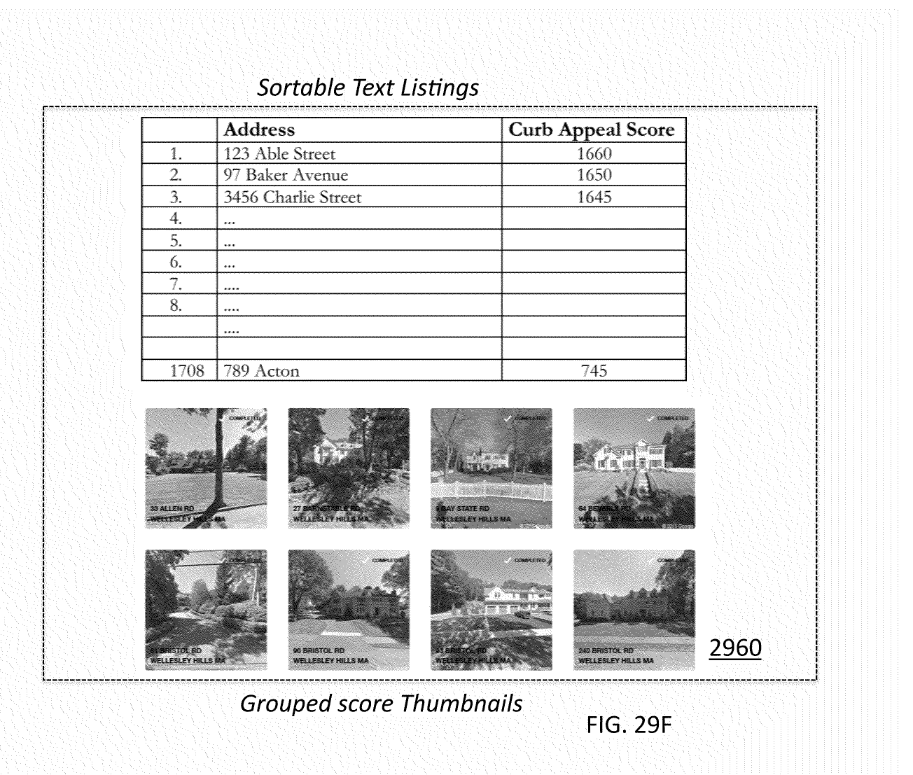

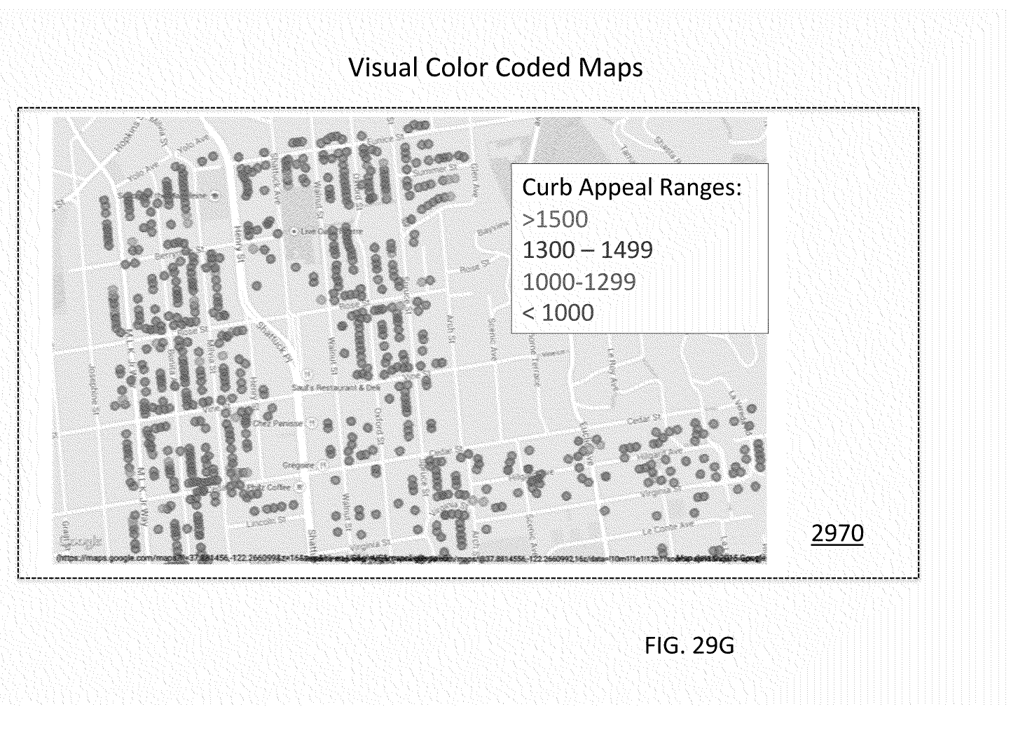

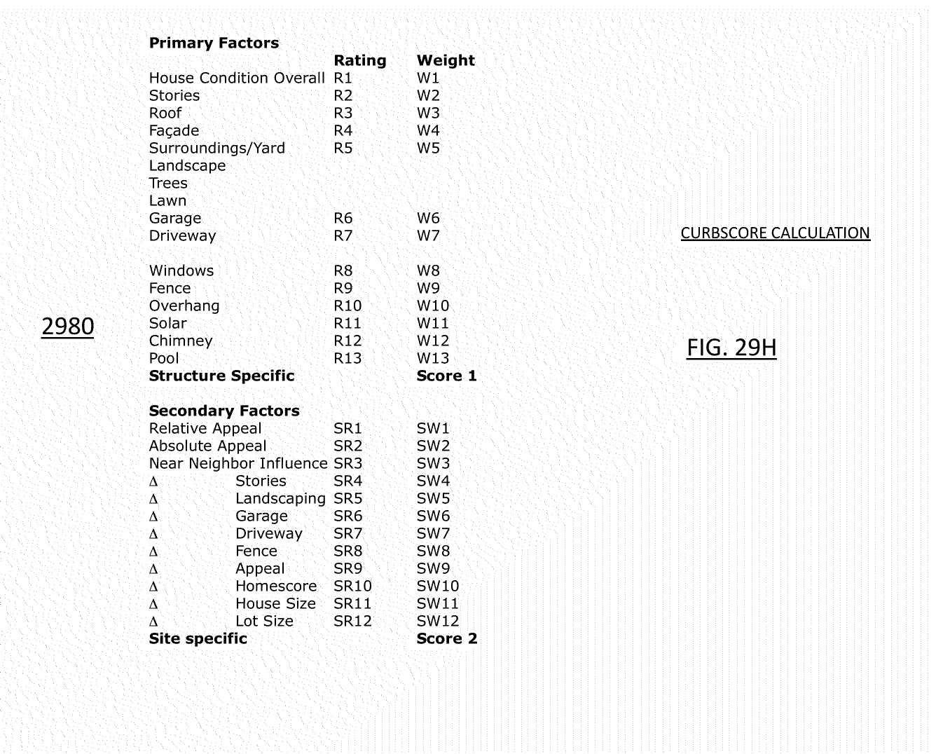

FIGS. 29A-29D show examples of embodiments of a similar metric to FIG. 28, referred to generally as curb appeal scoring. A curb appeal “score” (also referred to herein as a CurbReport™) is calculated using the present teachings, and presented to interested users, either in printed form, or online over the Internet in a browser, when they visit a website 110 etc. The curb appeal score, while similar in concept to the Homescore™ above, has a slightly is different focus and value, in that it measures other more subjective factors for a particular property. This calculation implicates factors such as “relative” appeal as it compares the property in question to others in a target area, and thus considers both functional and aesthetic parameters. As with other property specific data, the curb appeal score can be integrated within a record 400 (FIG. 4) and used in all of the variants discussed herein.

Generally speaking the inventive computed CurbReport™ is a quantitative and qualitative mathematical depiction of the desirability of a particular property as seen from the perspective of an investor, homeowner, etc. The report can be customized (see FIG. 29E) to accommodate the different perspectives and valuations of features that are unique or attendant to each industry. Thus, for example, a solar installation company may rate properties based on the lack of foliage overhang much higher than the quality of their landscaping, while a service company in the latter business would do the opposite, and so on. Particular merchants may disregard entirely certain features of a house as being irrelevant to their targeting. Unlike conventional appraisals, which do not consider properties at a granular-feature level, and are designed almost exclusively for home lending factors, the algorithms of the invention can be tailored with different inputs and weights to allow each industry to determine their own specific curb appeal score.

FIG. 29A depicts an interface 2900 seen by a user when they access website 110. This interface preferably explains to the user the basic methodology used to calculate a curb appeal score, including by considering basic items (such as how many bedrooms, baths; age, size, etc.) and more specific items (such as features that the property has that neighbors do or do not have). FIG. 29B further clarifies that “relative” appeal can also be used as a factor, such as how the property rates compared to neighbors (visually or structurally). Other expert ratings (Homescore™ calculated above) and crowdsourced data can also influence a curb appeal score. It is possible, for example, that many passerbys (gamers, volunteers, agents, paid raters) find the property attractive and indicate so in a mobile rating interface (not shown). FIG. 29C also shows that a curb is appeal score can be dependent on how much privacy is present at the property (does it have fence, what type); a physical condition, features such as trees, solar, pool, as well as estimates of fair market value, current listings, prior sales, etc. In other words, embodiments of the invention can retrieve and process prior sales and listings; it can then compare the Homescore™ or nominal curb appeal scores of such prior sales or existing listings to the building profile of the target property to determine a more accurate estimate of FMV. The resulting score can be presented then to the user as shown in FIG. 29D in any number of forms, including by indicating an absolute score, a relative score, comparisons to neighbors, related zip codes, etc. It will be understood that this is just an exemplary form and other computed data/formats will of course be apparent from the present teachings.

The report may be presented in electronic or hardcopy form, although the former of course allows for much more dynamic, interactive and visual richness. The report may be presented in a web browser, or within a mobile device, such as a smartphone, tablet, etc. For example, a model house with standard features is presented, including basic elements found in most homes. A presentation algorithm detects mouse-overs in areas of the house depiction within an interface and present relevant information for such feature.

FIG. 29B further identifies the key factors discussed herein for the user to help them understand the various inputs that go into the report calculus, including relative appeal by neighbor homes, expert ratings, crowd ratings, etc. FIG. 29C explains other factors that are considered (trees, solar, pool), privacy (fencing), physical condition and estimated fair market value (FMV) of course.

FIG. 29D is an example of a final output from the curb appeal report, which preferably identifies a curb appeal score, a relative score compared to other homes (both locally and nationally) and so on. A FMV score can be computed as well, by comparing or correlating the curb appeal score to the sales or listings of other homes in the area. This gives the user another perspective on the potential value of the home, and can be seen as a complement to such prior art techniques such as the ZillowEstimate™. It will be understood that other data, formats, etc. from the calculations described herein can be integrated into report 2900.

As seen in FIG. 29E it is expected that curb appeal scores will vary in accordance with different features in different geographic areas. For example, outdoor pools may be very desirable in some hot areas, and less desirable in colder areas which lots of trees, overhang, etc. (which can drive up cleaning costs). The present embodiments permit merchants to customize their own weighting of properties based on local tastes within an interface 2950. For instance in certain areas of the country, houses with shingle siding are more preferable than stucco facades; the converse may be true in other regions. Each of these preferences can be accommodated by a flexible scoring engine and interface that permits fine grained customization. As seen in this embodiment, users can customize and weight features directly within the interface using a slider, a set of radio buttons, or similar types of input mechanisms. The presence of elements (fenced yard, solar, chimney, etc.) can also be considered. It will be understood again that other types of features/factors can be captured, along with different visual or textual techniques for capturing a weighting factor. An algorithm to implement such interface therefore need only construct the data capture elements shown in 2950 based on the parameters used in the curb report. The data capture sliders, buttons, etc., directly influence the composition and weight of features used for the curb score calculation as shown in FIG. 29H.

Accordingly, any number of variables made possible by the present teachings can be incorporated into a user customizable “definition” of what makes a house attractive. In addition to the data enabled by the present invention, other mobile data (passerby ratings), existing/prior listings/sales data, general public data (#bedrooms, #bathrooms, age, #square feet, lot size, etc) can be included in a curb appeal score.

The reporting logic 170 is configured therefore to implement a Homescore™ (FIG. 28A-28C) and Curbreport™ Appeal Score (FIGS. 29A-29H) by calculating in accordance with the directives shown therein. Each structure, property, etc., can be scored in this fashion, and then presented for review by a user, including for example a real estate agent or other user interested in assessing property stock.

As seen in FIG. 29F, the results may be presented in sorted text form with rankings, addresses and scores, and/or in the form of selectable thumbnails, or some other descriptive useful format. It will be appreciate that other formats, such as shown in FIG. 18A, FIG. 18B, FIG. 19 and FIG. 24 can be used as well to profile and output leads for a merchant.

FIG. 29F depicts an example of a first type of graphical interface 2960 that provides sorted text based and image output for identifying a group of homes meeting predefined CurbReport™ criteria. For example a user can ask for a complete listing of curb appeal scores for every home in the 94709 zip code. The curb appeal scores are extracted and sorted from dB 2260 or other similar file store as described herein. They can then be presented in any convenient form, including as shown, or thumbnails as well. In some instances the identity or address of properties may be masked until the user completes a registration process, subscription process, etc. In contrast to conventional bank appraisals, which are static, limited to a single house, and restricted to the owner/bank for distribution, a user of the present platform can see information about housing stock that is dynamic (based on dynamic inputs provided to the system from significant number of stakeholders/crowd sources), across all housing, and available for anyone with access to the platform. In addition, multiple contexts or perspectives are configurable to compute different scores for different industries.

FIG. 29G for example shows another implementation of a graphical output in which curb appeal scores are matched by range to colors and then overlaid on a map. In this format, the curb appeal scores are banded within particular ranges. The ranges are then assigned distinct color values, and plotted in a visual map.

This technique has the benefit of permitting a user to quickly see and identify regions of a locale which are uniform, or non-homogenous, etc. It is also much faster for permitting a user to identify outliers, such as houses that have unusually high or low curb appeal scores for a particular region. Again it will be understood that other data, formats can be used for such visual map. The is properties may be individually labeled, or neighborhoods may be aggregated for different perspectives. For example, an entire section of a block extending between two side streets may be aggregated and then averaged to compute a neighborhood score. Moreover, as with the other reports and interfaces described herein, the details of an algorithm for doing the same can be derived from an examination of the interface itself (which defines an algorithmic structure) given the current state of the art in programming tools. Other examples will of course be apparent to those skilled in the art.

FIG. 29H shows a laundry list of potential factors that are enabled by the present invention and which can be used as metadata to compute a curb appeal score. Each of these factors may be stored as part of a record 400 (FIG. 4). This figure is a depiction of a spreadsheet interface 2980 useable for configuring and customizing a CurbReport™ score for a set of properties. The spreadsheet identifies the main components of a curb appeal score, and an accompanying rating and weight. Both structure and site specific data can be utilized as seen. In this version the elements, ratings, and weights can each be selectively controlled and filtered for any application. In a preferred embodiment the weightings adjust dynamically to reflect a 100% normalization. The final curb appeal score may be based on either or both structure specific data (score 1) and site specific score (score 2). Again this depiction is intended to be representative and it will be understood that other combinations and formats could be used. The data in interface 2980 thus acts as a modifier and define/configure the ultimate curb appeal score described herein.

Unlike prior art systems that only assess the desirability of a target property relative to its own features, the present embodiments can consider inter-house, or neighbor effects as well as secondary factors. For example, a 1-story home surrounded by 3-story homes will appear smaller and potentially less desirable when framed by its neighbors, irrespective of its other merits. Similarly, a house with average landscaping will create a different visual impact depending on whether its neighbors have poor or outstanding landscaping. This effect, however, cannot be seen using prior art systems which only focus on the is specifics of a single house taken out of context. This aspect of the invention, therefore, permits a virtual scoring to better model and reflect real world considerations.

Consequently embodiments of the invention can also include secondary factors, as seen in FIG. 29H which generally are based on a differential or A in characteristics between adjacent properties. In a preferred embodiment at least the two adjacent properties are considered for comparison, but it will be understood that the definition of “neighbor” house can be expanded to include up to N adjacent houses on either side, as well as houses immediately across the street, and so on. Again the focus of the secondary factor analysis is to quantify the experience and impression that a person would have examining the property in the context of its surroundings.

In a manner analogous to that shown for the Homescore™, a Curbscore™ calculation shown in FIG. 29H consists of an automated calculation involving:
a selected set of Primary desired parameters/features; (which can be varied or customized as needed);
a set of respective individual rating factors {R1, R2 . . . Rn} determined for each feature (from automated or manual coding);
a set of corresponding weighting factors {W1, W2 . . . Wn} specified for each feature (again, varied or customized as desired)

The product of each Rating*Weight is computed, and then a cumulative sum is identified for a Structure specific curbscore (Score 1). As seen in FIG. 29H a set of secondary factors can also be considered, including the parameters shown there such as:
Relative Appeal (how does the home look compared to its neighbors)
Absolute Appeal (how does the home look compared to all homes) Neighbor Influences:
Δ Stories (how does the home vary in stature/height compared to nearby homes)
Δ Landscaping (how does the home vary in landscaping features (trees, lawn) and quality compared to nearby homes)
ΔGarage (does the home have a garage and neighbors do not, and vice-versa)
ΔDriveway (does the home have a driveway and neighbors do not, and vice-versa)
Δ Fence (does the home have a fence/privacy and neighbors do not, and vice-versa))
Δ Appeal (how does the home compare from an aesthetic perspective to neighbors)
Δ HomeScore™ (how does the home condition compare to neighbors)
Δ House Size (how does the home size compare to neighbors)
Δ Lot Size (how does the property lot size compare to neighbors)

Other features could be considered of course, including more conventional factors, interior aspects (#bedrooms, baths, age, etc.) used by prior art systems. The product of each Rating*Weight is computed, and then a cumulative sum is identified for a site specific curbscore (Score 2). The two cumulative scores can then be summed, weighted, or subjected to any other convenient mathematical treatment to derive a final Curbscore™ that can be presented as seen in FIGS. 29A-29G.

### Integrated Home Improvement Website

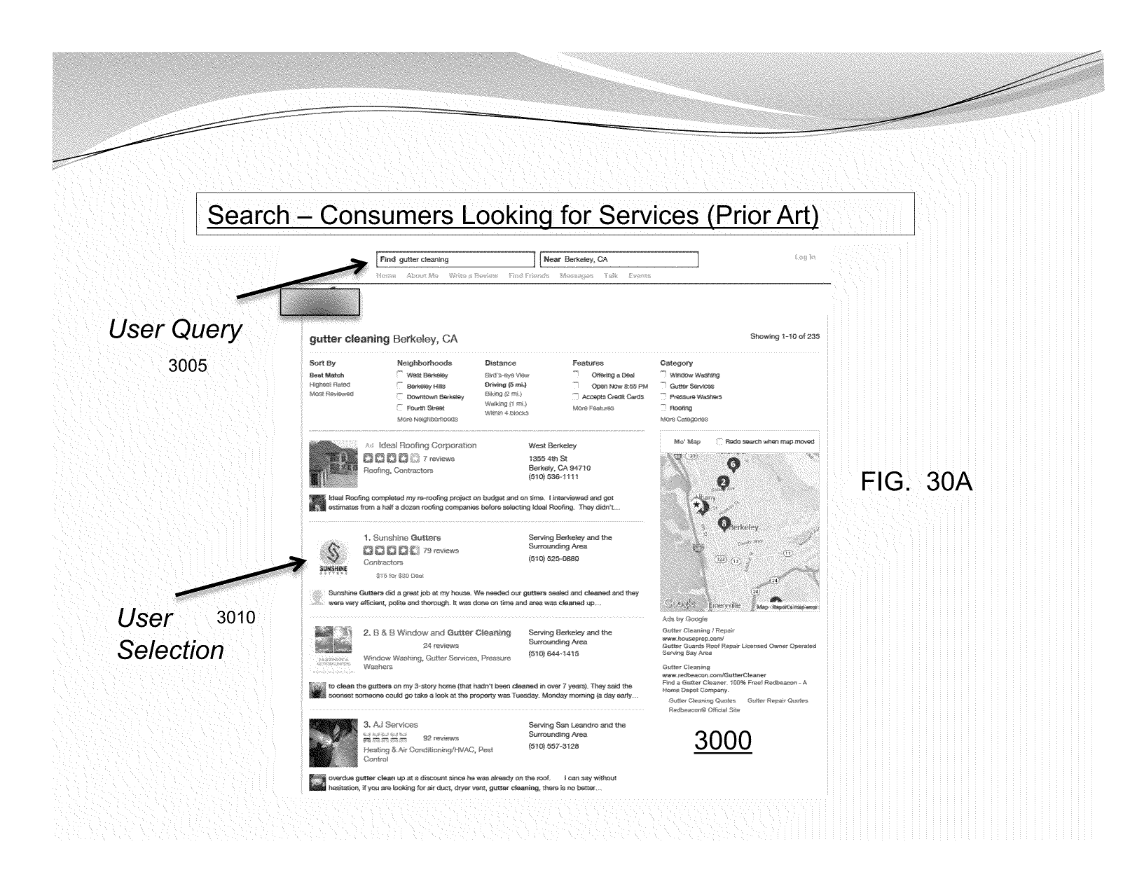

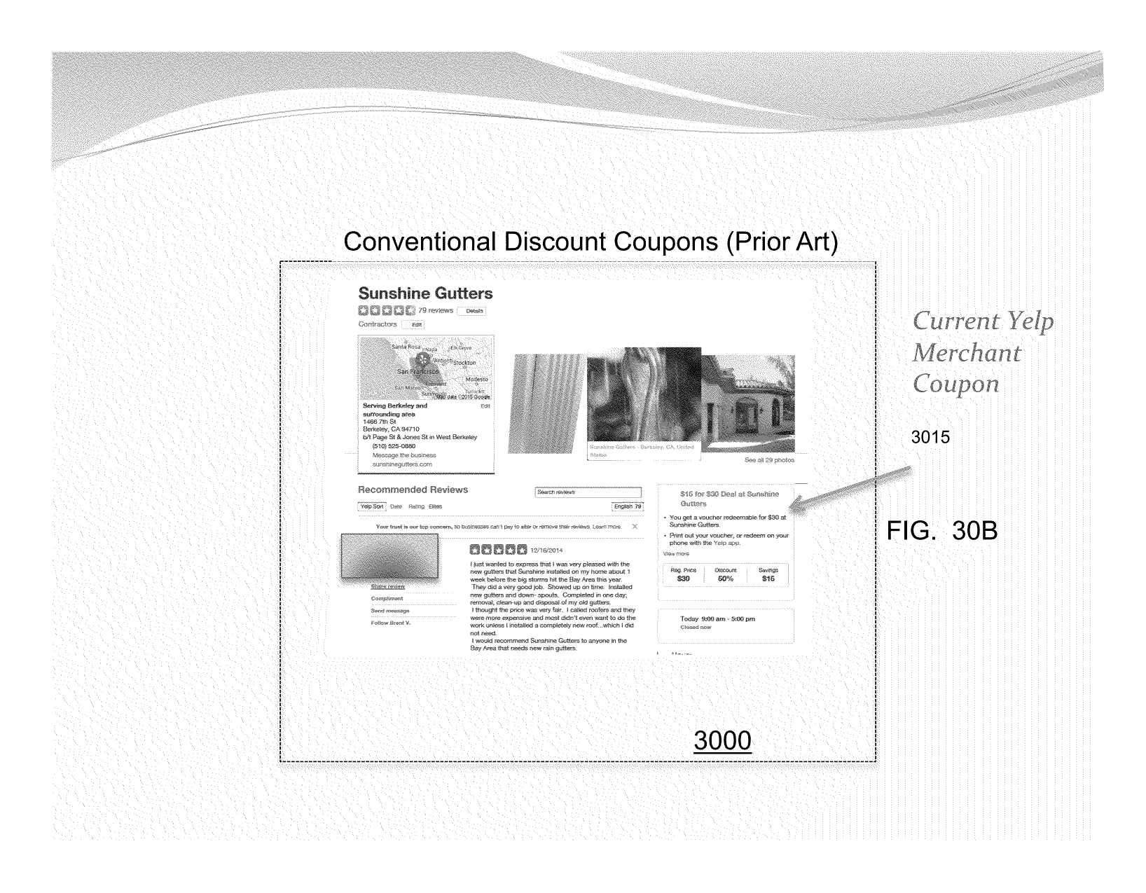

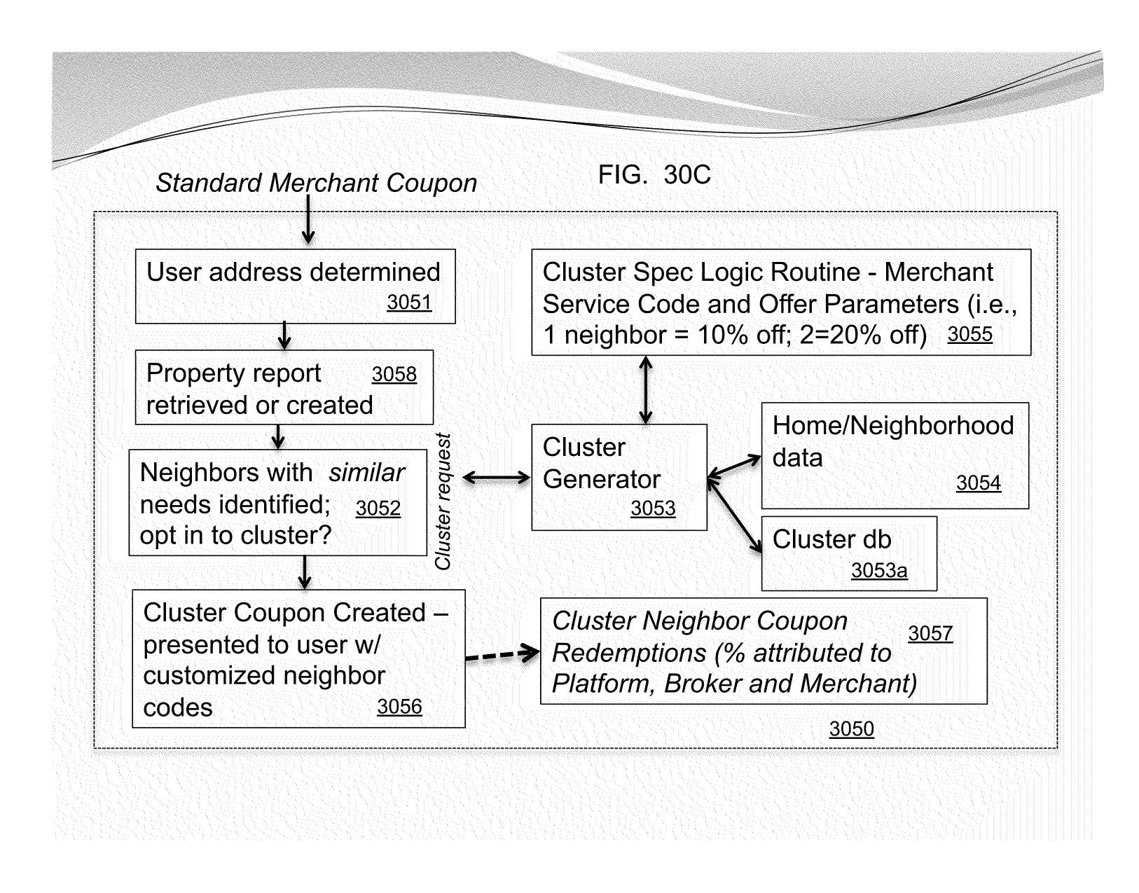

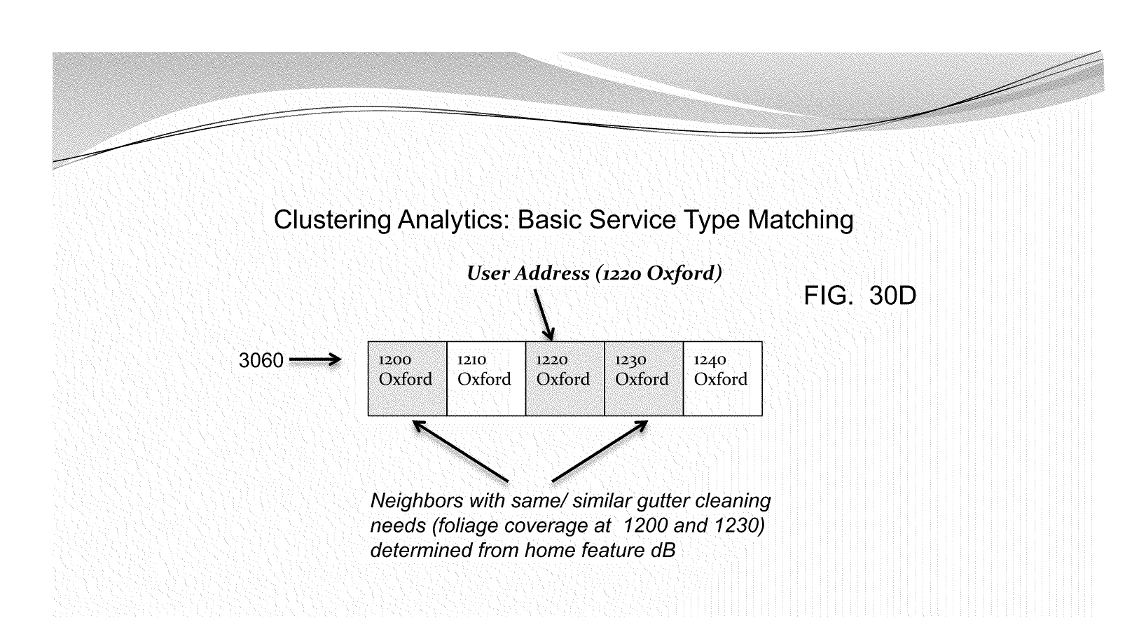

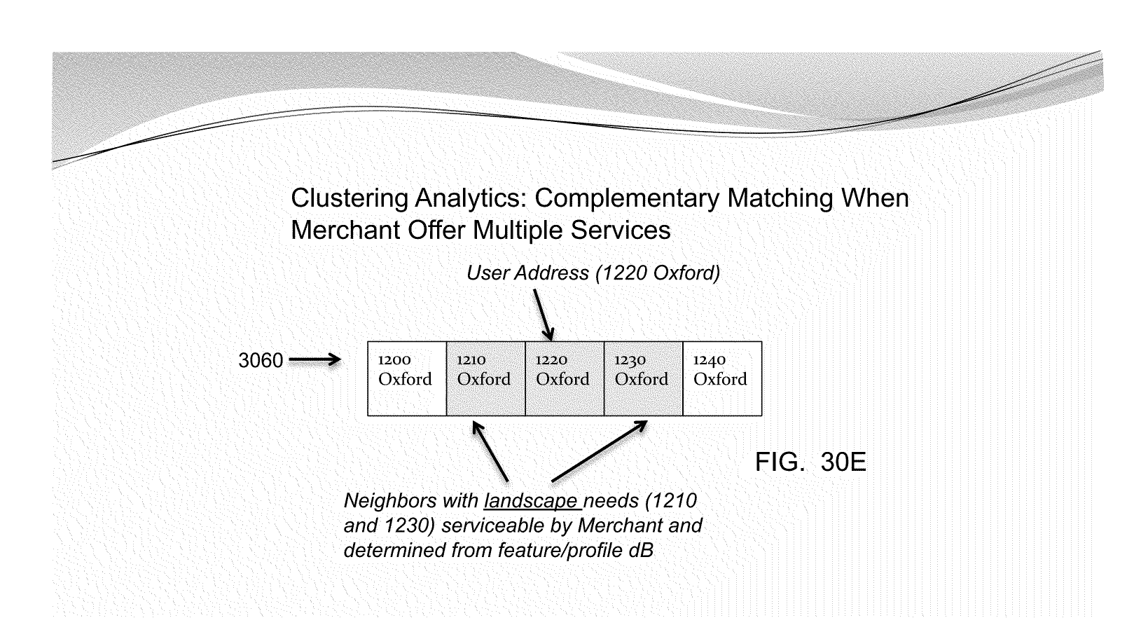

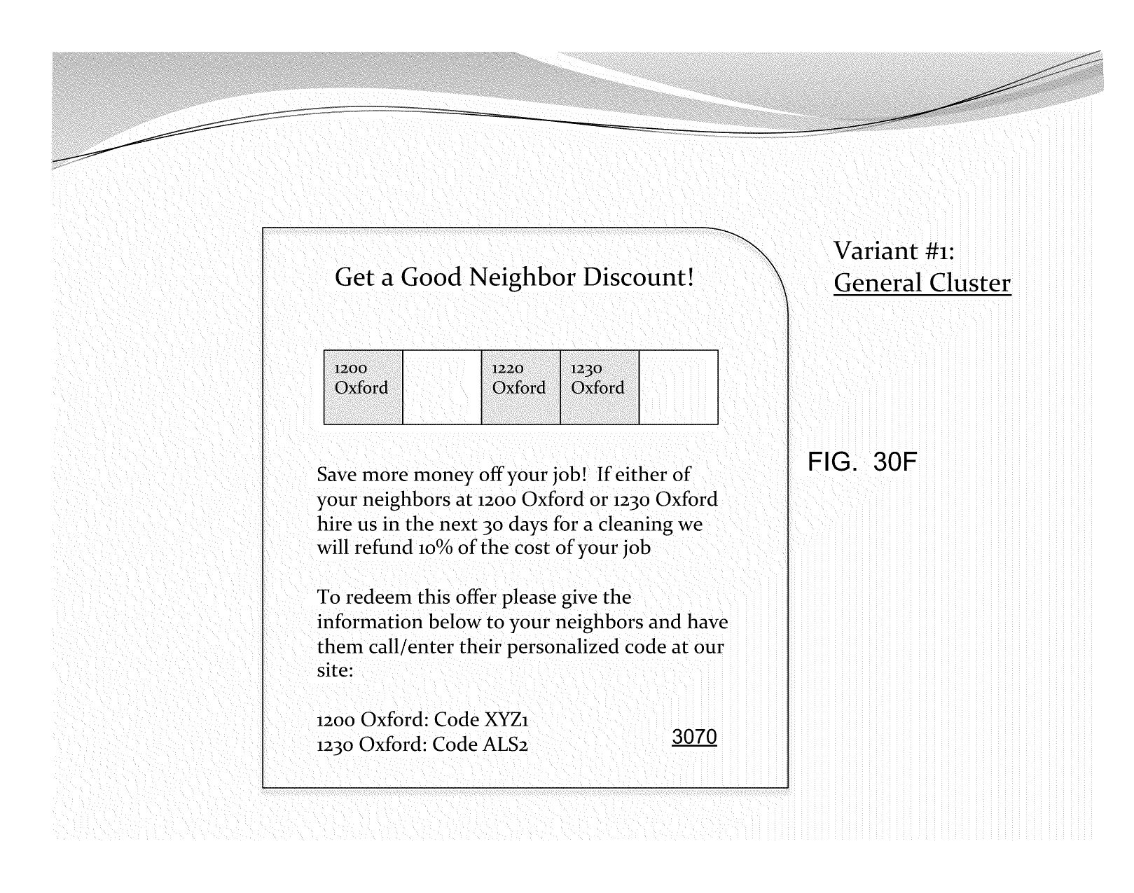

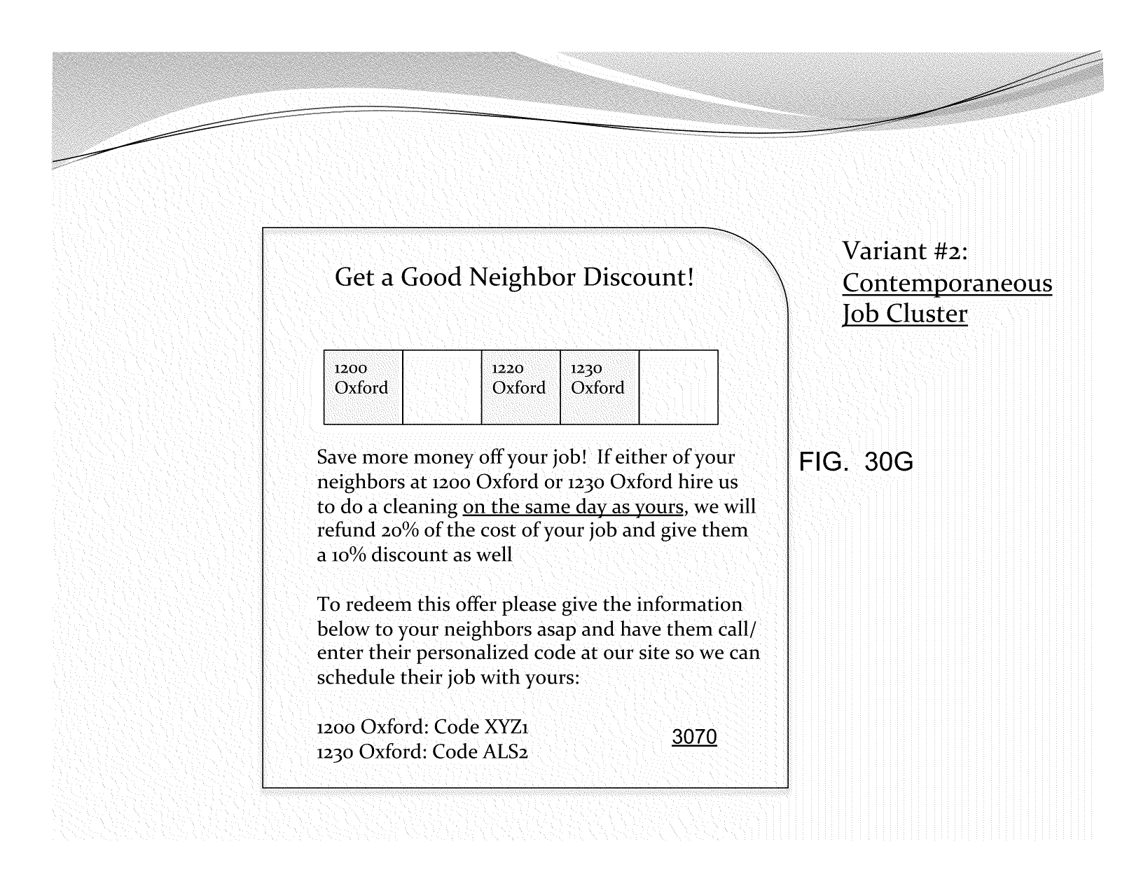

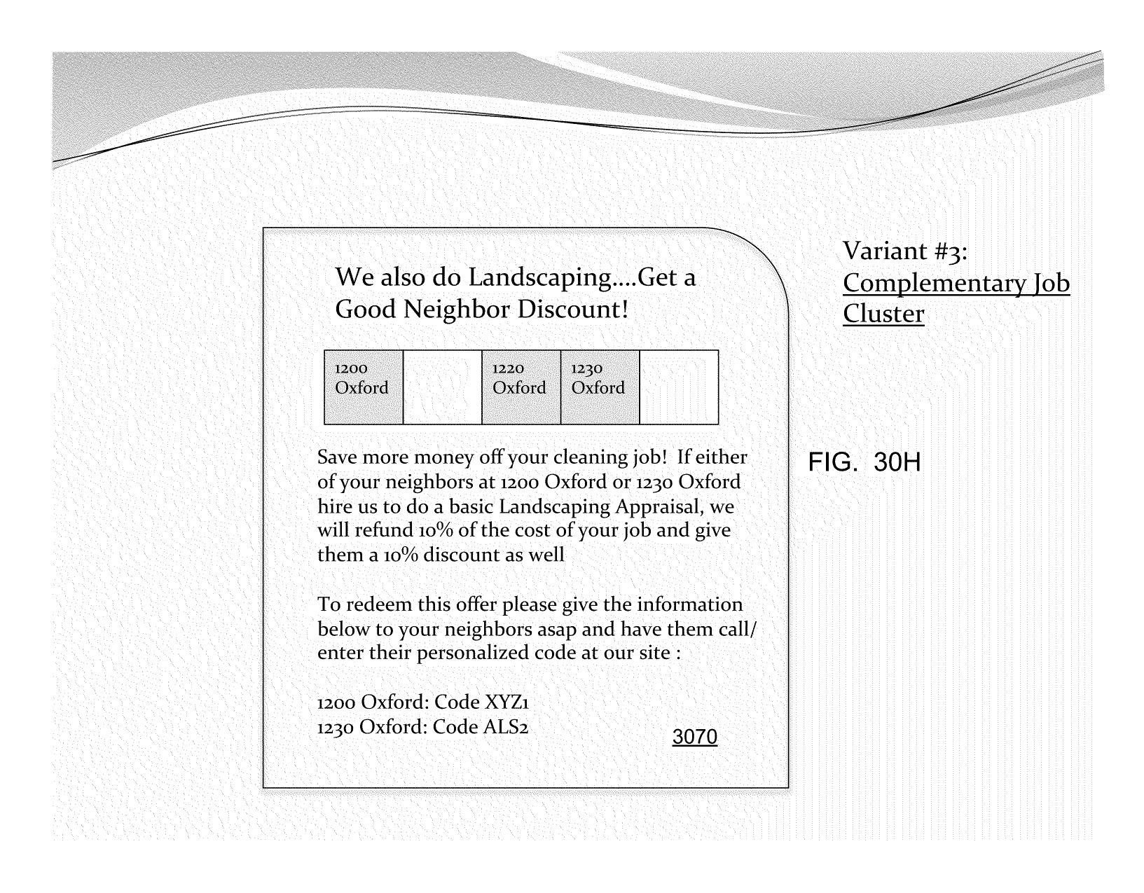

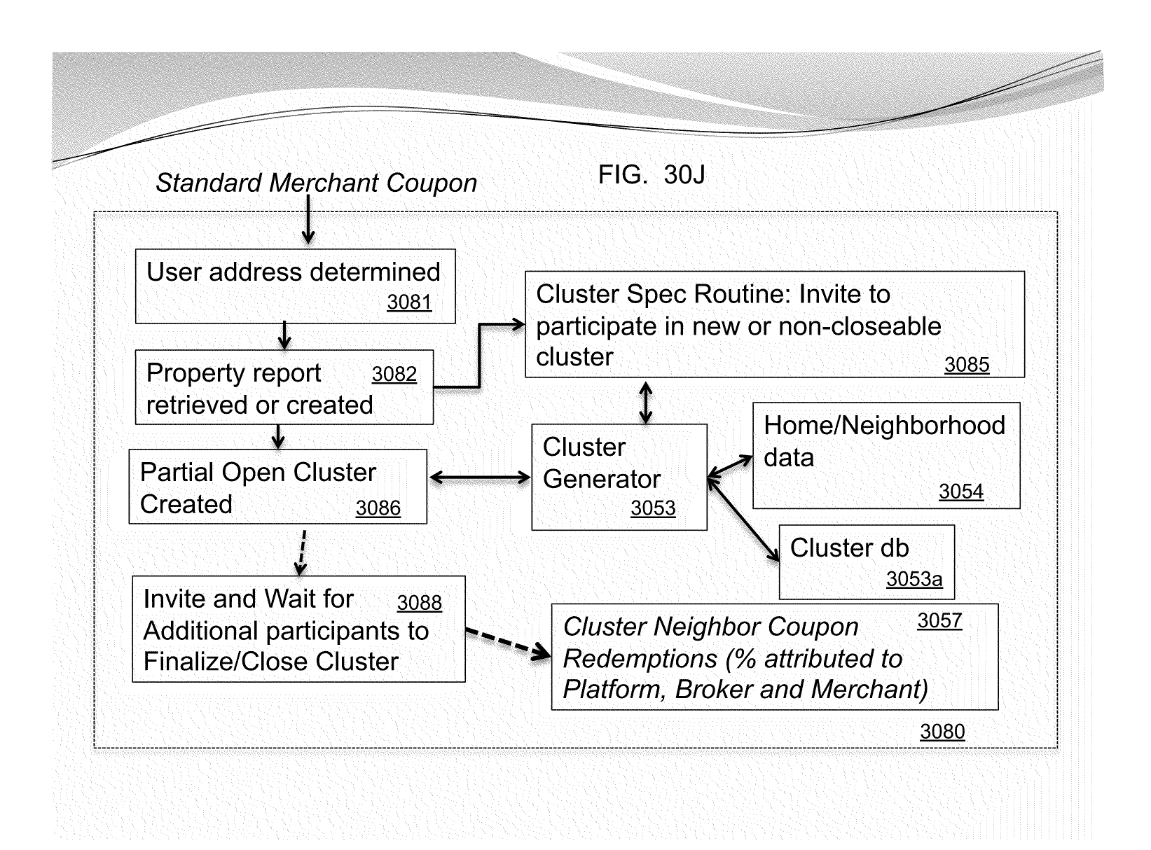

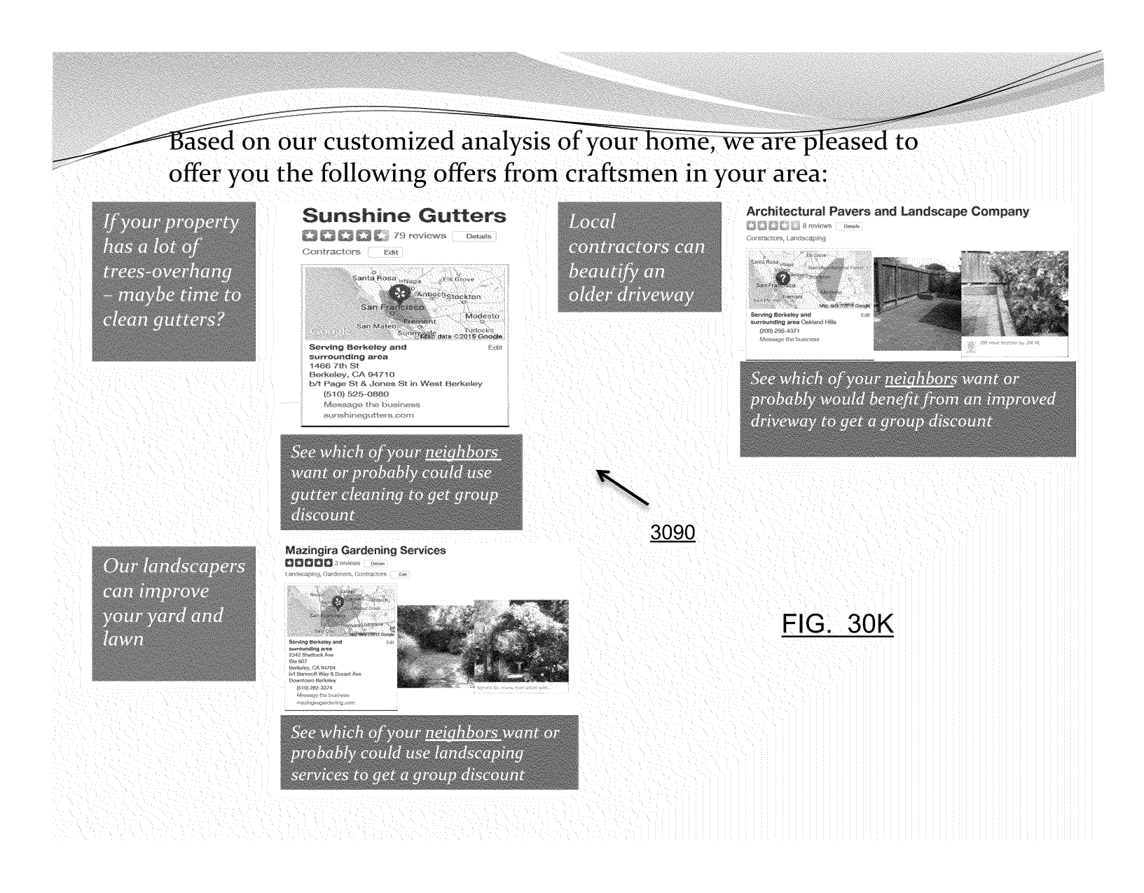

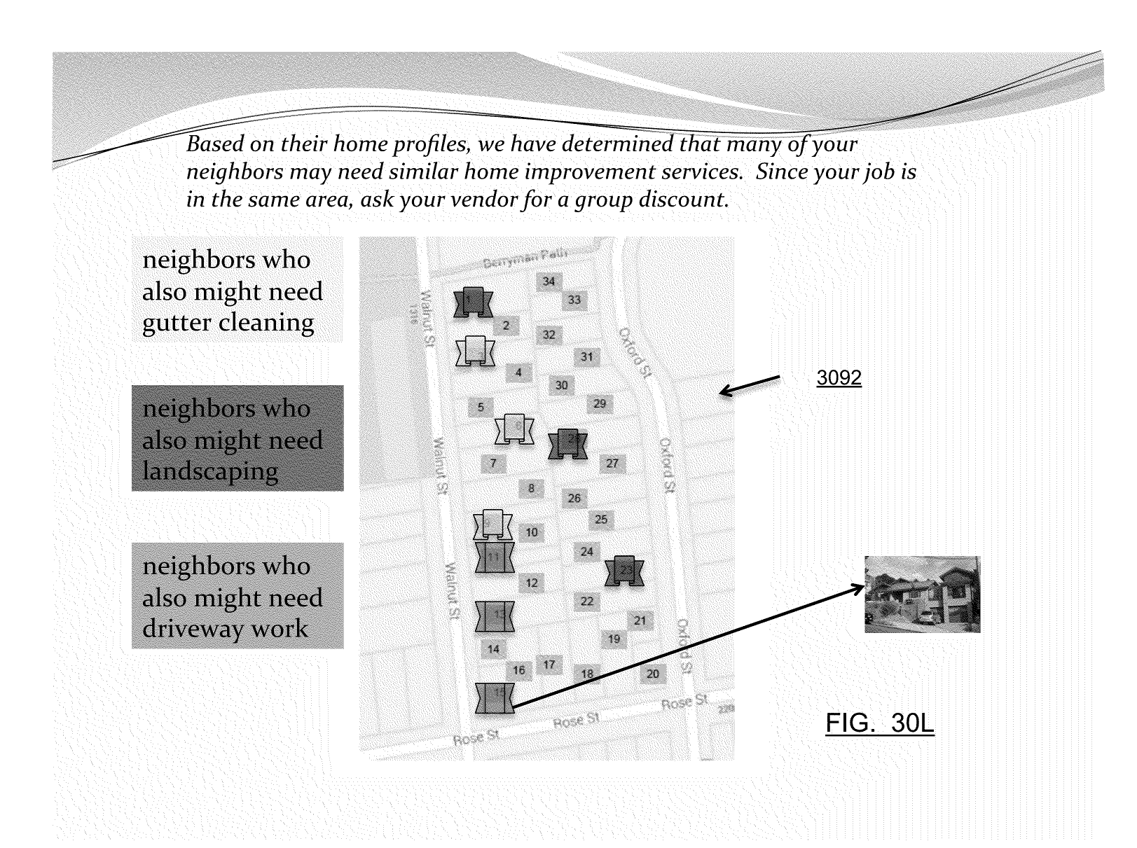

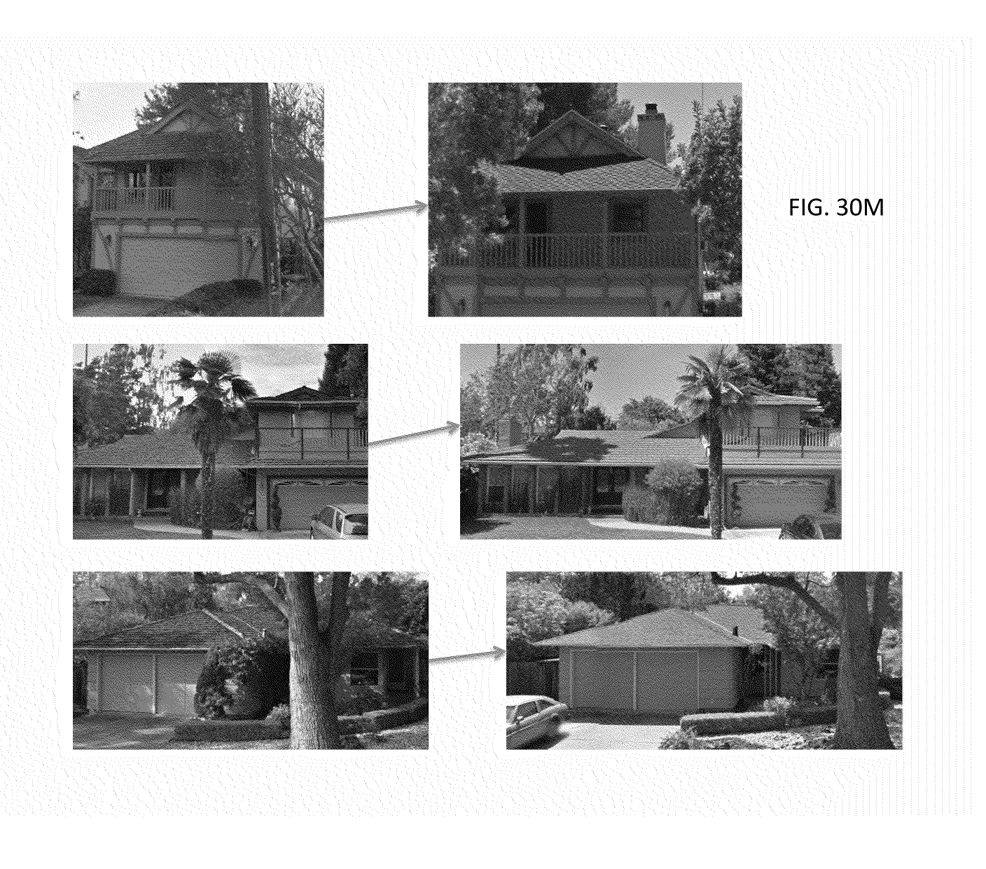

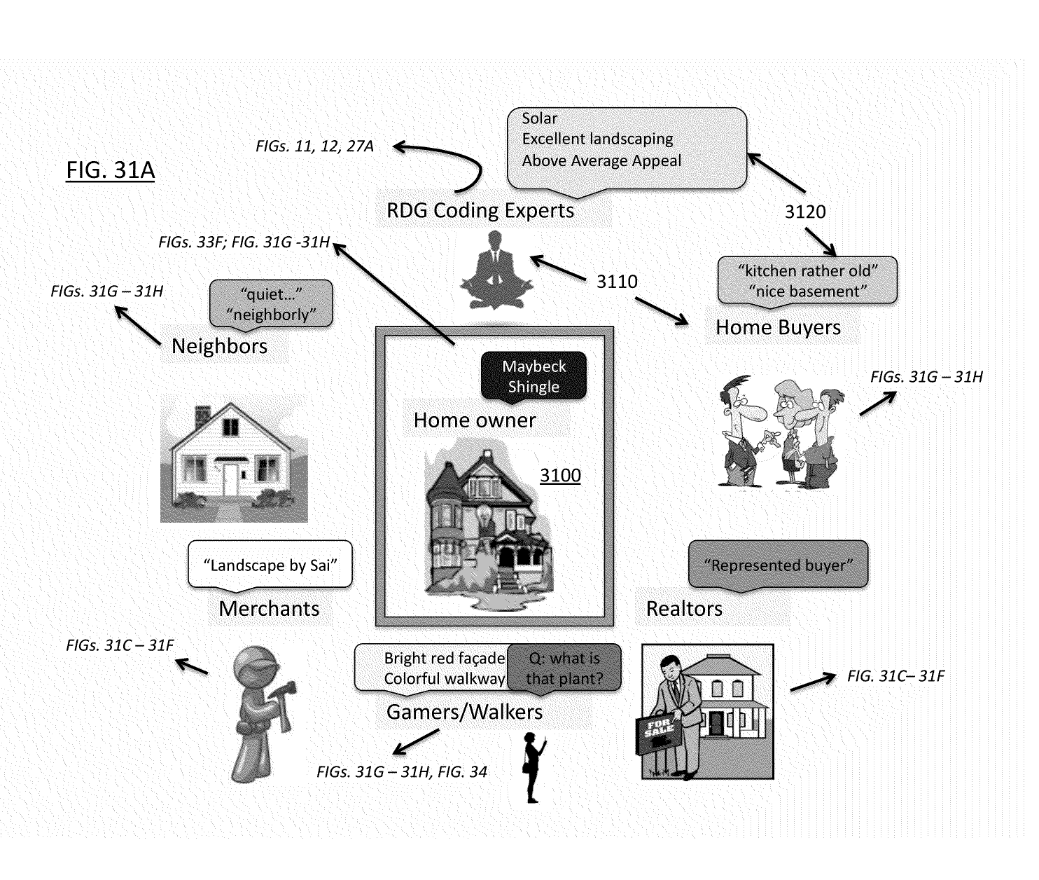

All of the features and functions discussed above can be incorporated and implemented at a standalone website dedicated to property assessments, review, etc. FIGS. 30A-30L depict an alternative embodiment of the invention that is integrated within part of a third party website 3000 (e.g. Yelp, Porch, Angie's List, Houzz, etc.) that supports home improvement services. Typical prior art systems (shown in FIGS. 30A and 30B) permit users who have home improvement needs to query and search for local merchants to assist with products and services. Such sites include query capability (the example here is from Yelp) so that a user search 3005 results in a set of relevant search results (which may be ranked by reputation, reviews, etc.) germane to their situation.

From there, a user can select an entry and be presented with an is offer/coupon 3015 as seen in FIG. 30B Here in response to a query for “gutter cleaning” the user has selected “Sunshine Gutters” as his/her selection 3010 from among a number of candidate merchants. In response to such selection, as seen in FIG. 30B, a user is presented with detailed information 3015 relating to the merchant, including a discount offer in some amount that can be applied to a future job. When the user selects such offer, he/she is prompted for more information to redeem the coupon and schedule a job against which the payment is credited. In these prior examples, a user is targeted 1:1, meaning a single user is given an opportunity to opt in to a single offer. The results are based in part on relevance, crowd sourced feedback—recommendations, and so on. The programming and algorithms for performing this functionality are well known in the art (see e.g. U.S. Pat. No. 8,712,907 incorporated by reference), and again, their structure and flow are self-apparent from the present teachings.

Embodiments of the present invention amplify engagement with the user at third party sites by generating and offering them enhanced cluster targeted coupons, discounts, 3020 etc. based on computed assessments, correlations, etc., that are tied to and contingent on securing cooperation from one or more qualified neighbors of the user. These targeted, personalized offers complement and augment the techniques discussed above for FIGS. 14, 15A, 15B. These cluster coupons, as alluded to above in connection with the discussion of FIG. 24, are based on aggregating users' demand in localized areas based on a predetermined set of offer clustering criteria specified by a merchant, including cluster type (which feature is implicated); cluster condition (to the extent a feature condition is required); min/max cluster participant size (number of jobs); cluster geographic proximity; cluster discount; cluster time limit for formation, and so on. The clusters therefore are used to generate enhanced user offers/coupons beyond those shown above in the prior art. This embodiment supplements and complements the prior art systems noted above.

The operation of this integrated embodiment 3050 is shown in FIG. 30C. A website 3000 computing system implements a number of routines and procedures that engage a user to locate other persons with similar needs so that is they can be targeted as a cluster. The diagrams, figures, flowcharts and disclosure provide substantial architectural framework and structure to permit a skilled artisan (including in computer programming) to implement the functions and features as described.

As seen in FIG. 30C, a standard merchant coupon or query is the preferred starting point for invoking a new targeted process 3050. The standard coupon may be in the form shown in FIG. 30B, namely, a specific offer to a specific user for a specific service. Alternatively the input may be in the form of a keyword, for example user A may ask for driveway repair.

Next a user's address is determined at step 3051. This can be done automatically by referencing a user's location, or input by the user directly. A (pre-computed) property report is then retrieved (if one exists already) from database 140 (or some other relational database that stores such home analyses) or, in the alternative, if one does not exist, creates one dynamically at step 3058 as described above. For example an automated call is made by a website computing system to a secondary computing site which solicits assistance from human or automated coders to identify, rate and score a particular property. The results are then returned to be used in the remainder of the integrated targeting process.

At step 3052, a cluster request call is made to a cluster generator logic routine 3053, which may be executed by the website computing system, or a third party system. To identify similar needs, the algorithm first matches the existing coupon or query to a particular home improvement service or product, to determine the user's intent. The home improvement service or product is then also mapped to one or more germane housing features. For example, a request for gutter cleaning could be mapped to feature “foliage overhang” and/or to landscaping.

During this step neighbors of a user are identified, including specifically those who have properties that were already determined to have (or likely to have) a similar need for driveway repair. This can be determined because, as noted herein, the various property rating mechanisms operate to collect and is depict comprehensive, multi-dimensional data for homes. Other factors can be considered as well to derive a set of predicted neighbor candidates who have a similar or complementary service need.

To do this, the cluster generator accesses and examines adjoining homes and neighborhoods corresponding to the user's address, as accessed from a database 140 by a neighbor matching routine using data from db 3054. Cluster generator 3053 may also query and examine if there are open clusters available in a cluster dB 3053a. The clusters are determined by reference to the parameters noted above, namely, the offer clustering criteria, which are specified individually by merchants through cluster specification logic 3055.

In a simple example, a gutter cleaning merchant may specify that they are offering a cluster discount coupon 3020 based on the following cluster opt-in requirements:
Coupon ID: unique code tying discount to a cluster
Cluster Min size: At least 3 homes
Cluster location: On the same street
Cluster distance constraints: No two of them being separated by no more than an address differential of 100 (i.e., 2020 Albion, 2050 Albion and 2140 Albion street would qualify)
Cluster feature 1: Each has a foliage overhang rating of “partial” or greater;
Cluster feature 2: Each has house condition of good or better;
Coupon normal rate: Normal cleaning rates=$200 per home
Coupon Offer=20% off normal rates for each
Complementary cluster matching features: landscaping, lawn,
Complementary service normal rate: Normal landscaping rates=$50 per visit per home
Complementary coupon Offer=20% off normal rates for each
Coupon Job time: week of May 1^{st}
Coupon Opt-in fee: $20 upfront, credited towards job
Coupon expiration date: must be satisfied by May 1, 2015

These (and other) parameters are stored in a database (not shown) by a cluster specification logic routine 3055. The tools for creating the cluster can be as described in connection with FIG. 24 or some other suitable automated logic. As a final output the computing system creates and stores a set of coupons that are associated with unique IDs, offers, and clusters. These can be stored in a relational database 3053a for example in any number of formats.

At some later time, a user may specify a query for gutter cleaning. Based on such query, the user is first associated with a nominal or standard merchant coupon 3015 such as presented above. If the user opts in to a clustering process, however (or is automatically placed there by logic 3050) their address information is then used by cluster generator 3053. The cluster generator can then determine if the user fits the profile for an existing open coupon cluster in database 3053a (i.e., if they were already identified as someone who qualified and could be offered—see below). When this occurs, the user is paired or matched to such cluster, or some other cluster depending on a cluster logic determination (as discussed below). Note that in some embodiments a merchant may also offer complementary services (such as landscaping and/or lawn services) that may be incorporated within a cluster coupon. If the user query (or user's home profile) matches such complementary criteria, they may be offered the cluster coupon on that basis as well.

If no matching cluster coupon exists already, the cluster generator logic 3053, using the cluster criteria specified by routine 3055, and matching logic 3054 analyzes home neighborhood data (including homes who have previously opted in to clusters before, or if they have had such project done before some threshold date based on analyzing permit data) to determine other adjoining homes in the vicinity of the user to see if any of them would qualify for the cluster criteria. Those properties matching the clustering criteria are then associated with the user and the specific cluster coupon as candidate cluster entities. Again if any of the candidate cluster entities have already opted in to a cluster offer, they are then matched to the user through one or more of the cluster coupons stored in db 3053a.

Accordingly the integrated logic 3050 keeps track of open clusters, completed clusters, etc., homes/persons who have opted in, etc., in cluster dB 3053a. The coupon/cluster dB 3053 stores and maintains status and content information such as the following in a cluster coupon record:

Coupon ID (a unique code identifying the particular coupon)

Matching Cluster Coupon ID (as determined from routine 3055)

User/Homeowner IDs of persons who are already accepted as part of cluster

User/Homeowner IDs of persons who have been offered cluster and not responded

User/Homeowner IDs of persons who qualify and could be offered cluster

Whether the cluster is still open or is closed (conditions satisfied)

Cluster Status: active or stale

Cluster expiration date

The cluster coupon generation logic 3053 examines when a first user opts in to a cluster coupon from routine 3055, and accesses or creates a record in cluster coupon relational database 3053a. Accordingly, it matches the first user to an existing coupon cluster, or creates a new one if needed based on specifications from the merchant. From there it constructs the rest of the cluster coupon details within the record so they are accessible and ready to be matched to other target homeowners accessing the integrated platform later who meet the cluster profile.

Consequently, in the example above, the integrated logic 3050 may determine that the user's gutter cleaning request qualifies for inclusion in multiple clusters from different merchant offers that are already open in db3053a. The cluster generator logic 3053 preferably operates with logic that ranks clusters by their expiration date. Therefore it preferably closes a particular coupon cluster as quickly as possible, rather than maintaining yet another open cluster. In other words, as between placing the user in an uncertain state as to the availability of a discount (since it may or may not be filled in one cluster coupon) it is better to place them into a cluster coupon that will close and be completed with their participation. Alternatively or in addition to this the cluster logic may use or weight other factors, and pair the homeowner with a cluster that matches a primary condition (i.e., is the same type of feature: gutter cleaning, not a complementary condition) offers a greatest economic return, is based on total job cost, commissions, etc., or alternatively based on a closest geographical distance, or a prior association with other members of the cluster, or based on a nearest in time cluster expiration date, and so on. The predicted candidate neighbors 3054 may be derived by reference to other factors as well of course, including whether they are related in some way (through a social graph for example) to a user. As alluded to above, online permit data may be analyzed as well to determine if a similar job occurred at such property prior to some threshold date for the particular feature, type, etc. For example, composite roofs may need to be replaced every 10-15 years, and permit data can reveal prior jobs done in the past, to identify candidates in the future. These types of neighbors may be targeted as well as potential cluster candidates. Other examples of prioritization fulfillment logic will be apparent to those skilled in the art. Consequently, at step 3056 the selected cluster coupon is presented to the homeowner/user along with the pertinent requirements.

Redemption logic 3057 keeps track of if/when a user (or other targeted home owner in the cluster) opts in to the cluster coupon conditions, such as by agreeing to pay an upfront fee, to have the job take place at a certain date/time, etc. This data is used to create and update an engagement graph or network that identifies vendor/merchant—house associations, and identifies future cluster candidates. These relationships can be searched later on, so that a user can query and find exemplars for a virtual portfolio from a particular merchant. From these interactions the coupon/cluster db 3053a is also updated of course to keep accurate track of the state of open and closed offers. As noted above, the system preferably attempts to create and close clusters as quickly as possible. This helps avoid lag and other delays which may cause participants to forget or back out of scheduled projects, because they are informed very quickly of the ratification of the cluster. In addition the redemption data is maintained in a is relational database 3057a which tracks merchants, homeowners who have opted into clusters and projects. This data can be made part of a structure relaitonal database 140 (FIG. 1) and made available to for a number of purposes, including in a mobile application such as shown in FIGS. 3A and 3B. As part of interface 380 for example, a mobile user can inquire on specific jobs performed at a particular site. This can be presented to the user within interface 380 as a separate list, including at least the following fields and data items:

Property feature: landscaping

Merchant providing: Acme gardens

Offers Available: Yes (cluster coupon, etc.)

In other words, a passerby or web peruser can inspect a property, determine if a feature is attractive or interesting, and inquire on the identity of the merchant who is responsible. At the same time they can be shown if there are open discounts, cluster coupons or regular offers available from the same merchant. Depending on the user's interest, they can be injected into the platform 3050 as discussed above to interact dynamically with an offering system. This variant of the invention permits mobile users or other users to observe, locate and engage with merchants whose work appears to be attractive. While some existing systems allow craftspersons to create online, customized portfolios, these platforms require extensive work and investment of time by the merchant. In the present embodiments, a craftsperson's portfolio can be automatically constructed, augmented and expanded rapidly for perusal by prospective home improvement customers.

In other instances of course the user may be presented with offer information that must be seen and elected by a neighbor to complete the cluster ratification. For example, they may be given a phone number, email, report, etc., which gives a code to the neighbor to opt into the coupon offer within a predetermined time, such as shown in FIGS. 14, 15A, 15B either in hard copy form, electronic form, etc. Again, as noted above, the cluster neighbor may be selected in part based on prior participation in cluster discounts. Feedback is then provided to the merchant and cluster coupon participants to coordinate the is job required at the various property sites.

In some embodiments a user may be offered to opt in and be matched to more than one coupon cluster from multiple merchants. In this respect merchants are incentivized through competition to create cluster coupons that are likely to be ratified quickly as a result of smaller cluster sizes, bigger discounts, more liberal location requirements, etc. Further still in some embodiments a user may be “conditionally” opted in to more than one of the same kind of coupon cluster but yet be included only in the first to close. The other unclosed cluster would then develop an additional opening due to the user's withdrawal of the conditional opt-in. User opt-ins therefore may have their own conditions and constraints, including a time-to-fill requirement for example. Other parameters will be apparent as well. This again incentivizes merchants to create clusters that are easy and more likely to be fulfilled.

Unlike prior art technological attempts to group common interests over the Internet, the present invention should result in enhanced uptake and redemption of offers, because it matches users better (based on predictions for a highly correlated lead/need) and further groups them by neighborhood, which appeals to a sense of common community and experience. Furthermore, by aligning the merchant incentives better with community interests, the former can be induced to proffer and pass on savings achieved from reducing operational costs per job. Consequently the invention also affords a true improvement over prior technical programming, which did not consider such variables or analyze them in the manner described herein.

Note that in a direct matching process (i.e., one where the user's targeted query is directly matched to other homeowners with the same identified need) a property report may or may not be retrieved or generated at step 3058. In other words, while step 3058 is shown in FIG. 30C, the integrated offer logic 3050 may simply use the address information and nothing more to compare and create (or locate) a cluster to match the user's profile. This is due to the fact that the user's target needs and intent can be gleaned directly from his/her query. It is only in the instance of offering complementary, unspecified (or unexpressed) needs is (described further below) that the homeowner report is strictly necessary for purposes of comparing against a set of neighbor homes with overlapping needs.

FIGS. 30D-30E describe visually the analytical approaches used in embodiments of the enhanced cluster based advertising targeting system implemented in accordance with embodiments of the present invention. As seen in FIG. 30D for example, candidate cluster members—neighbors of user A with similar needs (in this instance, gutter cleaning)—can be ascertained by identifying properties with significant foliage overhang (which would deposit leaves and debris in gutters). Potential cluster candidates can also be determined simply by analyzing neighbors who have expressed an interest before generally even in other related home improvement services, and/or who have opted in to clusters before. Alternatively they can be determined, as noted above, by predicting a need for a specific feature based on age, type of such feature, and work done in the past at a particular data. In FIG. 30E, given a user address (1220 Oxford) neighbors at 1200 and 1230 Oxford are identified also (from a relational database of automated home assessments noted above) to have potential same or similar features. This is an example of a complementary candidate match, based on the services offered by a merchant. For example, a merchant X may offer both landscaping and gutter cleaning. By doing a broader “match” to a complementary service, neighbors at 1210 and 1230 can be identified as potential candidates for landscaping offered by merchant X as part of a hybrid cluster that includes gutter cleaning. Other considerations can be used as well of course, including an overall appeal score, as structures in good condition tend to reflect homeowner tendencies to spend and attend to their homes. Because the merchants can specify the scope and matching characteristics of the clustering coupons, different types of homeowner needs can be matched as desired.

FIGS. 30F-30H are representative embodiments of an electronic or physical manifestation of a cluster coupon 3070. Again, these embodiments complement and augment the types of customized offers shown earlier in FIGS. 14, 15A and 15B. In the example of FIG. 30F, the user is given an offer of a 10% is discount if a neighbor also opts in and hires the merchant for a project. Generally speaking as seen in FIG. 30F a coupon offer 3070 contains specifics on the requirements for inclusion in the cluster, including type of job, amount of discount, timing, and home specific restrictions (i.e., for 1210 Oxford, only 1200 and 1230 Oxford are eligible in this offer). The neighbor offerings are also uniquely coded so they can be matched appropriately by the integrated platform 3050.

FIG. 30G is an example of another variant, in which a time constraint is imposed on the offer performance date. In other words, the cluster coupon is contingent on both parties electing to have the cleaning service on the same day. FIG. 30H is an example of a complementary cluster coupon 3070. When the homeowner redeems a gutter cleaning offer, they are matched to other local neighbors who may not need such service, but who may need another service offered by the merchant, such as Landscaping. Other examples will be apparent for the format, style, offers, etc.

Again because different merchants have different operational constraints, efficiencies, etc., their targeting criteria will vary significantly for composing cluster coupons. For instance a merchant in landscaping services may prefer or have significant discounts for jobs performed on the same day. A driveway repair company may only require that the jobs be performed in the same week. Other examples will be apparent based on the present teachings, and it is expected that the different service providers will implement a wide variety of offerings using the flexible targeting criteria enabled by the present platform.

Note that embodiments of the present inventions implement an automated targeting 1:many offering that is superior to existing third party services that aggregate offers, such as for example offered by Groupon. In the latter case, the vendor has little or no knowledge of the needs of the potential purchasers, and simply mass emails offers to users based on their geographical location, prior purchase history, etc. Nor do these vendors create a collaborative environment mechanism or automated pool to help persuade a local neighbor to cooperate with the user. In other words, the present invention leverages off of existing is neighborhood relationships and determined needs to enhance engagement and adoption of local artisan goods and services. It will be understood that the content and format can be varied as desired for any application. The embodiments shown in these figures are well suited as part of online advertising at a general search site, a customized home improvement site, and so on.

It will be readily appreciated by skilled artisans that the cluster platform 3050 solves a number of problems in the art of computer targeting of home improvement services/products advertising. That is, in the prior art, the uptake or redemption rate for a particular offer from a particular vendor may be extremely low. This also results in less traffic/visitors to a website because they are dissatisfied with the offers. For those actual visitors to the site, they may become frustrated and leave because they do not obtain personalized attention for their specific home circumstances.

Again a primary difference to prior art techniques is that the offers are enhanced over that shown in the art, and are not limited to user interests, keywords, etc., but are more precisely targeted to specific clustered homes/properties based on their location, physical attributes and predicted needs, including based on prior adoption of cluster offers. Consequently the ad targeting, in a sense, can be directed to home characteristics, not just user characteristics.

In addition it can be seen that the platform effectively takes existing articles (a physical or electronic coupon or offer) and transforms them into clustered variants which are more useful and attractive to users/homeowners. By automatically identifying and placing like positioned homeowners within programmable “clusters,” and selectively controlling their presentation to an optimal set of homeowners, embodiments of the present invention can increase this rate significantly to the benefit of both users, merchants and an advertising delivery platform operator. This cluster in turn is achieved in part by automated scoring and classification of building structures to identify common features, conditions, etc. While the functions and benefits of such platform are unique and hitherto undiscovered, the cluster logic routines which effectuate the interfaces, is determinations and reports shown in FIG. 30A-30J may be implemented using different kinds of programming languages, computing machines/servers, etc., depending on the application and requirements. It will be understood that the specific implementation will vary from platform to platform depending on the underlying operating platform used.

FIG. 30J illustrates a complementary aspect of the integrated embodiment 3050 shown in FIG. 30C, and depicts the behavior of platform 3000 as experienced by a user who is looking for products/services that may be the same or complementary to those identified later by another user undergoing engagement with logic 3050. Logic 3080 in this instance tracks the behavior of logic 3050, and in this respect like reference numbers are intended to reference similar operation unless otherwise indicated.

The main difference in this instance is that the clustering algorithm process is driven and derived at the portal side, instead of making a call to a clustering service per se. Also, the clustering can be done based on user queries, and not exclusively with reference to geographical clustering. In other words, a database of queries by users A, B, C is maintained as a potential candidate set. As new queries are made, they are analyzed to determine if a query by new user D for a service/project can be clustered with similar services requested by users A, B, C.

As seen in FIG. 30J, the user addressed is determined at step 3081 during a computing operation (as noted for step 3051 above). A property report can then be retrieved during an operation 3082, again in a similar manner to operation 3058 identified above.

Queries from other users may be logged or cached by platform 3000. A first user U1 for example, may query “gutter cleaning,” and be presented with offers, including a cluster coupon Cl from a merchant M1 based on matching to such term. Again the cluster coupons may be created based on any desired merchant parameters, such as explained above in connection with operation 3053, 3055, relational databases 3053a, 3054, etc. In this instance, the merchant's cluster is either new (with no members) or is incomplete (meaning, it is can accept at least one more member beyond the current user). When U1 opts into such incomplete cluster (at step 3085) the merchant M1 creates a partial open cluster at operation 3086, using U1 as the proto member, or seed participant. From that point forward, platform 3080 generates an invitation to the user to opt in to the new cluster, and waits for additional users with similar needs/queries to finalize or close the cluster at step 3088. Note that there may be time limits and other constraints on the opt-in details imposed by operation 3088. A merchant for example may allow more users than the target nominal cluster size to be given the offering, on the expectation that not all offerees will accept, and to induce such users to partake before a cluster is closed. Accordingly a max user cluster offer number may be higher than a minimum or maximum cluster target size.

At a later time, a second user makes a query that is based on the same, similar, or semantically matched keywords to the earlier “gutter cleaning.” It can then be matched to the earlier prior queries at operation 3085 for purposes of identifying the second user as a potential partner in group cluster Cl based on parameters 3055 as noted earlier. Again, this would happen as part of operation 3088 until a max user cluster offer size had been reached, or the cluster is closed through redemptions. Assuming the cluster is open, an electronic invitation is then generated at step 3085 and sent to the second user.

Opt-ins and redemptions are monitored during operation 3057 to determine whether cluster Cl is finalized or closed. In this variant no property details from either user are required, per se, as the cluster logic simply uses query details to propose partner matching or clustering. This approach may be desirable in very lightweight embodiments where access to property reports, addresses, etc., is limited.

In another variant, during operation 3085 the second user is matched to other earlier users based on other factors, such as property details, address, prior cluster adoptions, etc., as described above in the integrated platform 3050. Note that in some embodiments, a user A may be included in more than one cluster at a time for the same project, until one of the clusters is closed due to is fulfilling the cluster criteria. The filling of the clusters may be based on a time based priority (first opened, first closed) or other factors such as a percentage of cluster completion (how many participants still required); the relationship of user A to other participants (social graph); a proximity between user A and the participants in the two open clusters; other merchant economics, such as a discount level offered to the participants, a timeliness factor, and so on. Those skilled in the art will appreciate that any number of different factors may be used to influence the generation, filling and closure of the inventive clusters.

FIG. 30K is an example of a visual cluster based coupon 3090 output by the algorithm above, and which presented to a homeowner for identifying merchants appropriate for their home improvement/service needs, as well as prospective neighbor/partners that could participate in a merchant cluster. Again this information can be presented in a web browser, or part of an app, or in some other graphical interface.

FIG. 30L is an example of a visual graphical cluster map presented to a homeowner for identifying prospective neighbor/partners that could participate in a merchant cluster. In this instance the candidates are broken down by identified or predicted need, preferably by icon, color or some other visually useful demarcation.

As alluded to herein, in mobile app embodiments, the user(s) may be persons observing or seeing a particular property P1 at a particular location in person. By selecting particular predesignated tags (paint, landscaping, roofing, doors, etc.), or providing customized query tags (“Where can I find this garage door”), those persons can be similarly matched and clustered with other users or homeowners looking for similar goods or services. In such instance the logic path for the mobile app user is slightly different, in that the property report can include not only the user's home H, but also the structure P1 being observed, to see if there is a potential clustering of such homes within a merchant's targeting parameter logic. Embodiments of the invention therefore facilitate matching homeowner needs better to merchant offers.

FIG. 30M shows real-world samples and demonstrations of the utility of is the invention(s) in assessing and identifying housing structures for potential home improvements/services. These three examples of real world homes show before and after pictures of roofing services. The pictures on the left are taken from an earlier version of image database (2010-2011), and were classified by an expert rating system (such as described herein, including with manual coding using the inventive interfaces) with roof structures that were in fair to poor condition. The potential for such properties as cluster candidates and targeted marketing therefore is readily identified. The pictures on the right indeed reflect remedial work performed on such structures, as confirmed from a permit database in 94301 and 94303 zip codes, and from the images themselves. In each instance, again, a newer version of an image database and expert coding confirms the condition of such features as good or excellent condition. Similar back testing using images of windows and their conditions reveals similar results, in that instances where such features were now deemed excellent, it was apparent from prior images that the prior structures were deficient. Thus the value of the inventions in identifying such conditions, good or bad, is easily demonstrated from these simple examples. The described methods have significant potential for identifying leads for merchants, real estate agents, etc. While the testing examples shown are for roofing features, it is expected that other types of projects could be similarly identified and confirmed from permit data.

### Property Tag Collection Modalities and Merchant Galleries

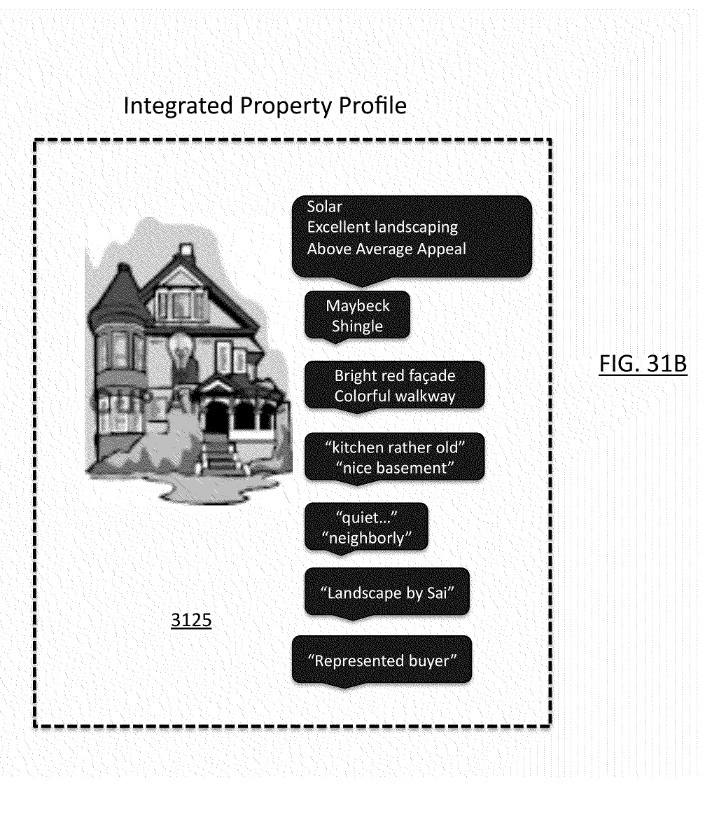

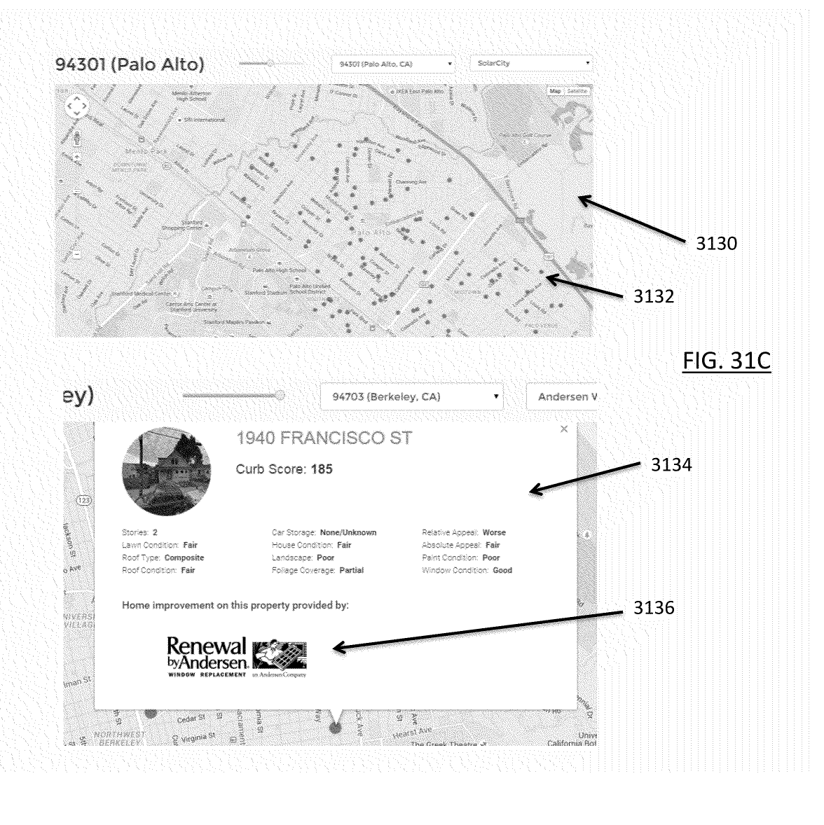

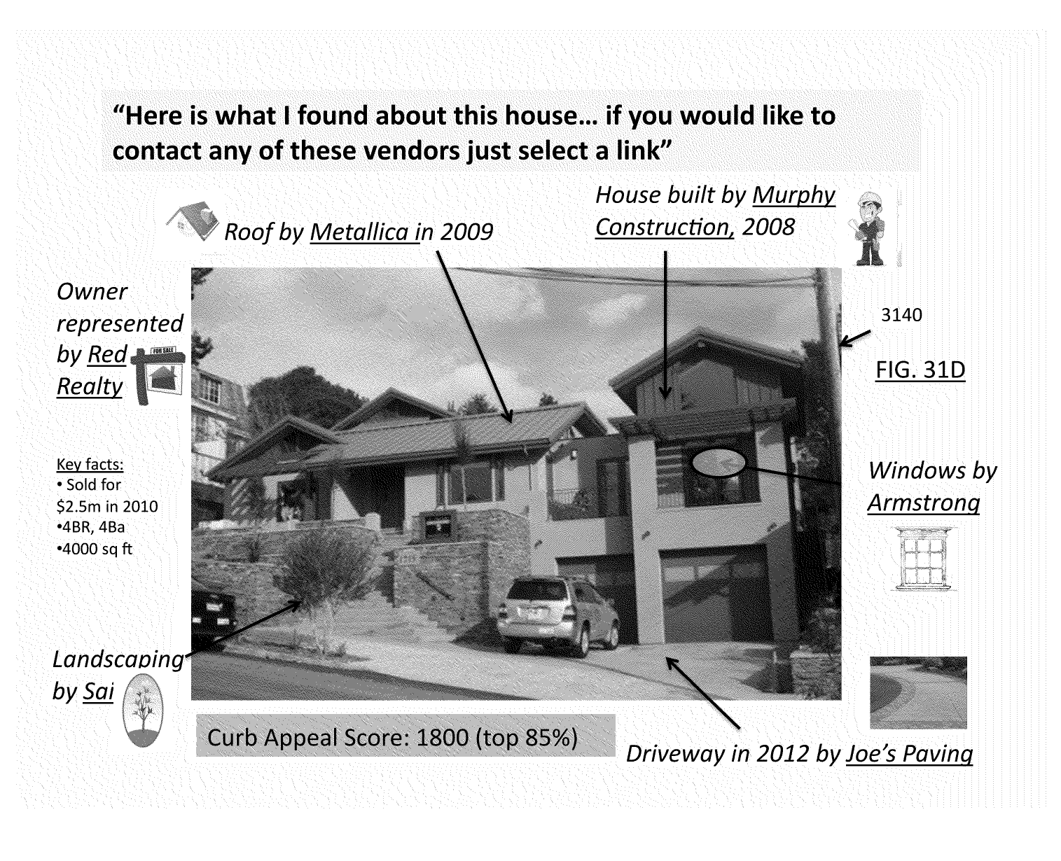

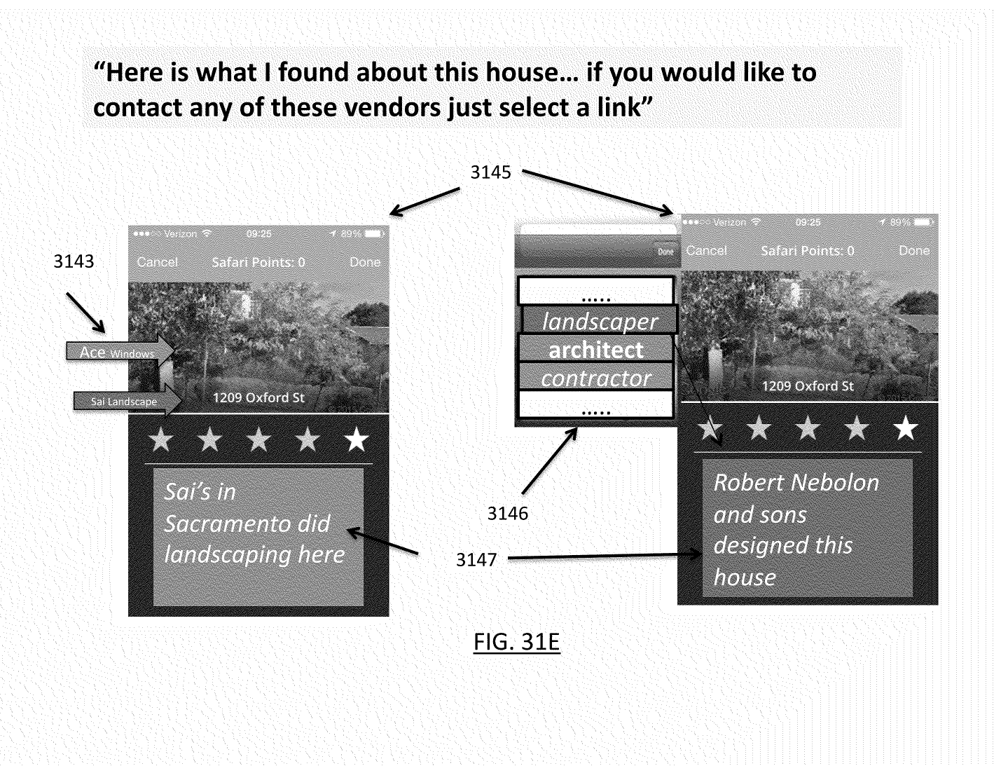

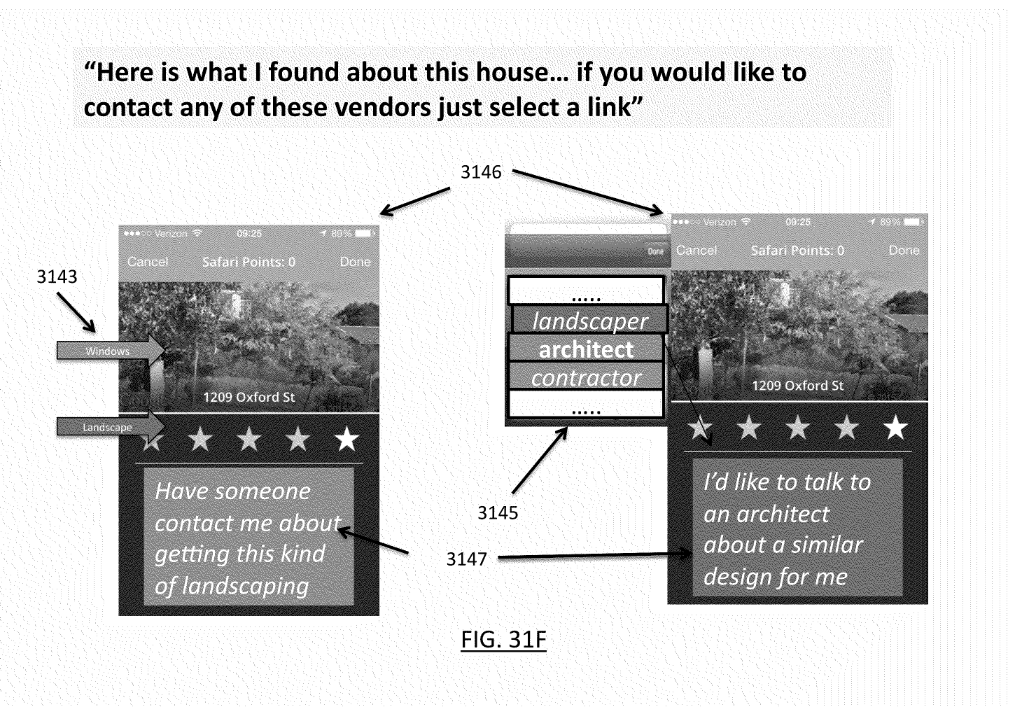

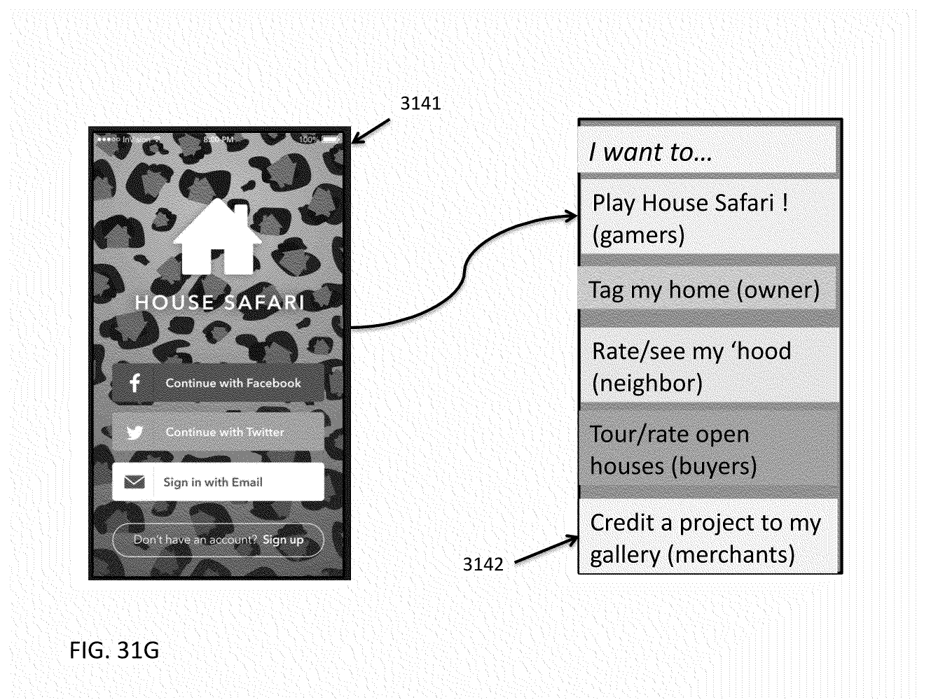

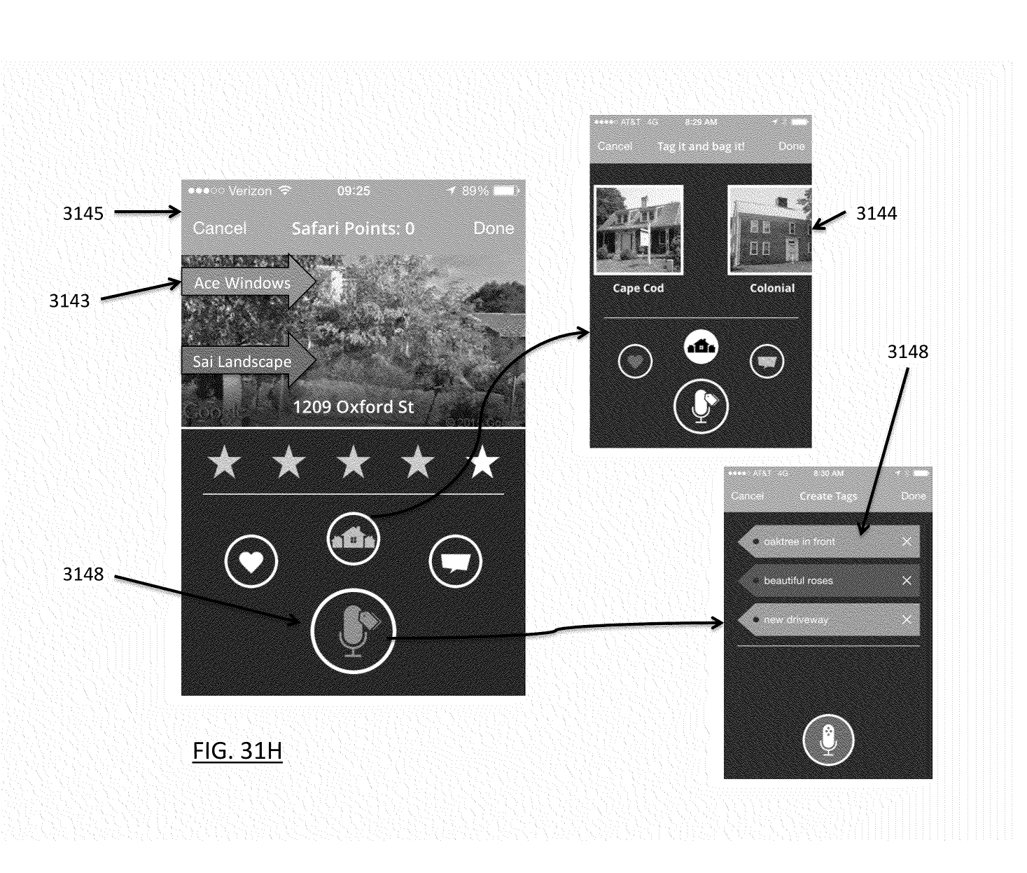

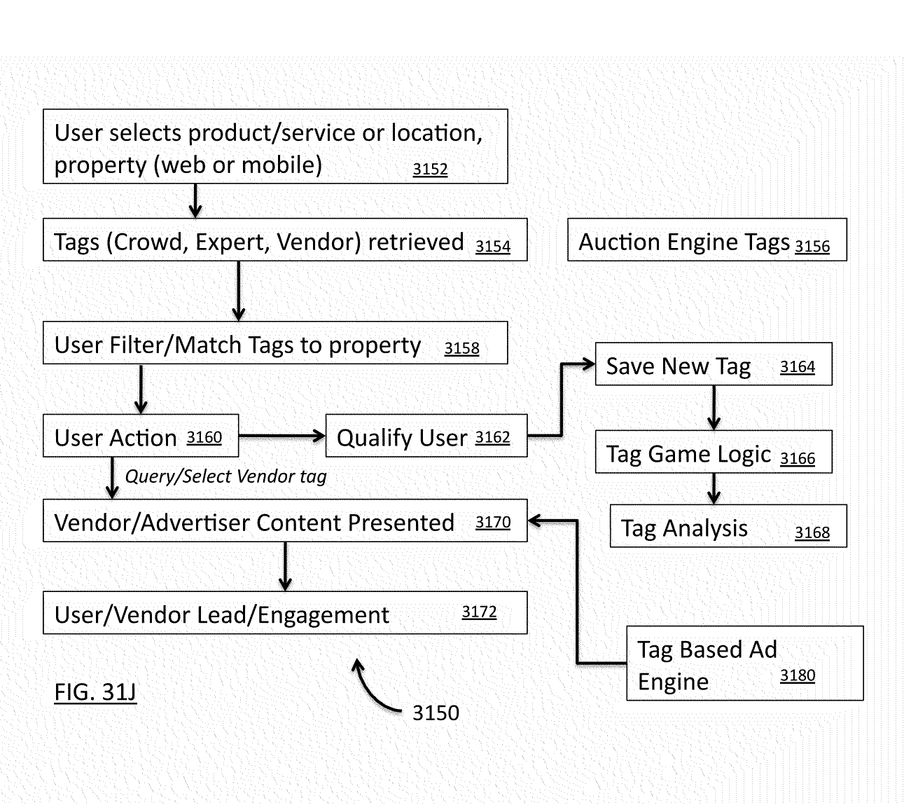

FIG. 31A is a visual depiction of different representative stakeholders participating in and contributing to an automated property tag platform through different modalities and interactions. Each of the identified stakeholders 3110 contributes different and unique content 3120 vis-a-vis a target property 3100, preferably in the form of short descriptors, or “tags” which may include text, images, or other multi-media content. By collecting different tags from different perspectives, a more comprehensive and thorough characterization can be made of the target property. These tags, along with other metadata, are preferably stored in a property record 400 as seen in FIG. 4, or part of a coding relational is database 1654 (FIG. 16) and other locations as need by the routines described herein.

For example, a variety of tags may be solicited and created from stakeholders 3110, including:

1. Structure coding Experts: a feature scoring engine automatically creates tags for properties that were expert coded with precision using the interfaces noted above;
2. Game/passerby tags: mobile app users can free form tag properties as they observe them in person as part of a game or for general interest; these users can provide additional visceral descriptors such as “colorful walkway” or “impressive tree” and so on; such persons may also ask questions (as seen further below) to obtain crowdsourced feedback and answers from other users of the platform, or from other stakeholders (i.e., a commercial nursery merchant may respond);
3. Homeowner tags: a mode by which homeowners add tags through a mobile app (and by web) about their property, neighbors and neighborhood characteristics; to improve data quality this mode is preferably subject to verification to ensure only an actual property owner is providing input; this allows homeowners to contribute structure specific tags such as “Maybeck” or “shingle” based on their first hand personal knowledge of the home; owners can also provide other general information about themselves, including interest tags which identify their individual interests in hobbies, recreational activities, music, sports, food, etc.
4. Neighbor tags: a mode by which users add tags about neighbors, neighborhood characteristics and a neighbor's property; for example a user may indicated that the street is noisy, or that the occupants of a home are “quiet” or “neighborly” and so on; again preferably this mode is subject to verification to ensure only actual neighbors are contributing input; In addition, to protect privacy and ensure data quality such tags may be subject to temporary “quarantine” before being published to any platform. In such state the tags, content, etc., can is be programmatically or manually scanned for improper or offensive material. Furthermore, to enhance privacy of participants, individual items or tags may be published randomly, intermittently, or in drips to prevent association with particular persons. In other words, if persons P1, P2 contribute tags {TP1A-TP1m} and {TP2n-TP2z}, the information can be published randomly over time on the platform, interleaving participants and tags. As an example of a time sequence of postings: TP1a, TP2n, TP2p, TP2q, TP1b, etc. Other forms of randomization and anonymization will be apparent. Note that the collective, neighborhood wide data may be available in aggregate form for determining and presenting neighbor scores, even as individual items are kept back or left unpublished. Furthermore, neighbors may contribute tags identifying their individual interests, their neighborhood interests, etc. For example, a neighborhood may have interest in sports, bbqs, movies, etc.
5. Home Shopping tags: a mode by which prospective home buyers rate/visit properties during open houses, preferably through a mobile app; a user may peruse the property online, or in person at an open house, and contribute information such as “kitchen is old” or “nice basement” and so on from their first hand impressions; as with other modes, this is also to verification to ensure only people physically present at the address can provide input;
6. Agent tags: a mode by which agents provide tags to homes through either/both a mobile app or web interface; for example an agent may contribute a tag indicating that they acted as the representative for the purchaser/seller of the home or provide a “wish” tag asking that they be considered as agent for such property; as with other modalities, this can be made subject to verification to make sure an actual realtor is providing the tags;
7. Home Improvement Professional Tags: a mode by which professionals (contractors, architects, product/service suppliers, home improvement merchants) add tags to home through either/both mobile app or web interface that has onboarding capability; In simplest form, two basic kinds of tags are described herein: a) “portfolio” style, which acts as an extended billboard for merchant's work; b) advertising, which again acts as a type of wish tag to be is considered for work for a specific type of product/service or feature; as with other modalities, this may be made subject to verification to make sure an actual professional. In some instances an app can be operated in a “live” mode so contractors can instantly get credit for their work as they complete a job.
8. 3P informational data/tags: data can be pulled from Walkscore, Zillow, permits from public agencies, and other public sources to be overlaid on a property canvass in the form of tags.

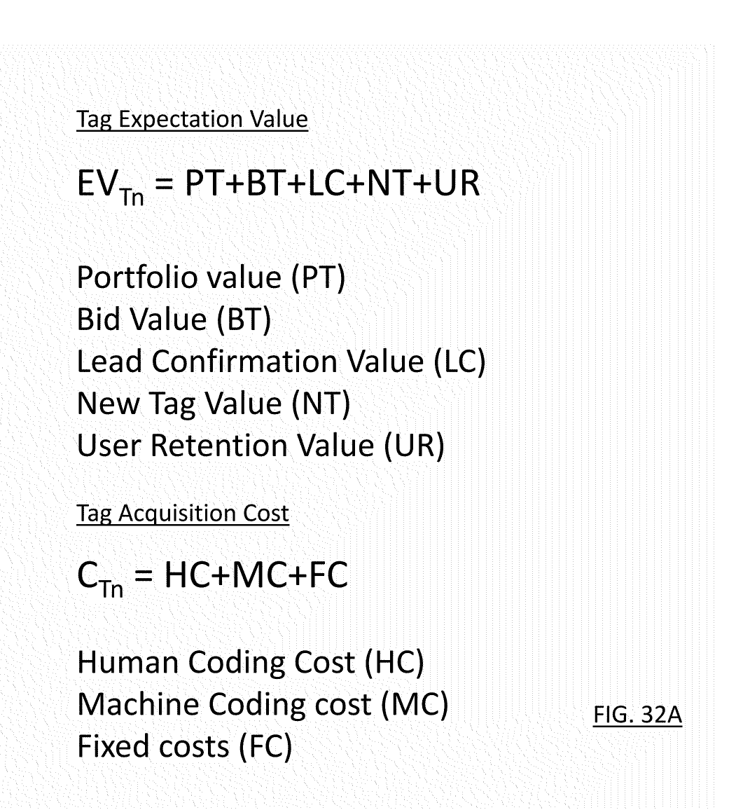

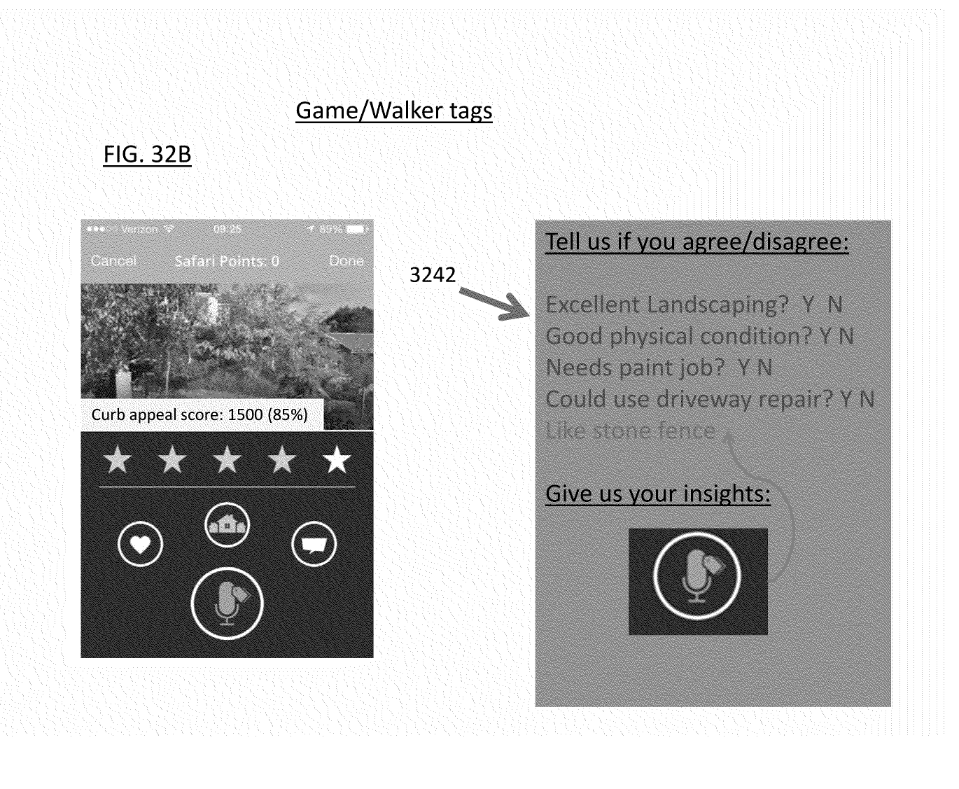

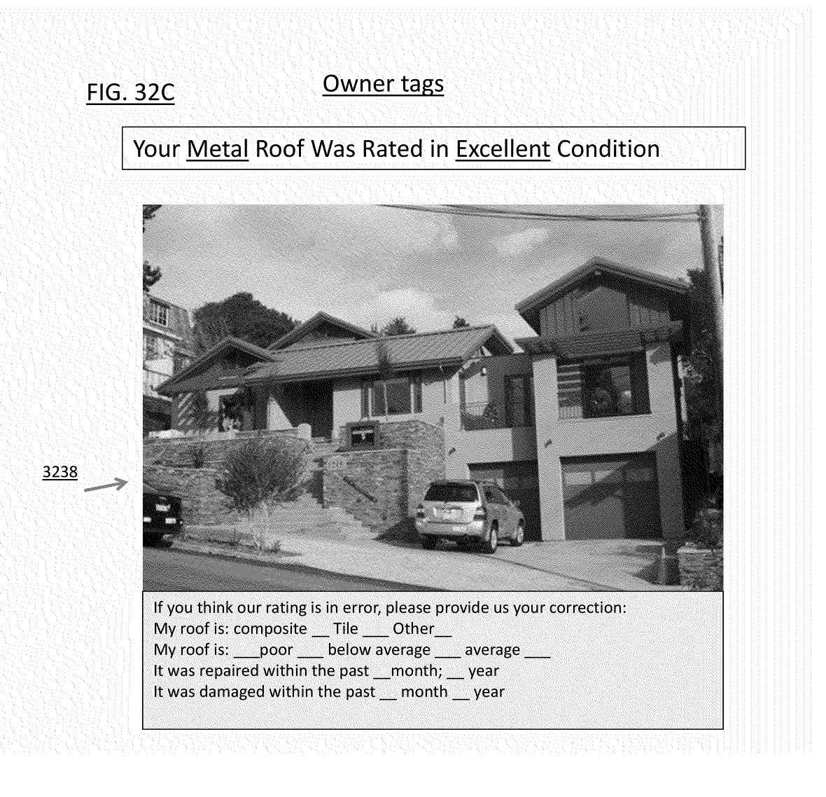

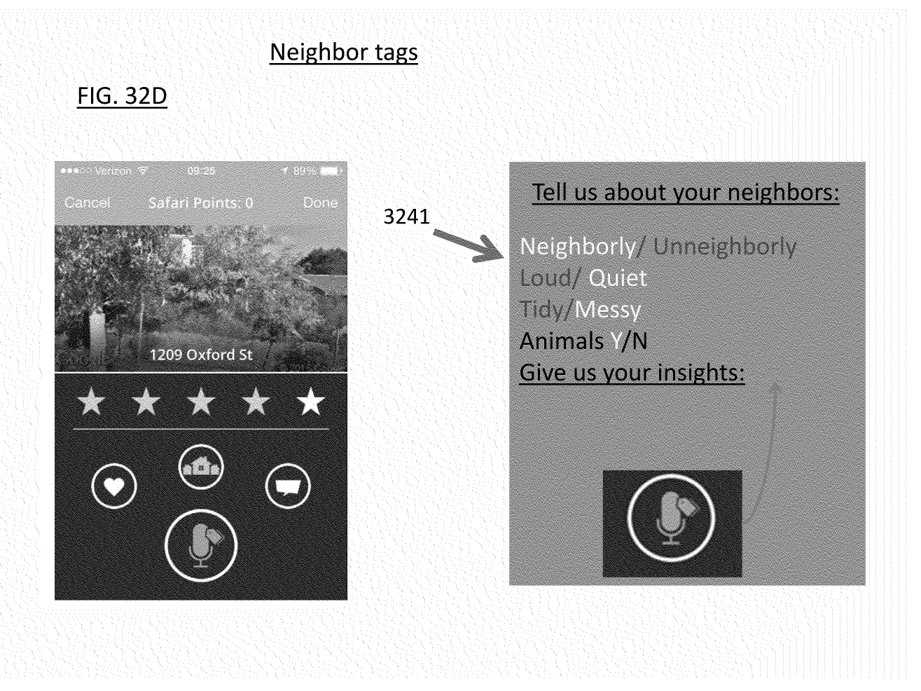

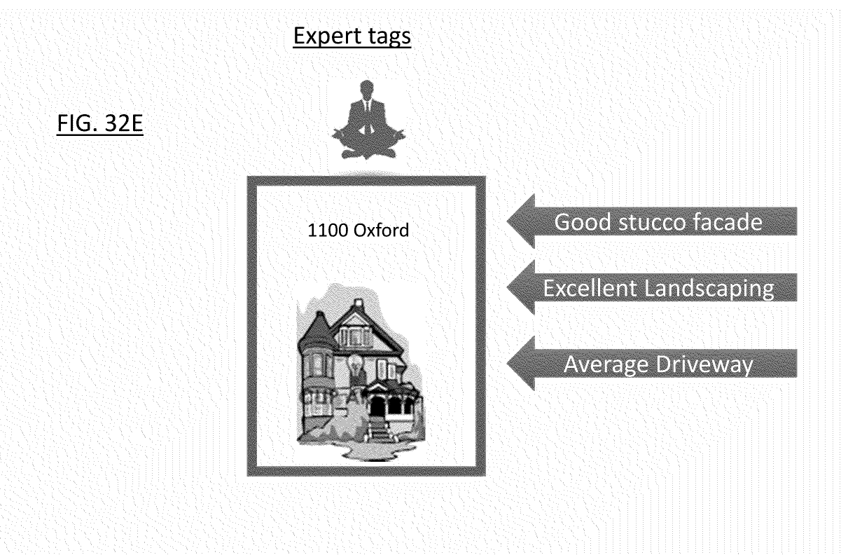

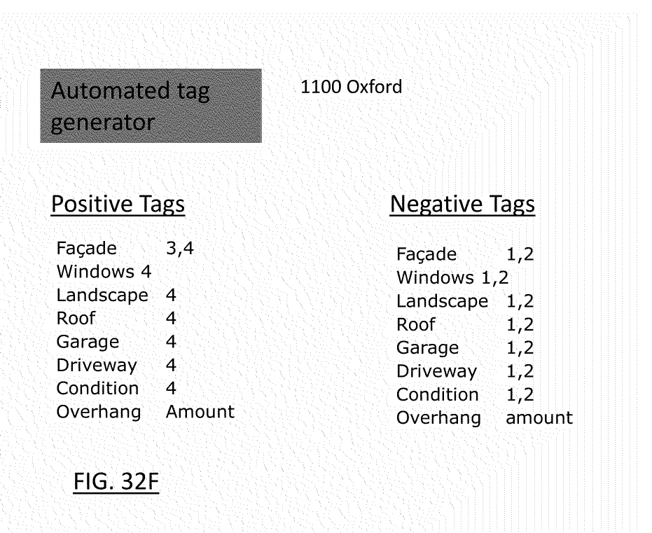

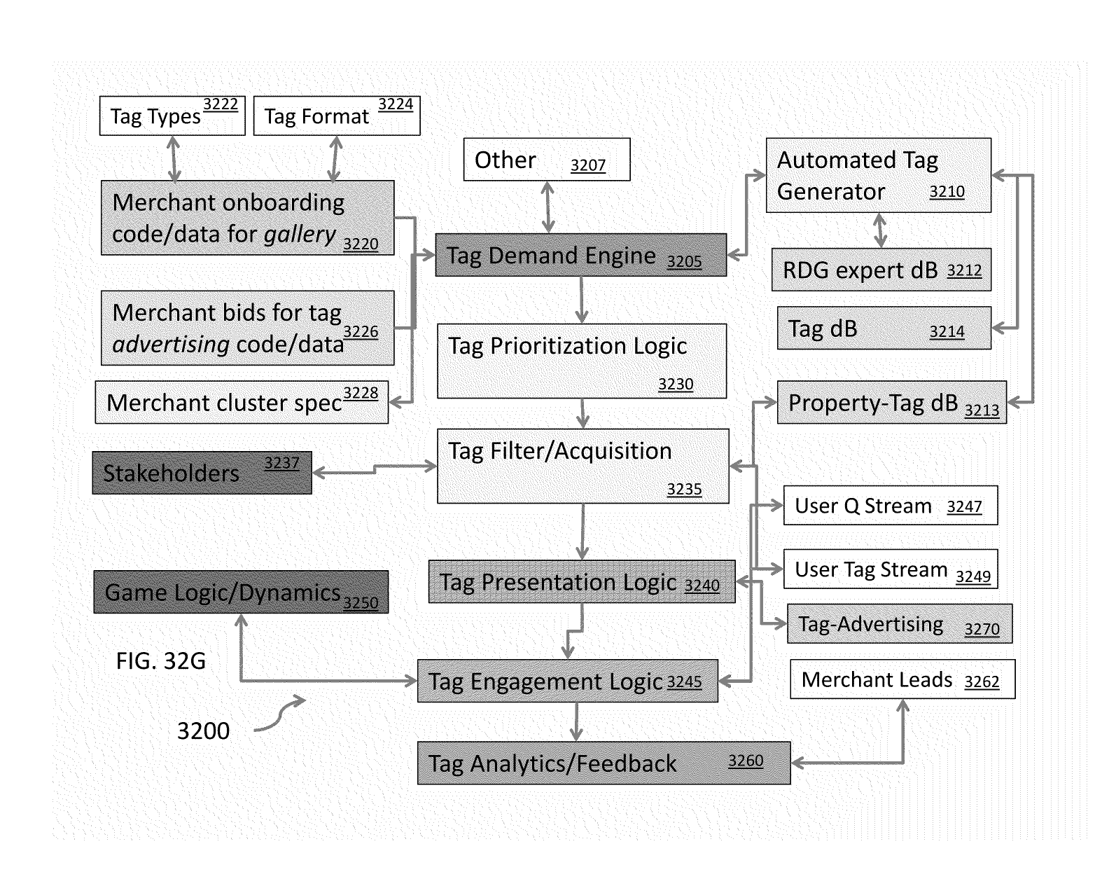

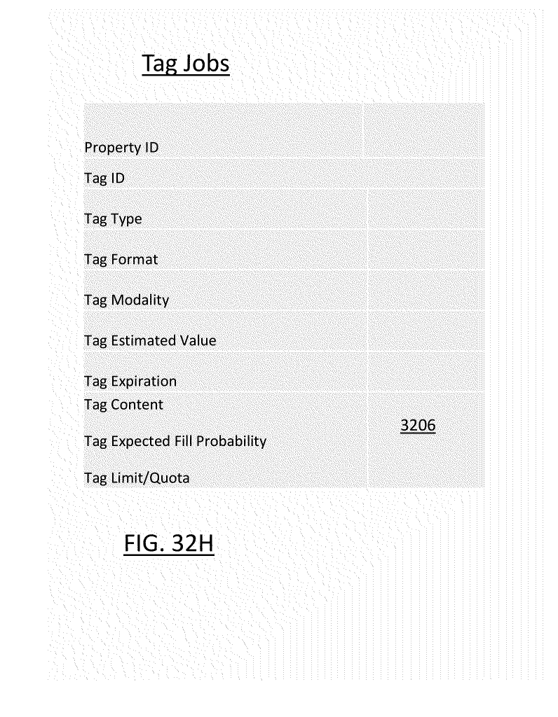

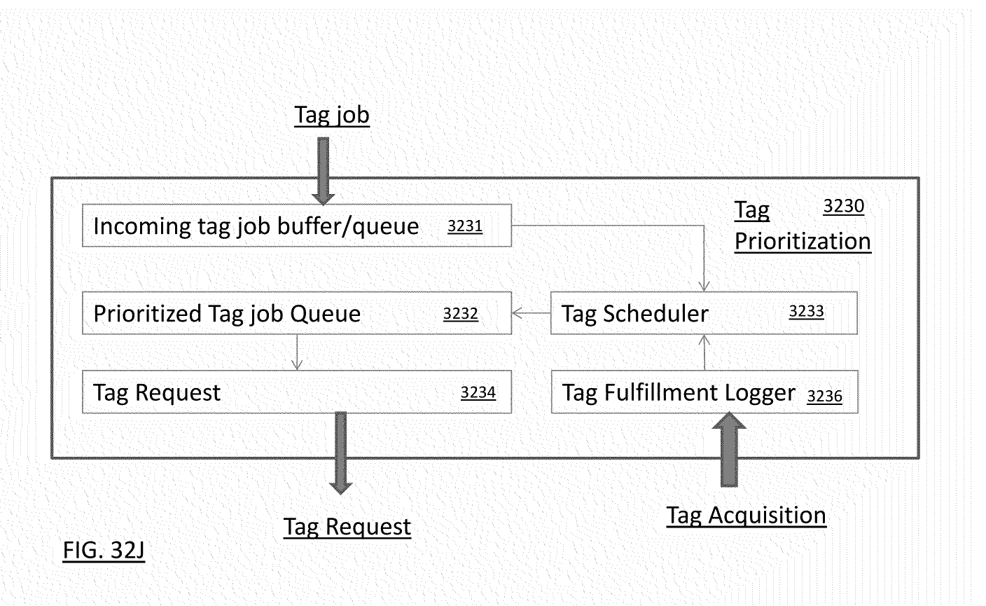

These are but examples of course and the embodiments described herein permit any manner of free-form descriptors to be applied to properties to assist in their characterization and depiction. Specific types of tags are also described below and shown in FIGS. 32A-32E.

The result of this collection of tags is shown in FIG. 31B as a visual depiction of a representative record 3125 of different tag types associated with a target property (as may be stored in a record 400). This tag record 3125 for each property 3100 is then compiled into a relational database, including for example as part of metadata db 1654 (FIG. 16) and record 400 (FIG. 4). The aggregate combination of such integrated property profiles, taken across all properties, defines a virtual gallery or platform of property descriptors or tags that can be explored and exploited to drive commercial engagement with users. Again while text descriptors are shown here, it will be understood that images and other data can be associated as tags with the property 3100.

In a preferred embodiment, each property can have one or more available tag slots, one for each type of stakeholder who can contribute information. In some instances, as in the example of craftsmen, a property may have multiple merchants slots which correspond to tag subtypes. This can be done to accommodate different disciplines so that a property can have a facade tag slot, a roof tag slot, and so on.

FIG. 31C shows a graphical web or mobile visual map generated by embodiments of the invention, in which merchant property tags are presented in a virtual property gallery. Embodiments of the invention allow merchants to amplify word of mouth or expand their presence by tagging individual homes is within a set of properties at any geographic location. These gallery tags effectively act as virtual billboards for the merchant in an online realm.

Thus, when a user makes a query for merchant “Solarcity” projects in zip code 94303 for example, a map interface 3130 is generated with icons, symbol or other graphical indicia 3132 to denote jobs or projects tagged by such entity. Selecting any one of these identified dots in the map causes a more extensive record to be presented, including with details of tags 3134 for the property as well as merchant information 3136 which may be in the form of advertising, logos. Again other information can be presented as well as desired for any application. Notably the Solarcity credits or adoption in FIG. 31C (which are limited to only a recent time period of less than 2 years) can be seen to be naturally clustered in proximity to each other. They are not entirely randomly distributed as would be expected by normal hiring based on probability alone. This validates one of the premises of the present invention, namely, that neighbor word of mouth (or neighbor exposure to a merchant's work) and similar local factors can influence adoption and induce neighbor peers to retain a particular merchant for a particular job. By increasing an exposure of a merchant to neighbors (through identifying other likely candidates in a neighborhood for example), word of mouth can thus be accelerated and amplified.

FIG. 31D shows a graphical web-based visual house profile generated by embodiments of the invention, in which merchant property tags are presented for a target property. Again for any property 3140, a rendering algorithm retrieves house image data, house tag data, merchant data, etc., from the relational databases described herein and assembles the same into a visual collage. The rendering may create and present annotations, labels, arrows etc. to accent and emphasize the key features of the contributions of the merchants. As noted above, each property can have multiple slots for merchant tag subtypes, and these slots can be coded to be presented in distinct regions for simplicity.

The merchant tags are preferably arranged in a frame format to permit easy visual identification and correlation to the property. In other instances merchants can also be given software tools (such as the coding interface and is tools described herein) to add their tags directly to a property through manual tagging. Other information, such as a house curb appeal score, can also be presented if desired. As indicated in FIG. 31D, the tags are preferably implemented as active links so that other merchant/vendor data can be presented by simply selecting one of such links.

FIG. 31E shows a first variant of graphical mobile app interface generated by embodiments of the invention, in which merchant property tags are selectable and presented for a target property within a mobile device for a user's convenience. A graphical interface 3145 presents house images to user to permit such person to contribute or view tags 3143 associated with a target property. Using conventional geolocation routines on a mobile device, the system detects a physical location of the user, bring up maps with nearby properties, and allows the user to select a target home. Again this interface complements and augments the capability described above in connection with the web-based approach seen in FIG. 27B.

The tags may be presented on the screen directly in the form of graphical icons which expand visually to provide additional information, such as shown in a designated portion 3147 of the interface. As noted earlier, the tags 3143 may also include active links which permit a user to access additional merchant data, either through the app, or through a browser. The tags may have three dimensional touch features as well, so that additional data is presented in response to additional pressure, contact time, etc. To make the task of viewing tags easier within a small mobile display, different types of selection filters 3146 can also be employed so that only tags related to such service are activated. In the example shown a picker wheel is used, but it will be apparent that other forms can be used as well.

FIG. 31F shows that the interface of FIG. 31E can also include a modality in which users are permitted to make inquiries about specific features and/or tags associated with a property. A typical use case for this will be when the user sees a property online, or walking by, and pulls up the house in question. From there the user can make inquiries in the form of free descriptive text tags, or from predefined text messages (“I would like to talk to the architect of this home”) and so on. Again FIG. 31F merely provides exemplary details and it will be understood that the particular data and format can vary according to application, platform, etc. For example, while not shown here, it will be apparent that the other tag slots for other stakeholders (owners, neighbors, etc.) can be presented and populated for visual review.

FIG. 31G shows an entry screen generated by embodiments of the invention for selecting different modalities of tags, in which property tags are input and output based on a profile/type of a mobile app user and a selected modality. In this instance, a mobile interface 3141 presents options 3142, one of which is to allow a merchant or vendor to “credit” a project to their respective business galleries. A virtual business gallery, in this case, refers to a virtual domain which contains properties as objects and permits merchants to tag or credit such locations as clients, jobs, etc. In mobile form, this allows a merchant to associate a structure with a project in the field, so that it can be seen immediately. For example a painter may finish completing a house, and then tag the property, along with text, other images, to identify the type of paint, the name of the vendor, and so on, for perusal by other users. A landscaper may tag a prominent tree, or lawn fixtures, etc. This makes it easier for later users of a mobile app to discover and research home improvement professionals and items in the field, and at times when they are most likely to be psychologically receptive to advertising, or when they are most likely to be making a decision regarding a home improvement service or item.

FIG. 31H shows an entry screen 3145 generated by embodiments of the invention for inputting different types of tags and metadata for a target property. As above when a property is selected, a mobile user can contribute tags 3143 through different input modalities 3148 including through dedicated activatable icon/buttons. As shown for example a house icon brings up a selection of architectural types 3144 that can be designated by a user. This allows persons with knowledge of housing styles to contribute their insights on such properties. Selecting a heart symbol allows the user to designate the property as a favorite; is a gold star rating bar allows the user to input a graphical rating, and so on. Of particular note is microphone button which then activates a speech recognition (SR) routine which is preferably native to the device. The SR routine (which may be based on SIRI for example in an iOS implementation) permits a user to vocalize short, fast tags which are decoded into text descriptors as shown. The tags may be stacked, added, deleted, etc., as shown. This free form addition of content allows for rich, free form contribution of important, salient features of properties from persons who are experiencing and seeing them first hand. Because of the lightweight aspect of this input modality, user-contributors can add substantial feature content very quickly as they perambulate a neighborhood. Again it will be understood that the types of buttons, data and format will vary according to each device and the embodiment is intended merely be exemplary.

FIG. 31J shows a structure and general flow of an algorithm 3150 that presents and collects tags to a user within a mobile or web interface. A user selects a property at step 3152, or a particular desired product/service. In the latter case for example, a user may inquire about examples of “excellent windows” in a particular locale.

At step 3154 db 1654 and other relevant property records 400 are queried, to retrieve a set of relevant tags that match the user query. In a preferred embodiment, all forms of tags from all stakeholders (experts, crowd, merchants) are retrieved as candidates. In the case of a particular property of interest to the user, step 3158 filters the tags accordingly to match the user's specific intent for property-specific tags.

Of particular note as well is that “auction” engine tags 3156 may also be presented to a user in connection with a query to a specific property. This auction may be conducted in a manner similar to that conducted for general keyword auctions by ad serving engines, and/or in accordance with the discussion above for FIG. 22, FIG. 25A and FIG. 25B. For example, a merchant may request that their tag or ad be shown to a user looking for a specific tag, or a specific product/service on the present platform. These auction tags may be used in is conjunction with, or in lieu of merchant gallery tags when none are available at a particular property that is unclaimed. For instance, a user may walk or drive by a property, and make a note or tag about the landscaping. In the absence of (or in addition to) a merchant tag claiming the property in question, a different landscaping vendor can present an ad or tag to the user, indicating that they can be contacted for such product or service. This type of tag can fill out or supplement an existing gallery of tags to enhance usability, interest, etc.

The tags may then be presented to the user at step 3160, along with the input screens noted above to receive user-contributed tags as well. An action by the user is identified, such as entering a tag, selecting a tag, or some other form of query about the property or feature thereof. In the latter case, at step 3170 content for a vendor gallery/credit tag (see tags 3143, 3147 FIG. 31E) or auction tag (see tag 3147 FIG. 31F) from a tag based ad engine 3180 is presented to the user. The user's engagement is then registered at step 3172 and used to drive leads to merchants regarding the user's expressed intent. For example a landscaping company may receive leads from (and information about) users who selected at any form of landscaping tag, regardless of whether the tag was their own gallery tag. The leads may include the user name or email, an address, a location where the tag was selected, what other tags were examined, and so on. Other types of information can be presented in the lead as well.

When users opt to contribute tags, an optional step 3162 is performed, to quality their input. For example, only certified expert raters would be eligible or qualified to contribute certain types of house specific expert ratings. Assigning or crediting realtor tags may be restricted to only registered realtors. A tag about the characteristics of the neighbor, or neighborhood, may be restricted to actual verified neighbors. In the case of a walker/passerby, free form tags or game tags might be enabled only when the user is detected in the vicinity of the property in question. Other examples will be apparent, and in each instance where a different tag type is involved from a different stakeholder customized qualifications may be imposed to ensure data integrity, quality, etc., including as described above in connection with FIG. 23 (owner, tenant verification).

The tags are saved at step 3164 in a metadata db as noted earlier in any convenient form. In the event of a tag generated as part of a house search/rating game contemplated herein, game logic 3166 can credit the user tag and update their game stats/performance. For example a user may be requested to tag 5 different roofs in a particular neighborhood that he/she believes are in need of immediate repair at least in part. The number and quality of tags provided by the user may be logged, and so on. Other examples of course are apparent.

At step 3168 the tags are preferably analyzed. If they are free form text descriptor tags for example, a natural language routine (not shown) can be employed to identify and map the content to specific house features, specific products/services, specific merchants, and so on. The labelling of the tags and their correlation to such other entities, features can be done with a number of different software tools known in the art.

### Property Based Tag System Architecture and Processes

At a high level the present tag based architecture can be considered to include a number of fundamental interworking parts, whose structure and operation are described in more detail below. Generally they include a few main interacting components:
a tag “demand” engine;
a tag “prioritization” engine;
an automated machine tag “creation” engine (primarily for expert or automated classifier data)
a tag “acquisition” engine; and
a tag “fulfillment” engine

At a basic level machine tags can be based on some target demand parameter. The creation of tags, even if by humans within the present architecture, is preferably not left entirely to complete random selection by human game users, but, rather, should also be driven by “demand” as determined for example by needs of home improvement professionals in the virtual merchant ecosystem. This should result in maximum utility/gain for each tag created and presented in the house gallery.

Thus, a demand engine looks at competing factors such as these: 1) demand from N (e.g. N=100) paint companies asking for paint information offering an average of X$ for each lead; 2) M (e.g. M=10) lawn vendors who offer Y$ per lead, where Y>X. In such scenarios, an aggregate sized market from the vendors for different tag types can be calculated as N*X and M*Y. By sorting total market sizes by tag, a demand engine can determine which tags have a greatest demand, and thus which should be solicited by system 3200.

At the same time, tag creation or capture rate is constrained or is limited (meaning that it may not be possible to generate sufficient tags for N different companies), so an average $ per tag can be a useful metric as well. Thus, all things considered, when Y>X, and a tag generation/acquisition rate is small, it may be more advantageous to focus on higher return per tag.

Using such dynamics, or a combination thereof, a “paint” tag creation/acquisition may be selectively driven or prioritized over acquisition of “lawn” tag creation/acquisition both programmatically and human wise. In this approach the demand from vendors can thus drive the tag creation process. Because of the rich expert data set collected, and support from crowd sourced data, a vendor can specify single features at first (“I want leads for customers with poor or below average paint”) but can be refined later to more complex situations (“but they should also have above average landscaping”).

To further the process tag “demand” engine also needs to talk to and coordinate with prioritization logic. This allows the tag creation/acquisition process to be fined tuned based not only on determined demand needs of professional suppliers but other system goals. For example the prioritization logic might use something like “information completeness” within a particular geographic region or neighborhood as a ranking factor for tags. In other words, other parameters that serve an important purpose, such as data completeness, data confirmation, data accuracy etc. can be drivers as well. This can be used to confirm machine tags are accurate by soliciting solicit human feedback.

Consequently a machine tag creation engine pushes out tentative automated tags to specific properties based on expert coding data, or an is automated classifier's identification of features. While less constrained, again the creation of machine tags is preferably based on some kind of “demand” characteristic. Thus, each property in a region can be automatically assigned machine specified tags that can be tentatively pinned to each property.

A tag acquisition engine then uses the output of the demand engine and solicits/acquires tags from users playing a social game, from paid data collectors, or simply volunteers based on these parameters. A fulfillment engine then determines how the acquisition process is performing in terms of satisfying the demand/acquisition process, by analyzing different metrics such as a tags requested/acquired ratio, broken by subtype, region, etc. The creation, output and use of tags is thus monitored to identify hot neighborhoods, hot topics, etc. within differentiated demographic groups. Merchants and other interested parties can then get customized reports on tag based leads, including as discussed above for FIG. 24 for example.

FIG. 32A depicts generally the parameters and calculus associated with the inventive property tags of the present invention. Preferred embodiments of the invention start off with a premise that a tag is a unit of engagement content. Another premise is that the engagement algorithms should focus on creating and presenting tags that have the most value within a mobile app canvass both to users and merchants in the virtual gallery system.

As noted, a value of tags solicited from the stakeholders can be measured according to a number of metrics, some of which are more straightforward than others. An expectation value of a tag can be calculated approximately by several factors, including:
1) Payment by a merchant to place their portfolio tag (PT) on a particular property to credit it as part of their gallery; (“I will pay $1 for my virtual sign tag to appear on the property”);
2) Payment by a merchant to place a bid tag (BT) on a property for a particular feature (“I will pay $1 if someone wants to find a merchant who can do a roof job like that shown on the property”)
3) Value of lead confirmation (LC) of tag; for example when a tentative is automated tag is generated for a property such as “needs paint”; embodiments of the invention can ask a mobile game user “please confirm/reject.” The verification of the tag's accuracy has value because it confirms it as a possible lead value. Since clustering is employed in embodiments as well, this confirmation can have great value in such applications as well. For example if a vendor implements clustering (“I will give a 20% discount if 3 people on the same block do a driveway”) and the system already has confirmation that two people need driveways, then finding a third prospect is extremely valuable.
4) Value for potential for new tag (NT) generation: the existence of a tag describing a feature of a house drives engagement as it is more likely to cause a user (including a homeowner) to add his/her own than if there is nothing there at all;
5) Value for user retention (UR): adding a tag for a person, or on a particular property, increases the chance that the user will continue to play in the game and contribute content—this mechanism can reduce churn and help to keep people in a ratings ecosystem/game as contributors

These are but examples of parameters that can be used to derive a nominal tag value, and others of course can be employed. In some instances of course, a weighting or separate probability factor can be incorporated as well to account for both the likelihood of a tag being input by a user and/or selected by a user after it is created and placed in the platform. Both events can be independently modelled after sufficient data is captured to provide better insights and drivers into a tag collection/presentation platform.

A principal tenet, therefore, is that a tag generation/presentation process, if driven by demand measured by merchant requirements, should increase an overall economic value and attraction of a virtual platform. Against this expectation value must be weighed the cost of acquiring the tag; including namely, the human coding time (which is a function of the difficulty of identifying the feature, or production rate)+machine coding costs (if tag generation is automated)+various fixed costs (what one must pay for acquiring images for is analysis and the like). The tags help to define a virtual merchant gallery that can be explored by users interested in properties, home improvement, etc.

Embodiments of the invention therefore can be seen as taking existing articles (physical properties, work projects, property multimedia content (including image files) etc) and transforming them into (or rendering new) virtual variants which include tags, annotations, labels and other features that are useful to merchants and other stakeholders. Analysis is made both of physical objects (through captured data) and virtual objects to identify, assess and rate properties.

In general, therefore preferred embodiments consider tag value and cost parameters in determining what, how and when to generate or acquire specific tags for specific properties. These decisions drive engagement logic that then interacts with appropriate stakeholders to complete a tag creation process.

FIG. 32B is a depiction of a mobile app property tag screen interface generated in accordance with the present teachings configured for inputting gamer/pedestrian/volunteer tags/metadata. Game tags identify attributes of properties and streets/blocks as part of participating in a game, or as a volunteer. These tags can be contributed as part of a mobile game, but can also be used by other services provided within a mobile app, such as part of a home buying diary or part of a home improvement services query system. These tags serve many purposes, such as to supplement expert data, engage/entertain gamers, inform home buyers, home improvement shoppers, etc. They can be used by home shoppers as a diary or review tool as they attend open houses. Home improvement shoppers can search the tag dB to find homes meeting certain profiles (are crowd favorites, etc.) Mobile tags can also drive marketing to homeowners after a sufficient quantity of data about a particular house has been accumulated, such that particular properties can receive crowd awards for such things as most tagged, most popular.

As indicated above, it may be desirable to constrain a game rater to actually be in the proximity of the structure, but it is not strictly necessary. For gamers, we prefer to prioritize tag collection based on demand for certain products/services and/or particular properties.

Examples of game tag drivers:
a paint company is looking for leads in 94709 and pays a subscription for promising leads matching a particular profile; a game app on the mobile phone creates a house “Safari” that focuses on prompting—asking specific relevant questions (“Does this house need paint”) or confirmations of those kinds of tags, to identify useful leads;
a house goes on the market and has an open house (which we can be determined by reference to online listings); the mobile game app thus finds and drives gamers for information about that house as part of a Safari. (“Tell us about what you liked or didn't′ like in this house”)
a house has permitting activity, indicating work at such location; finding and predicting other houses in the vicinity which could benefit from similar work from a merchant could lead to additional jobs; such data can also reflect potential sales activity (preparation for putting a house on the market) which may be useful to a realtor merchant;
a review of the expert or machine coded relational database reveals gaps on many streets because of lack of data (e.g., house is too hard to see) or it is desired to confirm some automated rating tag (poor paint). The system directs gamers there to acquire info that would be otherwise missed and/or to maintain freshness/currency (“Tell us about what condition this house is in”)
It is determined that users ask about or engage with game questions pertaining to a particular house feature with a high frequency. This means it is a hot topic, so data collection is tailored to focus on that data with prompts. (“Tell us about the landscaping at this property”)

The examples of questions and tags 3242 presented in FIG. 32B are merely exemplary, and it will be understood can take any form supported by a mobile interface. Other types of questions can also be presented in a gaming modality:

| | | | |
|---|---|---|---|
| Street has: | light to no vehicle | medium traffic | heavy traffic |
| | traffic | | |
| Street has: | Light to no | Medium traffic | Heavy traffic |
| | pedestrian traffic | | |
| Street Noise | Light to moderate | Medium | Busy |
| Street Vagrants: | Few/many | Benign/aggressive | |
| Street Parking | Little/ample | | |
| Street Trash | Clean/dirty | | |
| Street Trees | Ample/barren | | |
| Street housing | Older/Newer/Mixed | | |
| Street Lighting | Good/poor | | |
| Street Smell | Pleasant/Unpleasant | | |
| Factors? Trees, | Garbage, decay | | |
| flowers | | | |

Again these are examples and others will be apparent to those skilled in the art from the present teachings. It is expected that gamers and volunteers will be induced to contribute content, ratings, tags, etc, as part of a game competition, rewards, and similar recognition. Also, some individuals enjoy mapping out their neighborhoods and identifying features of interest. In addition gamers and volunteers can opt in to see alerts identifying new contributors, ratings, etc., provided in the platform or in a specific region. It should be noted that embodiments of the invention improve on prior art online computing processes which purport to assist home buyers for example in finding appropriate housing stock. Such systems, as alluded to earlier, provide basic statistics such as crime scores, walkability scores, etc., but they are derived from second hand data, and not first hand percipient knowledge. In other words, they typically rely on accessing a third party database to identify publicly known information, such as police reports, sales reports, etc. The accuracy of such systems is thus improved by implementing the present teachings, wherein information from first hand observation is incorporated and analyzed as well. Moreover, unlike prior art survey approaches, the present data capture can occur at any time (i.e., is not constrained to a telephone call or paper survey), is dynamically and continually updated with new information, and is visible in real-time for all interested persons to observe.

Other stakeholders who can contribute tags and content of course are the property owners themselves. FIG. 32C is a depiction of a property tag screen interface 3238 generated in accordance with the present teachings configured for inputting home owner tags/metadata. In preferred embodiments a user's status as an owner is verified first using one or more techniques as disclosed herein.

In addition to general tags identifying content about their homes, the owner may be presented with one or more selected features or descriptors, to solicit their input or feedback. In the example given, the owner is informed that the expert rating of their metal roof was excellent. An editing section is provided in the interface to receive corrections, edits, etc.

Like the game/volunteer tags, owners may input information in free form or predetermined labels. For example they can identify who did work on their house, to credit a vendor. This, too, acts as a form of virtual sign or endorsement that may be valuable to merchants. Homeowners can thus utilize a combination of text and spoken input to identify such information as:
I have check off boxes: solar/pool/ . . .
My windows came from: {ABC}
My doors came from: {DEF}
My contractor was {Bill A}
   and so on. These can be considered “brag” tags in some instances as owners will want to associate their property with well-known merchants having a reputation for solid work. Owners are also induced to contribute information since increasing public awareness of the home's improvements, owners usually results in higher curb appeal, resale value, etc. In addition merchants can induce or incentivize homeowners to provide endorsements in exchange for monetary rewards when there is a tangible correlation to a user's viewing of the home and selection of the merchant for a project. For example, a mobile user, seeing a new fence at a property, selects a homeowner brag tag identifying Acme as the contractor. This information is used by Acme to credit the home owner with an electronic coupon or some other form of consideration. This is yet another pathway for embodiments of the invention to let physical housing stock act as virtual billboards for vendors.

Owners may provide “needs” tags (I'm interested in X services) and opt-in is to cluster coupons (“I'm interested in collaborating with a neighbor for any of these services”) and so on. Owners are also neighbors, and can use such mode as well to provide “neighbor” tags as discussed herein.

Finally, while ancillary to some of the principles set forth herein, it is apparent that the tag model and relational database can be expanded to include other types of user commercial community interests. For example a user may be able to tag their home with classified tags that are visible to mobile users. A homeowner may specify:

Classified tags: SELL/OFFER

I have an X for sale (or a unit to rent)

My price is y$

You can reach me at:

Here is a picture:

Classified tags: Buy/Need

I need an X (desk, couch, TV)

My offer is y$

You can reach me at:

The inclusion of these types of tags makes it easier for neighbors to find and identify items of interest from persons and locations situated near them. A mobile user can thus easily query “find me mattresses for sale in these blocks” and obtain a visual map of home locations that have such items. Similarly, suggestion tags can be incorporated as well:

Request for suggestion tags:

a. I need a {blank} for {task X} (babysitter, dog sitter}

b. My price is y$

c. You can reach me at:

In addition to request for recommendation tags, recommendation referral tags can be provided as well: I recommend {blank} at {Y}. Other types of personal interest, service tags will be apparent as well, and can be integrated into the platform. For example persons who like to play particular games (chess, bridge, etc.) can identify themselves for community perusal. As noted herein, is owners may be qualified per the qualification process shown in FIG. 23 before their data is accepted.

Neighbors are also potential stakeholders in a property. FIG. 32D is a depiction of a property tag screen interface 3241 generated in accordance with the present teachings configured for inputting neighbor(hood) tags/metadata. Neighbors have unique information about properties and occupants that can be useful for prospective tenants, home buyers, etc. Preferably to rate a neighborhood or a property, a user must be within a block or address range specified for the neighborhood, or within a house in question. Thus, address verification can be performed as described herein or other means, including by confirming a location of the rater in question as described in FIG. 23. In some instances neighbor tags (and other tags) may be quarantined for a certain duration (a few hours, days) pending verification.

As with other tags, neighbor tags may be in free-form text, or predetermined responses. Some sample questions that can be asked and tagged include:
Neighborly/Unneighborly (or Neighborly? Y/N)
Kids/No kids (or Kids? (y/n)
Married/Unmarried
Religious/Non religious
Loud/Quiet
Animals/No Animals
Dogs Y/N Friendly/Unfriendly; Bark: occasionally/too much
Tidy/Messy
Landscape kept up/Landscape out of control
Nosey/Mind Their Own Business
Old/middle age/young
Street parking: shares/hogs
Noisy outdoor equipment: rarely/often
Boundary disputes? Rarely/often
Tree/hedge issues? Yes/No

Again it will be understood that these are but examples. In some instances because of privacy considerations (legal or voluntary) not all of this data can or should be compiled. Nonetheless using data from neighbors, embodiments of the present invention can compile and create “neighborhood” scores reflecting different sentiment, attitude, etc. by neighbors towards each other. This information is useful to persons looking to rent, buy, etc. in a particular locale.

First, each of the above questions can be assigned a value that is positive or negative. For example “neighborly” can be scored with a +1, “unneighborly” with a −1, and no response with a 0. Even with such limited information, each house/property can be assigned a value, and then aggregated across all properties for a street, neighborhood, etc., to derive a neighbor score.

Additional weighting for scoring may be included when more than one neighbor provides information about a particular property/occupants. For example, two different neighbors may rate a particular property (occupant(s)) as friendly or neighborly. The second vote or tag may be attenuated, or the total available score may be capped in some way to normalize comparisons across neighborhoods. For example a second “neighborly” vote may be scored by ½, a third vote by ¼, and so on. This will result in a theoretical max score of 2 for any particular property. Thus, affirmations or validations of other user data can be acknowledged and factored into a neighborhood score.

As a general formula, the number of neighbors (N) contributing scores and the aggregate score (S) is determined. When N is above some threshold (which can be specified as desired for any application to considered reliable) the ratio of N/S can be considered a primitive form of “neighborliness score” for a street, neighborhood, zip code, or any other desired bounded location.

Mutual similarly scored favorable ratings can also be considered in the neighborliness score, or presented separately as an absolute figure, a percentage of neighbors or ratings, and so on. That is, the number of mutual neighbor pairs assigning a favorable rating to each other can be considered as well as a form of “harmony factor,” as it may reflect community understanding, collaboration, etc. Conversely, a number of mutual negative ratings can be considered a form of discord and can be accounted for in any desired fashion. Furthermore other data mined from the tags, including positive and negative sentiment can be identified, using a text sentiment classifier. Such classifiers are currently used in other contexts, and can be modified to analyze the tags of the present invention as well. This allows a neighborliness score to be multi-dimensional, and to consider and be based on multiple easily measurable parameters of self-reporting including:

% of positive comments about a property

% of positive comments about occupants/neighbors

% of negative comments about property

% of negative comments about neighbors

Ratios of such positive/negative comment figures

“Sniping/strife” figures, including # and % of negative sentiment ratings between neighbors reporting on each other;

“Harmony” factor as noted above, including # and % of common sentiment ratings between neighbors reporting on each other;

“Picked on/pariah” figures, including # of targeted actors, and % of negative comments directed to such neighbors (or even a single neighbor)—this can help to identify if a neighborhood includes one or two actors that that appear to be disliked by a large fraction of neighbors;

“Model citizens”—as above, except based on positive sentiment

In other embodiments, all of such figures, scores, ratings, etc., can be normalized by the number of properties or occupants in the region in question. This ensures that a small absolute number of neighbors do not have a disproportionate impact on a neighborliness score. In addition, timing of ratings can be monitored to identify positive and negative trends, retaliation for negative comments, reciprocity for positive comments, and so on. Such acts of behavior can be used as well to factor into a neighborliness score.

In preferred embodiments, control of the scope of visible neighborhood data can be based on the identity or type of user. To protect privacy, data can be is aggregated on a street or block level, and anonymized. For example, general users interested in neighborhood scores can only see block (or other size) level data that is in aggregated form to protect privacy of both raters and subjects. Persons living in the neighborhood may see more detailed data for particular houses, but without information on attribution for any ratings or comments. Owners may see even more data, including both specific ratings and specific raters. That is, the characteristics of any particular house can be made private to only the occupant or owners thereof. The neighbor tag “engine” therefore can log contributors, tags, etc., and create individual property compilations/neighbor profiles.

Other major contributors to a tag relational database are expert codings as described above and seen generally again in FIG. 32E. As described above, expert raters identify, classify and rate structure features, which are captured as part of structure feature relational database. From this data, an automated tag generator (seen in FIG. 32G) creates tentative tags that are visible and useable in a mobile app or web interface.

The mapping of features to tags is relatively straightforward, and can be a simple synthesis of some or all of the feature, type, condition data fields discussed above. This can be done using a parser routine that uses a template configured to accept and decode data into distinct categories. For example, a facade may be stucco and in good shape. Each piece of coding metadata can be mapped to a corresponding tag in any desired form, and it will be understood that this is just an example.

Using such automated approach, each property should have a relatively large number of automated tentative tags. Again, however, since not are all equal in value to each user, they can be filtered as desired to any modality, or the status of the user. For example, only an owner of the property may be shown all the tags, while a neighbor may see a fraction of such; registered users or members of a platform may be constrained as well to see only certain types of tags.

In other modes (i.e., passerby or game) a filtering algorithm decides which is tags to display while the user is at such location, or perusing a property online. For example, it may be most useful or valuable, from a tag perspective, to identify and select the best two features and the two worst features, and ask a mobile app user to “confirm” them in an interface as part of the ratings game. This approach rewards both creation of new tags and confirmation of tentative tags as part of a mobile game and can help to induce and solicit large numbers of tags and ratings for target properties.

In a preferred approach, both positive and negative attributes are selected for presentation for two reasons, as seen in FIG. 32F. First, negative features (e.g., poor roof) help to generate leads for merchants. Positive features are included to validate and confirm the accuracy of expert coding using the rating tool discussed above. In addition positive tags can be used to engage more with homeowners, who will be motivated to provide feedback about their houses. As seen in FIG. 32F, any desired feature, type or condition can be selected for presentation in an interface. Furthermore cut-offs or other thresholds can be established to qualify inclusion (i.e., facade must rate 3 or 4 to be a positive tag, 1 or 2 to qualify as a negative tag). Again other formats and examples will be apparent from the present teachings.

The automated tags may be designated “tentative” tags in this scenario until they have been confirmed by live, on-site raters. This ensures continuing accurate, fresh data. Thus a tentative tag may be “Excellent Landscaping” and that tag is shown to a mobile user on location who is then asked to verify it as a volunteer or part of a house rating game. Again in preferred embodiments, merchant demand may be the driving catalyst for creating, identifying and presenting tags within a mobile interface.

FIG. 32G is a block diagram of the main components and flow of an automated system 3200 implemented in accordance with the present teachings. System 3200 includes an algorithm and platform that operate to achieve the goals described above, namely, collecting and presenting relevant property tags for interested stakeholders, which are synthesized and compiled, including in the types of records shown in FIG. 4.
Tag Types 3222: this specification is an electronic file or relational database containing logical descriptors in electronic form of the kinds of tags supported (game tags, expert tags, vendor tags, permit tags etc.), what their format is, etc.; preferably as noted above tags also include sub-types, so that different craftsmen can be differentiated by their specialty as well (contractors, carpenters, roofers, etc.)
Tag Format/Data 3224: this specification another electronic file or relational database that identifies what data fields make up a tag (Tag Id, property Id, what type; tag appearance; who added it; where it is to be placed in an interface, etc.) and similar information required for system 3200; an example of merchant tags are shown in FIGS. 31D, 31E;
Merchant onboarding routine 3220: this program assists merchants to select/configure tags, add them to platform 3200 as part of their extended gallery/portfolio to specific properties; in a simplest approach a vendor can simply specify addresses of jobs they have completed, a type of tag (or subtype) and any identifying information they wish to include (logo, content, URL) in the associated tag;
Merchant bids advertising tag bids routine 3226: as noted above, this routine permits merchants to bid on tags (including specific subtypes) or on queries; such tags can be shown in lieu of or in addition to other tags for a particular property, including other gallery tags; for example a window vendor may desire to on showing their tag in a “window” feature slot in a property canvass within a mobile or browser interface when such slot is available;
Merchant cluster specification 3228: this includes the same type of information as noted above for boxes 3053 and 3055 (FIG. 30C); this electronic files specifies such information as how big a cluster has to be, what tag, feature or service is targeted, etc. the merchant cluster specification may have access to the cluster db described above, which includes information on prior homeowners who opted in to clusters, and so on;
Expert DB 3212: this represents the expert coded set of metadata for properties, as collected through the present inventive interface and explained earlier for db 1654 (FIG. 16);
Tag dB 3214: the entire set of tags that have been created for every property in system 3200; this relational database may be broken up into separate tables indexed by key information (tag id, tag type, property id, tag creator, tag timestamp, tag content, etc.) as desire for any particular application;
Property-Tag dB: an indexed database or file which identifies, for each property ID, which tags (preferably tag IDs) are associated with such property;
Tag Demand engine 3205: as seen in the flow diagram, this routine monitors merchant request inputs and drives creation and synthesis of tags through tag “jobs” based on different parameters, including one or more of: a) merchants who pay for gallery projection (i.e., “I did windows for this house” originating from routine 3220) b) merchants who want to bid for placement for a tag (“If you like this house design, contact me”) from routine 3226—as noted above, this allows unclaimed houses to be the subject of competitive ad bidding; c) output from merchant cluster specification 3228, which helps to define a set of tags that are optimally desired or useable in system 3200; for example a merchant may specify that tags relating to “poor roofs” are preferably clustered in groups of 3 on a particular block; when tag demand engine scans a property-tag db 3213 and detects a group of 2 that meet the cluster criteria, a tag “job” may be initiated (output) by demand engine 3205 to help fill such cluster with another property within the relevant block; d) automated tag generator 3210 is configured to review property tag db 3212 to detect gaps, errors, or data that may be flagged as requiring additional verification or confirmation; for example, in field sampling may be used to confirm expert ratings; such samplings compare an onsite, in person rating for a feature Rf with the second hand, image based expert rating Re; when such analysis reveals that expert coding for a feature A tends to result in a ratings differential RA which exceeds a target error rate Rt (for example, roofs tend to be over or under rated by more than one grading value), then these features can be singled out for collection to increase a data accuracy of a property features relational database; e) other tag requests can be generated by additional routines or parameters 3207 which may be created by administrative requests, or other metadata from other databases; for example, a third party listing service may identify upcoming open houses, properties for sale, etc; these properties may benefit from new tags, so they are presented as well to tag demand engine 3205 for servicing; other sources may include local agency permit databases, which identify permits (jobs) at particular houses; by identifying such permits, including a type of work (e.g., roofing) a location, and a merchant (Acme), this information can be used to drive solicitation of tags for other homes near such location as potential neighbor-collaborators; in addition, realtor agents may request to have information on housing permit data to identify prospective housing stock going on the market, since sellers will frequently perform small jobs in anticipation of dressing up a property for listing;

The output from tag demand engine 3205 is preferably a set of tag jobs 3206, each of which includes at least a few basic pieces of information required by prioritization logic 3230, including as seen in FIG. 32H

property id; (i.e., to which structure the tag belongs)

tag id; (a numerical value to uniquely identify the tag)

tag type; (a specific property feature (i.e., roof, metal, poor condition); a cluster; an open ended tag; a general game tag;

tag format: (open ended (i.e., allows any input/modality); constrained (limited to specific questions, responses))

tag modality; (which modalities (neighbor, gamer, etc.) are to be solicited for input on the tag)

tag estimated value; (as described above)

tag expiration time; (a time limit for acquiring the tag)

tag content; (multimedia data for the tag, and/or pointers to data regarding a merchant or other entity)

tag expected fill probability; (a system estimate, based on historical observation for similar tag types, of a fulfillment rate through acquisition within the tag time limit);

tag limit/quota: how many times the tag can be acquired independently from different acquirers; in some instances it may be desired or useful to acquire multiple versions of the same tag for the property, to increase engagement with users, increase property profile coverage, etc.

It will be understood that this is just an example of what may be embodied by a tag job, and other variants will be useable depending on system parameters, requirements, etc. The tags may further include a field identifying the type of user (general mobile user, gamer, homeowner, etc.) that the tag should be solicited from. The format and data type for each field of the tag job will be a function of the particular application. The generation of tag jobs is easily implemented through routine coding using known software tools programmed based on the description herein. In addition, skilled artisans will appreciate that more basic versions of the tag acquisition may use only a small subset of such tag job characteristics.
Automated tag generator 3210: this routine uses expert ratings from db 3212, and tag db 3214, to automatically create or seed tags for properties in relational database 3213. In addition, local agency online permit data can be mined for purposes of identifying merchant projects at particular sites, and potential listing opportunities for realtors. From such data basic tags, including merchant, location, type of work, cost, dates, etc. can be gleaned and converted into an automated permit tag. Again the mapping used by such routine can be readily implemented using known software tools based on the present disclosure.
Tag prioritization logic 3230: this routine takes the tag jobs, organizes them, and pushes them out as tasks or requests to mobile users and other is interested stakeholders; as seen further in FIG. 32J this logic preferably uses a basic queue or incoming buffer 3231 to store incoming tag jobs on a first-in-first out basis; the tags are then preferably adjusted or sorted into a separate prioritized queue 3232 by scheduling logic 3233, which in turn is preferably driven by system based targeting logic, and not simply time of request alone; for example, as noted above, a system may consider the estimated value of a tag in determining what priority to assign to it for acquisition; the estimated value, in turn, may be based on the tag estimated value and its estimated fill rate specified in the tag job; other parameters may be considered as well in determining the ordering or prioritization of tag jobs by logic 3230; as with the other routines described herein, the algorithm and structure of such routine can be readily implemented using known software tools based on the present disclosure. Tag scheduler 3233 also does housekeeping tasks, such as noting tags which have expired, identifying tags which have been acquired or fulfilled (as output by tag acquisition engine 3235), determining if a tag has reached a quota and so on. By logging the completion of task jobs, routine 3236 can account for task job traffic, acquisition rates, etc., and develop a model and understanding of a task acquisition probability through different capture modalities. The tag prioritization logic 3220 then pushes out the tag jobs in a prioritized fashion through tag requester 3234 to a tag filter/acquisition routine 3235, along with any other metadata or device/platform specifics required to assist with the tag acquisition process from interested participants in the platform. Additional targeting logic may be employed by tag request routine 3234 to solicit the particular tag job through a particular modality (homeowner, gamer, etc.) or from particular persons in particular areas to maximize the probability of acquiring the tag in question. For example it makes more sense to solicit tags about a particular property from system participants who are located nearby, or from game participants who may be incentive to acquire such tag as part of achieving a game goal or objective. In addition the tag requester may is also send out tag job nullification messages after determining that a tag has been acquired
Tag Filter/Acquisition Logic 3235: this routine takes the task jobs, and routes them to participants in the platform for completion. The participants may be different stakeholders 3237 (homeowners neighbors 3239, volunteers, gamers, professionals, and so on) who interact with system 3200 in different ways or modalities. As noted above, particular tags may be requested from particular acquirers based on a location of a property, a location of a participant, and so on. In other instances this logic can access the feedback/redemption behavior of individual user/participants (including as compiled by a game routine, or game achievement logic) and direct tag jobs to persons deemed to be most active users, or most likely to respond to a tag acquisition request.
Tag presentation logic 3240: this algorithm selects which tags will be shown for a property within a mobile app, a web interface, etc., depending on the participant and the mode of data capture. The status of the user (i.e., what type of stakeholder, or whether they are registered, a member of the platform, etc.) can also be considered. Examples of this are shown above in FIG. 32B, 32C, 32D, 32E, etc. It should be noted that in most instances, a tag request option can be enabled or disabled so that casual users are not required to see an output from acquisition logic 3235. Thus such persons can simply use an interface to add tags at their own pace, whim, interests, etc. In a viewing mode, or query mode, any and all tags associated with a property may be displayed to a user. Additional filtering can implemented for users so that they are only shown particular tags for particular features. In other words, a pedestrian may request to only see the merchant tags for paint jobs of the houses as they stroll a neighborhood. Another user may request to only see cluster related tags, to assist in developing a cluster group of common service/product needs. Other users may only be interested in landscaping tags, and so on. The filtering can be implemented in accordance with any parameter controllable by platform 3200 and thus can be extremely flexible and engaging. In some instances the presentation logic can include a “learn” mode, by which it learns from the behavior of a user and modify its behavior accordingly. For example the presentation logic may note that a user is in a mood or mindset to be examining windows and doors of properties of interest. This is determined by analyzing the types of tags requested, the types of tags selected, etc., in a particular session. When the user has expressed a clear interest in a certain type of property feature, the presentation logic 3240 can automatically select appropriate tags for presentation in available slots within the interface. This modality can be employed until the user begins to show interest in another type of feature or tag, or manually resets the learn mode. This feature can be easily implemented based on the current disclosure and the current knowledge of the art by skilled artisans. In addition, in a “push” mode, where tag requests are implemented and sent out for fulfillment to data acquirers, it may be useful to incorporate additional prioritization at the device/user level, to avoid tag request overload. For example, a particular participant may be qualified, eligible or designated to receive N different tag requests. The user can control which tags to fulfill, in the same manner as identified above for controlling which tags to view. Furthermore the user's location can be identified, so that only relevant tags for such locale are requested, Finally, other factors, including tag estimated value, can be implemented at the last mile or sidewalk level of engagement, so that the most useful or valuable tags are solicited from a particular user at any time. The prioritization of tag acquisition at the device level can be adjusted in a number of different ways therefore according to system requirements, feedback, etc. Another aspect that can be incorporated, as discussed above, is tag advertising from an engine 3270. This may be implemented as discussed above for FIG. 22, FIGS. 25A and 25B as well. Merchants can bid to present tags on features or queries made by users to a platform so that they can be exposed to potential clients reviewing or is seeking home improvement or other products/services. These ads, as noted above, may be presented in addition to or in lieu of other tags when none are available for a particular property. For example, a merchant may mine an expert ratings db 3210 to identify properties having superior roofs. When a property is seen by a user, such merchant may present their tag within the interface in the absence of a gallery credit tag to another merchant for such feature, The advertising logic may be implemented in accordance again with selected system requirements.
Tag engagement logic 3245: this routine measures user queries, user selection of tags, user creation of tags (including in response to tag requests) and other interactions. This data is output to the tag acquisition logic 3235 which performs housekeeping tasks to identify newly created tags. This data is used also to compile profiles of users as well, to determine their tag job completion rate, tag interests, etc. so that they can be considered for later tag acquisitions. In addition, the engagement logic creates and outputs relevant tag lead information, which may include one or more of the following items of data: 1) property id; 2) user id; 3) tag data (tag types, tag ids, etc.); 4) other user content (query, media, etc.)
Tag analytics routine 3260; this routine measures which tags are viewed, captured, and by whom, etc.; each participant's tags are logged as well to credit their accounts as part of a leaderboard, game achievement or similar recognition. One output, for example, identifies to a merchant whether a user interacted with a tag, a query, etc. relating to the merchant, or some service/product offered by the merchant. These are then used by a merchant lead engine 3262 to create a feed, report, or other database for merchant review/consumption, including through an API. The output may take the form as seen in FIGS. 18A, 18B, 19 and FIG. 24 as well. This routine can optionally include other natural language processing, mapping, etc., to decode and map queries and tag content into categories, features, etc., as described above. This permits free form entry of lightweight content through spoken dialog inputs, which is most convenient for mobile applications. Other types of metrics that can be generated include:
   Tags Added
   How many total tags contributed in entire system?
   Number of tags contributed per user
   Variety of tags contributed (topic area)
   positive/negative sentiment in tags
   Tags selected/seen
   Number of tags selected, and what type
   Number of total leads created
   Number of leads broken down by feature
   Engagement with leads
Other Outputs: as tags are created, they are pushed to db 3213 and used to populate the database there. User Q Stream 3247 includes content from users as they pose questions or questions tags, which are then broadcast or pushed out to rest of users for response; for example, a user may ask “does anyone know what kind of material this is” and so on; User tag stream 3249: this includes an unfiltered feed of all the tags users are creating; parts of such feed may be broadcast to other distribution channels, including Twitter, social media, etc.; In addition, both users and merchants can customize a mobile app or other interface to generate system alerts of interest. These can be made wide in scope (across an entire city or zip code) or narrow (across a single block of addresses on the same street) For example, a user may want to see examples of new projects in their neighborhood, or new tags identifying garage doors (to see examples), etc. When viewing properties in a live, in person mode, a gamer/user can also filter an experience to only see tags created within a certain recent time period as well, to avoid seeing duplicate or stale information. Consequently stakeholders can identify specific projects, features, properties, etc. for which they want to receive alerts about. These can be geographically defined as well for particular areas of interest. Other examples will be apparent to those skilled in the art.

As will be apparent to those skilled in the art the aforementioned diagrams, figures and discussion provide substantial architectural framework to permit a skilled artisan to implement such features as described.

Embodiments of the invention thus permit assessment of and predictions for building stock, including occupancy, individual and aggregate element condition, prospects for purchase, etc. Analysis is made both of physical objects (through captured data including in image form, or on location) and virtual objects to identify, assess and rate properties. While the main application is described in connection with assisting property seekers, home improvement merchants, real estate personnel and others to assess and develop leads for real estate prospects for single family residences, and home improvement services, a number of other uses can be made of the data captured and processed by embodiments of the present invention, including:
1) Insurance: policy premiums, risk assessments, etc., can be based on an evaluation of an upkeep/maintenance evidenced for a particular property; in this respect correlations may be developed between property condition ratings, occupancy estimates and number of claims filed, type of claim, severity, etc. For example a property insurer is likely to be interested in knowing if a building is vacant and thus more likely to be vandalized or have a higher risk of arson, etc. Other potential hazards (trees that are too close or overgrown, dilapidated ancillary structures adjacent to a structure, undesirable and dangerous fixtures (trampolines etc.) can be identified by insurers and used to adjust premiums on a structure by structure basis. Other similar uses will be apparent to skilled artisans;
2) Air quality/pollution estimation: government agencies and other stakeholders are likely to benefit from long term, longitudinal studies of building structure appearances, as they can reflect air pollution and presence of other chemicals in the air deleterious to building façades (and potentially humans). The invention can be used to study and examine differences in large numbers of structures located in particular neighborhoods at different time intervals for this purpose.
3) Home improvement/construction: builders and suppliers of building materials will benefit from direct access to a relational database of building stock condition data. Queries can be made to determine particular conditions in particular building elements for enhanced targeted advertising. For example suppliers of paint products can quickly develop a targeted list of prospects likely to need renovation. Overall assessments and estimates can be made for repairs/improvements to an entire building structure simply from processing the image data. Other examples will be apparent from the present teachings.
4) Banks/appraisers: property “comps” for a particular target property can be based more accurately on other properties having an identical building envelope, architectural style, visual aesthetic, etc.
5) Aging of materials: if the image stock for the properties is updated, long term evaluations of wear/aging characteristics of individual building elements can be assessed over time. Estimates and predictions can then be made of the age of a particular façade element (paint, siding, roof) simply by comparing such elements to reference norms of a known age.
6) Plants/foliage: Frequently house seekers or other similarly interested parties desire more information on landscaping features of a property, such as the identity of particular trees, flowers, plants or other foliage. Again such information can be captured by the on site viewers using a camera and matched against entries already logged in database 142, or some other relational database. For example users may capture publicly viewable foliage information at a location, tag it with appropriate descriptors, and make it available to other persons. When a second user visits the site later, there may be preexisting entries for the foliage in question which can be queried against to identify plants, flowers, trees, etc. Alternatively in some embodiments it may be possible to perform an image match against a botanical image database (not shown) which can determine the identify of such plant items. In this manner the natural elements of a neighborhood may also be mapped out to allow for is identification of particular types of flowers, trees or plants of interest. For example walking/nature tours could be divined from identifying specific property locations of prominent rose plants, oak trees, or other foliage in particular neighborhoods. This would facilitate further neighborhood exploration by local citizens interested in mapping out the natural elements of their environment and surroundings.

While the primary uses for some of the advertising materials are expected to be structure-specific, it is entirely possible that other providers of goods and services (doctors, dentists, etc.) may be able to exploit competitive intelligence in the aforementioned platform 2250 for purposes of piggybacking their own advertising content.

In general, by comparing publicly recorded owner data, including age and other demographics against building structure condition data, additional insights and useful correlations can be developed and exploited. It will be understood by those skilled in the art that the above are merely examples and that countless variations on the above can be implemented in accordance with the present teachings. A number of other conventional steps that would be included in a commercial application have been omitted, as well, to better emphasize the present teachings.

It will also be apparent to those skilled in the art that the modules of the present invention, including those illustrated in the figures can be implemented using any one of many known programming languages suitable for creating applications that can run on large scale computing systems, including servers connected to a network (such as the Internet). The details of the specific implementation of the present invention will vary depending on the programming language(s) used to embody the above principles, and are not material to an understanding of the present invention. Furthermore, in some instances, a portion of the hardware and software will be contained locally to a member's computing system, which can include a portable machine or a computing machine at the users premises, such as a personal computer, a PDA, digital video recorder, receiver, etc.

Furthermore it will be apparent to those skilled in the art that this is not the entire set of software modules that can be used, or an exhaustive list of all operations executed by such modules. It is expected, in fact, that other features will be added by system operators in accordance with customer preferences and/or system performance requirements. Furthermore, while not explicitly shown or described herein, the details of the various software routines, executable code, etc., required to effectuate the functionality discussed above in such modules are not material to the present invention, and may be implemented in any number of ways known to those skilled in the art. Such code, routines, etc. may be stored in any number of forms of machine readable media. The above descriptions are intended as merely illustrative embodiments of the proposed inventions. It is understood that the protection afforded the present invention also comprehends and extends to embodiments different from those above, but which fall within the scope of the present claims.

What is claimed is:

1. A method of rating a physical condition of properties and structures with a computing system comprising:
a. analyzing a database of property structure features for homes in a geographic region to identify structural data that includes at least three ratable components:
i. an identity of a physical feature at a property; wherein said identity of said physical feature is selected from a predetermined set of physical features each having a feature value within a first range of values;
ii. a type associated with said physical feature; wherein said type of said physical feature is selected from a predetermined set of physical feature types each having a feature type value within a second range of values;
iii. a condition associated with said physical feature; wherein said condition of said physical feature is selected from a predetermined set of physical feature conditions each having a feature condition value within a third range of values;
b. compiling a structural profile of each property based on said structural data, which profile includes all physical features of said property and their associated type(s) and associated condition(s);
c. providing a customizable filtering and scoring interface, which interface can be configured in accordance with a first user definition to select and/or weight individual ones of any or all of said predetermined set of physical features, said individual ones of said predetermined set of physical feature types, and said individual ones of predetermined set of physical feature conditions;
d. based on said configuration of said customizable filtering and scoring interface in accordance with said first user definition, calculating a customized home score for at least a target property based on said feature values, said feature type values and said feature condition values;
e. presenting said customized home score in an interface which includes individual interactive regions corresponding to said set of physical features.

2. The method of claim 1 further including steps: computing a noise score for a property based on analyzing ambient noise in a vicinity of such property; adjusting said customized home score based on said noise score.

3. The method of claim 2 wherein said ambient noise is collected from mobile computing devices without requiring explicit activation by users of such devices.

4. The method of claim 1 further including a step: computing a vehicle traffic score for a property based on analyzing traffic in a vicinity of such property; is adjusting said customized home score based on said vehicle traffic score.

5. The method of claim 1 wherein said set of physical features for said property are identified with annotations in predesignated portions of said interface.

6. The method of claim 1 further including a step: computing a customized home score for other properties in said geographic region associated with the target property and presenting a relative score of such target property compared to such other properties.

7. A method of rating a curb appeal of properties with a computing system comprising:
a. analyzing a database of property structure features for homes in a geographic region to calculate and assign a first structural rating for a first target property at a first location;
wherein said first structure rating is based on identifying a first set of individual physical features and scoring such features based on their associated first individual physical condition;
b. repeating step (a) for other homes in said geographic region to identify a second set of individual physical features and calculate a plurality of second structural ratings for homes in proximity to said first location;
c. assigning a second feature set rating to said first target property based on identifying an extent of an overlap between said first set is of individual physical features and said second set of individual physical features;
d. calculating a curb appeal score for said first target property based on said first structure rating, said second structural ratings, and said second feature set rating;
wherein said curb appeal score can be customized by filtering or selecting individual ones of said first set of physical features.

8. The method of claim 7, wherein both a base score and weighting can be adjusted for each individual one of said first set of physical features.

9. The method of claim 7 wherein a home value score based on a predicted fair market value is included as part of said curb appeal score.

10. The method of claim 7 including a step: outputting a visual heat map indicating curb appeal scores in one or more neighborhoods.

11. The method of claim 7 wherein other homes in said geographic region include neighbors of said first target property in proximity to said first location, including a second neighbor property and a third neighbor property.

12. The method of claim 11 wherein said neighbors are located immediately adjacent on either side of said first target property.
